(19) United States
(12) Patent Application Publication
(10) Pub. No.: US 2020/0404919 A1
(43) Pub. Date: Dec. 31, 2020

(54) USE OF HETEROARYL-TRIAZOLE AND HETEROARYL-TETRAZOLE COMPOUNDS AS PESTICIDES IN PLANT PROTECTION

(71) Applicant: Bayer Aktiengesellschaft, Leverkusen (DE)

(72) Inventors: Hans-Georg SCHWARZ, Dorsten (DE); Werner HALLENBACH, Nordhorn (DE); Alexander ARLT, Koeln (DE); Kerstin ILG, Koeln (DE); Marc LINKA, Duesseldorf (DE); Elke HELLWEGE, Langenfeld (DE); Ulrich EBBINGHAUS-KINTSCHER, Dortmund (DE); Sebastian HORSTMANN, Leverkusen (DE); Peter JESCHKE, Bergisch Gladbach (DE); Martin FUESSLEIN, Duesseldorf (DE); Yolanda CANCHO GRANDE, Leverkusen, (DE); Arunas Jonas DAMIJONAITIS, Leverkusen (DE)

(21) Appl. No.: 16/977,903

(22) PCT Filed: Mar. 5, 2019
(86) PCT No.: PCT/EP2019/055368

§ 371 Date: Sep. 3, 2020

(30) Foreign Application Priority Data
Mar. 8, 2018 (EP) 18160736.7
Jul. 26, 2018 (EP) 18185778.0

(51) Int. Cl. A01N 43/653

(52) U.S. Cl. CPC A01N 43/653

(57) ABSTRACT

The present invention relates to the use of heteroaryl-triazole and heteroaryl-tetrazole compounds, to the use of formulations and compositions comprising such compounds for controlling animal pests, including arthropods and insects, in plant protection.

The present invention relates to the use of heteroaryl-triazole and heteroaryl-tetrazole compounds, to the use of formulations and compositions comprising such compounds for controlling animal pests, including arthropods and insects, in plant protection.

Heteroaryl-triazole and heteroaryl-tetrazole compounds of Formula I are disclosed for the use in controlling ectoparasites on animals in WO 2017/192385. Plant protection properties were not described or disclosed.

Crop protection compositions, which also include pesticides, have to meet many demands, for example in relation to efficacy, persistence, spectrum, resistance breaking properties, pollinator and beneficial safety of their action and possible use. Questions of toxicity, the combinability with other active compounds or formulation auxiliaries play a role, as well as the question of the expense that the synthesis of an active compound requires. Furthermore, resistances may occur. For all these reasons, the search for novel crop protection compositions cannot be considered to be complete, and there is a constant need for novel compounds having properties which, compared to the known compounds, are improved at least in respect of individual aspects.

It was an object of the present invention to provide compounds which widen the spectrum of plant protection pesticides in various aspects. Surprisingly, it was discovered that known heteroaryl-triazole and heteroaryl-tetrazole compounds of Formula I provide broad insecticidal activity in the field of plant protection.

The present invention provides therefore the use of compounds of Formula I:

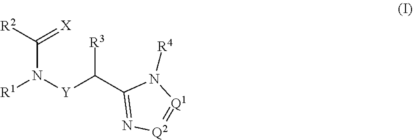

wherein:
X is O or S;
Q¹ and Q² are independently CR⁵ or N, provided at least one of Q and Q² is N;
Y is a direct bond or CH₂;
R¹ is H; C₁-C₆alkyl optionally substituted with one substituent selected from: CN, CONH₂, COOH, NO₂ and —Si(CH₃)₃; C₁-C₆haloalkyl; C₂-C₆alkenyl; C₂-C₆haloalkenyl; C₂-C₆alkynyl; C₂-C₆haloalkynyl; C₃-C₄cycloalkyl-C₁-C₂alkyl- wherein the C₃-C₄cycloalkyl is optionally substituted with 1 or 2 halo atoms; oxetan-3-yl-CH₂—; or benzyl optionally substituted with halo or C₁-C₃haloalkyl;
R² is phenyl, pyridine, pyrimidine, pyrazine or pyridazine, wherein the phenyl, pyridine, pyrimidine, pyrazine or pyridazine is optionally substituted with one to three substituents, provided the substituent(s) are not on either carbon adjacent to the carbon bonded to the

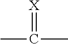

group, each independently selected from: C₁-C₃alkyl, C₁-C₃haloalkyl, C₁-C₃haloalkylsulfanyl, C₁-C₃alkoxy, C₁-C₃haloalkoxy, halo, NO₂, SF₅, CN, CONH₂, COOH and C(S)NH₂;
R³ is C₁-C₃alkyl or C₁-C₃haloalkyl;
R⁴ is pyridine, pyrimidine, pyrazine or pyridazine, wherein the pyridine, pyrimidine, pyrazine or pyridazine is optionally substituted with one substituent selected from: C₁-C₃alkyl, C₁-C₃haloalkyl, C₁-C₃alkoxy, C₃-C₄cycloalkyl, halo or hydroxy;
R⁵ is H, C₁-C₃alkyl, C₁-C₃haloalkyl, C₃-C₄cycloalkyl, C₁-C₃alkoxy, C₁-C₃alkoxyC(O)— or (C₁-C₃alkoxy)₂CH—;
   or a salt thereof,
   for controlling animal pests, including arthropods and insects, in plant protection.

In an alternative embodiment the present invention provides the use of compounds of Formula I:

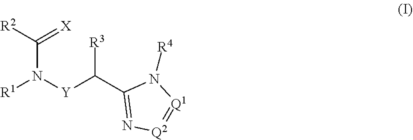

wherein:
X is O or S;
Q¹ and Q² are independently CR⁵ or N, provided at least one of Q¹ and Q² is N;
Y is a direct bond or CH₂;
R¹ is H; C₁-C₆alkyl optionally substituted with one substituent selected from: CN, CONH₂, COOH and NO₂; C₁-C₆haloalkyl; C₂-C₆alkenyl; C₂-C₆haloalkenyl: C₂-C₆alkynyl; C₂-C₆haloalkynyl; C₃-C₄cycloalkyl-C₁-C₂alkyl- wherein the C₃-C₄cycloalkyl is optionally substituted with 1 or 2 halo atoms; oxetan-3-yl-CH₂—; or benzyl optionally substituted with halo or C₁-C₃haloalkyl;
R² is phenyl, pyridine, pyrimidine, pyrazine or pyridazine, wherein the phenyl, pyridine, pyrimidine, pyrazine or pyridazine is optionally substituted with one to three substituents, provided the substituent(s) are not on either carbon adjacent to the carbon bonded to the

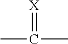

group, each independently selected from: C₁-C₃alkyl, C₁-C₃haloalkyl, C₁-C₃haloalkylsulfanyl, C₁-C₃alkoxy, C₁-C₃haloalkoxy, halo, NO₂, SF₅, CN, CONH₂ and COOH; R³ is C₁-C₃alkyl or C₁-C₃haloalkyl;
R⁴ is pyridine, pyrimidine, pyrazine or pyridazine, wherein the pyridine, pyrimidine, pyrazine or pyridazine is optionally substituted with one substituent selected from: C₁-C₃alky; C₁-C₃haloalkyl, C₁-C₃alkoxy, C₁-C₄cycloalkyl, halo or hydroxy;
R⁵ is H, C₁-C₃alkyl, C₁-C₃haloalkyl, C₃-C₄cycloalkyl or C₁-C₃alkoxy;
   or a salt thereof,
   for controlling animal pests including arthropods and insects in plant protection.

As one of ordinary skill in the art will appreciate, compounds of Formula I contain a stereogenic centre which is indicated with an asterisk in the structure below:

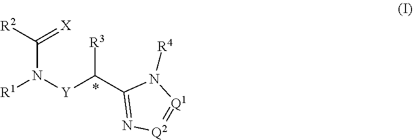

The present invention contemplates the use of both racemates and individual enantiomers. Compounds having preferred stereochemistry are set out below.

Preferred compounds of Formula I or salts thereof include compounds having one or more of the following features:
a) Y is a direct bond;
b) X is O:
c) X is S;
d) R³ is methyl;
e) Q¹ is N;
f) Q² is CR⁵ and R⁵ is H, C₁-C₃alkyl, C₁-C₃alkoxyC(O)—, or (C₁-C₃alkoxy)₂CH—;
f-2) Q² is CR⁵ and R⁵ is H, C₁-C₃alkyl, C₁-C₃alkoxyC(O)—, (C₁-C₃alkoxy)₂CH— or C₁-C₃haloalkyl;
g) Q² is CR⁵ and R⁵ is H, C₁-C₃alkyl, or (C₁-C₃alkoxy)₂CH—;
g-2) Q² is CR⁵ and R⁵ is H, C₁-C₃alkyl, (C₁-C₃alkoxy)₂CH— or C₁-C₃haloalkyl;
h) Q² is CR⁵ and R⁵ is H or C₁-C₃alkyl;
h-2) Q² is CR⁵ and R⁵ is H, C₁-C₃alkyl or C₁-C₃haloalkyl;
i) Q² is CR⁵ and R⁵ is H, methyl or (CH₃CH₂O)₂CH—;
i-2) Q² is CR⁵ and R is H, methyl, (CH₃CH₂O)₂CH— or CF₃;
j) Q² is CR⁵ and R⁵ is H or methyl;
j-2) Q² is CR⁵ and R⁵ is H, methyl or CF₃;
k) Q² is CR⁵ and R⁵ is H;
k-2) Q² is CR⁵ and R⁵ is H or CF₃;
l) Q¹ is N, Q² is CR⁵ and R⁵ is H, methyl or (CH₃CH₂O)₂CH—;
l-2) Q¹ is N, Q² is CR⁵ and R⁵ is H, methyl, (CH₃CH₂O)₂CH— or CF₃;
m) Q¹ is N, Q² is CR⁵ and R⁵ is H or methyl;
m-2) Q¹ is N, Q² is CR⁵ and R⁵ is H, methyl or CF₃;
m′) R⁴ is 2-pyridine, 3-pyridine, 4-pyridine, 2-pyrimidine, 4-pyrimidine, 5-pyrimidine, 2-pyrazine, 3-pyridazine or 4-pyridazine, wherein the 2-pyridine, 3-pyridine, 4-pyridine, 2-pyrimidine, 4-pyrimidine, 5-pyrimidine, 2-pyrazine, 3-pyridazine or 4-pyridazine is optionally substituted with one substituent selected from: C₁-C₃alkoxy, halo, or C₁-C₃haloalkyl
m′-2) R⁴ is 2-pyridine, 3-pyridine, 4-pyridine, 2-pyrimidine, 4-pyrimidine, 5-pyrimidine, 2-pyrazine, 3-pyridazine or 4-pyridazine, wherein the 2-pyridine, 3-pyridine, 4-pyridine, 2-pyrimidine, 4-pyrimidine, 5-pyrimidine, 2-pyrazine, 3-pyridazine or 4-pyridazine is optionally substituted with one substituent selected from: C₁-C₃alkoxy, halo, C₁-C₃haloalkyl, or C₁-C₃alkyl
n) R⁴ is a 2-pyridine optionally substituted with halo; or 2-pyrimidine optionally substituted with C₁-C₃alkoxy or halo;
n-2) R⁴ is a 2-pyridine optionally substituted with F, Cl, Br, I, C₁-C₃alkyl or C₁-C₃haloalkyl; or 2-pyrimidine optionally substituted with C₁-C₃alkoxy, F, Cl, Br, I, C₁-C₃alkyl or C₁-C₃haloalkyl;
o) R⁴ is a 2-pyridine optionally substituted with halo; or 2-pyrimidine optionally substituted with C₁-C₃alkoxy;
o-2) R⁴ is a 2-pyridine optionally substituted with F, Cl, Br, I, methyl, ethyl, propyl, or CF₃; or 2-pyrimidine optionally substituted with C₁-C₃alkoxy, F, Cl, Br, I, methyl, ethyl, propyl, CHF₂, or CF₃;
p) R⁴ is 2-pyridine or 2-pyrimidine;
p-2) R⁴ is 2-pyridine, 2-pyrimidine, 5-fluoro-2-pyridine, 5-chloro-2-pyridine, 5-bromo-2-pyridine, or 5-(trifluoromethyl)-2-pyridine;
q) R⁴ is 2-pyrimidine;
q-2) R⁴ is 2-pyrimidine, 5-fluoro-2-pyrimidine, 5-chloro-2-pyrimidine, 5-bromo-2-pyrimidine, or 5-(trifluoromethyl)-2-pyrimidine;
r) R¹ is H; C₁-C₆haloalkyl; C₁-C₆alkyl optionally substituted with CN or Si(CH₃)₃; C₃-C₆alkynyl; C₃-C₄cycloalkyl-C₁-C₂alkyl wherein the C₃-C₄cycloalkyl is optionally substituted with 1 or 2 halo atoms; oxetan-3-yl-CH₂—; or benzyl optionally substituted with halo;
s) R¹ is H; C₁-C₆haloalkyl; C₁-C₆alkyl optionally substituted with CN or Si(CH₃)₃; C₃-C₆alkynyl; C₃-C₄cycloalkyl-C₁-C₂alkyl wherein the C₃-C₄cycloalkyl is optionally substituted with 1 or 2 halo atoms;
t) R¹ is C₁-C₆haloalkyl; C₁-C₆alkyl; C₃-C₆alkynyl; C₃-C₄cycloalkyl-C₁-C₂alkyl wherein the C₃-C₄cycloalkyl is optionally substituted with 1 or 2 halo atoms;
t-2) R¹ is C₁-C₆haloalkyl; C₁-C₆alkyl optionally substituted with CN; C₃-C₆alkynyl; C₃-C₄cycloalkyl-C₁-C₂alkyl wherein the C₃-C₄cycloalkyl is optionally substituted with 1 or 2 halo atoms; or benzyl optionally substituted with halo;
u) R¹ is H, cyclopropyl-CH₂—, cyclobutyl-CH₂—, CH₃—, CH₃CH₂—, n-propyl, CH═C—CH₂—, CF₃CH₂CH₂—, FCH₂CH₂—, FCH₂CH₂CH₂—, CHF₂CH₂—, 2,2-difluorocyclopropyl-CH₂—, 2,2-dichlorocyclopropyl-CH₂—, benzyl, 4-fluorobenzyl, 3-oxetanyl, (CH₃)₃SiCH₂— or CN—CH₂—;
v) R¹ is H, cyclopropyl-CH₂—, cyclobutyl-CH₂—, CH₃—, CH₃CH₂—, n-propyl, CH═C—CH₂—, CF₃CH₂CH₂—, FCH₂CH₂—, FCH₂CH₂CH₂—, CHF₂CH₂—, 2,2-difluorocyclopropyl-CH₂, 2,2-dichlorocyclopropyl-CH₂—, benzyl, 3-oxetanyl or (CH₃)₃SiCH₂—;
w) R¹ is H, cyclopropyl-CH₂—, cyclobutyl-CH₂—, CH₃—, CH₃CH₂—, n-propyl, CH═C—CH₂—, CF₃CH₂CH₂—, FCH₂CH₂—, FCH₂CH₂CH₂—, CHF₂CH₂—, 2,2-difluorocyclopropyl-CH₂—, or (CH₃)₃SiCH₂—;
x) R¹ is H, cyclopropyl-CH₂—, cyclobutyl-CH₂—, CH₃—, CH₃CH₂—, n-propyl, CH≡C—CH₂—, CF₃CH₂CH₂—, FCH₂CH₂—, FCH₂CH₂CH₂—, CHF₂CH₂—, or 2,2-difluorocyclopropyl-CH₂—;
x′) R¹ is H, cyclopropyl-CH₂—, cyclobutyl-CH₂—, CH₃—, CH₃CH₂—, n-propyl, CH≡C—CH₂—, CF₃CH₂CH₂—, FCH₂CH₂—, FCH₂CH₂CH₂— or CHF₂CH₂—;
y) R¹ is H, cyclopropyl-CH₂—, cyclobutyl-CH₂—, CH₃—, CH₃CH₂—, CH≡C—CH₂—, CF₃CH₂CH₂— or CHF₂CH₂—;
z) R¹ is H, cyclopropyl-CH₂—, CH₃—, CH₃CH₂—, CH≡C—CH₂—, CF₃CHCH₂— or CHF₂CH₂—;
aa) R¹ is H, cyclopropyl-CH₂—, CH₃—, CH₃CH₂—, CF₃CH₂CH₂— or CHF₂—CH₂—;
bb) R² is phenyl, 3-pyridine or 4-pyridine substituted with one to three substituents selected from: C₁-C₃haloalkyl, C₁-C₃haloalkoxy, C₁-C₃haloalkylsulfanyl, halo, CN or C(S)NH₂, provided the substituent(s) are not on either carbon adjacent to the carbon bonded to the

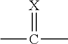

group;
bb-2) R² is phenyl, 2-pyridine, 2-pyrazine, 3-pyridine or 4-pyridine substituted with one to three substituents selected from: C₁-C₃alkyl, C₁-C₃haloalkyl, C₁-C₃haloalkoxy, C₁-C₃haloalkylsulfanyl, halo, CN or C(S)NH₂, provided the substituent(s) are not on either carbon adjacent to the carbon bonded to the

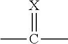

group;
cc) R² is phenyl, 3-pyridine or 4-pyridine substituted with one to three substituents selected from: C₁-C₃haloalkyl, C₁-C₃haloalkoxy, C₁-C₃haloalkylsulfanyl, halo or CN, provided the substituent(s) are not on either carbon adjacent to the carbon bonded to the

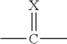

group;
cc-2) R² is phenyl, 2-pyridine, 2-pyrazine, 3-pyridine or 4-pyridine substituted with one to three substituents selected from: C₁-C₃alkyl, C₁-C₃haloalkyl, C₁-C₃haloalkoxy, C₁-C₃haloalkylsulfanyl, halo or CN, provided the substituent(s) are not on either carbon adjacent to the carbon bonded to the

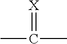

group;
dd) R² is phenyl or 3-pyridine substituted with one to three substituents selected from: C₁-C₃haloalkyl, C₁-C₃haloalkoxy, C₁-C₃haloalkylsulfanyl, halo or CN, provided the substituent(s) are not on either carbon adjacent to the carbon bonded to the

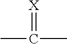

group;
dd-2) R² is phenyl, 2-pyridine, 2-pyrazine, or 3-pyridine substituted with one to three substituents selected from: C₁-C₃alkyl, C₁-C₃haloalkyl, C₁-C₃haloalkoxy, C₁-C₃haloalkylsulfanyl, halo or CN, provided the substituent(s) are not on either carbon adjacent to the carbon bonded to the

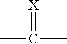

group;
ee) R² is 3,5-bis(trifluoromethyl)phenyl, 3,5-dichlorophenyl, 3,4,5-trichlorophenyl, 3-chlorophenyl, 4-chlorophenyl, 3,4-dichlorophenyl, 3-trifluoromethoxyphenyl, 3-chloro-5-trifluoromethylphenyl, 3-cyanophenyl, 3-chloro-5-trifluoromethoxyphenyl, 5-trifluoromethylpyridin-3-yl, 5-bromopyridin-3-yl, 5-trifluoromethylsulfanylpyridin-3-yl, 3-bromo-5-trifluoromethylphenyl, 3-cyano-5-trifluoromethyl-phenyl, 3-chloro-5-cyanophenyl, 3-trifluoromethoxy-5-chlorophenyl, 3-trifluoromethylsulfanylphenyl, 3-trifluoromethylsulfanyl-5-chlorophenyl, or 2,6-bis(trifluoromethyl)pyridin-4-yl;
ee-2) R² is 3,5-bis(trifluoromethyl)phenyl, 3,5-dichlorophenyl, 3,4,5-trichlorophenyl, 3-chlorophenyl, 4-chlorophenyl, 3,4-dichlorophenyl, 3-trifluoromethoxyphenyl, 3-chloro-5-trifluoromethylphenyl, 3-cyanophenyl, 3-chloro-5-trifluoromethoxyphenyl, 5-trifluoromethylpyridin-3-yl, 5-bromopyridin-3-yl, 5-trifluoromethylsulfanylpyridin-3-yl, 3-bromo-5-trifluoromethylphenyl, 3-cyano-5-trifluoromethyl-phenyl, 3-chloro-5-cyanophenyl, 3-trifluoromethoxy-5-chlorophenyl, 3-trifluoromethylsulfanylphenyl, 3-trifluoromethylsulfanyl-5-chlorophenyl, 2,6-bis(trifluoromethyl)pyridin-4-yl, 3,5-dimethylphenyl, 4-trifluoromethyl-6-chloropyridin-2-yl, 4,6-dichloropyridin-2-yl, 6-chloropyridazin-2-yl, 3-bromo-5-chlorophenyl, 3-iodo-5-chlorophenyl, 4-chloro-3,5-difluorophenyl, 3-fluoro-5-cyanophenyl, or 3-chloro-[(2,2,2-trifluoroethyl)sulfanyl]phenyl;
ff) R² is 3,5-bis(trifluoromethyl)phenyl, 3,5-dichlorophenyl, 3-trifluoromethoxyphenyl, 3-chloro-5-trifluoromethylphenyl, 3-cyanophenyl, 3-chloro-5-cyanophenyl, 3-chloro-5-trifluoromethoxyphenyl, 3-chloro-5-trifluoromethylsulfanylphenyl, 5-trifluoromethylpyridin-3-yl, 3-bromo-5-trifluoromethylphenyl or 3-cyano-5-trifluoromethylphenyl;
ff-2) R² is 3,5-bis(trifluoromethyl)phenyl, 3,5-dichlorophenyl, 3-trifluoromethoxyphenyl, 3-chloro-5-trifluoromethylphenyl, 3-cyanophenyl, 3-chloro-5-cyanophenyl, 3-chloro-5-trifluoromethoxyphenyl, 3-chloro-5-trifluoromethylsulfanylphenyl, 5-trifluoromethylpyridin-3-yl, 3-bromo-5-trifluoromethylphenyl, 3-cyano-5-trifluoromethyl-phenyl, 3,5-dimethylphenyl, 4-trifluoromethyl-6-chloropyridin-2-yl, 4,6-dichloropyridin-2-yl, 6-chloropyridazin-2-yl, 3-bromo-5-chlorophenyl, 3-iodo-5-chlorophenyl, 4-chloro-3,5-difluorophenyl, 3-fluoro-5-cyanophenyl, or 3-chloro-[(2,2,2-trifluoroethyl)sulfanyl]phenyl;
gg) R² is 3,5-bis(trifluoromethyl)phenyl, 3,5-dichlorophenyl, 3-trifluoromethoxyphenyl, 3-chloro-5-trifluoromethylphenyl, 3-cyanophenyl, 3-chloro-5-trifluoromethoxyphenyl, 3-chloro-5-trifluoromethylsulfanylphenyl, or 5-trifluoromethylpyridin-3-yl;
gg-2) R² is 3,5-bis(trifluoromethyl)phenyl, 3,5-dichlorophenyl, 3-trifluoromethoxyphenyl, 3-chloro-5-trifluoromethylphenyl, 3-cyanophenyl, 3-chloro-5-trifluoromethoxyphenyl, 3-chloro-5-trifluoromethylsulfanylphenyl, 5-trifluoromethylpyridin-3-yl, 3,5-dimethylphenyl, 4-trifluoromethyl-6-chloropyridin-2-yl, 4,6-dichloropyridin-2-yl, 6-chloropyridazin-2-yl, 3-bromo-5-chlorophenyl, 3-iodo-5-chlorophenyl, 4-chloro-3,5-difluorophenyl, 3-fluoro-5-cyanophenyl, or 3-chloro-[(2,2,2-trifluoroethyl)sulfanyl]phenyl;
hh) R² is 3,5-bis(trifluoromethyl)phenyl, 3-chloro-5-trifluoromethylphenyl, 3-cyanophenyl, 3-chloro-5-trifluoromethoxyphenyl, 3-chloro-5-trifluoromethylsulfanylphenyl, 5-trifluoromethylpyridin-3-yl or 3-cyano-5-trifluoromethylphenyl;
hh-2) R² is 3,5-bis(trifluoromethyl)phenyl, 3-chloro-5-trifluoromethylphenyl, 3-cyanophenyl, 3-chloro-5-trifluoromethoxyphenyl, 3-chloro-5-trifluoromethylsulfanylphenyl, 5-trifluoromethylpyridin-3-yl, 3-cyano-5-trifluoromethylphenyl, 3,5-dimethylphenyl, 4-trifluoromethyl-6-chloropyridin-2-yl, 4,6-dichloropyridin-2-yl, 6-chloropyridazin-2-yl, 3-bromo-5-chlorophenyl, 3-iodo-5-chlorophenyl, 4-chloro-3,5-difluorophenyl, 3-fluoro-5-cyanophenyl, or 3-chloro-[(2,2,2-trifluoroethyl)sulfanyl]phenyl;
ii) R² is 3,5-bis(trifluoromethyl)phenyl, 3-chloro-5-trifluoromethylphenyl, 3-chloro-5-trifluoromethoxyphenyl, 3-chloro-5-trifluoromethylsulfanylphenyl, or 5-trifluoromethylpyridin-3-yl;
ii-2) R² is 3,5-bis(trifluoromethyl)phenyl, 3-chloro-5-trifluoromethylphenyl, 3-chloro-5-trifluoromethoxyphenyl, 3-chloro-5-trifluoromethylsulfanylphenyl, 5-trifluoromethylpyridin-3-yl, 3,5-dimethylphenyl, 4-trifluoromethyl-6-chloropyridin-2-yl, 4,6-dichloropyridin-2-yl, 6-chloropyridazin-2-yl, 3-bromo-5-chlorophenyl, 3-iodo-5-chlorophenyl, 4-chloro-3,5-difluorophenyl, 3-fluoro-5-cyanophenyl, or 3-chloro-[(2,2,2-trifluoroethyl)sulfanyl]phenyl;
jj) R² is 3,5-bis(trifluoromethyl)phenyl or 3-chloro-5-trifluoromethylsulfanylphenyl;
jj-2) R² is 3,5-bis(trifluoromethyl)phenyl, 3-chloro-5-trifluoromethylsulfanylphenyl, 3,5-dimethylphenyl, 4-trifluoromethyl-6-chloropyridin-2-yl, 4,6-dichloropyridin-2-yl, 6-chloropyridazin-2-yl, 3-bromo-5-chlorophenyl, 3-iodo-5-chlorophenyl, 4-chloro-3,5-difluorophenyl, 3-fluoro-5-cyanophenyl, or 3-chloro-[(2,2,2-trifluoroethyl)sulfanyl]phenyl.

For controlling animal pests, including arthropods and insects, in plant protection, preferred compounds of the present invention are compounds of Formula II′:

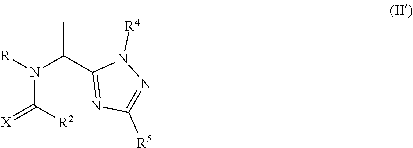

X is O or S;
R¹ is H; C₁-C₆haloalkyl; C₁-C₆alkyl optionally substituted with CN or —Si(CH₃)₃; C₃-C₆alkynyl; C₃-C₄cycloalkyl-C₁-C₂alkyl wherein the C₃-C₄cycloalkyl is optionally substituted with 1 or 2 halo atoms; oxetan-3-yl-CH₂—; or benzyl optionally substituted by halo;
R² is phenyl, 3-pyridine or 4-pyridine substituted with one to three substituents selected from: C₁-C₃haloalkyl, C₁-C₃haloalkoxy, C₁-C₃haloalkylsulfanyl, halo, CN or C(S)NH₂, provided the substituent(s) are not on either carbon adjacent to the carbon bonded to the

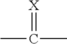

group;
R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with one substituent selected from: C₁-C₃alkoxy, halo, or C₁-C₃haloalkyl;
R⁵ is H, C₁-C₃alkyl, C₁-C₃alkoxyC(O)— or (C₁-C₃alkoxy)₂CH—,
   or a salt thereof.

In an alternative embodiment, for controlling animal pests, including arthropods and insects, in plant protection, preferred compounds of the present invention are compounds of Formula II′:

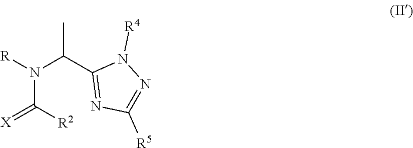

X is O or S;
R¹ is H; C₁-C₆haloalkyl; C₁-C₆alkyl optionally substituted with CN or —Si(CH₃)₃; C₃-C₆alkynyl; C₃-C₄cycloalkyl-C₁-C₂alkyl wherein the C₃-C₄cycloalkyl is optionally substituted with 1 or 2 halo atoms; oxetan-3-yl-CH₂—; or benzyl optionally substituted by halo;
R² is phenyl, 2-pyridine, 2-pyrazine, 3-pyridine or 4-pyridine substituted with one to three substituents selected from: C₁-C₃alkyl, C₁-C₃haloalkyl, C₁-C₃haloalkoxy, C₁-C₃haloalkylsulfanyl, halo, CN or C(S)NH₂, provided the substituent(s) are not on either carbon adjacent to the carbon bonded to the

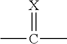

group;
R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with with one substituent selected from: C₁-C₃alkoxy, halo, C₁-C₃haloalkyl, or C₁-C₃alkyl;
R⁵ is H, C₁-C₃alkyl, C₁-C₃alkoxyC(O)—, (C₁-C₃alkoxy)₂CH—, or C₁-C₃haloalkyl, or a salt thereof.

For controlling animal pests, including arthropods and insects, in plant protection, preferred compounds of the present invention are compounds of Formula II:

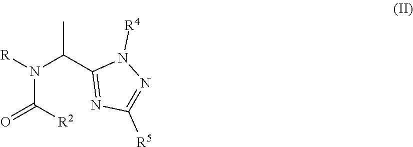

wherein:
R¹ is H; C₁-C₆haloalkyl; C₁-C₆alkyl; C₃-C₆alkynyl; benzyl, 3-oxetanyl or C₃-C₄cycloalkyl-C₁-C₂alkyl wherein the C₃-C₄cycloalkyl is optionally substituted with 1 or 2 halo atoms;
R² is phenyl or 3-pyridine substituted with one to three substituents selected from C₁-C₃haloalkyl, C₁-C₃haloalkoxy, C₁-C₃haloalkylsulfanyl, halo or CN, provided the substituent(s) are not on either carbon adjacent to the carbon bonded to the

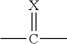

group;
R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with with one substituent selected from: C₁-C₃alkoxy, halo, or C₁-C₃haloalkyl
R⁵ is H or C₁-C₃alkyl, or a salt thereof.

In an alternative embodiment, for controlling animal pests, including arthropods and insects, in plant protection, preferred compounds of the present invention are compounds of Formula II:

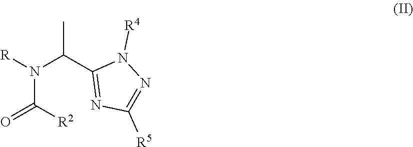

wherein:
R¹ is H; C₁-C₆haloalkyl; C₁-C₆alkyl optionally substituted with CN; C₃-C₆alkynyl; benzyl optionally substituted with halo; 3-oxetanyl or C₃-C₄cycloalkyl-C₁-C₂alkyl wherein the C₃-C₄cycloalkyl is optionally substituted with 1 or 2 halo atoms;
R² is phenyl, 2-pyridine, 2-pyrazine or 3-pyridine substituted with one to three substituents selected from C₁-C₃alkyl, C₁-C₃haloalkyl, C₁-C₃haloalkoxy, C₁-C₃haloalkylsulfanyl, halo or CN, provided the substituent(s) are not on either carbon adjacent to the carbon bonded to the

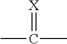

group;
R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with with one substituent selected from: C₁-C₃alkoxy, halo, C₁-C₃haloalkyl, or C₁-C₃-alkyl
R⁵ is H, C₁-C₃alkyl, or C₁-C₃haloalkyl, or a salt thereof.

For controlling animal pests, including arthropods and insects, in plant protection, particularly preferred compounds of the present invention are compounds of Formula II′a or IIa:

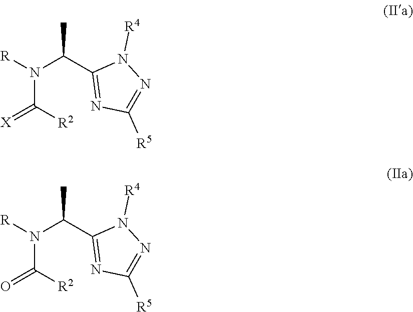

wherein
X, R¹, R², R⁴ and R are as defined for Formula II′ or Formula II respectively; or a salt thereof.

For controlling animal pests, including arthropods and insects, in plant protection, preferred compounds of Formula I, II′ and II′a, or salts thereof, include those in which R¹ is H, cyclopropyl-CH₂—, cyclobutyl-CH₂, CH₃—, CH₃CH₂—, n-propyl, CH≡C—CH₂—, CF₃CH₂CH₂—, CHF₂CH₂, —FCH₂CH₂—, FCH₂CH₂CH₂—, 2,2-difluorocyclopropyl-CH₂—, 2,2-dichlorocyclopropyl-CH₂—, benzyl, 4-fluorobenzyl, 3-oxetanyl, (CH₃)₃SiCH₂—, or CN—CH₂—; R² is 3,5-bis(trifluoromethyl)phenyl, 3,5-dichlorophenyl, 3-trifluoromethoxyphenyl, 3-chloro-5-trifluoromethylphenyl, 3-cyanophenyl, 3-chloro-5-trifluoromethoxyphenyl, 3-chloro-5-trifluoromethylsulfanylphenyl, 5-trifluoromethylpyridin-3-yl, 3-bromo-5-trifluoromethylphenyl, 3-cyano-5-trifluoromethylphenyl or 2,6-bis(trifluoromethyl)pyridin-4-yl; R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with one substituent selected from: C₁-C₃alkoxy, halo, or C₁-C₃haloalkyl; and R⁵ is H, methyl or (CH₃CH₂O)₂CH—In an alternative embodiment, for controlling animal pests, including arthropods and insects, in plant protection, preferred compounds of Formula I, II′ and II′a, or salts thereof, include those in which R¹ is H, cyclopropyl-CH₂—, cyclobutyl-CH₂, CH₃—, CH₃CH₂—, n-propyl, CH≡C—CH₂—, CF₃CH₂CH₂—, CHF₂CH₂, —FCH₂CH₂—, FCH₂CH₂CH₂—, 2,2-difluorocyclopropyl-CH₂—, 2,2-dichlorocyclopropyl-CH₂—, benzyl, 4-fluorobenzyl, 3-oxetanyl, (CH₃)₃SiCH₂—, or CN—CH₂—; R² is 3,5-bis(trifluoromethyl)phenyl, 3,5-dichlorophenyl, 3,5-dimethylphenyl, 3-bromo-5-chlorophenyl, 3-iodo-5-chlorophenyl, 4-chloro-3,5-difluorophenyl, 3-trifluoromethoxyphenyl, 3-chloro-5-trifluoromethylphenyl, 3-cyanophenyl, 3-fluoro-5-cyanophenyl, 3-chloro-[(2,2,2-trifluoroethyl)sulfanyl]phenyl, 3-chloro-5-trifluoromethoxyphenyl, 3-chloro-5-trifluoromethylsulfanylphenyl, 5-trifluoromethylpyridin-3-yl, 3-bromo-5-trifluoromethylphenyl, 3-cyano-5-trifluoromethylphenyl, 4-trifluoromethyl-6-chloropyridin-2-yl, 4,6-dichloropyridin-2-yl, 6-chloropyridazin-2-yl, or 2,6-bis(trifluoromethyl)pyridin-4-yl; R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with one substituent selected from: C₁-C₃alkoxy, halo, C₁-C₃haloalkyl or C₁-C₃alkyl; and R⁵ is H, methyl, (CH₃CH₂O)₂CH— or trifluoromethyl.

For controlling animal pests, including arthropods and insects, in plant protection, preferred compounds of Formula I, II′, II, II′a and IIa, or salts thereof, include those in which R¹ is H, cyclopropyl-CH₂—, cyclobutyl-CH₂, CH₃—, CH₃CH₂—, n-propyl, CH≡C—CH₂—, CF₃CH₂CH₂—, CHF₂CH₂—, FCH₂CH₂—, FCH₂CH₂CH₂—, benzyl, 4-fluorobenzyl, 3-oxetanyl, 2,2-difluorocyclopropyl-CH₂— or 2,2-dichlorocyclopropyl-CH₂—; R² is 3,5-bis(trifluoromethyl)phenyl, 3,5-dichlorophenyl, 3,4,5-trichlorophenyl 3-chlorophenyl, 4-chlorophenyl, 3,4-dichlorophenyl, 3-trifluoromethoxyphenyl, 3-chloro-5-trifluoromethylphenyl, 3-cyanophenyl, 3-chloro-5-trifluoromethoxyphenyl, 3-chloro-5-trifluoromethylsulfanylphenyl, 5-trifluoromethylpyridin-3-yl, 5-bromopyridin-3-yl, 5-trifluoromethylsulfanylpyridin-3-yl, 3-bromo-5-trifluoromethylphenyl, 3-cyano-5-trifluoromethyl-phenyl 3-chloro-5-cyanophenyl, 3-trifluoromethoxy-5-chlorophenyl, 3-trifluoromethylsulfanylphenyl, 3-trifluoromethylsulfanyl-5-chlorophenyl, or 2,6-bis(trifluoromethyl)pyridin-4-yl; is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with one substituent selected from: C₁-C₃alkoxy, halo, or C₁-C₃haloalkyl and R⁵ is H or methyl.

In an alternative embodiment, for controlling animal pests, including arthropods and insects, in plant protection, preferred compounds of Formula I, II′, II, II′a and IIa, or salts thereof, include those in which R¹ is H, cyclopropyl-CH₂—, cyclobutyl-CH₂, CH₃—, CH₃CH₂—, n-propyl, CH≡C—CH₂—, CF₃CH₂CH₂—, CHF₂CH₂—, FCH₂CH₂—, FCH₂CH₂CH₂—, benzyl, 4-fluorobenzyl, 3-oxetanyl, 2,2-difluorocyclopropyl-CH₂—, 2,2-dichlorocyclopropyl-CH₂— or CN—CH₂—; R² is 3,5-bis(trifluoromethyl)phenyl, 3,5-dichlorophenyl, 3,5-dimethylphenyl, 3-bromo-5-chlorophenyl, 3-iodo-5-chlorophenyl, 3,4,5-trichlorophenyl, 4-chloro-3,5-difluorophenyl, 3-chlorophenyl, 4-chlorophenyl, 3,4-dichlorophenyl, 3-trifluoromethoxyphenyl, 3-chloro-5-trifluoromethylphenyl, 3-cyanophenyl, 3-chloro-5-trifluoromethoxyphenyl, 3-chloro-5-trifluoromethylsulfanylphenyl, 5-trifluoromethylpyridin-3-yl, 5-bromopyridin-3-yl, 5-trifluoromethylsulfanylpyridin-3-yl, 3-bromo-5-trifluoromethylphenyl, 3-cyano-5-trifluoromethyl-phenyl, 3-chloro-5-cyanophenyl, 3-fluoro-5-cyanophenyl, 3-trifluoromethoxy-5-chlorophenyl, 3-trifluoromethylsulfanylphenyl, 3-chloro-[(2,2,2-trifluoroethyl)sulfanyl]phenyl, 3-trifluoromethylsulfanyl-5-chlorophenyl, 4-trifluoromethyl-6-chloropyridin-2-yl, 4,6-dichloropyridin-2-yl, 6-chloropyridazin-2-yl, or 2,6-bis(trifluoromethyl)pyridin-4-yl; is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with one substituent selected from: C₁-C₃alkoxy, halo, C₁-C₃haloalkyl or C₁-C₃alkyl and R⁵ is H, methyl or trifluoromethyl.

For controlling animal pests, including arthropods and insects, in plant protection, further preferred compounds of Formula I, II′, II, II′a and IIa, or salts thereof, include those in which R¹ is H, cyclopropyl-CH₂—, cyclobutyl-CH₂, CH₃—, CH₃CH₂—, n-propyl, CH≡C—CH₂—, CF₃CH₂CH₂—, CHF₂CH₂—, FCH₂CH₂—, FCH₂CH₂CH₂—, benzyl, 4-fluorobenzyl, 3-oxetanyl or 2,2-difluorocyclopropyl-CH₂—; R² is 3,5-bis(trifluoromethyl)phenyl, 3,5-dichlorophenyl, 3,4,5-trichlorophenyl, 3-chlorophenyl, 4-chlorophenyl, 3,4-dichlorophenyl, 3-trifluoromethoxyphenyl, 3-chloro-5-trifluoromethylphenyl, 3-cyanophenyl, 3-chloro-5-trifluoromethoxyphenyl, 5-trifluoromethylpyridin-3-yl, 5-bromopyridin-3-yl, 5-trifluoromethylsulfanylpyridin-3-yl, 3-bromo-5-trifluoromethylphenyl, 3-cyano-5-trifluoromethyl-phenyl, 3-chloro-5-cyanophenyl, 3-trifluoromethoxy-5-chlorophenyl, 3-trifluoromethylsulfanylphenyl, 3-trifluoromethylsulfanyl-5-chlorophenyl, 3-chloro-5-trifluoromethylsulfanylphenyl, or 2,6-bis(trifluoromethyl)pyridin-4-yl; R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with one substituent selected from: C₁-C₃alkoxy, halo, or C₁-C₃haloalkyl; and R⁵ is H or methyl.

In an alternative embodiment, for controlling animal pests, including arthropods and insects, in plant protection, further preferred compounds of Formula I, II′, II, II′a and IIa, or salts thereof, include those in which R¹ is H, cyclopropyl-CH₂—, cyclobutyl-CH₂, CH₃—, CH₃CH₂—, n-propyl, CH≡C—CH₂—, CF₃CH₂CH₂—, CHF₂CH₂—, FCH₂CH₂—, FCH₂CH₂CH₂—, benzyl, 4-fluorobenzyl, 3-oxetanyl, 2,2-difluorocyclopropyl-CH₂— or CN—CH₂—; R² is 3,5-bis(trifluoromethyl)phenyl, 3,5-dichlorophenyl, 3,5-dimethylphenyl, 3-bromo-5-chlorophenyl, 3-iodo-5-chlorophenyl, 3,4,5-trichlorophenyl, 4-chloro-3,5-difluorophenyl, 3-chlorophenyl, 4-chlorophenyl, 3,4-dichlorophenyl, 3-trifluoromethoxyphenyl, 3-chloro-5-trifluoromethylphenyl, 3-cyanophenyl, 3-chloro-5-trifluoromethoxyphenyl, 5-trifluoromethylpyridin-3-yl, 5-bromopyridin-3-yl, 5-trifluoromethylsulfanylpyridin-3-yl, 3-bromo-5-trifluoromethylphenyl, 3-cyano-5-trifluoromethyl-phenyl, 3-chloro-5-cyanophenyl, 3-fluoro-5-cyanophenyl, 3-trifluoromethoxy-5-chlorophenyl, 3-trifluoromethylsulfanylphenyl, 3-chloro-[(2,2,2-trifluoroethyl)sulfanyl]phenyl, 3-trifluoromethylsulfanyl-5-chlorophenyl, 3-chloro-5-trifluoromethylsulfanylphenyl, 4-trifluoromethyl-6-chloropyridin-2-yl, 4,6-dichloropyridin-2-yl, 6-chloropyridazin-2-yl, or 2,6-bis(trifluoromethyl)pyridin-4-yl; R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with one substituent selected from: C₁-C₃alkoxy, halo, C₁-C₃haloalkyl or C₁-C₃alkyl; and R is H, methyl or trifluoromethyl.

For controlling animal pests, including arthropods and insects, in plant protection, further preferred compounds of Formula I, II′, II, II′a and IIa, or salts thereof, include those in which R¹ is H, cyclopropyl-CH₂—, cyclobutyl-CH₂—, CH₃—, CH₃CH₂—, n-propyl, CH≡C—CH₂—, CF₃CH₂CH₂—, CHF₂CH₂—, FCH₂CH₂, FCH₂CH₂CH₂—, benzyl or 3-oxetanyl; R² is 3,5-bis(trifluoromethyl)phenyl, 3,5-dichlorophenyl, 3,4,5-trichlorophenyl, 3-chlorophenyl, 4-chlorophenyl, 3,4-dichlorophenyl, 3-trifluoromethoxyphenyl, 3-chloro-5-trifluoromethylphenyl, 3-cyanophenyl, 3-chloro-5-trifluoromethoxyphenyl, 3-chloro-5-trifluoromethylsulfanylphenyl, 5-trifluoromethylpyridin-3-yl, 5-bromopyridin-3-yl, 5-trifluoromethylsulfanylpyridin-3-yl, 3-bromo-5-trifluoromethylphenyl, 3-cyano-5-trifluoromethyl-phenyl, 3-chloro-5-cyanophenyl, 3-trifluoromethoxy-5-chlorophenyl, 3-trifluoromethylsulfanylphenyl, 3-trifluoromethylsulfanyl-5-chlorophenyl, or 2,6-bis(trifluoromethyl)pyridin-4-yl; R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with one substituent selected from: C₁-C₃alkoxy, halo, or C₁-C₃haloalkyl; and R⁵ is H or methyl.

In an alternative embodiment, for controlling animal pests, including arthropods and insects, in plant protection, further preferred compounds of Formula I, II′, II, II′a and IIa, or salts thereof, include those in which R¹ is H, cyclopropyl-CH₂—, cyclobutyl-CH₂—, CH₃—, CH₃CH₂—, n-propyl, CH≡C—CH₂—, CF₃CH₂CH₂—, CHF₂CH₂—, FCH₂CH₂, FCH₂CH₂CH₂—, benzyl, 4-fluorobenzyl; 3-oxetanyl or CN—CH₂—; R² is 3,5-bis(trifluoromethyl)phenyl, 3,5-dichlorophenyl, 3,5-dimethylphenyl, 3-bromo-5-chlorophenyl, 3-iodo-5-chlorophenyl, 3,4,5-trichlorophenyl, 4-chloro-3,5-difluorophenyl, 3-chlorophenyl, 4-chlorophenyl, 3,4-dichlorophenyl, 3-trifluoromethoxyphenyl, 3-chloro-5-trifluoromethylphenyl, 3-cyanophenyl, 3-chloro-5-trifluoromethoxyphenyl, 3-chloro-5-trifluoromethylsulfanylphenyl, 5-trifluoromethylpyridin-3-yl, 5-bromopyridin-3-yl, 5-trifluoromethylsulfanylpyridin-3-yl, 3-bromo-5-trifluoromethylphenyl, 3-cyano-5-trifluoromethyl-phenyl, 3-chloro-5-cyanophenyl, 3-fluoro-5-cyanophenyl, 3-trifluoromethoxy-5-chlorophenyl, 3-trifluoromethylsulfanylphenyl, 3-chloro-[(2,2,2-trifluoroethyl)sulfanyl]phenyl, 3-trifluoromethylsulfanyl-5-chlorophenyl, 4-trifluoromethyl-6-chloropyridin-2-yl, 4,6-dichloropyridin-2-yl, 6-chloropyridazin-2-yl, or 2,6-bis(trifluoromethyl)pyridin-4-yl; R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with one substituent selected from: C₁-C₃alkoxy, halo, C₁-C₃haloalkyl, or C₁-C₃alkyl; and R⁵ is H, methyl or trifluoromethyl.

For controlling animal pests, including arthropods and insects, in plant protection, further preferred compounds of Formula I, II′, and II′a, or salts thereof, include those in which R¹ is H, cyclopropyl-CH₂—, cyclobutyl-CH—, CH₃, CH₃CH₂—, CF₃CHCH₂—, CHF₂CH—, benzyl, 3-oxetanyl, or CH≡C—CH—: R² is 3,5-bis(trifluoromethyl)phenyl, 3,5-dichlorophenyl, 3,4,5-trichlorophenyl, 3-chlorophenyl, 4-chlorophenyl, 3,4-dichlorophenyl, 3-trifluoromethoxyphenyl, 3-chloro-5-trifluoromethylphenyl, 3-cyanophenyl, 3-chloro-5-trifluoromethoxyphenyl, 5-trifluoromethylpyridin-3-yl, 5-bromopyridin-3-yl, 5-trifluoromethylsulfanylpyridin-3-yl, 3-bromo-5-trifluoromethylphenyl, 3-cyano-5-trifluoromethyl-phenyl, 3-chloro-5-cyanophenyl, 3-trifluoromethoxy-5-chlorophenyl, 3-chloro-5-trifluoromethylsulfanylphenyl, 3-trifluoromethylsulfanylphenyl, 3-trifluoromethylsulfanyl-5-chlorophenyl, or 2,6-bis(trifluoromethyl)pyridin-4-yl; R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with one substituent selected from: C₁-C₃alkoxy, halo, or C₁-C₃haloalkyl: and R⁵ is H, methyl or (CH₃CH₂O)₂CH—.

In an alternative embodiment, for controlling animal pests, including arthropods and insects, in plant protection, further preferred compounds of Formula I, II, and II′a, or salts thereof, include those in which R¹ is H, cyclopropyl-CH₂—, cyclobutyl-CH₂, CH₃—, CH₃CH₂—, CF₃CH₂CH₂—, CHF₂CH₂—, benzyl, 4-fluorobenzyl, 3-oxetanyl, CN—CH₂—, or CH≡C—CH₂—; R² is 3,5-bis(trifluoromethyl)phenyl, 3,5-dichlorophenyl, 3,5-dimethylphenyl, 3-bromo-5-chlorophenyl, 3-iodo-5-chlorophenyl, 3,4,5-trichlorophenyl, 4-chloro-3,5-difluorophenyl, 3-chlorophenyl, 4-chlorophenyl, 3,4-dichlorophenyl, 3-trifluoromethoxyphenyl, 3-chloro-5-trifluoromethylphenyl, 3-cyanophenyl, 3-chloro-5-trifluoromethoxyphenyl, 5-trifluoromethylpyridin-3-yl, 5-bromopyridin-3-yl, 5-trifluoromethylsulfanylpyridin-3-yl, 3-bromo-5-trifluoromethylphenyl, 3-cyano-5-trifluoromethyl-phenyl, 3-chloro-5-cyanophenyl, 3-fluoro-5-cyanophenyl, 3-trifluoromethoxy-5-chlorophenyl, 3-chloro-5-trifluoromethylsulfanylphenyl, 3-chloro-[2,2,2-trifluoroethyl)sulfanyl]phenyl, 3-trifluoromethylsulfanylphenyl, 3-trifluoromethylsulfanyl-5-chlorophenyl, 4-trifluoromethyl-6-chloropyridin-2-yl, 4,6-dichloropyridin-2-yl, 6-chloropyridazin-2-yl, or 2,6-bis(trifluoromethyl)pyridin-4-yl; R⁴ is 2-pyridine, 3-pyridine, 4-pyridine 2-pyrimidine, 4-pyrimidine, 5-pyrimidine, 2-pyrazine, 3-pyridazine or 4-pyridazine, wherein the 2-pyridine, 3-pyridine, 4-pyridine 2-pyrimidine, 4-pyrimidine, 5-pyrimidine, 2-pyrazine, 3-pyridazine or 4-pyridazine is optionally substituted with one substituent selected from: C₁-C₃alkyl, C₁-C₃alkoxy, halo, or C₁-C₃haloalkyl: and R⁵ is H, methyl, trifluoromethyl or (CH₃CH₂O)₂CH—.

For controlling animal pests, including arthropods and insects, in plant protection, a preferred compound of the present invention is N-(cyclopropylmethyl)-N-[1-(2-pyrimidin-2-yl-1,2,4-triazol-3-yl)ethyl]-3,5-bis(trifluoromethyl)benzamide (I-48), or a salt thereof. An especially preferred compound is N-(cyclopropylmethyl)-N-[(1S)-1-(2-pyrimidin-2-yl-1,2,4-triazol-3-yl)ethyl]-3,5-bis(trifluoromethyl)benzamide (I-49), or a salt thereof. Another preferred compound of the present invention is N-prop-2-ynyl-N-[1-(2-pyrimidin-2-yl-1,2,4-triazol-3-yl)ethyl]-3,5-bis(trifluoromethyl)benzamide (I-35), or a salt thereof. An especially preferred compound is N-prop-2-ynyl-N-[(1S)-1-(2-pyrimidin-2-yl-1,2,4-triazol-3-yl)ethyl]-3,5-bis(trifluoromethyl)benzamide (I-46), or a salt thereof. Another preferred compound of the present invention is N-methyl-N-[1-(2-pyrimidin-2-yl-1,2,4-triazol-3-yl)ethyl]-3,5-bis(trifluoromethyl)benzamide (I-65), or a salt thereof. An especially preferred compound is N-methyl-N-[(1S)-1-(2-pyrimidin-2-yl-1,2,4-triazol-3-yl)ethyl]-3,5-bis(trifluoromethyl)-benzamide (I-75), or a salt thereof.

Another preferred compound of the present invention is 3-chloro-N-(cyclopropylmethyl)-N-[1-(2-pyrimidin-2-yl-1,2,4-triazol-3-yl)ethyl]-5-(trifluoromethyl)benzamide (I-06), or a salt thereof.

Another preferred compound of the present invention is 3-chloro-N-[1-(2-pyrimidin-2-yl-1,2,4-triazol-3-yl)ethyl]-5-(trifluoromethyl)-N-(3,3,3-trifluoropropyl)benzamide (I-26), or a salt thereof.

Another preferred compound of the present invention is N-(cyclopropylmethyl)-N-[1-(2-pyrimidin-2-yl-1,2,4-triazol-3-yl)ethyl]-5-(trifluoromethyl)pyridine-3-carboxamide (I-28), or a salt thereof.

Another preferred compound of the present invention is 3-chloro-N-(cyclopropylmethyl)-N-[1-(2-pyrimidin-2-yl-1,2,4-triazol-3-yl)ethyl]-5-(trifluoromethoxy)benzamide (I-37), or a salt thereof.

Another preferred compound of the present invention is 3-cyano-N-(cyclopropylmethyl)-N-[1-(2-pyrimidin-2-yl-1,2,4-triazol-3-yl)ethyl]benzamide (I-38), or a salt thereof.

Another preferred compound of the present invention is 3-chloro-N-(cyclopropylmethyl)-N-[1-(2-pyrimidin-2-yl-1,2,4-triazol-3-yl)ethyl]-5-(trifluoromethyl)benzamide (I-40), or a salt thereof.

Another preferred compound of the present invention is 3-chloro-N-prop-2-ynyl-N-[1-(2-pyrimidin-2-yl-1,2,4-triazol-3-yl)ethyl]-5-(trifluoromethyl)benzamide (I-41), or a salt thereof.

Another preferred compound of the present invention is 3-cyano-N-(cyclopropylmethyl)-N-[1-(2-pyrimidin-2-yl-1,2,4-triazol-3-yl)ethyl]-5-(trifluoromethyl)benzamide (I-50), or a salt thereof.

Another preferred compound of the present invention is 3-bromo-N-(cyclopropylmethyl)-N-[1-(2-pyrimidin-2-yl-1,2,4-triazol-3-yl)ethyl]-5-(trifluoromethyl)benzamide (I-62), or a salt thereof.

Another preferred compound of the present invention is N-[1-(2-pyrimidin-2-yl-1,2,4-triazol-3-yl)ethyl]-3,5-bis(trifluoromethyl)benzamide (I-63), or a salt thereof. An especially preferred compound is N-[(1S)-1-(2-pyrimidin-2-yl-1,2,4-triazol-3-yl)ethyl]-3,5-bis(trifluoromethyl)benzamide (I-66), or a salt thereof.

Another preferred compound of the present invention is 3-chloro-N-[1-(2-pyrimidin-2-yl-1,2,4-triazol-3-yl)ethyl]-5-(trifluoromethylbenzamide (I-76), or a salt thereof. An especially preferred compound is 3-chloro-N-[(1S)-1-(2-pyrimidin-2-yl-1,2,4-triazol-3-yl)ethyl]-5-(trifluoromethyl)benzamide (I-113), or a salt thereof.

Another preferred compound of the present invention is 3-chloro-N-(cyclopropylmethyl)-N-[1-[2-(5-fluoropyrimidin-2-yl)-5-methyl-1,2,4-triazol-3-yl]ethyl]-5-(trifluoromethyl)benzamide (I-77), or a salt thereof.

Another preferred compound of the present invention is 3-chloro-N-[1-[2-(5-chloropyrimidin-2-yl)-5-methyl-1,2,4-triazol-3-yl]ethyl]-N-(cyclopropylmethyl)-5-(trifluoromethyl)benzamide (I-78), or a salt thereof.

Another preferred compound of the present invention is 3-chloro-N-[1-[2-(5-chloropyrimidin-2-yl)-1,2,4-triazol-3-yl]ethyl]-N-(cyclopropylmethyl)-5-(trifluoromethyl)benzamide (I-80), or a salt thereof.

Another preferred compound of the present invention is 3-chloro-N-(cyclopropylmethyl)-N-[1-[2-(5-fluoropyrimidin-2-yl)-1,2,4-triazol-3-yl]ethyl]-5-(trifluoromethyl)benzamide (I-81), or a salt thereof.

Another preferred compound of the present invention is 3-chloro-N-[1-[2-(5-chloro-2-pyridyl)-1,2,4-triazol-3-yl]ethyl]-N-(cyclopropylmethyl)-5-(trifluoromethyl)benzamide (I-84), or a salt thereof.

Another preferred compound of the present invention is 3-chloro-N-(2,2-difluoroethyl)-N-[1-(2-pyrimidin-2-yl-1,2,4-triazol-3-yl)ethyl]-5-(trifluoromethyl)benzamide (I-89), or a salt thereof.

Another preferred compound of the present invention is N-[1-[2-(5-bromopyrimidin-2-yl)-1,2,4-triazol-3-yl]ethyl]-3-chloro-N-(cyclopropylmethyl)-5-(trifluoromethyl)benzamide (I-92), or a salt thereof.

Another preferred compound of the present invention is 3-chloro-N-(cyclopropylmethyl)-N-[(1S)-1-(2-pyrimidin-2-yl-1,2,4-triazol-3-yl)ethyl]-5-(trifluoromethyl)benzamide (I-93), or a salt thereof.

Another preferred compound of the present invention is 3-chloro-N-ethyl-N-[1-(2-pyrimidin-2-yl-1,2,4-triazol-3-yl)ethyl]-5-(trifluoromethyl)benzamide (I-97), or a salt thereof.

Another preferred compound of the present invention is 3-chloro-N-methyl-N-[1-(2-pyrimidin-2-yl-1,2,4-triazol-3-yl)ethyl]-5-(trifluoromethyl)benzamide (I-100), or a salt thereof.

Another preferred compound of the present invention is 3-chloro-N-(cyclopropylmethyl)-N-[1-(2-pyrimidin-2-yl-1,2,4-triazol-3-yl)ethyl]-5-(trifluoromethylsulfanyl)benzamide (I-107), or a salt thereof.

Another preferred compound of the present invention is 3-chloro-5-cyano-N-[1-(2-pyrimidin-2-yl-1,2,4-triazol-3-yl)ethyl]benzamide (I-114), or a salt thereof.

Another preferred compound of the present invention is 3-chloro-N-[(1S)-1-[2-(2-pyridyl)-1,2,4-triazol-3-yl]ethyl]-5-(trifluoromethyl)benzamide (I-117), or a salt thereof.

Another preferred compound of the present invention is 3-chloro-N-[1-(2-pyrimidin-2-yl-1,2,4-triazol-3-yl)ethyl]-5-(trifluoromethoxy)benzamide (I-119), or a salt thereof.

Another preferred compound of the present invention is 3-chloro-N-[(1S)-1-[2-(5-chloro-2-pyridyl)-1,2,4-triazol-3-yl]ethyl]-5-(trifluoromethyl)benzamide (I-120), or a salt thereof.

Another preferred compound of the present invention is 3-chloro-N-(2,2-difluoroethyl)-N-[1-(2-pyrimidin-2-yl-1,2,4-triazol-3-yl)ethyl]-5-(trifluoromethoxy)benzamide (I-121), or a salt thereof.

Another preferred compound of the present invention is 3-bromo-5-chloro-N-[1-(2-pyrimidin-2-yl-1,2,4-triazol-3-yl)ethyl]benzamide (I-125), or a salt thereof.

Another preferred compound of the present invention is 3-chloro-5-iodo-N-[1-(2-pyrimidin-2-yl-1,2,4-triazol-3-yl)ethyl]benzamide (I-126), or a salt thereof.

Another preferred compound of the present invention is 3-chloro-N-(2,2-difluoroethyl)-N-[(1S)-1-(2-pyrimidin-2-yl-1,2,4-triazol-3-yl)ethyl]-5-(trifluoromethyl)benzamide (I-127), or a salt thereof.

Another preferred compound of the present invention is N-[(1S)-1-[2-(5-bromo-2-pyridyl)-1,2,4-triazol-3-yl]ethyl]-3-chloro-5-(trifluoromethyl)benzamide (I-129), or a salt thereof.

Another preferred compound of the present invention is 3-chloro-N-[(1S)-1-[2-(5-chloro-2-pyridyl)-5-(trifluoromethyl)-1,2,4-triazol-3-yl]ethyl]-5-(trifluoromethyl)benzamide (I-131), or a salt thereof.

Another preferred compound of the present invention is 3-chloro-N-[(1S)-1-[2-(5-iodo-2-pyridyl)-1,2,4-triazol-3-yl]ethyl]-5-(trifluoromethyl)benzamide (I-132), or a salt thereof.

Another preferred compound of the present invention is N-[(1S)-1-[2-(5-chloro-2-pyridyl)-5-(trifluoromethyl)-1,2,4-triazol-3-yl]ethyl]-3,5-bis(trifluoromethyl)benzamide (I-136), or a salt thereof.

Another preferred compound of the present invention is 3-bromo-5-chloro-N-[(1S)-1-[2-(5-chloro-2-pyridyl)-1,2,4-triazol-3-yl]ethyl]benzamide (I-137), or a salt thereof.

Another preferred compound of the present invention is 3,5-bis(trifluoromethyl)-N-[(1S)-1-[2-[5-(trifluoromethyl)pyrimidin-2-yl]-1,2,4-triazol-3-yl]ethyl]benzamide (I-140), or a salt thereof.

Another preferred compound of the present invention is 3-chloro-N-[(1S)-1-[2-(5-fluoro-2-pyridyl)-1,2,4-triazol-3-yl]ethyl]-5-(trifluoromethyl)benzamide (I-143), or a salt thereof.

Another preferred compound of the present invention is 3-chloro-N-[(1S)-1-[2-pyrimidin-2-yl-5-(trifluoromethyl)-1,2,4-triazol-3-yl]ethyl]-5-(trifluoromethyl)benzamide (I-145), or a salt thereof.

Another preferred compound of the present invention is 3-chloro-5-(trifluoromethyl)-N-[(1S)-1-[2-[5-(trifluoromethyl)-2-pyridyl]-1,2,4-triazol-3-yl]ethyl]benzamide (I-151), or a salt thereof.

However, the use of the compounds of formula (I), (II), (II′), (IIa) and (IIa′) in the control of ectoparasites on animals is excluded.

In a preferred embodiment, the invention is directed to the use of the compounds of formula (I), (II), (II′), (IIa) and (IIa′) in the control of insects from the order of the Blattodea, Coleoptera, Dermaptera, Diptera, Hemiptera, Heteroptera, Hymenoptera, Isopoda, Isoptera, Lepidoptera, Orthoptera or Saltatoria, Psocoptera, Thysanoptera and Zygentoma (=Thysanura) in plant protection.

More preferred is the use of the compounds of formula (I), (II), (II′), (IIa) and (IIa′) in the control of Agriotes linneatus, Agriotes mancus, Anthonomus grandis, Anthonomus pomorum, Ceutorrhynchus assimilis, Ceutorrhynchus quadridens, Ceutorrhynchus rapae, Diabrotica balteata, Diabrotica barberi, Diabrotica undecimpunctata howardi, Diabrotica undecimpunctata undecimpunctata, Diabrotica virgifera virgifera, Diabrotica virgifera zeae, Diabrotica speciose, Epitrix cucumeris, Leptinotarsa decemlineata, Lissorhoptrus oryzophilus, Meligethes aeneus, Phaedon cochleariae, Phyllotreta armoraciae, Phyllotreta pusilla, Phyllotreta ramosa, Phyllotreta striolata, Psylliodes affinis, Psylliodes chrysocephala, Psylliodes punctulata, Sternechus paludatus Ceratitis capitate, Cerastium comatum, Chamaepsila rosae, Dacus ciliates, Delia antiqua, Delia platura, Delia radicum, Drosphila melanogaster, Drosophila suzukii, Liriomyza brassicae, Liriomyza huidobrensis, Liriomyza sativae, Rhagoletis cerasi, Rhagoletis indifferens, Acrthosiphon pisum, Amrasca biguttula, Aonidiella aurantii, Aphis citricola, Aphis craccivora, Aphis fabae, Aphis forbesi, Aphis glycines, Aphis gossypii, Aphis hederae, Aphis illinoisensis, Aphis middletoni, Aphis nasturtii, Aphis nerii, Aphis pomi, Aphis spiraecola, Aphis viburniphila, Bemisia tabaci, Brevicoryne brassicae, Cacopsylla pyri, Diaphorina citri, Dysaphis plantaginea, Eriosoma lanigerum, Empoasca abrupta, Empoasca fabae, Empoasca maligna, Empoasca solana, Empoasca stevensi, Lipaphis erysimi, Mahanarva spp, Metopolophium dirhodum, Myzus ascalonicus, Myzus cerasi, Myzus ligustri, Myzus ornatus, Myzus persicae, Myzus nicotianae, Nephotettix cincticeps, Nasonovia ribisnigri, Nephotettix nigropictus, Nilaparvata lugens, Pemphigus bursarius, Planococcus citri, Planococcus ficus, Quadraspidiotus perniciosus, Rhopalosiphum maidis, Rhopalosiphum padi, Sitobion avenae, Trialeurodes vaporariorum, Dichelops furcatus, Dichocrocis sp., Euschistus heros, Euschistus servus, Euschistus tristigmus, Euschistus variolarius, Idioscopus clypealis, Lygus elisus, Lygus hesperus, Lygus lineolaris, Nezara viridula, Piezodorus guildinii, Sogatella furcifera, Adoxophyes orana, Agrotis segetum, Agrotis ipsilon, Alabama argillacea, Anticarsia gemmatalis, Artogeia rapae, Autographa gamma, Chilo plejadellus, Chilo suppressalis, Chrysodeixis chalcites, Cnaphalocrocis medinalis, Cydia nigricana, Cydia pomonella, Diaphania hyalinata, Diaphania nitidalis, Diatraea saccharalis, Elasmopalpus lignosellus, Earias sp., Eupoecilia ambiguella, Grapholita molesta, Helicoverpa armigera, Helicoverpa zea, Heliothis virescens, Hellula undalis, Leucinodes orbonalis, Lobesia botrana, Mamestra brassicae, Ostrinia nubilalis, Pandemis heparana, Paralobesia viteana, Pectinophora gossypiella, Perileucoptera coffeella, Phyllocnistis citrella, Pieris brassicae, Plutella xylostella (=Plutella maculipennis), Pseudoplusia includens, Prodenia sp., Phthorimaea operculella, Rachiplusia nu, Spodoptera eradiana, Spodoptera exigua, Spodoptera frugiperda, Spodoptera praefica, Tuta absoluta, Trichoplusia ni, Frankliniella fusca, Frankliniella occidentalis, Frankliniella schultzei, Frankliniella tritici, Frankliniella vaccinii, Frankliniella williamsi, Thrips palmi, Thrips tabaci, Bactericera cockerelli, Aculus sp., Brevipalpus phoenicis sensu lato, Eriophyes sp., Oligonychus ilicis, Panonychus citri, Panonychus ulmi, Phyllocoptruta oleivora, Polyphagotarsonemus latus, Tetranychus kanzawai, Tetranychus pacificus, Tetranychus urticae in plant protection.

Particularly preferred is the use of the compounds of formula (I), (II), (II′), (IIa) and (IIa′) in the control of Agriotes linneatus, Anthonomus grandis, Diabrotica balteata, Diabrotica barberi, Diabrotica virgifera virgifera, Diabrotica virgifera zea, Leptinotarsa decemlineata, Meligethes aeneus, Phaedon cochleariae, Cydia pomonella, Chilo suppressalis, Elasmopalpus lignosellus, Helicoverpa armigera, Helicoverpa zea, Ostrinia nubilalis, Plutella xylostella, Spodoptera exigua, Spodoptera frugiperda, Spodoptera littoralis, Tuta absoluta, Aphis glycines, Metopolophium dirhodium, Rhopalosiphum padi, Nilaparvata lugens; Nephotettix cincticeps, Nezara viridula, Dichelops furcatus, Euschistus heros, Lygus Hesperus in plant protection.

Very particularly preferred is the use for the control of Phaedon cochleariae in plant protection.

Very particularly preferred is the use for the control of Diabrotica balteata ein plant protection.

Very particularly preferred is the use for the control of Spodoptera frugiperda in plant protection.

Very particularly preferred is the use for the control of Aphis gossypii in plant protection.

Very particularly preferred is the use for the control of Myzus persicae in plant protection.

Very particularly preferred is the use for the control of Tetranvchus urticae in plant protection.

Very particularly preferred is the use for the control of Nilaparvata lugens in plant protection.

Very particularly preferred is the use for the control of Nezara viridula in plant protection.

A further subject-matter of the invention is the use of a compound or a salt of formula (I), (II), (II′), (IIa) and (IIa′) in vector control, wherein the host is the human body.

A further subject-matter of the invention is the method of controlling vectors in which a compound or a salt of formula (I), (II), (II′), (IIa) and (IIa′) is allowed to act on vectors and/or their habitat, wherein the host is the human body, excluding methods of treatment of the human body.

As used herein, the term “C₁-C₆alkyl” refers to a straight or branched, monovalent saturated aliphatic chain of one to six carbon atoms, for example, methyl, ethyl, propyl, isopropyl, butyl, t-butyl, and the like.

Likewise, the term “C₁-C₃alkyl” includes methyl, ethyl, isopropyl, and the like.

As used herein, the term “C₁-C₆haloalkyl” refers to a C₁-C₆alkyl moiety substituted with one or more halogen atoms which may be the same or different. Examples include trifluoromethyl, 2-fluoroethyl, 3-fluoropropyl, 3,3,3-trifluoropropyl, 4-chlorobutyl, and the like.

Likewise, the term “C₁-C₃haloalkyl” includes trifluoromethyl, 2-fluoroethyl, 3-fluoropropyl, 3,3,3-trifluoropropyl, and the like.

As used herein the term “C₁-C₃haloalkylsulfanyl” refers to a C₁-C₃haloalkyl moiety linked through a sulfur atom.

As used herein, the term “C₃-C₄cycloalkyl” refers to cyclopropyl or cyclobutyl.

As used herein, the term “C₃-C₄cycloalkyl-C₁-C₂alkyl-” refers to a C₃-C₄cycloalkyl linked through a C₁-C₂alkyl chain.

As used herein, the term “C₂-C₆alkenyl” refers to a straight or branched alkenyl chain having form two to six carbon atoms and one double bond, for example, ethenyl, prop-1-enyl, but-2-enyl, and the like.

As used herein, the term “C₂-C₆haloalkenyl” refers to a C₂-C₆alkenyl moiety substituted with one or more halo atoms which may be the same or different.

As used herein, the term “C₂-C₆alkynyl” refers to a straight or branched alkynyl chain having from two to six carbon atoms and one triple bond, for example, ethynyl, prop-2-ynyl, but-3-ynyl, and the like.

As used herein, the term “C₂-C₆haloalkynyl” refers to a C₂-C₆alkynyl moiety substituted with one or more halo atoms which may be the same or different.

As used herein, the term “halo”’ refers to a chlorine, bromine, iodine or fluorine atom.

As used herein, the term “C₁-C₃alkoxy” refers to a straight or branched alkyl chain having from 1 to 3 carbon atoms attached to an oxygen atom, for example, ethoxy, propoxy, tert-butoxy, and the like.

As used herein, the term “C₁-C₃haloalkoxy” refers to a C₁-C₃alkoxy moiety substituted with one or more halogen atoms which may be the same or different. Examples include trifluoromethoxy, 2-fluoroethoxy, 3-fluoropropoxy, 3,3,3-trifluoropropoxy, 4-chlorobutoxy, and the like.

### Isomers

Depending on the nature of the substituents, the compounds of the formula (I) may be in the form of geometric and/or optically active isomers or corresponding isomer mixtures in different compositions. These stereoisomers are, for example, enantiomers, diastereomers, atropisomers or geometric isomers. Accordingly, the invention encompasses both pure stereoisomers and any mixture of these isomers.

### Methods and Uses

The invention relates to methods for controlling animal pests, in which compounds of the formula (I) are allowed to act on animal pests and/or their habitat. The control of the animal pests is preferably conducted in agriculture and forestry, and in material protection. Preferably excluded herefrom are methods for the surgical or therapeutic treatment of the human or animal body and diagnostic methods carried out on the human or animal body.

The invention furthermore relates to the use of the compounds of the formula (I) as pesticides, in particular crop protection agents.

In the context of the present application, the term “pesticide” in each case also always comprises the term “crop protection agent”.

The compounds of the formula (I), having good plant tolerance, favourable homeotherm toxicity and good environmental compatibility, are suitable for protecting plants and plant organs against biotic and abiotic stressors, for increasing harvest yields, for improving the quality of the harvested material and for controlling animal pests, especially insects and arachnids.

The compounds of the formula (I) can preferably be used as pesticides. They are active against normally sensitive and resistant species and against all or some stages of development. The abovementioned pests include:

pests from the phylum of the Arthropoda, in particular from the class of the Arachnida, for example Acarus spp., for example Acarus siro, Aceria kuko, Aceria sheldoni, Aculops spp., Aculus spp., for example Aculus fockeui, Aculus schlechtendali, Amblyomma spp., Amphitetranychus viennensis, Argas spp., Boophilus spp., Brevipalpus spp., for example Brevipalpus phoenicis, Bryobia graminum, Bryobia praetiosa, Centruroides spp., Chorioptes spp., Dermanyssus gallinae, Dermatophagoides pteronyssinus, Dermatophagoides farinae, Dermacentor spp., Eotetranychus spp., for example Eotetranychus hicoriae, Epitrimerus pyri, Eutetranychus spp., for example Eutetranychus banksi, Eriophyes spp., for example Eriophyes pyri, Glycyphagus domesticus, Halotydeus destructor, Hemitarsonemus spp., for example Hemitarsonemus latus (=Polyphagotarsonemus latus), Hyalomma spp., Ixodes spp., Latrodectus spp., Loxosceles spp., Neutrombicula autumnalis, Nuphersa spp., Oligonychus spp., for example Oligonychus coffeae, Oligonychus coniferarum, Oligonychus ilicis, Oligonychus indicus, Oligonychus mangiferus, Oligonychus pratensis, Oligonychus punicae, Oligonychus yothersi, Ornithodorus spp., Ornithonyssus spp., Panonychus spp., for example Panonychus citri (=Metatetranychus citri), Panonychus ulmi (=Metatetranychus ulmi), Phyllocoptruta oleivora, Platytetranychus multidigituli, Polyphagotarsonemus latus, Psoroptes spp., Rhipicephalus spp., Rhizoglyphus spp., Sarcoptes spp., Scorpio maurus, Steneotarsonemus spp., Steneotarsonemus spinki, Tarsonemus spp., for example Tarsonemus confusus, Tarsonemus pallidus, Tetranychus spp., for example Tetranychus canadensis, Tetranychus cinnabarinus, Tetranychus turkestani, Tetranychus urticae, Trombicula alfreddugesi, Vaejovis spp., Vasates lycopersici;

from the class of the Chilopoda, for example Geophilus spp., Scutigera spp.;

from the order or the class of the Collembola, for example Onychiurus armatus; Sminthurus viridis;

from the class of the Diplopoda, for example Blaniulus guttulatus;

from the class of the Insecta, for example from the order of the Blattodea, for example Blatta orientalis, Blattella asahinai, Blattella germanica, Leucophaea maderae, Loboptera decipiens, Neostylopyga rhombifolia, Panchlora spp., Parcoblatta spp., Periplaneta spp., for example Periplaneta americana, Periplaneta australasiae, Pycnoscelus surinamensis, Supella longipalpa;

from the order of the Coleoptera, for example Acalymma vittatum, Acanthoscelides obtectus, Adoretus spp., Aethina tumida, Agelastica alni, Agrilus spp., for example Agrilus planipennis, Agrilus coxalis, Agrilus bilineatus, Agrilus anxius, Agriotes spp., for example Agriotes linneatus, Agriotes mancus, Alphitobius diaperinus, Amnhimallon solstitialis, Anobium punctatum, Anoplophora spp., for example Anoplophora glabripennis, Anthonomus spp., for example Anthonomus grandis, Anthrenus spp., Apion spp., Apogonia spp., Atomaria spp., for example Atomaria linearis, Attagenus spp., Baris caerulescens, Bruchidius obtectus, Bruchus spp., for example Bruchus pisorum, Bruchus rufimanus, Cassida spp., Cerotoma trifurcata, Ceutorrhynchus spp., for example Ceutorrhynchus assimilis, Ceutorrhynchus quadridens, Ceutorrhynchus rapae, Chaetocnema spp., for example Chaetocnema confinis, Chaetocnema denticulata, Chaetocnema ectypa, Cleonus mendicus, Conoderus spp., Cosmopolites spp., for example Cosmopolites sordidus, Costelytra zealandica, Ctenicera spp., Curculio spp., for example Curculio caryae, Curculio caryatrypes, Curculio obtusus, Curculio sayi, Cryptolestes ferrugineus, Cryptolestes pusillus, Cryptorhynchus lapathi, Cryptorhynchus mangiferae, Cylindrocopturus spp., Cylindrocopturus adspersus, Cylindrocopturus furnissi, Dendroctonus spp., for example Dendroctonus ponderosae, Dermestes spp., Diabrotica spp., for example Diabrotica balteata, Diabrotica barberi, Diabrotica undecimpunctata howardi, Diabrotica undecimpunctata undecimpunctata, Diabrotica virgifera virgifera, Diabrotica virgifera zeae, Dichocrocis spp., Dicladispa armigera, Diloboderus spp., Epicaerus spp., Epilachna spp., for example Epilachna borealis, Epilachna varivestis, Epitrix spp., for example Epitrix cucumeris, Epitrix fuscula, Epitrix hirtipennis, Epitrix subcrinita, Epitrix tuberis, Faustinus spp., Gibbium psylloides, Gnathocerus cornutus, Hellula undalis, Heteronychus arator, Heteronyx spp., Hylamorpha elegans, Hylotrupes bajulus, Hypera postica, Hypomeces squamosus, Hypothenemus spp., for example Hypothenemus hampei, Hypothenemus obscurus, Hypothenemus pubescens, Lachnosterna consanguinea, Lasioderma serricorne, Latheticus oryzae, Lathridius spp., Lema spp., Leptinotarsa decemlineata, Leucoptera spp., for example Leucoptera coffeella, Limonius ectypus, Lissorhoptrus oryzophilus, Listronotus (=Hyperodes) spp., Lixus spp., Luperodes spp., Luperomorpha xanthodera, Lyctus spp., Megacyllene spp., for example Megacyllene robiniae, Megascelis spp., Melanotus spp., for example Melanotus longulus oregonensis, Meligethes aeneus, Melolontha spp., for example Melolontha melolontha, Migdolus spp., Monochamus spp., Naupactus xanthographus, Necrobia spp., Neogalerucella spp., Niptus hololeucus, Oryctes rhinoceros, Oryzaephilus surinamensis, Oryzaphagus oryzae, Otiorhynchus spp., for example Otiorhynchus cribricollis, Otiorhynchus ligustici, Otiorhynchus ovatus, Otiorhynchus rugosostriarus, Otiorhynchus sulcatus, Oulema spp., for example Oulema melanopus, Oulema oryzae, Oxycetonia jucunda, Phaedon cochleariae, Phyllophaga spp., Phyllophaga helleri, Phyllotreta spp., for example Phyllotreta armoraciae, Phyllotreta pusilla, Phyllotreta ramosa, Phyllotreta striolata, Popillia japonica, Premnotrypes spp., Prostephanus truncatus, Psylliodes spp., for example Psylliodes affinis, Psylliodes chrysocephala, Psylliodes punctulata, Ptinus spp., Rhizobius ventralis, Rhizopertha dominica, Rhynchophorus spp., Rhynchophorus ferrugineus, Rhynchophorus palmarum, Scolytus spp., for example Scolytus multistriatus, Sinoxylon perforans, Sitophilus spp., for example Sitophilus granarius, Sitophilus linearis, Sitophilus oryzae, Sitophilus zeamais, Sphenophorus spp., Stegobium paniceum, Sternechus spp., for example Sternechus paludatus, Symphyletes spp., Tanymecus spp., for example Tanymecus dilaticollis, Tanymecus indicus, Tanymecus palliatus, Tenebrio molitor, Tenebrioides mauretanicus, Tribolium spp., for example Tribolium audax, Tribolium castaneum, Tribolium confusum, Trogoderma spp., Tychius spp., Xylotrechus spp., Zabrus spp., for example Zabrus tenebrioides;

from the order of the Dermaptera, for example Anisolabis maritime, Forficula auricularia, Labidura riparia; from the order of the Diptera, for example Aedes spp., for example Aedes aegypti, Aedes albopictus, Aedes sticticus, Aedes vexans, Agromyza spp., for example Agromyza frontella, Agromyza parvicornis, Anastrepha spp., Anopheles spp., for example Anopheles quadrimaculatus, Anopheles gambiae, Asphondylia spp., Bactrocera spp., for example Bactrocera cucurbitae, Bactrocera dorsalis, Bactrocera oleae, Bibio hortulanus, Calliphora erythrocephala, Calliphora vicina, Ceratitis capitata, Chironomus spp., Chrysomya spp., Chrysops spp., Chrysozona pluvialis, Cochliomya spp., Contarinia spp., for example Contarinia johnsoni, Contarinia nasturtii, Contarinia pyrivora, Contarinia schulzi, Contarinia sorghicola, Contarinia tritici, Cordylobia anthropophaga, Cricotopus sylvestris, Culex spp., for example Culex pipiens, Culex quinquefasciatus, Culicoides spp., Culiseta spp., Cuterebra spp., Dacus oleae, Dasineura spp., for example Dasineura brassicae, Delia spp., for example Delia antiqua, Delia coarctata, Delia florilega, Delia platura, Delia radicum, Dermatobia hominis, Drosophila spp., for example Drosphila melanogaster, Drosophila suzukii, Echinocnemus spp., Euleia heraclei, Fannia spp., Gasterophilus spp., Glossina spp., Haematopota spp., Hydrellia spp., Hydrellia griseola, Hylemya spp., Hippobosca spp., Hypoderma spp., Liriomyza spp., for example Liriomyza brassicae, Liriomyza huidobrensis, Liriomyza sativae, Lucilia spp., for example Lucilia cuprina, Lutzomyia spp., Mansonia spp., Musca spp., for example Musca domestica, Musca domestica vicina, Oestrus spp., Oscinella frit, Paratanytarsus spp., Paralauterborniella subcincta, Pegomya or Pegomyia spp., for example Pegomya betae, Pegomya hyoscyami, Pegomya rubivora, Phlebotomus spp., Phorbia spp., Phormia spp., Piophila casei, Platyparea poeciloptera, Prodiplosis spp., Psila rosae, Rhagoletis spp., for example Rhagoletis cingulata, Rhagoletis completa, Rhagoletis fausta, Rhagoletis indifferens, Rhagoletis mendax, Rhagoletis pomonella, Sarcophaga spp., Simulium spp., for example Simulium meridionale, Stomoxys spp., Tabanus spp., Tetanops spp., Tipula spp., for example Tipula paludosa, Tipula simplex, Toxotrypana curvicauda;

from the order of the Hemiptera, for example Acizzia acaciaebaileyanae, Acizzia dodonaeae, Acizzia uncatoides, Acrida turrita, Acyrthosipon spp., for example Acyrthosiphon pisum, Acrogonia spp., Aeneolamia spp., Agonoscena spp., Aleurocanthus spp., Aleyrodes proletella, Aleurolobus barodensis, Aleurothrixus floccosus, Allocaridara malayensis, Amrasca spp., for example Amrasca bigutulla, Amrasca devastans, Anuraphis cardui, Aonidiella spp., for example Aonidiella aurantii, Aonidiella citrina, Aonidiella inornata, Aphanostigma piri, Aphis spp., for example Aphis citricola, Aphis craccivora, Aphis fabae, Aphis forbesi, Aphis glycines, Aphis gossypii, Aphis hederae, Aphis illinoisensis, Aphis middletoni, Aphis nasturtii, Aphis nerii, Aphis pomi, Aphis spiraecola, Aphis viburniphila, Arboridia apicalis, Arytainilla spp., Aspidiella spp., Aspidiotus spp., for example Aspidiotus nerii, Atanus spp., Aulacorthum solani, Bemisia tabaci, Blastopsylla occidentalis, Boreioglycaspis melaleucae, Brachycaudus helichrysi, Brachycolus spp., Brevicoryne brassicae, Cacopsylla spp., for example Cacopsylla pyricola, Calligypona marginata, Capulinia spp., Carneocephala fulgida, Ceratovacuna lanigera, Cercopidae, Ceroplastes spp., Chaetosiphon fragaefolii, Chionaspis tegalensis, Chlorita onukii, Chondracris rosea, Chromaphis juglandicola, Chrysomphalus aonidum, Chrysomphalus ficus, Cicadulina mbila, Coccomytilus halli, Coccus spp., for example Coccus hesperidum, Coccus longulus, Coccus pseudomagnoliarum, Coccus viridis, Cryptomyzus ribis, Cryptoneossa spp., Ctenarytaina spp., Dalbulus spp., Dialeurodes chittendeni, Dialeurodes citri, Diaphorina citri, Diaspis spp., Diuraphis spp., Doralis spp., Drosicha spp., Dysaphis spp., for example Dysaphis apiifolia, Dysaphis plantaginea, Dysaphis tulipae, Dysmicoccus spp., Empoasca spp., for example Empoasca abrupta, Empoasca fabae, Empoasca maligna, Empoasca solana, Empoasca stevensi, Eriosoma spp., for example Eriosoma americanum, Eriosoma lanigerum, Eriosoma pyricola, Erythroneura spp., Eucalyptolyma spp., Euphyllura spp., Euscelis bilobatus, Ferrisia spp., Fiorinia spp., Furcaspis oceanica, Geococcus coffeae, Glycaspis spp., Heteropsylla cubana, Heteropsylla spinulosa, Homalodisca coagulata, Hyalopterus arundinis, Hyalopterus pruni, Icerya spp., for example Icerya purchasi, Idiocerus spp., Idioscopus spp., Laodelphax striatellus, Lecanium spp., for example Lecanium corni (=Parthenolecanium corni), Lepidosaphes spp., for example Lepidosaphes ulmi, Lipaphis erysimi, Lopholeucaspis japonica, Lycorma delicatula, Macrosiphum spp., for example Macrosiphum euphorbiae, Macrosiphum lilii, Macrosiphum rosae, Macrosteles facifrons, Mahanarva spp., Melanaphis sacchari, Metcalfiella spp., Metcalfa pruinosa, Metopolophium dirhodum, Monellia costalis, Monelliopsis pecanis, Myzus spp., for example Myzus ascalonicus, Myzus cerasi, Myzus ligustri, Myzus ornatus, Myzus persicae, Myzus nicotianae, Nasonovia ribisnigri, Neomaskellia spp., Nephotettix spp., for example Nephotettix cincticeps, Nephotettix nigropictus, Nettigoniclla spectra, Nilaparvata lugens, Oncometopia spp., Orthezia praelonga, Oxya chinensis, Pachypsylla spp., Parabemisia myricae, Paratrioza spp., for example Paratrioza cockerelli, Parlatoria spp., Pemphigus spp., for example Pemphigus bursarius, Pemphigus populivenae, Peregrinus maidis, Perkinsiella spp., Phenacoccus spp., for example Phenacoccus madeirensis, Phloeomyzus passerinii, Phorodon humuli, Phylloxera spp., for example Phylloxera devastatrix, Phylloxera notabilis, Pinnaspis aspidistrae, Planococcus spp., for example Planococcus citri, Prosopidopsylla flava, Protopulvinaria pyriformis, Pseudaulacaspis pentagona, Pseudococcus spp., for example Pseudococcus calceolariae, Pseudococcus comstocki, Pseudococcus longispinus, Pseudococcus maritimus, Pseudococcus viburni, Psyllopsis spp., Psylla spp., for example Psylla buxi, Psylla mali, Psylla pyri, Pteromalus spp., Pulvinaria spp., Pyrilla spp., Quadraspidiotus spp., for example Quadraspidiotus juglansregiae, Quadraspidiotus ostreaeformis, Quadraspidiotus perniciosus, Quesada gigas, Rastrococcus spp., Rhopalosiphum spp., for example Rhopalosiphum maidis, Rhopalosiphum oxyacanthae, Rhopalosiphum padi, Rhopalosiphum rufiabdominale, Saissetia spp., for example Saissetia coffeae, Saissetia miranda, Saissetia neglecta, Saissetia oleae, Scaphoideus titanus, Schizaphis graminum, Selenaspidus articulatus, Sipha flava, Sitobion avenae, Sogata spp., Sogatella furcifera, Sogatodes spp., Stictocephala festina, Siphoninus phillyreae, Tenalaphara malayensis, Tetragonocephela spp., Tinocallis caryaefoliae, Tomaspis spp., Toxoptera spp., for example Toxoptera aurantii, Toxoptera citricidus, Trialeurodes vaporariorum, Trioza spp., for example Trioza diospyri, Typhlocyba spp., Unaspis spp., Viteus vitifolii, Zygina spp.;

from the suborder of the Heteroptera, for example Aelia spp., Anasa tristis, Antestiopsis spp., Boisea spp., Blissus spp., Calocoris spp., Campylomma livida, Cavelerius spp., Cimex spp., for example Cimex adjunctus, Cimex hemipterus, Cimex lectularius, Cimex pilosellus, Collaria spp., Creontiades dilutus, Dasynus piperis, Dichelops furcatus, Diconocoris hewetti, Dysdercus spp., Euschistus spp., for example Euschistus heros, Euschistus servus, Euschistus tristigmus, Euschistus variolarius, Eurydema spp., Eurygaster spp., Halyomorpha halys, Heliopeltis spp., Horcias nobilellus, Leptocorisa spp., Leptocorisa varicornis, Leptoglossus occidentalis, Leptoglossus phyllopus, Lygocoris spp., for example Lygocoris pabulinus, Lygus spp., for example Lygus elisus, Lygus hesperus, Lygus lineolaris, Macropes excavatus, Megacopta cribraria, Miridae, Monalonion atratum, Nezara spp., for example Nezara viridula, Nysius spp., Oebalus spp., Pentomidae, Piesma quadrata, Piezodorus spp., for example Piezodorus guildinii, Psallus spp., Pseudacysta persea, Rhodnius spp., Sahlbergella singularis, Scaptocoris castanea, Scotinophora spp., Stephanitis nashi, Tibraca spp., Triatoma spp.;

from the order of the Hymenoptera, for example Acromyrmex spp., Athalia spp., for example Athalia rosae, Atta spp., Camponotus spp., Dolichovespula spp., Diprion spp., for example Diprion similis, Hoplocampa spp., for example Hoplocampa cookei, Hoplocampa testudinea, Lasius spp., Linepithema (Iridiomyrmex) humile, Monomorium pharaonis, Paratrechina spp., Paravespula spp., Plagiolepis spp., Sirex spp., for example Sirex noctilio, Solenopsis invicta, Tapinoma spp., Technomyrmex albipes, Urocerus spp., Vespa spp., for example Vespa crabro, Wasmannia auropunctata, Xeris spp.;

from the order of the Isopoda, for example Armadillidium vulgare, Oniscus asellus, Porcellio scaber;

from the order of the Isoptera, for example Coptotermes spp., for example Coptotermes formosanus, Cornitermes cumulans, Cryptotermes spp., Incisitermes spp., Kalotermes spp., Microtermes obesi, Nasutitermes spp., Odontotermes spp., Porotermes spp., Reticulitermes spp., for example Reticulitermes flavipes, Reticulitermes hesperus;

from the order of the Lepidoptera, for example Achroia grisella, Acronicta major, Adoxophyes spp., for example Adoxophyes orana, Aedia leucomelas, Agrotis spp., for example Agrotis segetum, Agrotis ipsilon, Alabama spp., for example Alabama argillacea, Amyelois transitella, Anarsia spp., Anticarsia spp., for example Anticarsia gemmatalis, Argyroploce spp., Autographa spp., Barathra brassicae, Blastodacna atra, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., for example Chilo plejadellus, Chilo suppressalis, Choreutis pariana, Choristoneura spp., Chrysodeixis chalcites, Clysia ambiguella, Cnaphalocerus spp., Cnaphalocrocis medinalis, Cnephasia spp., Conopomorpha spp., Conotrachelus spp., Copitarsia spp., Cydia spp., for example Cydia nigricana, Cydia pomonella, Dalaca noctuides, Diaphania spp., Diparopsis spp., Diatraea saccharalis, Dioryctria spp., for example Dioryctria zimmermani, Earias spp., Ecdytolopha aurantium, Elasmopalpus lignosellus, Eldana saccharina, Ephestia spp., for example Ephestia elutella, Ephestia kuehniella, Epinotia spp., Epiphyas postvittana, Erannis spp., Erschoviella musculana, Etiella spp., Eudocima spp., Eulia spp., Eupoecilia ambiguella, Euproctis spp., for example Euproctis chrysorrhoea, Euxoa spp., Feltia spp., Galleria mellonella, Gracillaria spp., Grapholitha spp., for example Grapholita molesta, Grapholita prunivora, Hedylepta spp., Helicoverpa spp., for example Helicoverpa armigera, Helicoverpa zea, Heliothis spp., for example Heliothis virescens, Hofmannophila pseudospretella, Homoeosoma spp., Homona spp., Hyponomeuta padella, Kakivoria flavofasciata, Lampides spp., Laphygma spp., Laspeyresia molesta, Leucinodes orbonalis, Leucoptera spp., for example Leucoptera coffeella, Lithocolletis spp., for example Lithocolletis blancardella, Lithophane antennata, Lobesia spp., for example Lobesia botrana, Loxagrotis albicosta, Lymantria spp., for example Lymantria dispar, Lyonetia spp., for example Lyonetia clerkella, Malacosoma neustria, Maruca testulalis, Mamestra brassicae, Melanitis leda, Mocis spp., Monopis obviella, Mythimna separata, Nemapogon cloacellus, Nymphula spp., Oiketicus spp., Omphisa spp., Operophtera spp., Oria spp., Orthaga spp., Ostrinia spp., for example Ostrinia nubilalis, Panolis flammea, Parnara spp., Pectinophora spp., for example Pectinophora gossypiella, Perileucoptera spp., Phthorimaea spp., for example Phthorimaea operculella, Phyllocnistis citrella, Phyllonorycter spp., for example Phyllonorycter blancardella, Phyllonorycter crataegella, Pieris spp., for example Pieris rapae, Platynota stultana, Plodia interpunctella, Plusia spp., Plutella xylostella (=Plutella maculipennis), Podesia spp., for example Podesia syringae, Prays spp., Prodenia spp., Protoparce spp., Pseudaletia spp., for example Pseudaletia unipuncta, Pseudoplusia includens, Pyrausta nubilalis, Rachiplusia nu, Schoenobius spp., for example Schoenobius bipunctifer, Scirpophaga spp., for example Scirpophaga innotata, Scotia segetum, Sesamia spp., for example Sesamia inferens, Sparganothis spp., Spodoptera spp., for example Spodoptera eradiana, Spodoptera exigua, Spodoptera frugiperda, Spodoptera praefica, Stathmopoda spp., Stenoma spp., Stomopteryx subsecivella, Synanthedon spp., Tecia solanivora, Thaumetopoea spp., Thermesia gemmatalis, Tinea cloacella, Tinea pellionella, Tineola bisselliella, Tortrix spp., Trichophaga tapetzella, Trichoplusia spp., for example Trichoplusia ni, Tryporyza incertulas, Tuta absoluta, Virachola spp.;

from the order of the Orthoptera or Saltatoria, for example Acheta domesticus, Dichroplus spp., Gryllotalpa spp., for example Gryllotalpa gryllotalpa, Hieroglyphus spp., Locusta spp., for example Locusta migratoria, Melanoplus spp., for example Melanoplus devastator, Paratlanticus ussuriensis, Schistocerca gregaria;

from the order of the Phthiraptera, for example Damalinia spp., Haematopinus spp., Linognathus spp., Pediculus spp., Phylloxera vastatrix, Phthirus pubis, Trichodectes spp.;

from the order of the Psocoptera, for example Lepinotus spp., Liposcelis spp.;

from the order of the Siphonaptera, for example, Ceratophyllus spp., Ctenocephalides spp., for example Ctenocephalides canis, Ctenocephalides felis, Pulex irritans, Tunga penetrans, Xenopsylla cheopis;

from the order of the Thysanoptera, for example Anaphothrips obscurus, Baliothrips biformis, Chaetanaphothrips leeuweni, Drepanothrips reuteri, Enneothrips flavens, Frankliniella spp., for example Frankliniella fusca, Frankliniella occidentalis, Frankliniella schultzei, Frankliniella tritici, Frankliniella vaccinii, Frankliniella williamsi, Haplothrips spp., Heliothrips spp., Hercinothrips femoralis, Kakothrips spp., Rhipiphorothrips cruentatus, Scirtothrips spp., Taeniothrips cardamomi, Thrips spp., for example Thrips palmi, Thrips tabaci;

from the order of the Zygentoma (=Thysanura), for example Ctenolepisma spp., Lepisma saccharina, Lepismodes inquilinus, Thermobia domestica;

from the class of the Symphyla, for example Scutigerella spp., for example Scutigerella immaculata;

pests from the phylum of the Mollusca, for example from the class of the Bivalvia, for example Dreissena spp.,

and also from the class of the Gastropoda, for example Arion spp., for example Arion ater rufus, Biomphalaria spp., Bulinus spp., Deroceras spp., for example Deroceras laeve, Galba spp., Lymnaea spp., Oncomelania spp., Pomacea spp., Succinea spp.;

plant pests from the phylum of the Nematoda, i.e. phytoparasitic nematodes, in particular Aglenchus spp., for example Aglenchus agricola, Anguina spp., for example Anguina tritici, Aphelenchoides spp., for example Aphelenchoides arachidis, Aphelenchoides fragariae, Belonolaimus spp., for example Belonolaimus gracilis, Belonolaimus longicaudatus, Belonolaimus nortoni, Bursaphelenchus spp., for example Bursaphelenchus cocophilus, Bursaphelenchus eremus, Bursaphelenchus xylophilus, Cacopaurus spp., for example Cacopaurus pestis, Criconemella spp., for example Criconemella curvata, Criconemella onoensis, Criconemella ornata, Criconemella rusium, Criconemella xenoplax (=Mesocriconema xenoplax), Criconemoides spp., for example Criconemoides ferniae, Criconemoides onoense, Criconemoides ornatum, Ditylenchus spp., for example Ditylenchus dipsaci, Dolichodorus spp., Globodera spp., for example Globodera pallida, Globodera rostochiensis, Helicotylenchus spp., for example Helicotylenchus dihystera, Hemicriconemoides spp., Hemicycliophora spp., Heterodera spp., for example Heterodera avenae, Heterodera glycines, Heterodera schachtii, Hirschmaniella spp., Hoplolaimus spp., Longidorus spp., for example Longidorus africanus, Meloidogyne spp., for example Meloidogyne chitwoodi, Meloidogyne fallax, Meloidogyne hapla, Meloidogyne incognita, Meloinema spp., Nacobbus spp., Neotylenchus spp., Paralongidorus spp., Paraphelenchus spp., Paratrichodorus spp., for example Paratrichodorus minor, Paratylenchus spp., Pratylenchus spp., for example Pratylenchus penetrans, Pseudohalenchus spp., Psilenchus spp., Punctodera spp., Quinisulcius spp., Radopholus spp., for example Radopholus citrophilus, Radopholus similis, Rotylenchulus spp., Rotylenchus spp., Scutellonema spp., Subanguina spp., Trichodorus spp., for example Trichodorus obtusus, Trichodorus primitivus, Tylenchorhynchus spp., for example Tylenchorhynchus annulatus, Tylenchulus spp., for example Tylenchulus semipenetrans, Xiphinema spp., for example Xiphinema index.

The compounds of the formula (I) can optionally, at certain concentrations or application rates, also be used as herbicides, safeners, growth regulators or agents to improve plant properties, as microbicides or gametocides, for example as fungicides, antimycotics, bactericides, viricides (including agents against viroids) or as agents against MLO (mycoplasma-like organisms) and RLO (rickettsia-like organisms). If appropriate, they can also be used as intermediates or precursors for the synthesis of other active compounds.

### Formulations

The present invention further relates to formulations and use forms prepared therefrom as pesticides, for example drench, drip and spray liquors, comprising at least one compound of the formula (I). In some cases, the use forms comprise further pesticides and/or adjuvants which improve action, such as penetrants, e.g. vegetable oils, for example rapeseed oil, sunflower oil, mineral oils, for example paraffin oils, alkyl esters of vegetable fatty acids, for example rapeseed oil methyl ester or soya oil methyl ester, or alkanol alkoxylates and/or spreaders, for example alkylsiloxanes and/or salts, for example organic or inorganic ammonium or phosphonium salts, for example ammonium sulphate or diammonium hydrogenphosphate and/or retention promoters, for example dioctyl sulphosuccinate or hydroxypropyl guar polymers and/or humectants, for example glycerol and/or fertilizers, for example ammonium-, potassium- or phosphorus-containing fertilizers.

Customary formulations are, for example, water-soluble liquids (SL), emulsion concentrates (EC), emulsions in water (EW), suspension concentrates (SC, SE, FS, OD), water-dispersible granules (WG), granules (GR) and capsule concentrates (CS); these and further possible formulation types are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576. The formulations, in addition to one or more compounds of the formula (I), optionally comprise further agrochemically active compounds.

These are preferably formulations or use forms which comprise auxiliaries, for example extenders, solvents, spontaneity promoters, carriers, emulsifiers, dispersants, frost protectants, biocides, thickeners and/or further auxiliaries, for example adjuvants. An adjuvant in this context is a component which enhances the biological effect of the formulation, without the component itself having any biological effect. Examples of adjuvants are agents which promote retention, spreading, attachment to the leaf surface or penetration.

These formulations are prepared in a known way, for example by mixing the compounds of the formula (I) with auxiliaries such as, for example, extenders, solvents and/or solid carriers and/or other auxiliaries such as, for example, surfactants. The formulations are prepared either in suitable facilities or else before or during application.

The auxiliaries used may be substances suitable for imparting special properties, such as certain physical, technical and/or biological properties, to the formulation of the compounds of the formula (I), or to the use forms prepared from these formulations (for example ready-to-use pesticides such as spray liquors or seed dressing products).

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), the esters (including fats and oils) and (poly)ethers, the unsubstituted and substituted amines, amides, lactams (such as N-alkylpyrrolidones) and lactones, the sulphones and sulphoxides (such as dimethyl sulphoxide), the carbonates and the nitriles.

If the extender used is water, it is also possible to employ, for example, organic solvents as auxiliary solvents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide or dimethyl sulphoxide, carbonates such as propylene carbonate, butylene carbonate, diethyl carbonate or dibutyl carbonate, or nitriles such as acetonitrile or propanenitrile.

In principle, it is possible to use all suitable solvents. Examples of suitable solvents are aromatic hydrocarbons, such as xylene, toluene or alkylnaphthalenes, chlorinated aromatic or chlorinated aliphatic hydrocarbons, such as chlorobenzene, chloroethylene or methylene chloride, aliphatic hydrocarbons, such as cyclohexane, paraffins, petroleum fractions, mineral and vegetable oils, alcohols, such as methanol, ethanol, isopropanol, butanol or glycol and their ethers and esters, ketones such as acetone, methyl ethyl ketone, methyl isobutyl ketone or cyclohexanone, strongly polar solvents, such as dimethyl sulphoxide, carbonates such as propylene carbonate, butylene carbonate, diethyl carbonate or dibutyl carbonate, nitriles such as acetonitrile or propanenitrile, and also water.

In principle, it is possible to use all suitable carriers. Useful carriers include especially: for example ammonium salts and ground natural minerals such as kaolins, clays, talc, chalk, quartz, attapulgite, montmorillonite or diatomaceous earth, and ground synthetic materials such as finely divided silica, alumina and natural or synthetic silicates, resins, waxes and/or solid fertilizers. Mixtures of such carriers can likewise be used. Useful carriers for granules include: for example crushed and fractionated natural rocks such as calcite, marble, pumice, sepiolite, dolomite, and synthetic granules of inorganic and organic meals, and also granules of organic material such as sawdust, paper, coconut shells, corn cobs and tobacco stalks.

Liquefied gaseous extenders or solvents can also be used. Particularly suitable extenders or carriers are those which are gaseous at ambient temperature and under atmospheric pressure, for example aerosol propellant gases, such as halohydrocarbons, and also butane, propane, nitrogen and carbon dioxide.

Examples of emulsifiers and/or foam-formers, dispersants or wetting agents with ionic or nonionic properties, or mixtures of these surfactants, are salts of polyacrylic acid, salts of lignosulphonic acid, salts of phenolsulphonic acid or naphthalenesulphonic acid, polycondensates of ethylene oxide with fatty alcohols or with fatty acids or with fatty amines, with substituted phenols (preferably alkylphenols or arylphenols), salts of sulphosuccinic esters, taurine derivatives (preferably alkyl taurates), isethionate derivatives, phosphoric esters of polyethoxylated alcohols or phenols, fatty esters of polyols, and derivatives of the compounds containing sulphates, sulphonates and phosphates, for example alkylaryl polyglycol ethers, alkylsulphonates, alkyl sulphates, arylsulphonates, protein hydrolysates, lignosulphite waste liquors and methylcellulose. The presence of a surfactant is advantageous if one of the compounds of the formula (I) and/or one of the inert carriers is insoluble in water and when the application takes place in water.

It is possible to use colorants such as inorganic pigments, for example iron oxide, titanium oxide and Prussian Blue, and organic dyes such as alizarin dyes, azo dyes and metal phthalocyanine dyes, and nutrients and trace nutrients such as salts of iron, manganese, boron, copper, cobalt, molybdenum and zinc as further auxiliaries in the formulations and the use forms derived therefrom.

Additional components may be stabilizers, such as low-temperature stabilizers, preservatives, antioxidants, light stabilizers or other agents which improve chemical and/or physical stability. Foam formers or antifoams may also be present.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids may also be present as additional auxiliaries in the formulations and the use forms derived therefrom. Further possible auxiliaries are mineral and vegetable oils.

Optionally, further auxiliaries may be present in the formulations and the use forms derived therefrom. Examples of such additives include fragrances, protective colloids, binders, adhesives, thickeners, thixotropic agents, penetrants, retention promoters, stabilizers, sequestrants, complexing agents, humectants, spreaders. In general, the compounds of the formula (I) can be combined with any solid or liquid additive commonly used for formulation purposes.

Useful retention promoters include all those substances which reduce the dynamic surface tension, for example dioctyl sulphosuccinate, or increase the viscoelasticity, for example hydroxypropylguar polymers.

Suitable penetrants in the present context are all those substances which are usually used for improving the penetration of agrochemical active compounds into plants. Penetrants are defined in this context by their ability to penetrate from the (generally aqueous) application liquor and/or from the spray coating into the cuticle of the plant and thereby increase the mobility of active compounds in the cuticle. The method described in the literature (Baur et al., 1997, Pesticide Science 51, 131-152) can be used to determine this property. Examples include alcohol alkoxylates such as coconut fatty ethoxylate (10) or isotridecyl ethoxylate (12), fatty acid esters, for example rapeseed oil methyl ester or soya oil methyl ester, fatty amine alkoxylates, for example tallowamine ethoxylate (15), or ammonium and/or phosphonium salts, for example ammonium sulphate or diammonium hydrogenphosphate.

The formulations preferably comprise between 0.00000001 and 98% by weight of the compound of the formula (I) or, with particular preference, between 0.01% and 95% by weight of the compound of the formula (I), more preferably between 0.5% and 90% by weight of the compound of the formula (I), based on the weight of the formulation.

The content of the compound of the formula (I) in the use forms prepared from the formulations (in particular pesticides) may vary within wide ranges. The concentration of the compound of the formula (I) in the use forms is usually between 0.00000001 and 95% by weight of the compound of the formula (I), preferably between 0.00001 and 1% by weight, based on the weight of the use form. The compounds are employed in a customary manner appropriate for the use forms.

### Mixtures

The compounds of the formula (I) may also be employed as a mixture with one or more suitable fungicides, bactericides, acaricides, molluscicides, nematicides, insecticides, microbiologicals, beneficial species, herbicides, fertilizers, bird repellents, phytotonics, sterilants, safeners, semiochemicals and/or plant growth regulators, in order thus, for example, to broaden the spectrum of action, to prolong the duration of action, to increase the rate of action, to prevent repulsion or prevent evolution of resistance. In addition, such active compound combinations may improve plant growth and/or tolerance to abiotic factors, for example high or low temperatures, to drought or to elevated water content or soil salinity. It is also possible to improve flowering and fruiting performance, optimize germination capacity and root development, facilitate harvesting and improve yields, influence maturation, improve the quality and/or the nutritional value of the harvested products, prolong storage life and/or improve the processability of the harvested products.

Furthermore, the compounds of the formula (I) can be present in a mixture with other active compounds or semiochemicals such as attractants and/or bird repellants and/or plant activators and/or growth regulators and/or fertilizers. Likewise, the compounds of the formula (I) can be used to improve plant properties such as, for example, growth, yield and quality of the harvested material.

In a particular embodiment according to the invention, the compounds of the formula (I) are present in formulations or the use forms prepared from these formulations in a mixture with further compounds, preferably those as described below.

If one of the compounds mentioned below can occur in different tautomeric forms, these forms are also included even if not explicitly mentioned in each case. Further, all named mixing partners can, if their functional groups enable this, optionally form salts with suitable bases or acids.

### Preferred Insecticides/Acaricides/Nematicides for Mixtures

The active compounds identified here by their common names are known and are described, for example, in the pesticide handbook (“The Pesticide Manual” 16th Ed., British Crop Protection Council 2012) or can be found on the Internet (e.g. http://www.alanwood.net/pesticides). The classification is based on the current IRAC Mode of Action Classification Scheme at the time of filing of this patent application.

(1) Acetylcholinesterase (AChE) inhibitors, preferably carbamates selected from alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb, or organophosphates selected from acephate, azamethiphos, azinphos-ethyl, azinphos-methyl, cadusafos, chlorethoxyfos, chlorfenvinphos, chlormephos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel blockers, preferably cyclodiene-organochlorines selected from chlordane and endosulfan, or phenylpyrazoles (fiproles) selected from ethiprole and fipronil.

(3) Sodium channel modulators, preferably pyrethroids selected from acrinathrin, allethrin, d-cis-trans allethrin, d-trans allethrin, bifenthrin, bioallethrin, bioallethrin s-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans-isomer], deltamethrin, empenthrin [(EZ)-(1R)-isomer], esfenvalerate, etofenprox, fenpropathrin, fenvalerate, flucythrinate, flumethrin, tau-fluvalinate, halfenprox, imiprothrin, kadethrin, momfluorothrin, permethrin, phenothrin [(1R)-trans-isomer], prallethrin, pyrethrins (pyrethrum), resmethrin, silafluofen, tefluthrin, tetramethrin, tetramethrin [(1R)-isomer)], tralomethrin and transfluthrin or DDT or methoxychlor.

(4) Nicotinic acetylcholine receptor (nAChR) competitive modulators, preferably neonicotinoids selected from acetamiprid, clothianidin, dinotefuran, imidacloprid, nitenpyram, thiacloprid and thiamethoxam, or nicotine, or sulfoximines selected from sulfoxaflor, or butenolids selected from flupyradifurone, or mesoionics selected from triflumezopyrim.

(5) Nicotinic acetylcholine receptor (nAChR) allosteric modulators, preferably spinosyns selected from spinetoram and spinosad.

(6) Glutamate-gated chloride channel (GluCl) allosteric modulators, preferably avermectins/milbemycins selected from abamectin, emamectin benzoate, lepimectin and milbemectin.

(7) Juvenile hormone mimics, preferably juvenile hormone analogues selected from hydroprene, kinoprene and methoprene, or fenoxycarb or pyriproxyfen.

(8) Miscellaneous non-specific (multi-site) inhibitors, preferably alkyl halides selected from methyl bromide and other alkyl halides, or chloropicrine or sulphuryl fluoride or borax or tartar emetic or methyl isocyanate generators selected from diazomet and metam.

(9) Chordotonal organ TRPV channel modulators selected from pymetrozine and pyrifluquinazone.

(10) Mite growth inhibitors selected from clofentezine, hexythiazox, diflovidazin and etoxazole.

(11) Microbial disruptors of the insect gut membrane selected from Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and B.t. plant proteins selected from Cry1Ab, Cry1Ac, Cry1Fa, Cry1A.105, Cry2Ab, Vip3A, mCry3A, Cry3Ab, Cry3Bb and Cry34Ab1/35Ab1.

(12) Inhibitors of mitochondrial ATP synthase, preferably ATP disruptors selected from diafenthiuron, or organotin compounds selected from azocyclotin, cyhexatin and fenbutatin oxide, or propargite or tetradifon.

(13) Uncouplers of oxidative phosphorylation via disruption of the proton gradient selected from chlorfenapyr, DNOC and sulfluramid.

(14) Nicotinic acetylcholine receptor channel blockers selected from bensultap, cartap hydrochloride, thiocylam and thiosultap-sodium.

(15) Inhibitors of chitin biosynthesis, type 0, selected from bistrifluron, chlorfluazuron, diflubenzuron, flucycloxuron, flufenoxuron, hexaflumuron, lufenuron, novaluron, noviflumuron, teflubenzuron and triflumuron.

(16) Inhibitors of chitin biosynthesis, type 1 selected from buprofezin.

(17) Moulting disruptor (in particular for Diptera, i.e. dipterans) selected from cyromazine.

(18) Ecdysone receptor agonists selected from chromafenozide, halofenozide, methoxyfenozide and tebufenozide.

(19) Octopamine receptor agonists selected from amitraz.

(20) Mitochondrial complex III electron transport inhibitors selected from hydramethylnone, acequinocyl and fluacrypyrim.

(21) Mitochondrial complex I electron transport inhibitors, preferably METI acaricides selected from fenazaquin, fenpyroximate, pyrimidifen, pyridaben, tebufenpyrad and tolfenpyrad, or rotenone (Derris).

(22) Voltage-dependent sodium channel blockers selected from indoxacarb and metaflumizone.

(23) Inhibitors of acetyl CoA carboxylase, preferably tetronic and tetramic acid derivatives selected from spirodiclofen, spiromesifen and spirotetramat.

(24) Mitochondrial complex IV electron transport inhibitors, preferably phosphines selected from aluminium phosphide, calcium phosphide, phosphine and zinc phosphide, or cyanides selected from calcium cyanide, potassium cyanide and sodium cyanide.

(25) Mitochondrial complex II electron transport inhibitors, preferably beta-ketonitrile derivatives selected from cyenopyrafen and cyflumetofen, and carboxanilides selected from pyflubumide.

(28) Ryanodine receptor modulators, preferably diamides selected from chlorantraniliprole, cyantraniliprole and flubendiamide.

(29) Chordotonal organ Modulators (with undefined target site) selected from flonicamid.

(30) further active compounds selected from Acynonapyr, Afidopyropen, Afoxolaner, Azadirachtin, Benclothiaz, Benzoximate, Benzpyrimoxan, Bifenazate, Broflanilide, Bromopropylate, Chinomethionat, Chloroprallethrin, Cryolite, Cyclaniliprole, Cycloxaprid, Cyhalodiamide, Dicloromezotiaz, Dicofol, Dimpropyridaz, epsilon-Metofluthrin, epsilon-Momfluthrin, Flometoquin, Fluazaindolizine, Fluensulfone, Flufenerim, Flufenoxystrobin, Flufiprole, Fluhexafon, Fluopyram, Flupyrimin, Fluralaner, Fluxametamide, Fufenozide, Guadipyr, Heptafluthrin, Imidaclothiz, Iprodione, Isocycloseram, kappa-Bifenthrin, kappa-Tefluthrin, Lotilaner, Meperfluthrin, Oxazosulfyl, Paichongding, Pyridalyl, Pyrifluquinazon, Pyriminostrobin, Spirobudiclofen, Spiropidion, Tetramethylfluthrin, Tetraniliprole, Tetrachlorantraniliprole, Tigolaner, Tioxazafen, Thiofluoximate iodomethane; furthermore preparations based on Bacillus firmus (I-1582, BioNeem, Votivo), and also the following compounds: 1-{2-fluoro-4-methyl-5-[(2,2,2-trifluoroethyl)sulphinyl]phenyl}-3-(trifluoromethyl)-1H-1,2,4-triazole-5-amine (known from WO2006/043635) (CAS 885026-50-6), {1′-[(2E)-3-(4-chlorophenyl)prop-2-en-1-yl]-5-fluorospiro[indol-3,4′-piperidin]-1(2H)-yl}(2-chloropyridin-4-yl)methanone (known from WO2003/106457) (CAS 637360-23-7), 2-chloro-N-[2-{1-[(2E)-3-(4-chlorophenyl)prop-2-en-1-yl]piperidin-4-yl}-4-(trifluoromethyl)phenyl]isonicotinamide (known from WO2006/003494) (CAS 872999-66-1), 3-(4-chloro-2,6-dimethylphenyl)-4-hydroxy-8-methoxy-1,8-diazaspiro[4.5]dec-3-en-2-one (known from WO 2010052161) (CAS 1225292-17-0), 3-(4-chloro-2,6-dimethylphenyl)-8-methoxy-2-oxo-1,8-diazaspiro[4.5]dec-3-en-4-yl ethyl carbonate (known from EP2647626) (CAS 1440516-42-6) 4-(but-2-yn-1-yloxy)-6-(3,5-dimethylpiperidin-1-yl)-5-fluoropyrimidine (known from WO2004/099160) (CAS 792914-58-0), PF1364 (known from JP2010/018586) (CAS 1204776-60-2), (3E)-3-[1-[(6-chloro-3-pyridyl)methyl]-2-pyridylidene]-1,1,1-trifluoro-propan-2-one (known from WO2013/144213) (CAS 1461743-15-6), N-[3-(benzylcarbamoyl)-4-chlorophenyl]-1-methyl-3-(pentafluoroethyl)-4-(trifluoromethyl)-1H-pyrazole-5-carboxamide (known from WO2010/051926) (CAS 1226889-14-0), 5-bromo-4-chloro-N-[4-chloro-2-methyl-6-(methylcarbamoyl)phenyl]-2-(3-chloro-2-pyridyl)pyrazole-3-carboxamide (known from CN103232431) (CAS 1449220-44-3), 4-[5-(3,5-dichlorophenyl)-4,5-dihydro-5-(trifluoromethyl)-3-isoxazolyl]-2-methyl-N-(cis-1-oxido-3-thietanyl)-benzamide, 4-[5-(3,5-dichlorophenyl)-4,5-dihydro-5-(trifluoromethyl)-3-isoxazolyl]-2-methyl-N-(trans-1-oxido-3-thietanyl)-benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide (known from WO 2013/050317 A1) (CAS 1332628-83-7), N-[3-chloro-1-(3-pyridinyl)-1H-pyrazol-4-yl]-N-ethyl-3-[(3,3,3-trifluoropropyl) sulfinyl]-propanamide, (+)-N-[3-chloro-1-(3-pyridinyl)-1H-pyrazol-4-yl]-N-ethyl-3-[(3,3,3-trifluoropropyl)sulfinyl]-propanamide and (−)-N-[3-chloro-1-(3-pyridinyl)-1H-pyrazol-4-yl]-N-ethyl-3-[(3,3,3-trifluoropropyl)sulfinyl]-propanamide (known from WO 2013/162715 A2, WO 2013/162716 A2, US 2014/0213448 A1) (CAS 1477923-37-7), 5-[[(2E)-3-chloro-2-propen-1-yl]amino]-1-[2,6-dichloro-4-(trifluoromethyl)phenyl]-4-[(trifluoromethyl)sulfinyl]-1H-pyrazole-3-carbonitrile (known from CN 101337937 A) (CAS 1105672-77-2), 3-bromo-N-[4-chloro-2-methyl-6-[(methylamino)thioxomethyl]phenyl]-1-(3-chloro-2-pyridinyl)-1H-pyrazole-5-carboxamide, (Liudaibenjiaxuanan, known from CN 103109816 A) (CAS 1232543-85-9); N-[4-chloro-2-[[(1,1-dimethylethyl)amino]carbonyl]-6-methylphenyl]-1-(3-chloro-2-pyridinyl)-3-(fluoromethoxy)-1H-Pyrazole-5-carboxamide (known from WO 2012/034403 A1) (CAS 1268277-22-0), N-[2-(5-amino-1,3, 4-thiadiazol-2-yl)-4-chloro-6-methylphenyl]-3-bromo-1-(3-chloro-2-pyridinyl)-1H-pyrazole-5-carboxamide (known from WO 2011/085575 A1) (CAS 1233882-22-8), 4-[3-[2,6-dichloro-4-[(3,3-dichloro-2-propen-1-yl)oxy]phenoxy]propoxy]-2-methoxy-6-(trifluoromethyl)-pyrimidine (known from CN 101337940 A) (CAS 1108184-52-6); (2E)- and 2(Z)-2-[2-(4-cyanophenyl)-1-[3-(trifluoromethyl) phenyl]ethylidene]-N-[4-(difluoromethoxy)phenyl]-hydrazinecarboxamide (known from CN 101715774 A) (CAS 1232543-85-9); 3-(2,2-dichloroethenyl)-2,2-dimethyl-4-(1H-benzimidazol-2-yl)phenyl-cyclopropanecarboxylic acid ester (known from CN 103524422 A) (CAS 1542271-46-4); (4aS)-7-chloro-2,5-dihydro-2-[[(methoxycarbonyl)[4-[(trifluoromethyl)thio]phenyl]amino]carbonyl]-indeno[1,2-e][1,3,4]oxadiazine-4a(3H)-carboxylic acid methyl ester (known from CN 102391261 A) (CAS 1370358-69-2); 6-deoxy-3-O-ethyl-2,4-di-O-methyl-, 1-[N-[4-[1-[4-(1,1,2,2,2-pentafluoroethoxy) phenyl]-1H-1,2,4-triazol-3-yl]phenyl]carbamate]-α-L-mannopyranose (known from US 2014/0275503 A1) (CAS 1181213-14-8); 8-(2-cyclopropylmethoxy-4-trifluoromethyl-phenoxy)-3-(6-trifluoromethyl-pyridazin-3-yl)-3-aza-bicyclo[3.2.1]octane (CAS 1253850-56-4), (8-anti)-8-(2-cyclopropylmethoxy-4-trifluoromethyl-phenoxy)-3-(6-trifluoromethyl-pyridazin-3-yl)-3-aza-bicyclo[3.2.1]octane (CAS 933798-27-7), (8-syn)-8-(2-cyclopropylmethoxy-4-trifluoromethyl-phenoxy)-3-(6-trifluoromethyl-pyridazin-3-yl)-3-aza-bicyclo[3.2.1]octane (known from WO 2007040280 A1, WO 2007040282 A1) (CAS 934001-66-8), N-[3-chloro-1-(3-pyridinyl)-1H-pyrazol-4-yl]-N-ethyl-3-[(3,3,3-trifluoropropyl)thio]-propanamide (known from WO 2015/058021 A1, WO 2015/058028 A1) (CAS 1477919-27-9) and N-[4-(aminothioxomethyl)-2-methyl-6-[(methylamino)carbonyl]phenyl]-3-bromo-1-(3-chloro-2-pyridinyl)-1H-pyrazole-5-carboxamide (known from CN 103265527 A) (CAS 1452877-50-7), 5-(1,3-dioxan-2-yl)-4-[[4-(trifluoromethyl)phenyl]methoxy]-pyrimidine (known from WO 2013/115391 A1) (CAS 1449021-97-9), 3-(4-chloro-2,6-dimethylphenyl)-8-methoxy-1-methyl-1,8-diazaspiro[4.5]decane-2,4-dione (known from WO 2014/187846 A1) (CAS 1638765-58-8), 3-(4-chloro-2,6-dimethylphenyl)-8-methoxy-1-methyl-2-oxo-1, 8-diazaspiro[4.5]dec-3-en-4-yl-carbonic acid ethyl ester (known from WO 2010/066780 A1, WO 2011151146 A1) (CAS 1229023-00-0), 4-[(5S)-5-(3,5-Dichloro-4-fluorophenyl)-4,5-dihydro-5-(trifluoromethyl)-3-isoxazolyl]-N-[(4R)-2-ethyl-3-oxo-4-isoxazolidinyl]-2-methyl-benzamide (bekannt aus WO 2011/067272, WO2013/050302) (CAS 1309959-62-3).

### Preferred Fungicides for Mixtures

The active ingredients specified herein by their Common Name are known and described, for example, in The Pesticide Manual (16th Ed. British Crop Protection Council) or can be searched in the internet (e.g. www.alanwood.net/pesticides).

All named fungicidal mixing partners of the classes (1) to (15) can, if their functional groups enable this, optionally form salts with suitable bases or acids. All named mixing partners of the classes (1) to (15) can include tautomeric forms, where applicable.

1) Inhibitors of the ergosterol biosynthesis, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) Pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) Mefentrifluconazole, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]-methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]phenoxy}phenyl)-N-ethyl-N-methylimidoformamide, (1.068) N′-(2,5-dimethyl-4-{3-[(2,2,2-trifluoroethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) Ipfentrifluconazole.

2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) 3-(difluoromethyl)-1-methyl-N-[(3R)-1,1,3-trimethyl-2,3-dihydro-1H-inden-4-yl]-1H-pyrazole-4-carboxamide, (2.029) 3-(difluoromethyl)-1-methyl-N-[(3S)-1,1,3-trimethyl-2,3-dihydro-1H-inden-4-yl]-1H-pyrazole-4-carboxamide, (2.030) Fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) isoflucypram, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne.

3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid.

4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluoro-phenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine.

5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile.

6) Compounds capable to induce a host defence, for example (6.001) acibenzolar-S-methyl, (6.002) isotianil, (6.003) probenazole, (6.004) tiadinil.

7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.

8) Inhibitors of the ATP production, for example (8.001) silthiofam.

9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.

10) Inhibitors of the lipid and membrane synthesis, for example (10.001) propamocarb, (10.002) propamocarb hydrochloride, (10.003) tolclofos-methyl.

11) Inhibitors of the melanin biosynthesis, for example (11.001) tricyclazole, (11.002) 2,2,2-trifluoroethyl {3-methyl-1-[(4-methylbenzoyl)amino]butan-2-yl}carbamate.

12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).

13) Inhibitors of the signal transduction, for example (13.001) fludioxonil, (13.002) iprodione, (13.003) procymidone, (13.004) proquinazid, (13.005) quinoxyfen, (13.006) vinclozolin.

14) Compounds capable to act as an uncoupler, for example (14.001) fluazinam, (14.002) meptyldinocap.

15) Further compounds, for example (15.001) Abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) Ipflufenoquin, (15.042) 2-{2-fluoro-6-[(8-fluoro-2-methylquinolin-3-yl)oxy]phenyl}propan-2-ol, (15.043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen.

### Biological Pesticides as Mixing Components

The compounds of the formula (I) can be combined with biological pesticides.

Biological pesticides comprise in particular bacteria, fungi, yeasts, plant extracts and products formed by microorganisms, including proteins and secondary metabolites.

Biological pesticides comprise bacteria such as spore-forming bacteria, root-colonising bacteria and bacteria which act as biological insecticides, fungicides or nematicides.

Examples of such bacteria which are employed or can be used as biological pesticides are: Bacillus amyloliquefaciens, strain FZB42 (DSM 231179), or Bacillus cereus, in particular B. cereus strain CNCM I-1562 or Bacillus firmus, strain I-1582 (Accession number CNCM I-1582) or Bacillus pumilus, in particular strain GB34 (Accession No. ATCC 700814) and strain QST2808 (Accession No. NRRL B-30087), or Bacillus subtilis, in particular strain GB03 (Accession No. ATCC SD-1397), or Bacillus subtilis strain QST713 (Accession No. NRRL B-21661) or Bacillus subtilis strain OST 30002 (Accession No. NRRL B-50421) Bacillus thuringiensis, in particular B. thuringiensis subspecies israelensis (serotype H-14), strain AM65-52 (Accession No. ATCC 1276), or B. thuringiensis subsp. aizawai, in particular strain ABTS-1857 (SD-1372), or B. thuringiensis subsp. kurstaki strain HD-1, or B. thuringiensis subsp. tenebrionis strain NB 176 (SD-5428), Pasteuria penetrans, Pasteuria spp. (Rotylenchulus reniformis nematode)-PR3 (Accession Number ATCC SD-5834), Streptomyces microflavus strain AQ6121 (=QRD 31.013, NRRL B-50550), Streptomyces galbus strain AQ 6047 (Acession Number NRRL 30232).

Examples of fungi and yeasts which are employed or can be used as biological pesticides are:

Beauveria bassiana, in particular strain ATCC 74040, Coniothyrium minitans, in particular strain CON/M/91-8 (Accession No. DSM-9660), Lecanicillium spp., in particular strain HRO LEC 12, Lecanicillium lecanii, (formerly known as Verticillium lecanii), in particular strain KV01, Metarhizium anisopliae, in particular strain F52 (DSM3884/ATCC 90448), Metschnikowia fructicola, in particular strain NRRL Y-30752, Paecilomyces fumosoroseus (now: Isaria fumosorosea), in particular strain IFPC 200613, or strain Apopka 97 (Accession No. ATCC 20874), Paecilomyces lilacinus, in particular P. lilacinus strain 251 (AGAL 89/030550), Talaromyces flavus, in particular strain V117b, Trichoderma atroviride, in particular strain SCI (Accession Number CBS 122089), Trichoderma harzianum, in particular T. harzianum rifai T39. (Accession Number CNCM I-952).

Examples of viruses which are employed or can be used as biological pesticides are:

Adoxophyes orana (summer fruit tortrix) granulosis virus (GV), Cydia pomonella (codling moth) granulosis virus (GV), Helicoverpa armigera (cotton bollworm) nuclear polyhedrosis virus (NPV), Spodoptera exigua (beet armyworm) mNPV, Spodoptera frugiperda (fall armyworm) mNPV, Spodoptera littoralis (African cotton leafworm) NPV.

Also included are bacteria and fungi which are added as ‘inoculant’ to plants or plant parts or plant organs and which, by virtue of their particular properties, promote plant growth and plant health.

Examples which may be mentioned are:

Agrobacterium spp., Azorhizobium caulinodans, Azospirillum spp., Azotobacter spp., Bradyrhizobium spp., Burkholderia spp., in particular Burkholderia cepacia (formerly known as Pseudomonas cepacia), Gigaspora spp., or Gigaspora monosporum, Glomus spp., Laccaria spp., Lactobacillus buchneri, Paraglomus spp., Pisolithus tinctorus, Pseudomonas spp., Rhizobium spp., in particular Rhizobium trifolii, Rhizopogon spp., Scleroderma spp., Suillus spp., Streptomyces spp.

Examples of plant extracts and products formed by microorganisms including proteins and secondary metabolites which are employed or can be used as biological pesticides are:

Allium sativum, Artemisia absinthium, azadirachtin, Biokeeper WP, Cassia nigricans, Celastrus angulatus, Chenopodium anthelminticum, chitin, Armour-Zen, Dryopteris filix-mas, Equisetum arvense, Fortune Aza, Fungastop, Heads Up (Chenopodium quinoa saponin extract), Pyrethrum/Pyrethrins, Quassia amara, Quercus, Quillaja, Regalia, “Requiem™ Insecticide”, rotenone, ryania/ryanodine, Symphytum officinale, Tanacetum vulgare, thymol, Triact 70, TriCon, Tropaeulum majus, Urtica dioica, Veratrin, Viscum album, Brassicaceae extract, in particular oilseed rape powder or mustard powder.

### Safener as Mixing Components

The compounds of the formula (I) can be combined with safeners such as, for example, benoxacor, cloquintocet (-mexyl), cyometrinil, cyprosulfamide, dichlormid, fenchlorazole (-ethyl), fenclorim, flurazole, fluxofenim, furilazole, isoxadifen (-ethyl), mefenpyr (-diethyl), naphthalic anhydride, oxabetrinil, 2-methoxy-N-({4-[(methylcarbamoyl)amino]phenyl}sulphonyl)benzamide (CAS 129531-12-0), 4-(dichloroacetyl)-1-oxa-4-azaspiro[4.5]decane (CAS 71526-07-3), 2,2,5-trimethyl-3-(dichloroacetyl)-1,3-oxazolidine (CAS 52836-31-4).

### Plants and Plant Parts

All plants and plant parts can be treated in accordance with the invention. Here, plants are to be understood to mean all plants and plant parts such as wanted and unwanted wild plants or crop plants (including naturally occurring crop plants), for example cereals (wheat, rice, triticale, barley, rye, oats), maize, soya bean, potato, sugar beet, sugar cane, tomatoes, pepper, cucumber, melon, carrot, watermelon, onion, lettuce, spinach, leek, beans, Brassica oleracea (e.g. cabbage) and other vegetable species, cotton, tobacco, oilseed rape, and also fruit plants (with the fruits apples, pears, citrus fruits and grapevines). Crop plants can be plants which can be obtained by conventional breeding and optimization methods or by biotechnological and genetic engineering methods or combinations of these methods, including the transgenic plants and including the plant varieties which can or cannot be protected by varietal property rights. Plants should be understood to mean all developmental stages, such as seeds, seedlings, young (immature) plants up to mature plants. Plant parts should be understood to mean all parts and organs of the plants above and below ground, such as shoot, leaf, flower and root, examples given being leaves, needles, stalks, stems, flowers, fruit bodies, fruits and seeds, and also tubers, roots and rhizomes. Parts of plants also include harvested plants or harvested plant parts and vegetative and generative propagation material, for example seedlings, tubers, rhizomes, cuttings and seeds.

Treatment according to the invention of the plants and plant parts with the compounds of the formula (I) is carried out directly or by allowing the compounds to act on the surroundings, environment or storage space by the customary treatment methods, for example by immersion, spraying, evaporation, fogging, scattering, painting on, injection and, in the case of propagation material, in particular in the case of seeds, also by applying one or more coats.

As already mentioned above, it is possible to treat all plants and their parts according to the invention. In a preferred embodiment, wild plant species and plant cultivars, or those obtained by conventional biological breeding methods, such as crossing or protoplast fusion, and also parts thereof, are treated. In a further preferred embodiment, transgenic plants and plant cultivars obtained by genetic engineering methods, if appropriate in combination with conventional methods (genetically modified organisms), and parts thereof are treated. The term “parts” or “parts of plants” or “plant parts” has been explained above. The invention is used with particular preference to treat plants of the respective commercially customary cultivars or those that are in use. Plant cultivars are to be understood as meaning plants having new properties (“traits”) and which have been obtained by conventional breeding, by mutagenesis or by recombinant DNA techniques. They can be cultivars, varieties, bio- or genotypes.

### Transgenic Plant, Seed Treatment and Integration Events

The transgenic plants or plant cultivars (those obtained by genetic engineering) which are to be treated with preference in accordance with the invention include all plants which, through the genetic modification, received genetic material which imparts particular advantageous useful properties (“traits”) to these plants. Examples of such properties are better plant growth, increased tolerance to high or low temperatures, increased tolerance to drought or to levels of water or soil salinity, enhanced flowering performance, easier harvesting, accelerated ripening, higher yields, higher quality and/or a higher nutritional value of the harvested products, better storage life and/or processability of the harvested products. Further and particularly emphasized examples of such properties are increased resistance of the plants against animal and microbial pests, such as against insects, arachnids, nematodes, mites, slugs and snails owing, for example, to toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c Cry2Ab, Cry3Bb and CryIF and also combinations thereof), furthermore increased resistance of the plants against phytopathogenic fungi, bacteria and/or viruses owing, for example, to systemic acquired resistance (SAR), systemin, phytoalexins, elicitors and also resistance genes and correspondingly expressed proteins and toxins, and also increased tolerance of the plants to certain herbicidally active compounds, for example imidazolinones, sulphonylureas, glyphosate or phosphinothricin (for example the “PAT” gene). The genes which impart the desired traits in question may also be present in combinations with one another in the transgenic plants. Examples of transgenic plants which may be mentioned are the important crop plants, such as cereals (wheat, rice, triticale, barley, rye, oats), maize, soya beans, potatoes, sugar beet, sugar cane, tomatoes, peas and other types of vegetable, cotton, tobacco, oilseed rape and also fruit plants (with the fruits apples, pears, citrus fruits and grapes), with particular emphasis being given to maize, soya beans, wheat, rice, potatoes, cotton, sugar cane, tobacco and oilseed rape. Traits which are particularly emphasized are the increased resistance of the plants to insects, arachnids, nematodes and slugs and snails.

### Crop Protection—Types of Treatment

The treatment of the plants and plant parts with the compounds of the formula (I) is carried out directly or by action on their surroundings, habitat or storage space using customary treatment methods, for example by dipping, spraying, atomizing, irrigating, evaporating, dusting, fogging, broadcasting, foaming, painting, spreading-on, injecting, watering (drenching), drip irrigating and, in the case of propagation material, in particular in the case of seed, furthermore as a powder for dry seed treatment, a solution for liquid seed treatment, a water-soluble powder for slurry treatment, by incrusting, by coating with one or more coats, etc. It is furthermore possible to apply the compounds of the formula (I) by the ultra-low volume method or to inject the application form or the compound of the formula (I) itself into the soil.

A preferred direct treatment of the plants is foliar application, i.e. the compounds of the formula (I) are applied to the foliage, where treatment frequency and the application rate should be adjusted according to the level of infestation with the pest in question.

In the case of systemically active compounds, the compounds of the formula (I) also access the plants via the root system. The plants are then treated by the action of the compounds of the formula (I) on the habitat of the plant. This may be done, for example, by drenching, or by mixing into the soil or the nutrient solution, i.e. the locus of the plant (e.g. soil or hydroponic systems) is impregnated with a liquid form of the compounds of the formula (I), or by soil application, i.e. the compounds of the formula (I) according to the invention are introduced in solid form (e.g. in the form of granules) into the locus of the plants, or by drip application (often also referred to as “chemigation”), i.e. the liquid application of the compounds of the formula (I) according to the invention from surface or sub-surface driplines over a certain period of time together with varying amounts of water at defined locations in the vicinity of the plants. In the case of paddy rice crops, this can also be done by metering the compound of the formula (I) in a solid application form (for example as granules) into a flooded paddy field.

### Treatment of Seed

The control of animal pests by treating the seed of plants has been known for a long time and is the subject of continuous improvements. However, the treatment of seed entails a series of problems which cannot always be solved in a satisfactory manner. Thus, it is desirable to develop methods for protecting the seed and the germinating plant which dispense with, or at least reduce considerably, the additional application of pesticides during storage, after sowing or after emergence of the plants. It is furthermore desirable to optimize the amount of active compound employed in such a way as to provide optimum protection for the seed and the germinating plant from attack by animal pests, but without damaging the plant itself by the active compound employed. In particular, methods for the treatment of seed should also take into consideration the intrinsic insecticidal or nematicidal properties of pest-resistant or -tolerant transgenic plants in order to achieve optimum protection of the seed and also the germinating plant with a minimum of pesticides being employed.

The present invention therefore in particular also relates to a method for the protection of seed and germinating plants, from attack by pests, by treating the seed with one of the compounds of the formula (I). The method according to the invention for protecting seed and germinating plants against attack by pests furthermore comprises a method where the seed is treated simultaneously in one operation or sequentially with a compound of the formula (I) and a mixing component. It also comprises a method where the seed is treated at different times with a compound of the formula (I) and a mixing component.

The invention likewise relates to the use of the compounds of the formula (I) for the treatment of seed for protecting the seed and the resulting plant from animal pests.

Furthermore, the invention relates to seed which has been treated with a compound of the formula (I) according to the invention so as to afford protection from animal pests. The invention also relates to seed which has been treated simultaneously with a compound of the formula (I) and a mixing component. The invention furthermore relates to seed which has been treated at different times with a compound of the formula (I) and a mixing component. In the case of seed which has been treated at different points in time with a compound of the formula (I) and a mixing component, the individual substances may be present on the seed in different layers. Here, the layers comprising a compound of the formula (I) and mixing components may optionally be separated by an intermediate layer. The invention also relates to seed where a compound of the formula (I) and a mixing component have been applied as component of a coating or as a further layer or further layers in addition to a coating.

Furthermore, the invention relates to seed which, after the treatment with a compound of the formula (I), is subjected to a film-coating process to prevent dust abrasion on the seed.

One of the advantages encountered with a systemically acting compound of the formula (I) is the fact that, by treating the seed, not only the seed itself but also the plants resulting therefrom are, after emergence, protected against animal pests. In this manner, the immediate treatment of the crop at the time of sowing or shortly thereafter can be dispensed with.

It has to be considered a further advantage that by treatment of the seed with a compound of the formula (I), germination and emergence of the treated seed may be enhanced.

It is likewise to be considered advantageous that compounds of the formula (I) can be used in particular also for transgenic seed.

Furthermore, compounds of the formula (I) can be employed in combination with compositions or compounds of signalling technology, leading to better colonization by symbionts such as, for example, rhizobia, mycorrhizae and/or endophytic bacteria or fungi, and/or to optimized nitrogen fixation.

The compounds of the formula (I) are suitable for protection of seed of any plant variety which is used in agriculture, in the greenhouse, in forests or in horticulture. In particular, this takes the form of seed of cereals (for example wheat, barley, rye, millet and oats), corn, cotton, soya beans, rice, potatoes, sunflowers, coffee, tobacco, canola, oilseed rape, beets (for example sugarbeets and fodder beets), peanuts, vegetables (for example tomatoes, cucumbers, bean, cruciferous vegetables, onions and lettuce), fruit plants, lawns and ornamental plants. The treatment of the seed of cereals (such as wheat, barley, rye and oats), maize, soya beans, cotton, canola, oilseed rape, vegetables and rice is of particular importance.

As already mentioned above, the treatment of transgenic seed with a compound of the formula (I) is also of particular importance. This takes the form of seed of plants which, as a rule, comprise at least one heterologous gene which governs the expression of a polypeptide with in particular insecticidal and/or nematicidal properties. The heterologous genes in transgenic seed can originate from microorganisms such as Bacillus, Rhizobium, Pseudomonas, Serratia, Trichoderma, Clavibacter, Glomus or Gliocladium. The present invention is particularly suitable for the treatment of transgenic seed which comprises at least one heterologous gene originating from Bacillus sp. It is particularly preferably a heterologous gene derived from Bacillus thuringiensis.

In the context of the present invention, the compound of the formula (I) is applied to the seed. Preferably, the seed is treated in a state in which it is stable enough to avoid damage during treatment. In general, the seed may be treated at any point in time between harvest and sowing. The seed usually used has been separated from the plant and freed from cobs, shells, stalks, coats, hairs or the flesh of the fruits. For example, it is possible to use seed which has been harvested, cleaned and dried down to a moisture content which allows storage. Alternatively, it is also possible to use seed which, after drying, has been treated with, for example, water and then dried again, for example priming. In the case of rice seed, it is also possible to use seed which has been soaked, for example in water to a certain stage of the rice embryo (‘pigeon breast stage’), stimulating the germination and a more uniform emergence.

When treating the seed, care must generally be taken that the amount of the compound of the formula (I) applied to the seed and/or the amount of further additives is chosen in such a way that the germination of the seed is not adversely affected, or that the resulting plant is not damaged. This must be ensured particularly in the case of active compounds which can exhibit phytotoxic effects at certain application rates.

In general, the compounds of the formula (I) are applied to the seed in a suitable formulation. Suitable formulations and processes for seed treatment are known to the person skilled in the art.

The compounds of the formula (I) can be converted to the customary seed dressing formulations, such as solutions, emulsions, suspensions, powders, foams, slurries or other coating compositions for seed, and also ULV formulations.

These formulations are prepared in a known manner, by mixing the compounds of the formula (I) with customary additives such as, for example, customary extenders and also solvents or diluents, colorants, wetting agents, dispersants, emulsifiers, antifoams, preservatives, secondary thickeners, adhesives, gibberellins and also water.

Colorants which may be present in the seed-dressing formulations which can be used in accordance with the invention are all colorants which are customary for such purposes. It is possible to use either pigments, which are sparingly soluble in water, or dyes, which are soluble in water. Examples include the dyes known by the names Rhodamine B, C.I. Pigment Red 112 and C.I. Solvent Red 1.

Useful wetting agents which may be present in the seed dressing formulations usable in accordance with the invention are all substances which promote wetting and which are conventionally used for the formulation of agrochemically active compounds. Preference is given to using alkylnaphthalenesulphonates, such as diisopropyl- or diisobutylnaphthalenesulphonates.

Useful dispersants and/or emulsifiers which may be present in the seed dressing formulations usable in accordance with the invention are all nonionic, anionic and cationic dispersants conventionally used for the formulation of active agrochemical ingredients. Preference is given to using nonionic or anionic dispersants or mixtures of nonionic or anionic dispersants. Suitable nonionic dispersants include in particular ethylene oxide/propylene oxide block polymers, alkylphenol polyglycol ethers and tristryrylphenol polyglycol ethers, and the phosphated or sulphated derivatives thereof. Suitable anionic dispersants are in particular lignosulphonates, polyacrylic acid salts and arylsulphonate/formaldehyde condensates.

Antifoams which may be present in the seed dressing formulations usable in accordance with the invention are all foam-inhibiting substances conventionally used for the formulation of active agrochemical ingredients. Preference is given to using silicone antifoams and magnesium stearate.

Preservatives which may be present in the seed dressing formulations usable in accordance with the invention are all substances usable for such purposes in agrochemical compositions. Examples include dichlorophene and benzyl alcohol hemiformal.

Secondary thickeners which may be present in the seed dressing formulations usable in accordance with the invention are all substances which can be used for such purposes in agrochemical compositions. Cellulose derivatives, acrylic acid derivatives, xanthan, modified clays and finely divided silica are preferred.

Secondary thickeners which may be present in the seed dressing formulations usable in accordance with the invention are all substances which can be used for such purposes in agrochemical compositions. Cellulose derivatives, acrylic acid derivatives, xanthan, modified clays and finely divided silica are preferred.

Adhesives which may be present in the seed dressing formulations usable in accordance with the invention are all customary binders usable in seed dressing products. Polyvinylpyrrolidone, polyvinyl acetate, polyvinyl alcohol and tylose may be mentioned as being preferred.

Gibberellins which can be present in the seed-dressing formulations which can be used in accordance with the invention are preferably the gibberellins A1, A3 (=gibberellic acid), A4 and A7; gibberellic acid is especially preferably used. The gibberellins are known (cf. R. Wegler “Chemie der Pflanzenschutz- and Schädlingsbekämpfungsmittel”, vol. 2, Springer Verlag, 1970, pp. 401-412).

The seed dressing formulations usable in accordance with the invention can be used to treat a wide variety of different kinds of seed either directly or after prior dilution with water. For instance, the concentrates or the preparations obtainable therefrom by dilution with water can be used to dress the seed of cereals, such as wheat, barley, rye, oats, and triticale, and also the seed of maize, rice, oilseed rape, peas, beans, cotton, sunflowers, soya beans and beets, or else a wide variety of different vegetable seed. The seed dressing formulations usable in accordance with the invention, or the dilute use forms thereof, can also be used to dress seed of transgenic plants.

For treatment of seed with the seed dressing formulations usable in accordance with the invention, or the use forms prepared therefrom by adding water, all mixing units usable customarily for the seed dressing are useful. Specifically, the procedure in the seed dressing is to place the seed into a mixer, operated batch-wise or continuously, to add the particular desired amount of seed dressing formulations, either as such or after prior dilution with water, and to mix everything until the formulation is distributed homogeneously on the seed. If appropriate, this is followed by a drying operation.

The application rate of the seed dressing formulations usable in accordance with the invention can be varied within a relatively wide range. It is guided by the particular content of the compounds of the formula (I) in the formulations and by the seed. The application rates of the compound of the formula (I) are generally between 0.001 and 50 g per kilogram of seed, preferably between 0.01 and 15 g per kilogram of seed.

### Vector Control

The compounds of the formula (I) can also be used in vector control. For the purpose of the present invention, a vector is an arthropod, in particular an insect or arachnid, capable of transmitting pathogens such as, for example, viruses, worms, single-cell organisms and bacteria from a reservoir (plant, animal, human, etc.) to a host. The pathogens can be transmitted either mechanically (for example trachoma by non-stinging flies) to a host, or by injection (for example malaria parasites by mosquitoes) into a host.

Examples of vectors and the diseases or pathogens they transmit are:

1) Mosquitoes
Anopheles: malaria, filariasis;
Culex: Japanese encephalitis, other viral diseases, filariasis, transmission of other worms;
Aedes: yellow fever, dengue fever, other viral diseases, filariasis;
Simuliidae: transmission of worms, in particular Onchocerca volvulus;
Psychodidae: transmission of leishmaniasis

2) Lice: skin infections, epidemic typhus;

3) Fleas: plague, endemic typhus, cestodes;

4) Flies: sleeping sickness (trypanosomiasis); cholera, other bacterial diseases;

5) Mites: acariosis, epidemic typhus, rickettsialpox, tularaemia, Saint Louis encephalitis, tick-borne encephalitis (TBE), Crimean-Congo haemorrhagic fever, borreliosis;

6) Ticks: borellioses such as Borrelia burgdorferi sensu lato., Borrelia duttoni, tick-borne encephalitis, Q fever (Coxiella burnetii), babesioses (Babesia canis canis), ehrlichiosis.

Examples of vectors in the sense of the present invention are insects, for example aphids, flies, leafhoppers or thrips, which are capable of transmitting plant viruses to plants. Other vectors capable of transmitting plant viruses are spider mites, lice, beetles and nematodes.

Further examples of vectors in the sense of the present invention are insects and arachnids such as mosquitoes, in particular of the genera Aedes, Anopheles, for example A. gambiae, A. arabiensis, A. funestus, A. dirus (malaria) and Culex, psychodids such as Phlebotomus, Lutzomyia, lice, fleas, flies, mites and ticks capable of transmitting pathogens to animals and/or humans.

Vector control is also possible if the compounds of the formula (I) are resistance-breaking.

Compounds of the formula (I) are suitable for use in the prevention of diseases and/or pathogens transmitted by vectors. Thus, a further aspect of the present invention is the use of compounds of the formula (I) for vector control, for example in agriculture, in horticulture, in gardens and in leisure facilities, and also in the protection of materials and stored products.

### Preparation of Compounds

The compounds of Formula I, II′, II, II′a and IIa can be prepared by one of ordinary skill in the art following art recognized techniques and procedures.

More specifically, compounds of Formula I, II′, II, II′a and IIa can be prepared as illustrated on pages page 17, line 15 to page 24, line 7 in WO 2017/192385 and in schemes 1-7 in WO 2017/192385.

3-Chloro-5-[(trifluoromethyl)sulfanyl]benzamides as shown in example I-107 (scheme 8) can be synthesized in analogy as described in Angew. Chem. Int. Ed. 2012, 51, 2492-2495.

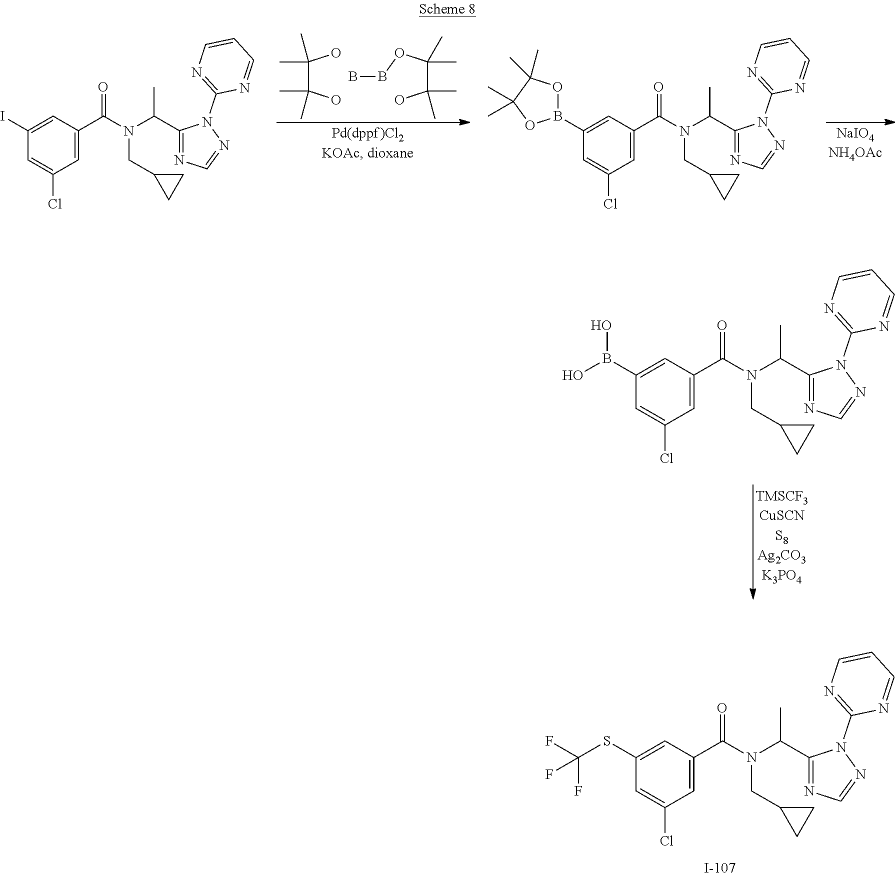

Scheme 9 illustrates the preparation of 3-haloalkyl triazoles as shown e.g. in example I-131. In a first step, a hydrazine amide is formed as described in EP 1099695. In a second step, (αS)-1,3-dihydro-α-methyl-1,3-dioxo-2H-isoindole-2-acetyl chloride, prepared from (αS)-1,3-dihydro-α-methyl-1,3-dioxo-2H-isoindole-2-acetic acid (Pht-Ala-OH purchased from ABCR) and oxalyl chloride according to Tetrahedron: Asymmetry, 21(8), 936-942, 2010, reacts with a hydrazone amide in the presence of a base, like pyridine, as described in EP 1099695. In a third step, the phthalimide protection group is removed by reaction with hydrazine hydrate in a suitable solvent, like ethanol, as described in WO 2018086605. In a final step, the obtained amine is reacted with a carboxylic acid to form the example compound, e.g. I-131. For example, a mixture of an amine, a carboxylic acid, a suitable coupling reagent, such as T3P®, [O-(7-azabenzotriazol-1-yl)-N,N,N′,N′-tetramethyluronium-hexafluorophosphate] (HATU), dicyclohexylcarbodiimid (DCC), 1-ethyl-3-(3-dimethylaminopropyl)carbodiimide (EDC) or hydroxybenzotriazole (HOBt), a suitable base such as triethylamine or N,N-diisopropylethylamine, in a suitable solvent such as ethyl acetate or N,N-dimethylformamide are mixed at temperatures ranging from around 0 to 100° C. to provide the example compound which may then be isolated and, if necessary and desired, purified using techniques well known in the art, such as chromatography.

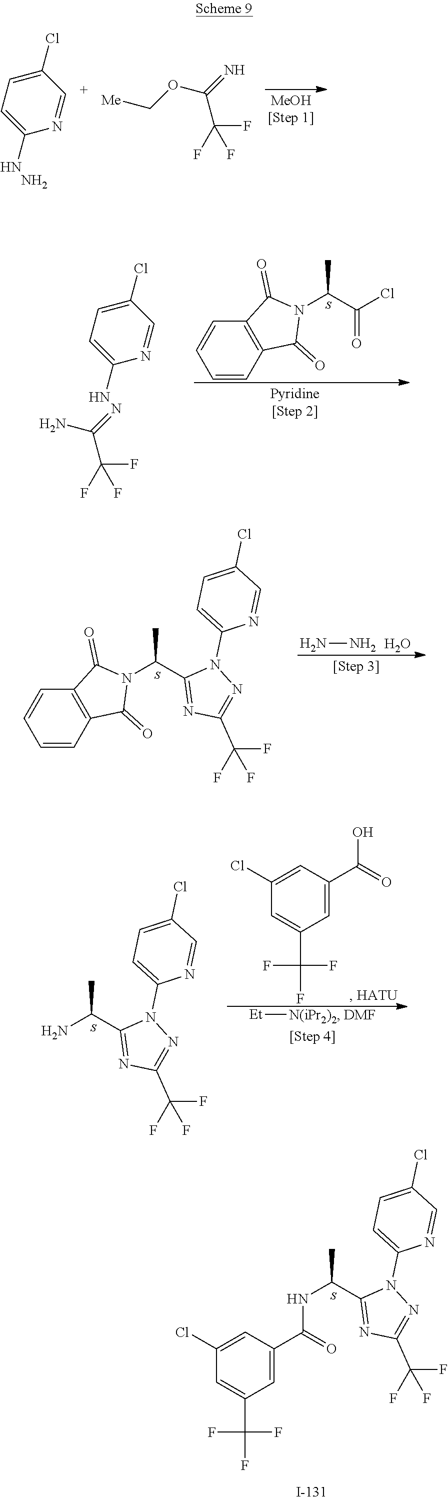

### Synthesis of 3-chloro-N-{(1S)-1-[1-(5-chloropyridin-2-yl)-3-(trifluoromethyl)-1H-1,2,4-triazol-5-yl]ethyl}-5-(trifluoromethyl)benzamide (Example I-131)

### Step 1: N′-(5-Chloropyridin-2-yl)(trifluoro)ethanehydrazonamide

To 4.30 g (30.00 mmol) 5-chloro-2-hydrazinyl-pyridine in methanol (30 mL) 7.74 g (42.00 mmol) 2,2,2-trifluoro-ethanimidic acid ethyl ester was added, and the reaction mixture was stirred at room temperature over night. The solvent was evaporated and the residue was then stirred with n-hexane (30 mL) and ethyl acetate (3 mL). The brownish precipitate was separated and dried to obtain 4.81 g (purity: 89.0%; yield: 59.8%) N′-(5-chloropyridin-2-yl)(trifluoro)ethanehydrazonamide.

Formula: C₇H₆ClF₃N₄

Molecular weight: 238.59 g/mol

HPLC-MS (ESI Positiv): 239.0 (M+1); Rₜ=0.91; 0.93 min (instrument: LC-MS7)

### Step 2: 2-[(1S)-1-[3-(Trifluoromethyl)-1-(1-(5-chloropyridin-2-yl)-1H-1,2,4-triazol-5-yl)ethyl]-1H-isoindole-1,3(2H)-dione

To 596.5 mg (2.50 mmol) (1Z)—N′-(5-chloropyridin-2-yl)(trifluoro)ethanehydrazonamide in pyridine (10 mL), 594.1 mg (2.50 mmol) (αS)-1,3-dihydro-α-methyl-1,3-dioxo-2H-isoindole-2-acetyl chloride (see preparation from (αS)-1,3-dihydro-α-methyl-1,3-dioxo-2H-isoindole-2-acetic acid (Pht-Ala-OH purchased from ABCR) and oxalyl chloride: Tetrahedron: Asymmetry, 21(8), 936-942, 2010) was added, and the reaction mixture was stirred at room temperature over night. Then saturated NaHCO₃ solution was added and the mixture was extracted with dichloromethane. The organic phase was separated, dried and the solvent was evaporated. The remaining solid residue was chromatographed with a cyclohexane/acetone gradient on silica gel to afford 495.0 mg (purity: 96.8%; yield: 45.4%) of the title compound as a colorless solid.

Formula: C₁₈H₁₁ClF₃N₅O₂

Molecular weight: 421.76 g/mol

HPLC-MS (ESI Positiv): 422.1 (M+1); Rₜ=1.50 min (instrument: LC-MS6)

¹³C-NMR with ¹H dec. (CPD) (150 MHz, CD₃CN, ppm) 6=17.6 (H₃C); 44.8 (CH); 119.1 (C—H, pyridinyl); 120.3 (F₃C, triazolyl); 124.0 (2×C—H, phthalyl); 132.4 (2×C, phthalyl); 132.9 C—Cl, pyridinyl); 135.5 (2×C—H, phthalyl); 140.5 (C—H, pyridinyl); 147.8 (C—H, pyridinyl); 148.9 (C—N, pyridinyl); 153.1 (C, triazolyl), 158.2 (C, triazolyl); 168.0 (2×C═O, phthalyl).

### Step 3: (αS)-Methyl-1-(5-chloropyridin-2-yl)-1H-1,2,4-triazole-5-methane amine

To 440.0 mg (1.043 mmol) 2-[(1S)-1-[3-(trifluoromethyl)-1-(1-(5-chloropyridin-2-yl)-1H-1,2,4-triazol-5-yl)ethyl]-1H-isoindole-1,3(2H)-dione in ethanol (10 mL), 142.4 mg (1.565 mmol) hydrazine-hydrate was added, and the reaction mixture was heated under reflux. After 30 minutes a colorless precipitate was formed. The reaction mixture was stirred and heated under reflux one additional hour, aceton (5 mL) was added and the heating was continued for further 30 minutes. The reaction mixture was concentrated and the solid residue was treated with ethanol. Then, the solvent was evaporated to afford 190.0 mg (yield: 62.4%) (αS)-methyl-1-(5-chloropyridin-2-yl)-1H-1,2,4-triazole-5-methane amine, which was used for the N-acylation reaction (step 4) without purification.

Formula: C₁₀H₉CF₃N₅

Molecular weight: 291.66 g/mol

HPLC-MS (ESI Positiv): 292.0 (M⁺); Rₜ=0.52 min (broad) (instrument: LC-MS7)

### Step 4: 3-Chloro-N-{(1S)-1-[1-(5-chloropyridin-2-yl)-3-(trifluoromethyl)-1H-1,2,4-triazol-5-yl]ethyl}-5-(trifluoromethyl)benzamide

To 188.9 mg (0.648 mmol) (αS)-methyl-1-(5-chloro-2-pyridinyl)-1H-1,2,4-triazole-5-methane amine, 150.0 mg (0.648 mmol) 3-chloro-5-(trifluoromethyl)-benzoic acid, 108.8 mg (0.842 mmol) N,N-diisopropylethylamine (Hunig's base) in N,N-dimethylformamide (DMF) (5 mL), 296.6 mg (0.778 mmol) [O-(7-azabenzotriazol-1-yl)-N,N,N′,N′-tetramethyluronium-hexafluorophosphate] (HATU) was added, and the reaction mixture was stirred at room temperature over night. The reaction mixture was concentrated and the solid residue was treated with dichloromethane and then extracted with a saturated NaHCO₃ solution and water. The organic phase was separated, dried and the solvent was evaporated.

The remaining solid residue was chromatographed with a cyclohexane/acetone gradient on silica gel to afford 230.0 mg (purity: 96.0%; yield: 68.4%) of the title compound.

Formula: C₁₈H₁₁Cl₂F₆N₅O

Molecular weight: 498.20 g/mol

HPLC-MS (ESI Positiv): 497.9 (M+), 498.9 (M+1); Rt=1.71 min (instrument: LC-MS7)

¹H-NMR: see NMR peaklist in table 2

The compounds according to the invention described in Table 1 below are likewise preferred compounds of the formula (I) according to the invention which are obtained according to or analogously to the synthesis schemes described above or in WO 2017/192385.

TABLE 1

| Example No. | Structure |
|---|---|
| I-01 | 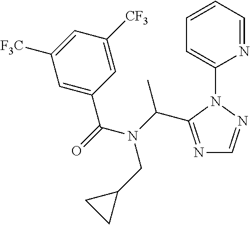 [SMILES: CC(c1ncnn1-c1ccccn1)N(CC1CC1)C(=O)c1cc(C(F)(F)F)cc(C(F)(F)F)c1] |
| I-02 | 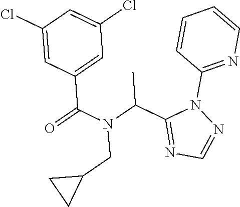 [SMILES: CC(c1ncnn1-c1ccccn1)N(CC1CC1)C(=O)c1cc(Cl)cc(Cl)c1] |
| I-03 | 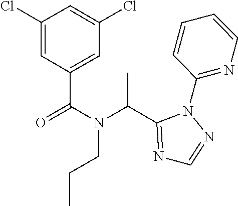 [SMILES: CCCN(C(=O)c1cc(Cl)cc(Cl)c1)C(C)c1ncnn1-c1ccccn1] |
| I-04 | 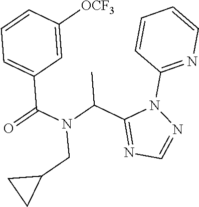 [SMILES: CC(c1ncnn1-c1ccccn1)N(CC1CC1)C(=O)c1cccc(OC(F)(F)F)c1] |
| I-05 | 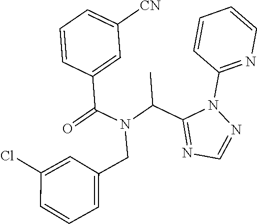 [SMILES: CC(c1ncnn1-c1ccccn1)N(Cc1cccc(Cl)c1)C(=O)c1cccc(C#N)c1] |
| I-06 | 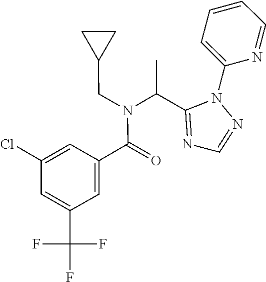 [SMILES: CC(c1ncnn1-c1ccccn1)N(CC1CC1)C(=O)c1cc(Cl)cc(C(F)(F)F)c1] |
| I-07 | 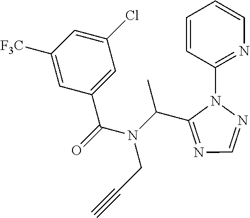 [SMILES: C#CCN(C(=O)c1cc(Cl)cc(C(F)(F)F)c1)C(C)c1ncnn1-c1ccccn1] |
| I-08 | 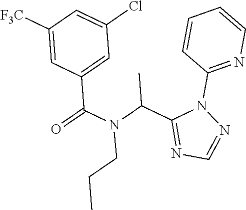 [SMILES: CCCN(C(=O)c1cc(Cl)cc(C(F)(F)F)c1)C(C)c1ncnn1-c1ccccn1] |
| I-09 | 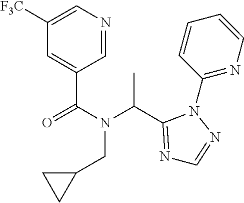 [SMILES: CC(c1ncnn1-c1ccccn1)N(CC1CC1)C(=O)c1cncc(C(F)(F)F)c1] |
| I-10 | 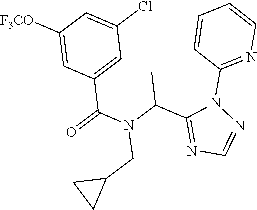 [SMILES: CC(c1ncnn1-c1ccccn1)N(CC1CC1)C(=O)c1cc(Cl)cc(OC(F)(F)F)c1] |
| I-11 | 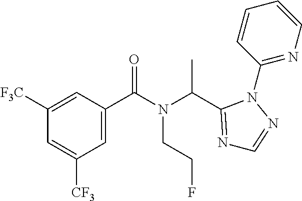 [SMILES: CC(c1ncnn1-c1ccccn1)N(CCF)C(=O)c1cc(C(F)(F)F)cc(C(F)(F)F)c1] |
| I-12 | 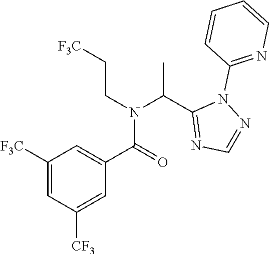 [SMILES: CC(c1ncnn1-c1ccccn1)N(CCC(F)(F)F)C(=O)c1cc(C(F)(F)F)cc(C(F)(F)F)c1] |
| I-13 | 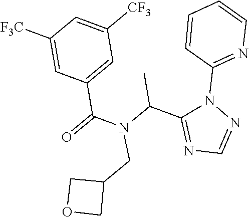 [SMILES: CC(c1ncnn1-c1ccccn1)N(CC1COC1)C(=O)c1cc(C(F)(F)F)cc(C(F)(F)F)c1] |
| I-14 | 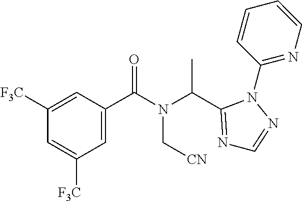 [SMILES: CC(c1ncnn1-c1ccccn1)N(CC#N)C(=O)c1cc(C(F)(F)F)cc(C(F)(F)F)c1] |
| I-15 | 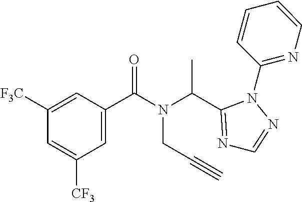 [SMILES: C#CCN(C(=O)c1cc(C(F)(F)F)cc(C(F)(F)F)c1)C(C)c1ncnn1-c1ccccn1] |
| I-16 | 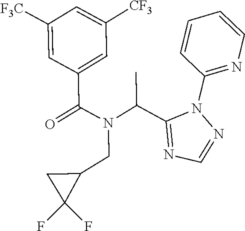 [SMILES: CC(c1ncnn1-c1ccccn1)N(CC1CC1(F)F)C(=O)c1cc(C(F)(F)F)cc(C(F)(F)F)c1] |
| I-17 | 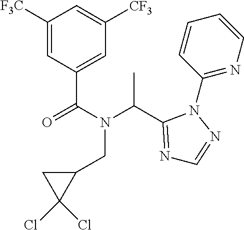 [SMILES: CC(c1ncnn1-c1ccccn1)N(CC1CC1(Cl)Cl)C(=O)c1cc(C(F)(F)F)cc(C(F)(F)F)c1] |
| I-18 | 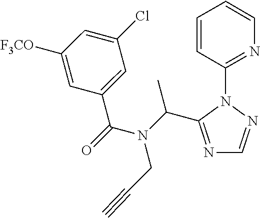 [SMILES: C#CCN(C(=O)c1cc(Cl)cc(OC(F)(F)F)c1)C(C)c1ncnn1-c1ccccn1] |
| I-19 | 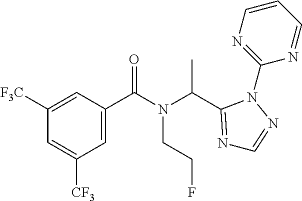 [SMILES: CC(c1ncnn1-c1ncccn1)N(CCF)C(=O)c1cc(C(F)(F)F)cc(C(F)(F)F)c1] |
| I-20 | 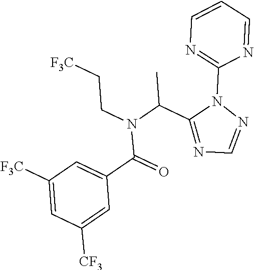 [SMILES: CC(c1ncnn1-c1ncccn1)N(CCC(F)(F)F)C(=O)c1cc(C(F)(F)F)cc(C(F)(F)F)c1] |
| I-21 | 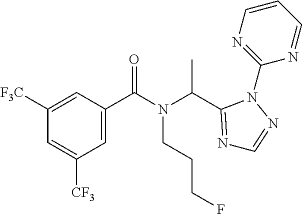 [SMILES: CC(c1ncnn1-c1ncccn1)N(CCCF)C(=O)c1cc(C(F)(F)F)cc(C(F)(F)F)c1] |
| I-22 | 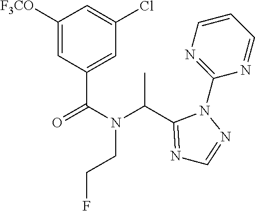 [SMILES: CC(c1ncnn1-c1ncccn1)N(CCF)C(=O)c1cc(Cl)cc(OC(F)(F)F)c1] |
| I-23 | 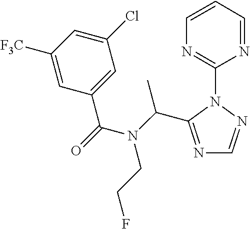 [SMILES: CC(c1ncnn1-c1ncccn1)N(CCF)C(=O)c1cc(Cl)cc(C(F)(F)F)c1] |
| I-24 | 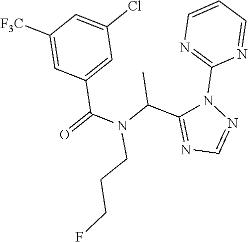 [SMILES: CC(c1ncnn1-c1ncccn1)N(CCCF)C(=O)c1cc(Cl)cc(C(F)(F)F)c1] |
| I-25 | 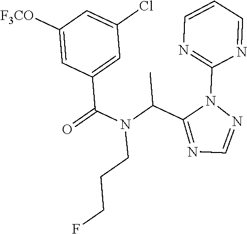 [SMILES: CC(c1ncnn1-c1ncccn1)N(CCCF)C(=O)c1cc(Cl)cc(OC(F)(F)F)c1] |
| I-26 | 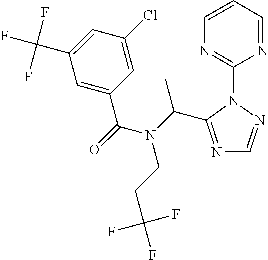 [SMILES: CC(c1ncnn1-c1ncccn1)N(CCC(F)(F)F)C(=O)c1cc(Cl)cc(C(F)(F)F)c1] |
| I-27 | 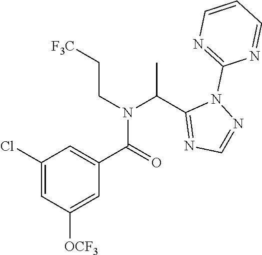 [SMILES: CC(c1ncnn1-c1ncccn1)N(CCC(F)(F)F)C(=O)c1cc(Cl)cc(OC(F)(F)F)c1] |
| I-28 | 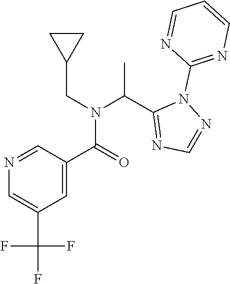 [SMILES: CC(c1ncnn1-c1ncccn1)N(CC1CC1)C(=O)c1cncc(C(F)(F)F)c1] |
| I-29 | 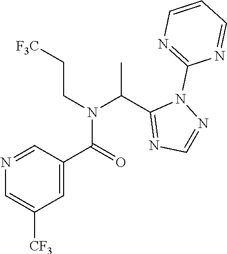 [SMILES: CC(c1ncnn1-c1ncccn1)N(CCC(F)(F)F)C(=O)c1cncc(C(F)(F)F)c1] |
| I-30 | 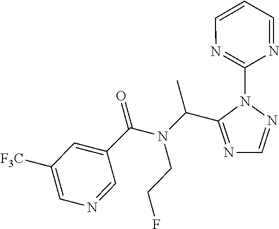 [SMILES: CC(c1ncnn1-c1ncccn1)N(CCF)C(=O)c1cncc(C(F)(F)F)c1] |
| I-31 | 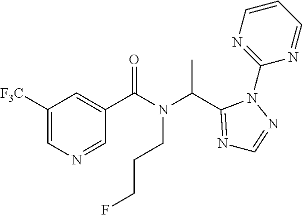 [SMILES: CC(c1ncnn1-c1ncccn1)N(CCCF)C(=O)c1cncc(C(F)(F)F)c1] |
| I-32 | 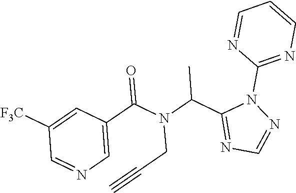 [SMILES: C#CCN(C(=O)c1cncc(C(F)(F)F)c1)C(C)c1ncnn1-c1ncccn1] |
| I-33 | 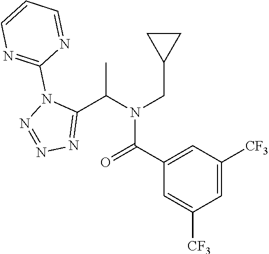 [SMILES: CC(c1nnnn1-c1ncccn1)N(CC1CC1)C(=O)c1cc(C(F)(F)F)cc(C(F)(F)F)c1] |
| I-34 | 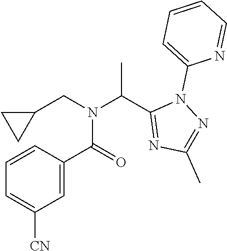 [SMILES: Cc1nc(C(C)N(CC2CC2)C(=O)c2cccc(C#N)c2)n(-c2ccccn2)n1] |
| I-35 | 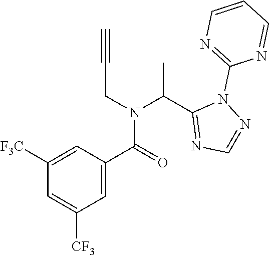 [SMILES: C#CCN(C(=O)c1cc(C(F)(F)F)cc(C(F)(F)F)c1)C(C)c1ncnn1-c1ncccn1] |
| I-36 | 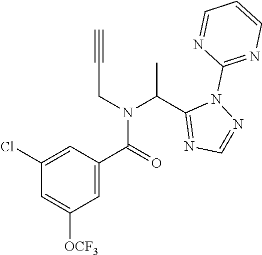 [SMILES: C#CCN(C(=O)c1cc(Cl)cc(OC(F)(F)F)c1)C(C)c1ncnn1-c1ncccn1] |
| I-37 | 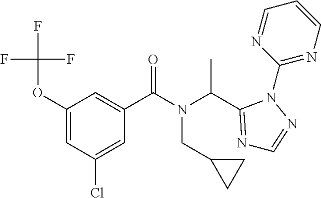 [SMILES: CC(c1ncnn1-c1ncccn1)N(CC1CC1)C(=O)c1cc(Cl)cc(OC(F)(F)F)c1] |
| I-38 | 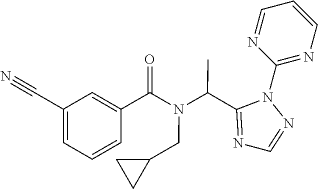 [SMILES: CC(c1ncnn1-c1ncccn1)N(CC1CC1)C(=O)c1cccc(C#N)c1] |
| I-39 | 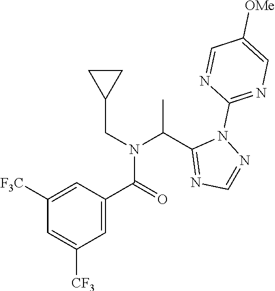 [SMILES: COc1cnc(-n2ncnc2C(C)N(CC2CC2)C(=O)c2cc(C(F)(F)F)cc(C(F)(F)F)c2)nc1] |
| I-40 | 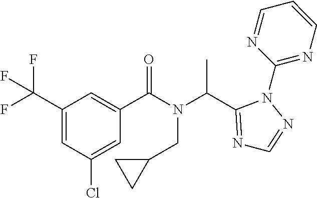 [SMILES: CC(c1ncnn1-c1ncccn1)N(CC1CC1)C(=O)c1cc(Cl)cc(C(F)(F)F)c1] |
| I-41 | 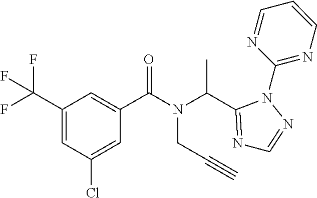 [SMILES: C#CCN(C(=O)c1cc(Cl)cc(C(F)(F)F)c1)C(C)c1ncnn1-c1ncccn1] |
| I-42 | 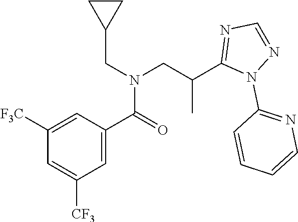 [SMILES: CC(CN(CC1CC1)C(=O)c1cc(C(F)(F)F)cc(C(F)(F)F)c1)c1ncnn1-c1ccccn1] |
| I-43 | 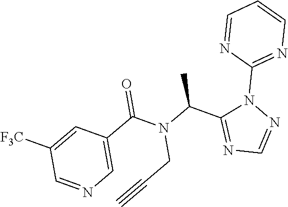 [SMILES: C#CCN(C(=O)c1cncc(C(F)(F)F)c1)[C@@H](C)c1ncnn1-c1ncccn1] |
| I-44 | 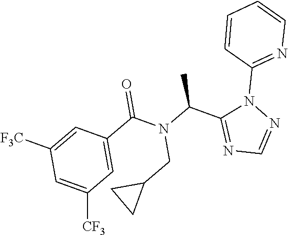 [SMILES: C[C@@H](c1ncnn1-c1ccccn1)N(CC1CC1)C(=O)c1cc(C(F)(F)F)cc(C(F)(F)F)c1] |
| I-45 | 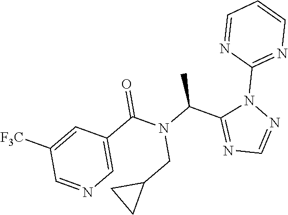 [SMILES: C[C@@H](c1ncnn1-c1ncccn1)N(CC1CC1)C(=O)c1cncc(C(F)(F)F)c1] |
| I-46 | 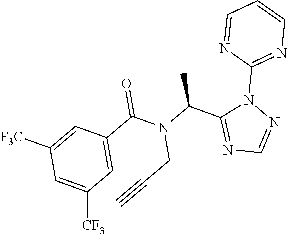 [SMILES: C#CCN(C(=O)c1cc(C(F)(F)F)cc(C(F)(F)F)c1)[C@@H](C)c1ncnn1-c1ncccn1] |
| I-47 | 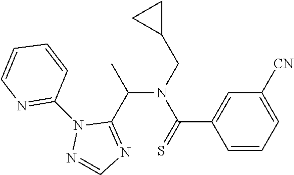 [SMILES: CC(c1ncnn1-c1ccccn1)N(CC1CC1)C(=S)c1cccc(C#N)c1] |
| I-48 | 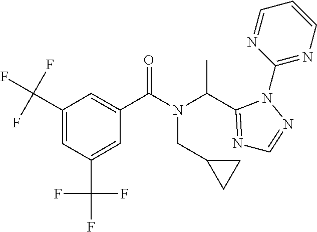 [SMILES: CC(c1ncnn1-c1ncccn1)N(CC1CC1)C(=O)c1cc(C(F)(F)F)cc(C(F)(F)F)c1] |
| I-49 | 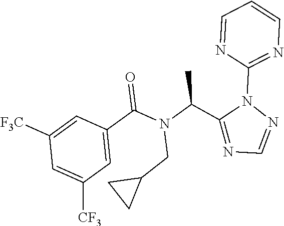 [SMILES: C[C@@H](c1ncnn1-c1ncccn1)N(CC1CC1)C(=O)c1cc(C(F)(F)F)cc(C(F)(F)F)c1] |
| I-50 | 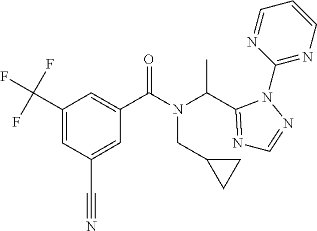 [SMILES: CC(c1ncnn1-c1ncccn1)N(CC1CC1)C(=O)c1cc(C#N)cc(C(F)(F)F)c1] |
| I-51 | 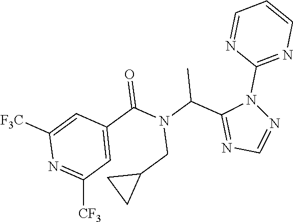 [SMILES: CC(c1ncnn1-c1ncccn1)N(CC1CC1)C(=O)c1cc(C(F)(F)F)nc(C(F)(F)F)c1] |
| I-52 | 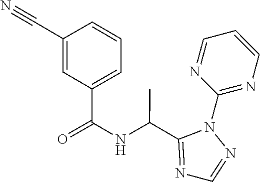 [SMILES: CC(NC(=O)c1cccc(C#N)c1)c1ncnn1-c1ncccn1] |
| I-53 | 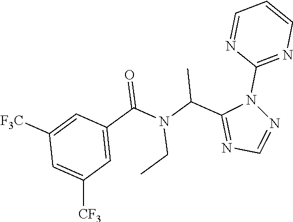 [SMILES: CCN(C(=O)c1cc(C(F)(F)F)cc(C(F)(F)F)c1)C(C)c1ncnn1-c1ncccn1] |
| I-54 | 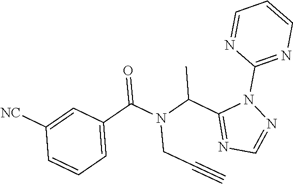 [SMILES: C#CCN(C(=O)c1cccc(C#N)c1)C(C)c1ncnn1-c1ncccn1] |
| I-55 | 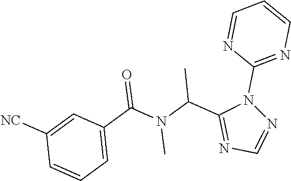 [SMILES: CC(c1ncnn1-c1ncccn1)N(C)C(=O)c1cccc(C#N)c1] |
| I-56 | 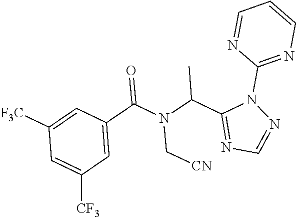 [SMILES: CC(c1ncnn1-c1ncccn1)N(CC#N)C(=O)c1cc(C(F)(F)F)cc(C(F)(F)F)c1] |
| I-57 | 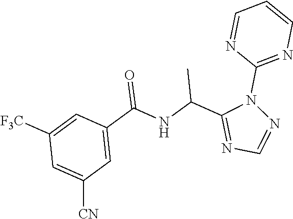 [SMILES: CC(NC(=O)c1cc(C#N)cc(C(F)(F)F)c1)c1ncnn1-c1ncccn1] |
| I-58 | 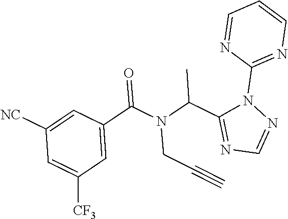 [SMILES: C#CCN(C(=O)c1cc(C#N)cc(C(F)(F)F)c1)C(C)c1ncnn1-c1ncccn1] |
| I-59 | 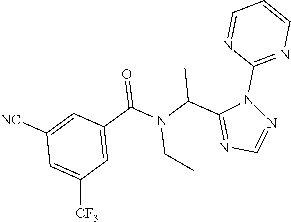 [SMILES: CCN(C(=O)c1cc(C#N)cc(C(F)(F)F)c1)C(C)c1ncnn1-c1ncccn1] |
| I-60 | 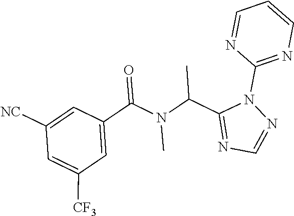 [SMILES: CC(c1ncnn1-c1ncccn1)N(C)C(=O)c1cc(C#N)cc(C(F)(F)F)c1] |
| I-61 | 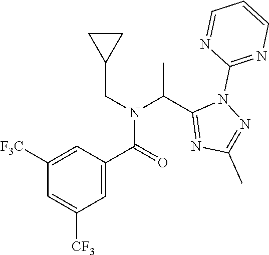 [SMILES: Cc1nc(C(C)N(CC2CC2)C(=O)c2cc(C(F)(F)F)cc(C(F)(F)F)c2)n(-c2ncccn2)n1] |
| I-62 | 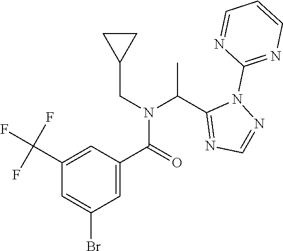 [SMILES: CC(c1ncnn1-c1ncccn1)N(CC1CC1)C(=O)c1cc(Br)cc(C(F)(F)F)c1] |
| I-63 | 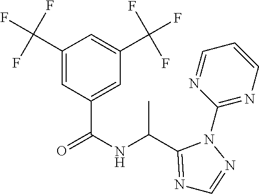 [SMILES: CC(NC(=O)c1cc(C(F)(F)F)cc(C(F)(F)F)c1)c1ncnn1-c1ncccn1] |
| I-64 | 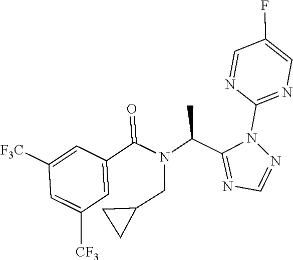 [SMILES: C[C@@H](c1ncnn1-c1ncc(F)cn1)N(CC1CC1)C(=O)c1cc(C(F)(F)F)cc(C(F)(F)F)c1] |
| I-65 | 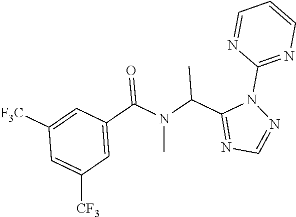 [SMILES: CC(c1ncnn1-c1ncccn1)N(C)C(=O)c1cc(C(F)(F)F)cc(C(F)(F)F)c1] |
| I-66 | 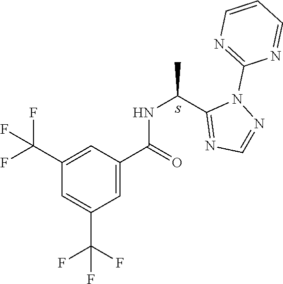 |
| I-67 | 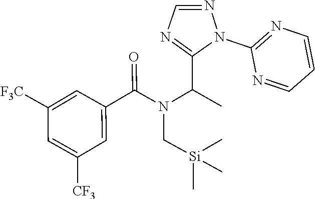 [SMILES: CC(c1ncnn1-c1ncccn1)N(C[Si](C)(C)C)C(=O)c1cc(C(F)(F)F)cc(C(F)(F)F)c1] |
| I-68 | 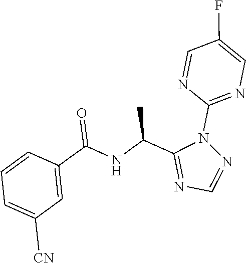 [SMILES: C[C@H](NC(=O)c1cccc(C#N)c1)c1ncnn1-c1ncc(F)cn1] |
| I-69 | 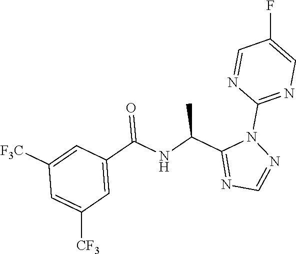 [SMILES: C[C@H](NC(=O)c1cc(C(F)(F)F)cc(C(F)(F)F)c1)c1ncnn1-c1ncc(F)cn1] |
| I-70 | 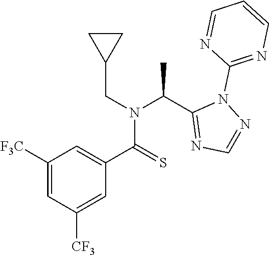 [SMILES: C[C@@H](c1ncnn1-c1ncccn1)N(CC1CC1)C(=S)c1cc(C(F)(F)F)cc(C(F)(F)F)c1] |
| I-71 | 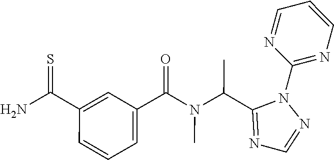 [SMILES: CC(c1ncnn1-c1ncccn1)N(C)C(=O)c1cccc(C(N)=S)c1] |
| I-72 | 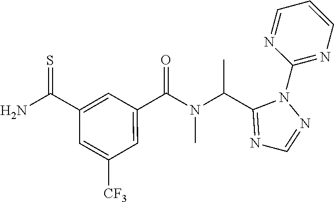 [SMILES: CC(c1ncnn1-c1ncccn1)N(C)C(=O)c1cc(C(N)=S)cc(C(F)(F)F)c1] |
| I-73 | 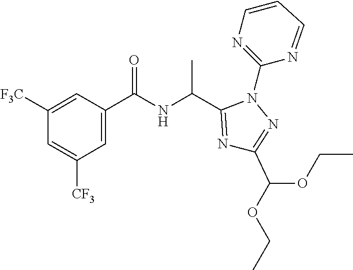 [SMILES: CCOC(OCC)c1nc(C(C)NC(=O)c2cc(C(F)(F)F)cc(C(F)(F)F)c2)n(-c2ncccn2)n1] |
| I-74 | 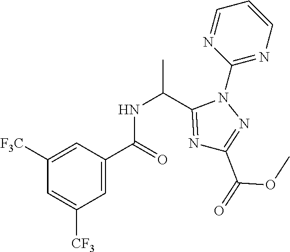 [SMILES: COC(=O)c1nc(C(C)NC(=O)c2cc(C(F)(F)F)cc(C(F)(F)F)c2)n(-c2ncccn2)n1] |
| I-75 | 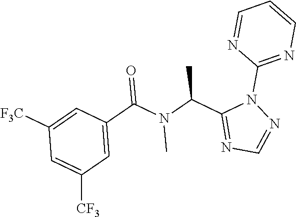 [SMILES: C[C@@H](c1ncnn1-c1ncccn1)N(C)C(=O)c1cc(C(F)(F)F)cc(C(F)(F)F)c1] |
| I-76 | 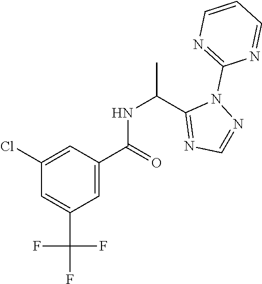 [SMILES: CC(NC(=O)c1cc(Cl)cc(C(F)(F)F)c1)c1ncnn1-c1ncccn1] |
| I-77 | 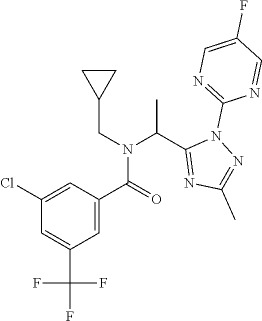 [SMILES: Cc1nc(C(C)N(CC2CC2)C(=O)c2cc(Cl)cc(C(F)(F)F)c2)n(-c2ncc(F)cn2)n1] |
| I-78 | 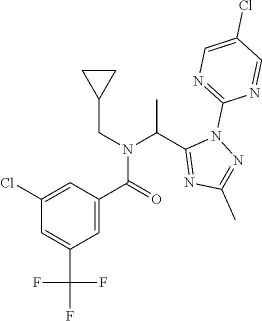 [SMILES: Cc1nc(C(C)N(CC2CC2)C(=O)c2cc(Cl)cc(C(F)(F)F)c2)n(-c2ncc(Cl)cn2)n1] |
| I-79 | 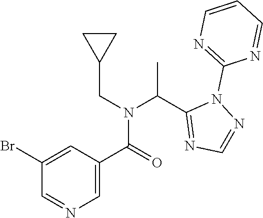 [SMILES: CC(c1ncnn1-c1ncccn1)N(CC1CC1)C(=O)c1cncc(Br)c1] |
| I-80 | 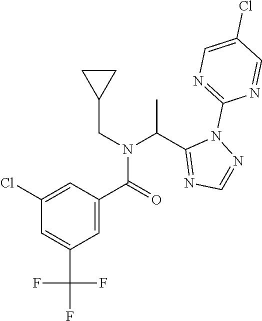 [SMILES: CC(c1ncnn1-c1ncc(Cl)cn1)N(CC1CC1)C(=O)c1cc(Cl)cc(C(F)(F)F)c1] |
| I-81 | 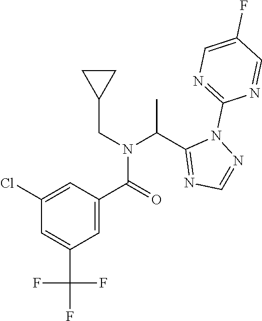 [SMILES: CC(c1ncnn1-c1ncc(F)cn1)N(CC1CC1)C(=O)c1cc(Cl)cc(C(F)(F)F)c1] |
| I-82 | 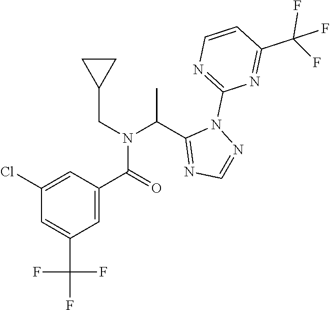 [SMILES: CC(c1ncnn1-c1nccc(C(F)(F)F)n1)N(CC1CC1)C(=O)c1cc(Cl)cc(C(F)(F)F)c1] |
| I-83 | 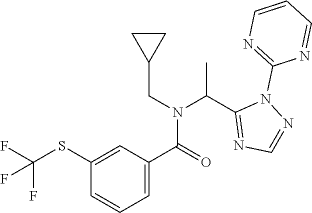 [SMILES: CC(c1ncnn1-c1ncccn1)N(CC1CC1)C(=O)c1cccc(SC(F)(F)F)c1] |
| I-84 | 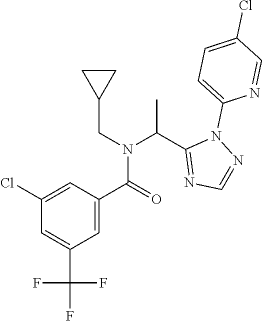 [SMILES: CC(c1ncnn1-c1ccc(Cl)cn1)N(CC1CC1)C(=O)c1cc(Cl)cc(C(F)(F)F)c1] |
| I-85 | 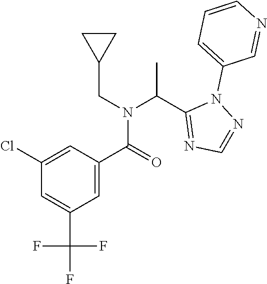 [SMILES: CC(c1ncnn1-c1cccnc1)N(CC1CC1)C(=O)c1cc(Cl)cc(C(F)(F)F)c1] |
| I-87 | 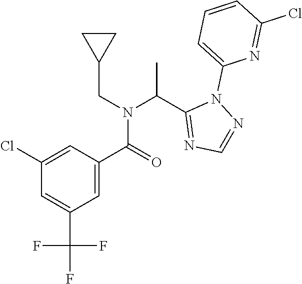 [SMILES: CC(c1ncnn1-c1cccc(Cl)n1)N(CC1CC1)C(=O)c1cc(Cl)cc(C(F)(F)F)c1] |
| I-88 | 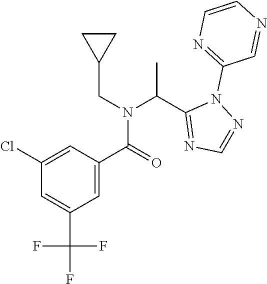 [SMILES: CC(c1ncnn1-c1cnccn1)N(CC1CC1)C(=O)c1cc(Cl)cc(C(F)(F)F)c1] |
| I-89 | 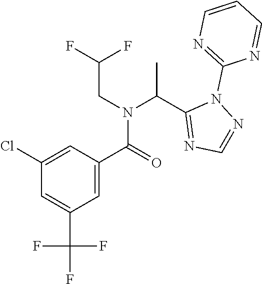 [SMILES: CC(c1ncnn1-c1ncccn1)N(CC(F)F)C(=O)c1cc(Cl)cc(C(F)(F)F)c1] |
| I-90 | 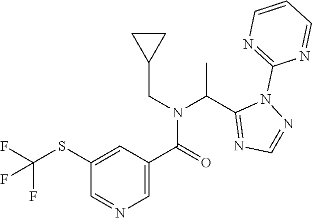 [SMILES: CC(c1ncnn1-c1ncccn1)N(CC1CC1)C(=O)c1cncc(SC(F)(F)F)c1] |
| I-91 | 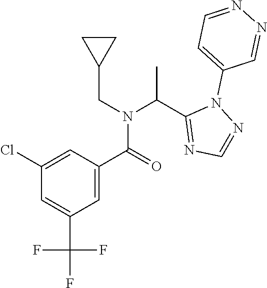 [SMILES: CC(c1ncnn1-c1ccnnc1)N(CC1CC1)C(=O)c1cc(Cl)cc(C(F)(F)F)c1] |
| I-92 | 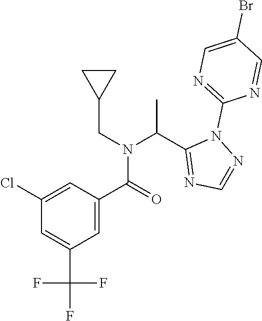 [SMILES: CC(c1ncnn1-c1ncc(Br)cn1)N(CC1CC1)C(=O)c1cc(Cl)cc(C(F)(F)F)c1] |
| I-93 | 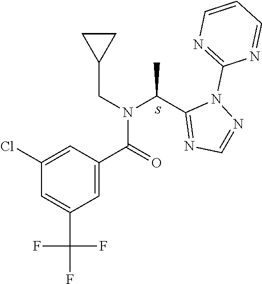 |
| I-94 | 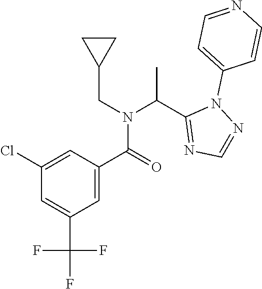 [SMILES: CC(c1ncnn1-c1ccncc1)N(CC1CC1)C(=O)c1cc(Cl)cc(C(F)(F)F)c1] |
| I-95 | 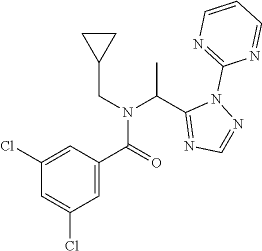 [SMILES: CC(c1ncnn1-c1ncccn1)N(CC1CC1)C(=O)c1cc(Cl)cc(Cl)c1] |
| I-96 | 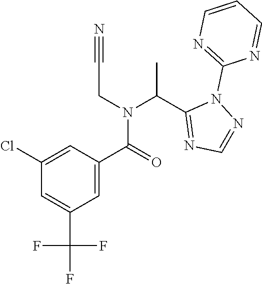 [SMILES: CC(c1ncnn1-c1ncccn1)N(CC#N)C(=O)c1cc(Cl)cc(C(F)(F)F)c1] |
| I-97 | 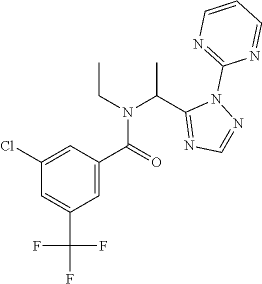 [SMILES: CCN(C(=O)c1cc(Cl)cc(C(F)(F)F)c1)C(C)c1ncnn1-c1ncccn1] |
| I-98 | 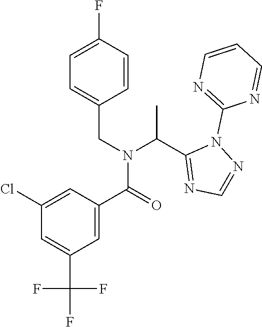 [SMILES: CC(c1ncnn1-c1ncccn1)N(Cc1ccc(F)cc1)C(=O)c1cc(Cl)cc(C(F)(F)F)c1] |
| I-99 | 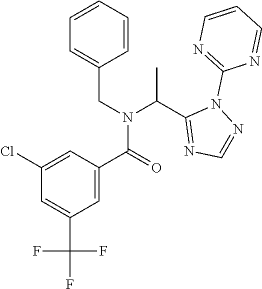 [SMILES: CC(c1ncnn1-c1ncccn1)N(Cc1ccccc1)C(=O)c1cc(Cl)cc(C(F)(F)F)c1] |
| I-100 | 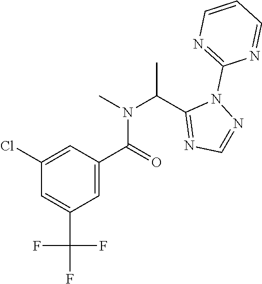 [SMILES: CC(c1ncnn1-c1ncccn1)N(C)C(=O)c1cc(Cl)cc(C(F)(F)F)c1] |
| I-101 | 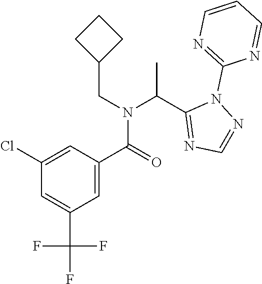 [SMILES: CC(c1ncnn1-c1ncccn1)N(CC1CCC1)C(=O)c1cc(Cl)cc(C(F)(F)F)c1] |
| I-102 | 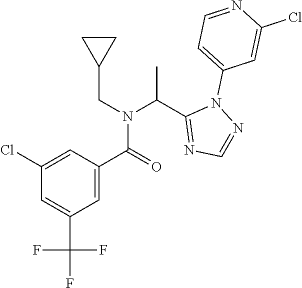 [SMILES: CC(c1ncnn1-c1ccnc(Cl)c1)N(CC1CC1)C(=O)c1cc(Cl)cc(C(F)(F)F)c1] |
| I-103 | 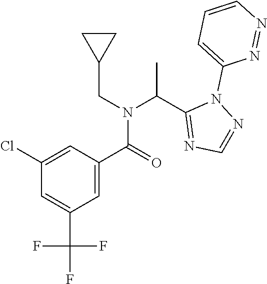 [SMILES: CC(c1ncnn1-c1cccnn1)N(CC1CC1)C(=O)c1cc(Cl)cc(C(F)(F)F)c1] |
| I-104 | 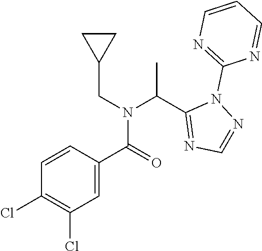 [SMILES: CC(c1ncnn1-c1ncccn1)N(CC1CC1)C(=O)c1ccc(Cl)c(Cl)c1] |
| I-105 | 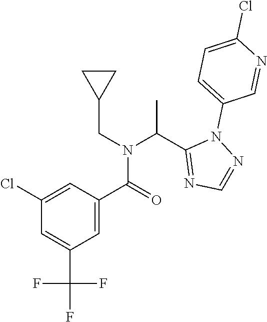 [SMILES: CC(c1ncnn1-c1ccc(Cl)nc1)N(CC1CC1)C(=O)c1cc(Cl)cc(C(F)(F)F)c1] |
| I-106 | 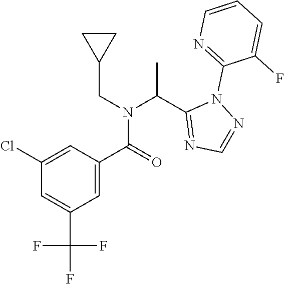 [SMILES: CC(c1ncnn1-c1ncccc1F)N(CC1CC1)C(=O)c1cc(Cl)cc(C(F)(F)F)c1] |
| I-107 | 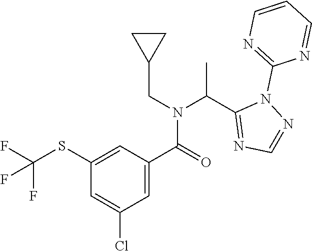 [SMILES: CC(c1ncnn1-c1ncccn1)N(CC1CC1)C(=O)c1cc(Cl)cc(SC(F)(F)F)c1] |
| I-108 | 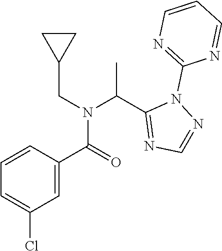 [SMILES: CC(c1ncnn1-c1ncccn1)N(CC1CC1)C(=O)c1cccc(Cl)c1] |
| I-109 | 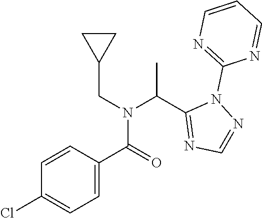 [SMILES: CC(c1ncnn1-c1ncccn1)N(CC1CC1)C(=O)c1ccc(Cl)cc1] |
| I-110 | 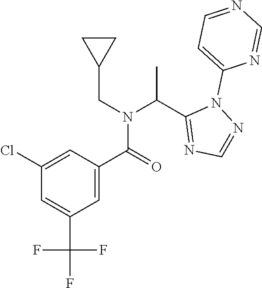 [SMILES: CC(c1ncnn1-c1ccncn1)N(CC1CC1)C(=O)c1cc(Cl)cc(C(F)(F)F)c1] |
| I-111 | 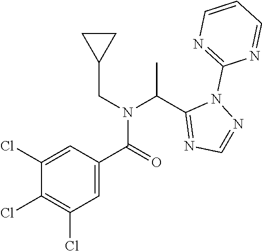 [SMILES: CC(c1ncnn1-c1ncccn1)N(CC1CC1)C(=O)c1cc(Cl)c(Cl)c(Cl)c1] |
| I-112 | 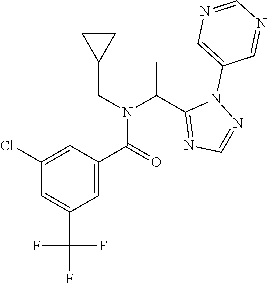 [SMILES: CC(c1ncnn1-c1cncnc1)N(CC1CC1)C(=O)c1cc(Cl)cc(C(F)(F)F)c1] |
| I-113 | 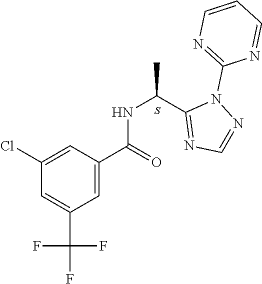 |
| I-114 | 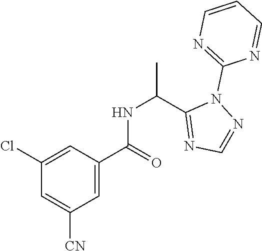 [SMILES: CC(NC(=O)c1cc(Cl)cc(C#N)c1)c1ncnn1-c1ncccn1] |
| I-115 | 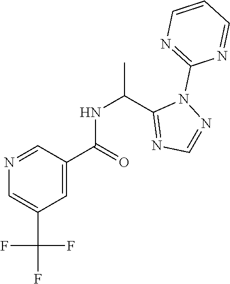 [SMILES: CC(NC(=O)c1cncc(C(F)(F)F)c1)c1ncnn1-c1ncccn1] |
| I-116 | 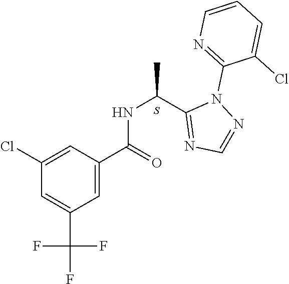 |
| I-117 | 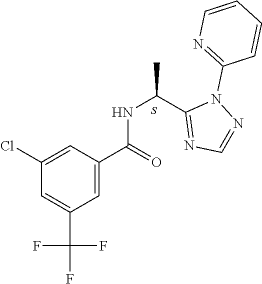 |
| I-118 | 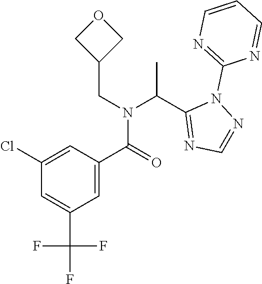 [SMILES: CC(c1ncnn1-c1ncccn1)N(CC1COC1)C(=O)c1cc(Cl)cc(C(F)(F)F)c1] |
| I-119 | 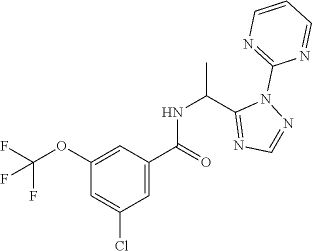 [SMILES: CC(NC(=O)c1cc(Cl)cc(OC(F)(F)F)c1)c1ncnn1-c1ncccn1] |
| I-120 | 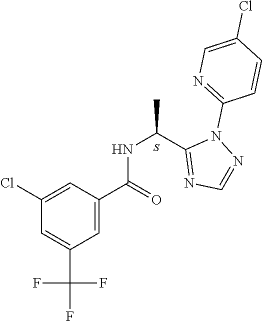 |
| I-121 | 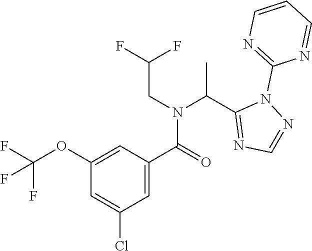 [SMILES: CC(c1ncnn1-c1ncccn1)N(CC(F)F)C(=O)c1cc(Cl)cc(OC(F)(F)F)c1] |
| I-122 | 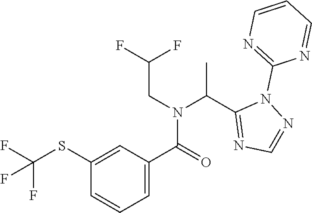 [SMILES: CC(c1ncnn1-c1ncccn1)N(CC(F)F)C(=O)c1cccc(SC(F)(F)F)c1] |
| I-123 | 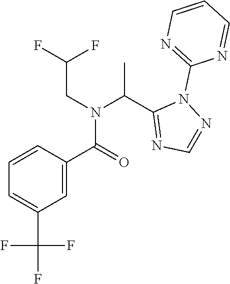 [SMILES: CC(c1ncnn1-c1ncccn1)N(CC(F)F)C(=O)c1cccc(C(F)(F)F)c1] |
| I-124 | 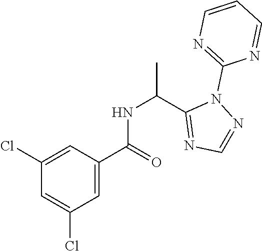 [SMILES: CC(NC(=O)c1cc(Cl)cc(Cl)c1)c1ncnn1-c1ncccn1] |
| I-125 | 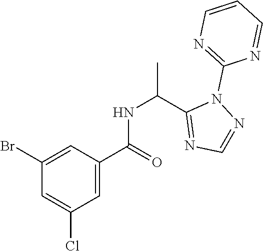 [SMILES: CC(NC(=O)c1cc(Cl)cc(Br)c1)c1ncnn1-c1ncccn1] |
| I-126 | 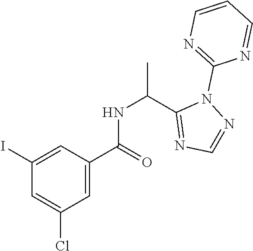 [SMILES: CC(NC(=O)c1cc(Cl)cc(I)c1)c1ncnn1-c1ncccn1] |
| I-127 | 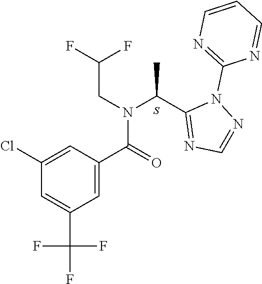 |
| I-128 | 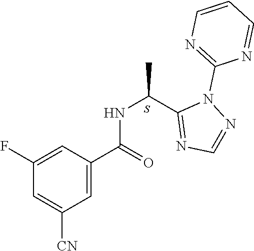 |
| I-129 | 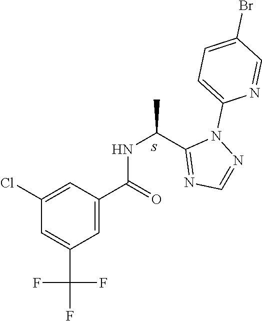 |
| I-130 | 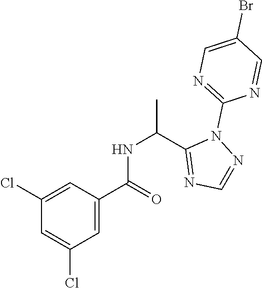 [SMILES: CC(NC(=O)c1cc(Cl)cc(Cl)c1)c1ncnn1-c1ncc(Br)cn1] |
| I-131 | 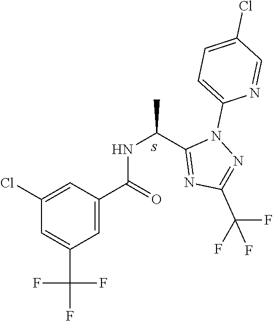 |
| I-132 | 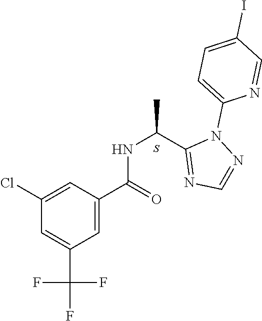 |
| I-133 | 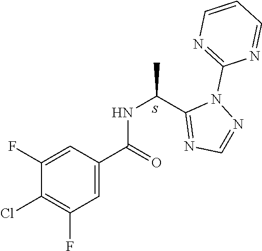 |
| I-134 | 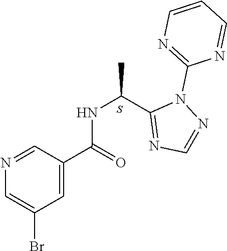 |
| I-135 | 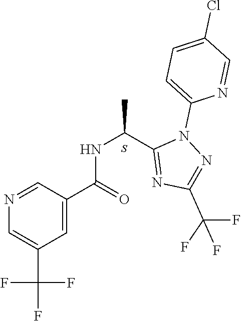 |
| I-136 | 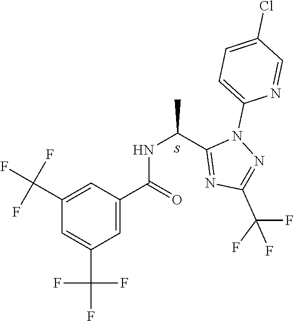 |
| I-137 | 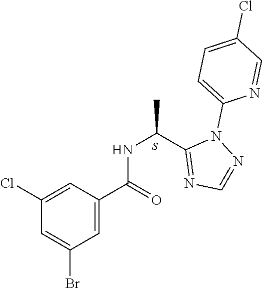 |
| I-138 | 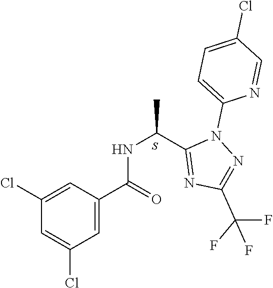 |
| I-139 | 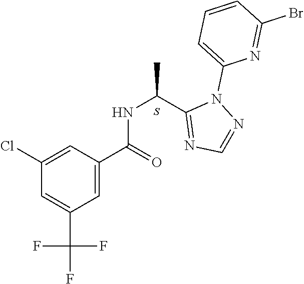 |
| I-140 | 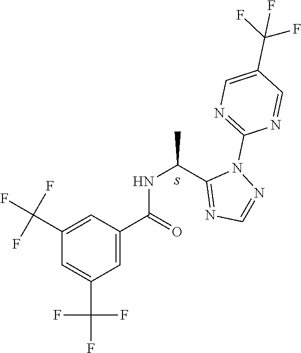 |
| I-141 | 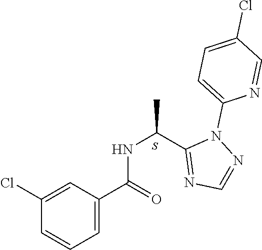 |
| I-142 | 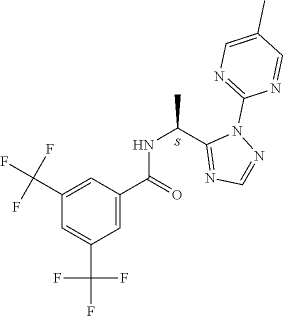 |
| I-143 | 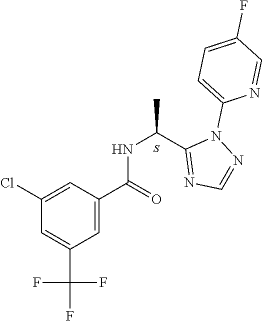 |
| I-144 | 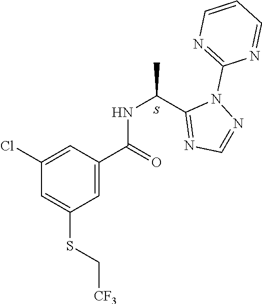 |
| I-145 | 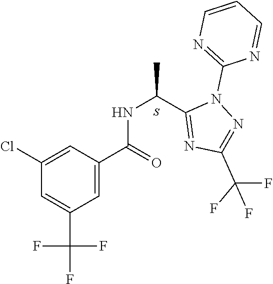 |
| I-146 | 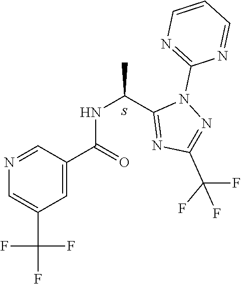 |
| I-147 | 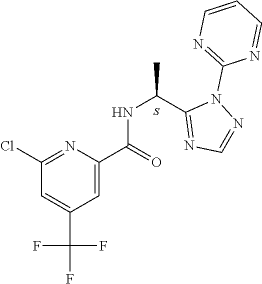 |
| I-148 | 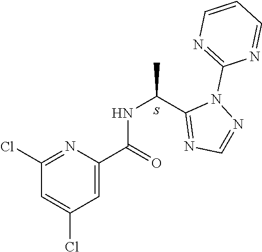 |
| I-149 | 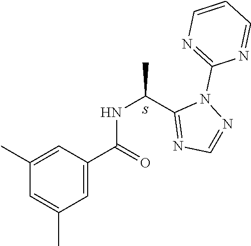 |
| I-150 | 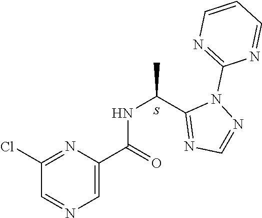 |
| I-151 | 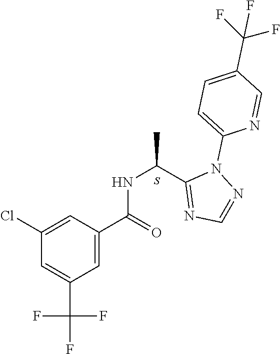 |

### LC-MS Methods

The determination of [M+H]+ or M-by LC-MS under acidic chromatographic conditions was done with 1 ml formic acid per liter acetonitrile and 0.9 ml formic acid per liter Millipore water aseluents. The column Zorbax Eclipse Plus C18 50 mm*2.1 mm was used. The temperature of the column oven was 55° C.

### Instruments:

LC-MS3: Waters UPLC with SQD2 mass spectrometer and SampleManager autosampler. Linear gradient 0.0 to 1.70 minutes from 10% acetonitrile to 95% acetonitrile, from 1.70 to 2.40 minutes constant 95% acetonitrile, flow 0.85 ml/min.

LC-MS6 and LC-MS7: Agilent 1290 LC, Agilent MSD, HTS PAL autosampler. Linear gradient 0.0 to 1.80 minutes from 10% acetonitrile to 95% acetonitrile, from 1.80 to 2.50 minutes constant 95% acetonitrile, flow 1.0 ml/min.

The determination of [M+H]+ by LC-MS under neutral chromatographic conditions was done with acetonitrile and Millipore water containing 79 mg/l ammonia carbonate as eluents.

### Instruments:

LC-MS4: Waters IClass Acquity with QDA mass spectrometer and FTN autosampler (column Waters Acquity 1.7 μm 50 mm*2.1 mm, oven temperature 45° C.). Linear gradient 0.0 to 2.10 minutes from 10% acetonitrile to 95% acetonitrile, from 2.10 to 3.00 minutes constant 95% acetonitrile, flow 0.7 ml/min.

LC-MS5: Agilent 1100 LC system with MSD mass spectrometer and HTS PAL autosampler (column: Zorbax XDB C18 1.8 μm 50 mm*4.6 mm, oven temperature 55° C.). Linear gradient 0.0 to 4.25 minutes from 10% acetonitrile to 95% acetonitrile, from 4.25 to 5.80 minutes constant 95% acetonitrile, flow 2.0 ml/min.

Retention time indices were calculated in all cases according to a homologous series of straight chain alkan-2-ones with 3 to 16 carbons where the index of the first alkanone was set to 300, the last alkanone to 1600, the ones between correspondingly by use of a linear interpolation between successive alkanones.

### NMR Data of Selected Examples

The determination of the ¹H-NMR data was done with a Bruker Avance III 400 MHz spectrometer equipped with a 1.7 mm TCI probehead, with tetramethylsilane as reference (0.00 ppm) and the measurements were usually recorded from solutions in the solvents CD₃CN, CDCl₃ or d₆-DMSO. Alternatively a Bruker Avance III 600 MHz instrument equipped with a 5 mm CPNMP probehead or a Bruker Avance NEO 600 MHz instrument equipped with a 5 mm TCI probehead were used for the measurements. Usually the measurements were carried out with a probehead temperature of 298 K. Other measurement temperatures are explicitly noticed.

### NMR Peak Lists Procedure

¹H-NMR data of selected examples are written in form of ¹H-NMR peak lists. δ-Values in ppm and the signal intensity in round brackets are listed to each signal peak. Semicolons are depicted as delimiters between the δ-value—signal intensity pairs.

Therefore the peak list of an example has the form:

δ₁ (intensity₁); δ₂ (intensity₂); . . . ; δᵢ (intensity₁); . . . ; δₙ (intensityₙ)

The intensity of sharp signals correlates with the height of the signals in a printed view of a ¹H-NMR spectrum in cm and shows the real relations of signal intensities. Several peaks from broad signals or the middle of the signal and their relative intensity in comparison to the most intensive signal in the spectrum can be shown.

Tetramethylsilane or the chemical shift of the solvent in cases where the sample does not contain tetramethylsilane is used for a calibration of the chemical shift for ¹H spectra. Therefore the tetramethylsilane peak can occur in ¹H-NMR peak lists, but not necessarily.

¹H-NMR peak lists are equivalent to classical ¹H-NMR prints and contain usually all peaks, which are also listed at classical ¹H-NMR-interpretations.

In addition, they can show signals of solvents, stereoisomers of the compounds which are optionally object of the invention, and/or peaks of impurities, like classical ¹H-NMR prints.

¹H-NMR solvent signals, the tetramethylsilane signal and the water signal in the corresponding solvent are excluded from the relative intensity calibration as they have very high intensity values.

On average, the peaks of stereoisomers of the compounds according to the invention and/or peaks of impurities have usually a lower intensity than the peaks of compounds according to the invention (for example with a purity >90%).

Such stereoisomers and/or impurities can be typical for the specific preparation process. Thus, the corresponding peaks can help to recognize the reproduction of the preparation process via “side-products-fingerprints”.

An expert, who calculates the peaks of the target compounds with known methods (MestreC, ACD-simulation, but also with empirically evaluated expectation values), can assign the peaks of the target compounds as needed, optionally using additional intensity filters. This assignment would be similar to the usual peak picking at classical ¹H-NMR interpretations.

The used solvent can be extracted from the JCAMP file with the parameter “solvent”, the spectrometer frequency with “observe frequency” and the spectrometer type with “spectrometer/data system”.

¹³C-NMR data are displayed analogous to ¹H-NMR data as peak lists from broadband decoupled ¹³C-NMR spectra. ¹³C-NMR solvent signals and tetramethylsilane are excluded from the relative intensity calibration as these signals can have very high intensities.

Further details of NMR-data description with peak lists are disclosed in the publication “Citation of NMR Peaklist Data within Patent Applications” of the Research Disclosure Database Number 564025.

TABLE 2

| No | Structure | NMR peak list |
|---|---|---|
| I-06 | 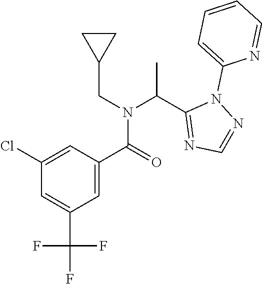 [SMILES: CC(c1ncnn1-c1ccccn1)N(CC1CC1)C(=O)c1cc(Cl)cc(C(F)(F)F)c1] | I-06: ¹H-NMR(600.1 MHz, CD3CN): δ = 8.4399 (3.6); 8.4324 (3.7); 8.0641 (12.1); 8.0473 (3.8); 8.0367 (2.1); 8.0341 (2.2); 8.0089 (5.9); 7.9992 (2.3); 7.9914 (2.3); 7.9399 (1.1); 7.9274 (2.1); 7.9160 (1.2); 7.9141 (1.2); 7.8496 (5.3); 7.8360 (4.6); 7.7683 (6.2); 7.7055 (2.9); 7.6918 (2.6); 7.5706 (3.6); 7.4618 (2.8); 7.4536 (3.0); 7.4496 (3.0); 7.4413 (2.7); 7.3586 (3.5); 7.3260 (1.6); 7.3176 (1.8); 7.3140 (1.8); 7.3056 (1.5); 7.2814 (3.2); 7.1916 (6.2); 7.0678 (6.5); 6.3792 (1.2); 6.3676 (3.7); 6.3560 (3.8); 6.3444 (1.2); 6.1649 (0.7); 6.1534 (2.1); 6.1418 (2.1); 6.1304 (0.7); 5.4720 (2.2); 3.6907 (1.2); 3.6804 (1.4); 3.6671 (1.7); 3.6565 (1.7); 3.5529 (1.7); 3.5412 (1.7); 3.5292 (1.3); 3.5176 (1.2); 2.8690 (2.1); 2.8572 (2.2); 2.8428 (3.1); 2.8310 (3.1); 2.7454 (3.0); 2.7357 (3.0); 2.7193 (2.0); 2.7097 (2.0); 2.2920 (70.9); 2.1805 (0.5); 2.0801 (0.4); 2.0760 (0.8); 2.0719 (1.2); 2.0677 (0.9); 2.0647 (1.0); 1.9920 (0.6); 1.9852 (1.5); 1.9771 (2.7); 1.9693 (67.3); 1.9652 (130.9); 1.9610 (192.6); 1.9570 (133.9); 1.9529 (68.7); 1.8541 (0.4); 1.8501 (0.8); 1.8460 (1.2); 1.8418 (0.9); 1.8376 (0.7); 1.8255 (16.0); 1.8139 (16.0); 1.7681 (8.4); 1.7565 (8.3); 1.0883 (0.4); 1.0790 (0.8); 1.0678 (1.1); 1.0568 (0.9); 1.0470 (0.5); 0.5561 (0.6); 0.5524 (0.6); 0.5437 (1.4); 0.5321 (1.8); 0.5227 (1.8); 0.5106 (1.6); 0.5021 (1.4); 0.4964 |
| | | (1.5); 0.4873 (1.5); 0.4814 (1.5); 0.4726 (1.4); 0.4657 (1.4); 0.4580 (1.1); |
| | | 0.4509 (0.5); 0.4437 (0.4); 0.3552 (0.5); 0.3471 (0.9); 0.3394 (1.3); 0.3315 |
| | | (1.5); 0.3249 (1.2); 0.3174 (0.6); 0.2979 (0.6); 0.2890 (1.0); 0.2826 (1.9); |
| | | 0.2740 (3.0); 0.2668 (3.0); 0.2626 (2.5); 0.2527 (2.7); 0.2447 (2.0); 0.2370 |
| | | (2.0); 0.2305 (2.2); 0.2228 (1.6); 0.2161 (0.8); 0.2079 (0.6); 0.0967 (0.7); |
| | | 0.0053 (4.3); −0.0001 (132.5); −0.0055 (4.5); −0.1002 (0.6); −0.1947 |
| | | (0.7); −0.2030 (1.7); −0.2110 (2.5); −0.2190 (2.7); −0.2264 (2.0); −0.2344 |
| | | (0.8); −0.3669 (0.8); −0.3750 (2.0); −0.3825 (2.6); −0.3905 (2.4); −0.3986 |
| | | (1.6); −0.4067 (0.6) |
| I-26 | 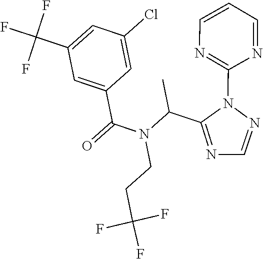 [SMILES: CC(c1ncnn1-c1ncccn1)N(CCC(F)(F)F)C(=O)c1cc(Cl)cc(C(F)(F)F)c1] | I-26: ¹H-NMR(600.1 MHz, CD3CN, 260 K): δ = 8.8851 (2.4); 8.8770 (2.4); 8.5608 (14.1); 8.5527 (14.3); 8.1148 (2.1); 8.0744 (11.8); 7.8482 (1.2); 7.6404 (6.3); 7.5770 (1.3); 7.5321 (1.4); 7.5213 (0.7); 7.5132 (1.3); 7.5052 (0.6); 7.4292 (5.8); 7.3763 (8.4); 7.3684 (8.5); 7.3602 (3.8); 6.4652 (0.7); 6.4536 (0.7); 6.2099 (1.2); 6.1984 (3.9); 6.1869 (4.0); 6.1754 (1.2); 5.4720 (0.9); 4.0919 (0.9); 4.0805 (1.2); 4.0764 (1.0); 4.0691 (1.8); 4.0653 (1.3); 4.0559 (3.1); 4.0424 (1.6); 4.0043 (1.5); 3.9908 (3.0); 3.9776 (1.8); 3.9704 (1.1); 3.9660 (1.2); 3.9549 (1.0); 3.4969 (0.5); 3.2781 (0.5); 2.6941 (0.5); 2.6761 (1.7); 2.6619 (2.5); 2.6586 (2.4); 2.6438 (2.5); 2.6298 (1.6); 2.6115 (0.5); 2.2912 (228.6); 2.2584 (0.3); 2.0800 (0.5); 2.0759 (1.0); 2.0718 (1.4); 2.0677 (0.9); 2.0636 (0.4); 1.9918 (0.4); 1.9851 (1.7); 1.9770 (3.6); 1.9691 (90.8); 1.9650 (172.8); 1.9609 (245.8); 1.9568 (169.0); 1.9527 (84.4); 1.9439 (1.4); 1.9329 (0.3); 1.8540 (0.6); 1.8499 (1.0); 1.8458 (1.4); 1.8417 (1.0); 1.8376 (0.5); 1.7333 (2.9); 1.7215 (3.1); 1.7093 (16.0); 1.6978 (15.9); −0.0001 (1.8) |
| I-28 | 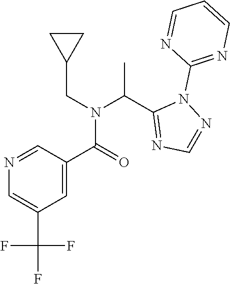 [SMILES: CC(c1ncnn1-c1ncccn1)N(CC1CC1)C(=O)c1cncc(C(F)(F)F)c1] | I-28: ¹H-NMR(600.1 MHz, CD3CN, 260 K): δ = 9.3634 (0.3); 8.9397 (7.2); 8.8709 (11.0); 8.8630 (11.5); 8.8500 (2.8); 8.6573 (2.6); 8.5780 (3.6); 8.5702 (3.9); 8.5405 (8.0); 8.0959 (10.1); 8.0436 (3.1); 7.9210 (2.4); 7.8075 (7.1); 7.5085 (3.0); 7.5006 (5.9); 7.4927 (3.1); 7.3975 (1.1); 7.3900 (1.9); 7.3825 (1.1); 6.4460 (1.2); 6.4345 (3.9); 6.4230 (4.0); 6.4115 (1.4); 6.1002 (0.5); 6.0891 (1.3); 6.0777 (1.3); 6.0665 (0.5); 3.6617 (0.7); 3.6511 (0.8); 3.6380 (1.1); 3.6276 (1.0); 3.5294 (1.0); 3.5180 (1.1); 3.5058 (0.8); 3.4943 (0.7); 2.9524 (1.6); 2.9411 (1.6); 2.9261 (3.8); 2.9148 (3.9); 2.8915 (3.8); 2.8822 (3.9); 2.8652 (1.6); 2.8559 (1.5); 2.3013 (40.2); 2.0728 (0.4); 1.9855 (0.4); 1.9622 (58.6); 1.9608 (57.9); 1.8456 (0.4); 1.8193 (15.8); 1.8077 (16.0); 1.7729 (5.3); 1.7616 (5.1); 1.0079 (0.7); 0.9981 (0.9); 0.9880 (0.7); 0.5597 (1.8); 0.5499 (2.4); 0.5398 (1.9); 0.4555 (1.2); 0.4440 (1.4); 0.4370 (1.2); 0.4305 (1.0); 0.4233 (0.8); 0.3293 (0.8); 0.3219 (1.0); 0.3142 (1.1); 0.2903 (0.8); 0.2752 (2.1); 0.2673 (2.8); 0.2602 (2.4); 0.2539 (1.8); 0.2452 (1.1); 0.2291 (1.2); 0.2202 (2.1); 0.2136 (2.4); 0.2069 (3.0); 0.1988 (2.8); 0.1929 (2.2); 0.1842 (1.6); 0.0967 (2.9); 0.0817 (0.3); 0.0466 (0.4); −0.0001 (478.4); −0.1002 (2.7); −0.2183 (0.8); −0.2264 (2.0); −0.2344 (2.7); −0.2422 (2.9); −0.2501 (2.2); −0.2580 (0.8); −0.4186 |
| | | (0.9); −0.4266 (2.3); −0.4345 (2.9); −0.4422 (2.7); −0.4503 (1.9); −0.4584 (0.7) |
| I-37 | 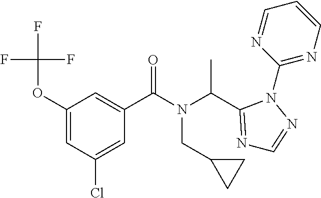 [SMILES: CC(c1ncnn1-c1ncccn1)N(CC1CC1)C(=O)c1cc(Cl)cc(OC(F)(F)F)c1] | I-37: ¹H-NMR(600.1 MHz, CD3CN, 260 K): δ = 8.8688 (11.3); 8.8609 (11.3); 8.6308 (4.5); 8.6232 (4.5); 8.0851 (10.1); 8.0308 (3.9); 7.5152 (3.2); 7.5075 (6.0); 7.4997 (3.1); 7.4364 (7.1); 7.4192 (1.5); 7.4116 (2.4); 7.4041 (1.3); 7.2821 (2.9); 7.1085 (3.5); 7.0931 (8.8); 7.0678 (2.9); 6.9673 (7.4); 6.3852 (1.3); 6.3738 (4.0); 6.3622 (4.0); 6.3508 (1.3); 6.1015 (0.6); 6.0902 (1.6); 6.0789 (1.6); 6.0678 (0.6); 3.6977 (0.9); 3.6876 (1.0); 3.6740 (1.3); 3.6640 (1.2); 3.5304 (1.2); 3.5188 (1.3); 3.5067 (1.0); 3.4951 (1.0); 2.9130 (1.7); 2.9013 (1.8); 2.8868 (3.8); 2.8752 (3.7); 2.8417 (3.6); 2.8324 (3.7); 2.8156 (1.8); 2.8062 (1.7); 2.2981 (75.4); 2.0776 (0.3); 2.0738 (0.5); 2.0706 (0.5); 1.9853 (0.5); 1.9669 (55.4); 1.9629 (86.3); 1.9593 (80.7); 1.8478 (0.5); 1.8447 (0.5); 1.8004 (15.8); 1.7888 (16.0); 1.7394 (6.4); 1.7281 (6.2); 1.2608 (0.4); 1.0622 (0.8); 1.0523 (1.1); 1.0425 (0.9); 0.5612 (1.8); 0.5515 (2.4); 0.5416 (2.0); 0.4750 (1.8); 0.4604 (1.3); |
| | | 0.3393 (0.8); 0.3311 (1.1); 0.3237 (1.4); 0.2911 (0.8); 0.2753 (3.0); 0.2682 |
| | | (4.2); 0.2613 (3.6); 0.2474 (1.6); 0.2406 (1.5); 0.2309 (2.2); 0.2247 (2.5); |
| | | 0.2182 (2.8); 0.2102 (2.0); 0.1954 (0.6); 0.0970 (2.6); −0.0001 |
| | | (466.2); −0.0277 (0.8); −0.0389 (0.5); −0.0557 (0.4); −0.1000 (2.7); −0.1854 |
| | | (0.8); −0.1931 (2.0); −0.2012 (2.9); −0.2089 (3.1); −0.2166 (2.4); −0.2241 |
| | | (1.0); −0.3793 (1.0); −0.3863 (2.4); −0.3940 (3.0); −0.4017 (2.8); −0.4098 |
| | | (2.0); −0.4174 (0.8) |
| I-38 | 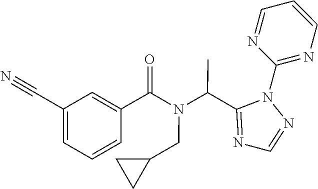 [SMILES: CC(c1ncnn1-c1ncccn1)N(CC1CC1)C(=O)c1cccc(C#N)c1] | I-38: ¹H-NMR(600.1 MHz, CD3CN, 260 K): δ = 8.8713 (11.4); 8.8633 (11.5); 8.5861 (4.3); 8.5784 (4.3); 8.0836 (10.4); 8.0332 (3.7); 7.7729 (4.2); 7.7600 (4.7); 7.6341 (1.6); 7.6241 (1.6); 7.5400 (2.9); 7.5270 (5.7); 7.5147 (6.0); 7.5074 (6.4); 7.4994 (3.3); 7.4729 (3.2); 7.4344 (8.2); 7.3963 (5.6); 7.3438 (4.8); 7.3309 (4.2); 6.4138 (1.3); 6.4023 (3.9); 6.3908 (3.9); 6.3793 (1.3); 6.0510 (0.6); 6.0399 (1.5); 6.0285 (1.5); 6.0175 (0.6); 5.4712 (1.0); 3.6646 (0.9); 3.6544 (1.0); 3.6411 (1.2); 3.6308 (1.2); 3.5106 (1.2); 3.4990 (1.2); 3.4872 (0.9); 3.4754 (0.9); 2.9030 (1.9); 2.8912 (2.0); 2.8768 (3.5); 2.8650 (3.5); 2.8221 (3.5); 2.8127 (3.5); 2.7960 (1.9); 2.7865 (1.8); 2.3013 (40.8); 2.0708 (0.4); 1.9841 (0.6); 1.9631 (47.6); 1.9599 (65.2); 1.9559 (45.2); 1.9519 (22.6); 1.8449 (0.4); 1.8029 (15.8); 1.7913 (16.0); 1.7607 (6.2); 1.7494 (5.8); 1.2577 (1.3); 1.0261 (1.0); 1.0170 (0.8); 0.8795 (0.4); 0.5526 (1.8); 0.5425 (2.3); 0.5321 (1.9); 0.4727 (1.2); |
| | | 0.4675 (1.3); 0.4595 (1.5); 0.4535 (1.5); 0.4456 (1.3); 0.4392 (1.2); 0.4320 |
| | | (0.9); 0.3297 (0.9); 0.3222 (1.2); 0.3151 (1.3); 0.2674 (0.8); 0.2524 (2.1); |
| | | 0.2444 (3.0); 0.2368 (3.1); 0.2313 (2.9); 0.2229 (2.2); 0.2110 (1.9); 0.2024 |
| | | (2.3); 0.1957 (2.4); 0.1892 (2.6); 0.1813 (1.9); 0.1665 (0.6); −0.2177 |
| | | (0.9); −0.2258 (2.0); −0.2338 (2.8); −0.2416 (2.9); −0.2492 (2.2); −0.2573 |
| | | (0.8); −0.4373 (1.0); −0.4451 (2.3); −0.4529 (2.9); −0.4606 (2.7); −0.4686 |
| | | (1.9); −0.4768 (0.7) |
| I-40 | 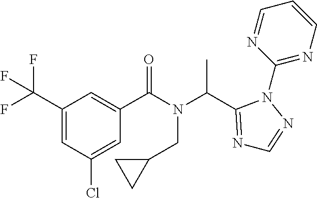 [SMILES: CC(c1ncnn1-c1ncccn1)N(CC1CC1)C(=O)c1cc(Cl)cc(C(F)(F)F)c1] | I-40: ¹H-NMR(600.1 MHz, CD3CN, 260 K): δ = 8.8656 (1.5); 8.8392 (1.2); 8.8311 (1.1); 8.7341 (0.4); 8.7165 (0.4); 8.6697 (0.5); 8.6615 (0.5); 8.2300 (6.3); 8.2293 (6.2); 8.2277 (5.8); 8.1914 (6.6); 8.1903 (6.2); 8.0539 (6.2); 7.9811 (5.3); 7.9796 (4.7); 7.9784 (4.3); 7.7396 (1.3); 7.4834 (1.7); 7.4426 (0.8); 7.4346 (0.7); 7.3729 (16.0); 7.3725 (16.0); 7.3117 (1.4); 6.4070 (0.7); 5.4665 (5.2); 5.4625 (1.4); 2.9664 (0.8); 2.8830 (0.8); 2.8310 (0.4); 2.8178 (0.3); 2.1062 (5.2); 2.1022 (1.3); 2.0708 (0.4); 2.0667 (0.4); 1.9842 (0.4); 1.9719 (0.6); 1.9681 (22.3); 1.9640 (50.2); 1.9599 (77.2); 1.9558 (62.7); 1.9517 (35.3); 1.9477 (7.8); 1.9284 (0.5); 1.9241 (0.5); 1.9198 (0.4); 1.9182 (0.4); 1.9067 (0.4); 1.8531 (0.6); 1.8490 (0.8); 1.8449 (1.1); 1.8408 (1.2); 1.8365 (1.4); 1.8031 (10.8); 1.6965 (0.4); 1.4050 (1.7); 1.4013 (0.6); 1.3603 (0.5); 1.3040 (0.7); 1.3002 (0.4); 1.2955 (0.5); 1.2824 (1.6); 0.5665 (0.7); 0.3118 (1.9); 0.0188 (6.5); 0.0149 |
| | | (1.8); −0.1964 (0.8); −0.3563 (0.8) |
| I-41 | 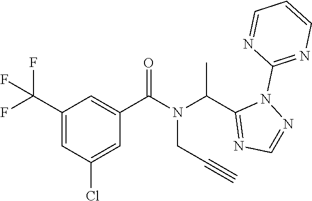 [SMILES: C#CCN(C(=O)c1cc(Cl)cc(C(F)(F)F)c1)C(C)c1ncnn1-c1ncccn1] | I-41: ¹H-NMR(400.2MHz, CD3CN, 260 K): δ = 8.8099 (3.0); 8.5815 (0.4); 8.5761 (0.4); 8.5475 (0.3); 8.0414 (16.0); 7.8014 (1.8); 7.7294 (0.4); 7.7162 (0.3); 7.7059 (0.4); 7.6200 (1.9); 7.5653 (2.2); 7.4845 (0.6); 7.4739 (0.6); 7.4269 (2.8); 6.5496 (1.2); 5.4503 (4.7); 4.5649 (0.4); 3.9073 (3.2); 2.4722 (0.4); 2.4672 (0.3); 2.2909 (2.3); 2.2154 (239.7); 2.1224 (0.3); 2.1163 (0.4); 2.1100 (0.4); 2.1038 (0.4); 2.0885 (0.4); 1.9736 (0.4); 1.9670 (1.1); 1.9552 (19.7); 1.9490 (37.4); 1.9429 (52.2); 1.9367 (36.7); 1.9306 (19.2); 1.7544 (9.7); 1.7384 (9.3); −0.0002 (4.8) |
| I-48 | 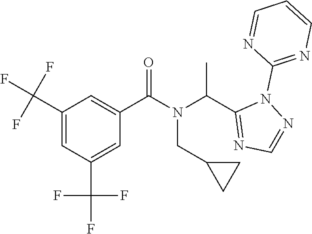 [SMILES: CC(c1ncnn1-c1ncccn1)N(CC1CC1)C(=O)c1cc(C(F)(F)F)cc(C(F)(F)F)c1] | I-48: ¹H-NMR(600.1 MHz, CD3CN, 260 K): δ = 8.8945 (0.4); 8.8865 (0.6); 8.8767 (12.4); 8.8687 (12.5); 8.5382 (3.4); 8.5303 (3.4); 8.0918 (11.4); 8.0759 (6.4); 8.0449 (0.8); 8.0309 (3.0); 7.9291 (2.1); 7.7355 (4.3); 7.6087 (14.4); 7.5174 (3.5); 7.5093 (6.7); 7.5013 (3.4); 7.3506 (1.0); 7.3427 (1.8); 7.3349 (1.0); 6.4119 (1.2); 6.4004 (3.9); 6.3888 (3.9); 6.3771 (1.2); 6.1105 (0.4); 6.0987 (1.2); 6.0872 (1.2); 6.0762 (0.4); 3.7604 (0.7); 3.7498 (0.7); 3.7366 (0.9); 3.7258 (0.9); 3.5675 (0.9); 3.5555 (0.9); 3.5433 (0.7); 3.5316 (0.7); 3.1121 (0.4); 3.1012 (0.4); 2.9268 (1.8); 2.9155 (1.9); 2.9005 (3.4); 2.8892 (3.4); 2.8407 (3.2); 2.8313 (3.3); 2.8145 (1.8); 2.8050 (1.8); 2.2894 (365.6); 2.2692 (0.4); 2.2563 (0.5); 2.0799 (1.0); 2.0758 (1.8); 2.0717 (2.6); 2.0675 (1.8); 2.0635 (1.0); 1.9849 (3.2); 1.9768 (6.6); 1.9690 (165.6); 1.9649 (319.2); 1.9608 (465.0); 1.9567 (319.4); 1.9526 (161.2); 1.9439 (2.4); 1.9289 (0.4); 1.9250 (0.3); 1.8826 (0.4); 1.8783 (0.5); 1.8743 (0.4); 1.8539 (1.1); 1.8498 (2.0); 1.8457 (2.9); 1.8416 (2.2); 1.8309 (16.0); 1.8192 (16.0); 1.7492 (4.6); 1.7377 (4.6); 1.5325 (0.7); 1.5208 (0.7); |
| | | 1.2830 (0.4); 1.2615 (0.5); 1.1112 (0.6); 1.1012 (0.7); 1.0918 (0.6); 0.5486 |
| | | (1.5); 0.5390 (2.0); 0.5282 (1.8); 0.5198 (1.3); 0.5148 (1.4); 0.5063 (1.5); |
| | | 0.4998 (1.4); 0.4932 (1.3); 0.4701 (0.4); 0.4647 (0.4); 0.3619 (0.6); 0.3451 |
| | | (1.0); 0.3116 (0.9); 0.3034 (0.7); 0.2938 (0.6); 0.2882 (0.9); 0.2794 (1.1); |
| | | 0.2730 (1.8); 0.2653 (2.4); 0.2579 (2.1); 0.2514 (1.6); 0.2429 (1.2); 0.2370 |
| | | (1.2); 0.2288 (1.7); 0.2215 (2.0); 0.2150 (2.3); 0.2072 (1.7); 0.2010 (1.0); |
| | | 0.1922 (0.6); 0.0967 (0.4); 0.0053 (3.2); −0.0001 (92.3); −0.0057 |
| | | (2.9); −0.1002 (0.4); −0.2354 (0.8); −0.2437 (1.8); −0.2517 (2.6); −0.2598 |
| | | (2.7); −0.2675 (2.1); −0.2757 (0.8); −0.4001 (0.9); −0.4082 (2.1); −0.4158 |
| | | (2.7); −0.4239 (2.5); −0.4318 (1.7); −0.4403 (0.7) |
| I-50 | 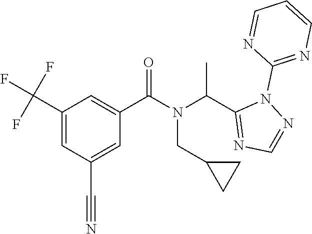 [SMILES: CC(c1ncnn1-c1ncccn1)N(CC1CC1)C(=O)c1cc(C#N)cc(C(F)(F)F)c1] | I-50: ¹H-NMR(600.1 MHz, CD3CN, 260 K): δ = 8.8706 (11.3); 8.8627 (11.4); 8.5895 (3.7); 8.5819 (3.7); 8.1555 (7.8); 8.0968 (10.2); 8.0398 (3.2); 8.0083 (2.6); 7.7668 (2.8); 7.7412 (10.2); 7.6638 (8.1); 7.5173 (3.2); 7.5095 (6.0); 7.5017 (3.1); 7.4007 (1.1); 7.3932 (1.9); 7.3857 (1.0); 6.4216 (1.3); 6.4101 (4.0); 6.3986 (4.0); 6.3872 (1.3); 6.0577 (0.5); 6.0470 (1.3); 6.0357 (1.3); 6.0247 (0.5); 5.4730 (1.2); 3.7295 (0.8); 3.7191 (0.8); 3.7059 (1.1); 3.6956 (1.0); 3.5726 (1.0); 3.5607 (1.1); 3.5489 (0.8); 3.5372 (0.8); 2.9338 (1.9); 2.9224 (1.9); 2.9075 (3.6); 2.8961 (3.6); 2.8529 (3.5); 2.8435 (3.6); 2.8266 (1.9); 2.8172 (1.8); 2.2993 (68.3); 2.0734 (0.4); 1.9857 (0.5); 1.9626 (63.2); 1.9606 (61.6); 1.8454 (0.4); 1.8120 (15.9); 1.8005 (16.0); 1.7487 (5.2); 1.7374 (5.1); 1.0793 (0.9); 1.0701 (0.7); 0.5638 (1.8); 0.5540 (2.4); 0.5440 (2.0); 0.5207 (0.5); 0.4957 (1.5); 0.4897 (1.6); 0.4835 (1.5); 0.3551 (0.7); 0.3394 (1.2); 0.2909 (1.8); 0.2821 (2.2); 0.2757 (2.7); 0.2679 (3.1); 0.2609 (2.5); 0.2460 (1.1); 0.2287 (1.1); 0.2200 (2.0); 0.2136 (2.4); 0.2070 (2.7); 0.1990 (2.0); 0.1843 (0.7); 0.0970 (3.1); 0.0420 |
| | | (0.5); 0.0273 (0.8); 0.0174 (1.4); −0.0001 (535.8); −0.1000 (3.2); −0.2218 |
| | | (0.8); −0.2297 (2.0); −0.2377 (2.8); −0.2454 (3.0); −0.2533 (2.3); −0.2609 |
| | | (0.9); −0.4245 (0.9); −0.4324 (2.3); −0.4403 (3.0); −0.4480 (2.8); −0.4560 |
| | | (2.0); −0.4641 (0.8) |
| I-52 | 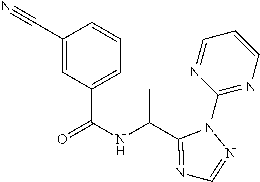 [SMILES: CC(NC(=O)c1cccc(C#N)c1)c1ncnn1-c1ncccn1] | I-52: ¹H-NMR(400.2 MHz, d₆-DMSO): δ = 9.2416 (3.0); 9.2237 (3.1); 8.9955 (13.6); 8.9833 (13.8); 8.2895 (0.3); 8.2700 (0.3); 8.2043 (4.3); 8.2007 (7.2); 8.1973 (4.4); 8.1615 (14.1); 8.0656 (2.5); 8.0626 (3.6); 8.0586 (2.6); 8.0458 (2.8); 8.0426 (3.8); 8.0388 (2.8); 8.0058 (2.6); 8.0027 (3.8); 7.9865 (3.0); 7.9833 (4.2); 7.6765 (3.8); 7.6569 (6.6); 7.6389 (5.9); 7.6272 (8.1); 7.6150 (4.1); 6.0276 (0.6); 6.0104 (2.6); 5.9928 (4.1); 5.9753 (2.6); 5.9580 (0.6); 3.3298 (23.1); 2.8779 (4.5); 2.6774 (0.4); 2.6729 (0.6); 2.6682 (0.4); 2.5262 (2.1); 2.5127 (37.1); 2.5084 (72.0); 2.5039 (92.6); 2.4994 (66.8); 2.4950 (32.3); 2.3350 (0.4); 2.3307 (0.6); 2.3262 (0.4); 1.6429 (16.0); 1.6255 (15.9); 1.2732 (0.6); 1.2589 (0.8); 1.2433 (0.9); 0.1459 (0.4); 0.0078 (3.6); −0.0002 (84.4); −0.0085 (3.1); −0.1496 (0.4) |
| I-62 | 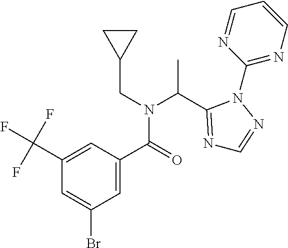 [SMILES: CC(c1ncnn1-c1ncccn1)N(CC1CC1)C(=O)c1cc(Br)cc(C(F)(F)F)c1] | I-62: ¹H-NMR(600.1 MHz, CD3CN, 260 K): δ = 8.8775 (11.6); 8.8695 (11.9); 8.6020 (4.6); 8.5942 (4.7); 8.3786 (0.5); 8.2313 (0.5); 8.1295 (0.4); 8.0858 (10.6); 8.0308 (4.1); 7.9343 (7.1); 7.7627 (3.1); 7.5234 (3.5); 7.5152 (8.6); 7.5081 (4.6); 7.4693 (7.8); 7.4586 (3.3); 7.3996 (1.4); 7.3919 (2.5); 7.3839 (1.4); 7.2922 (7.5); 6.3789 (1.3); 6.3674 (3.9); 6.3558 (3.9); 6.3443 (1.3); 6.1258 (0.6); 6.1144 (1.6); 6.1029 (1.6); 6.0915 (0.6); 4.0685 (1.6); 4.0566 (4.8); 4.0447 (4.9); 4.0329 (1.6); 3.7174 (0.9); 3.7071 (1.0); 3.6938 (1.3); 3.6833 (1.3); 3.5593 (1.3); 3.5476 (1.3); 3.5357 (1.0); 3.5238 (1.0); 2.9257 (2.0); 2.9142 (2.0); 2.8995 (3.3); 2.8881 (3.3); 2.8255 (3.2); 2.8160 (3.3); 2.7993 (2.0); 2.7898 (2.0); 2.2947 (35.1); 2.0800 (0.5); 2.0760 (0.8); 2.0719 (1.2); 2.0679 (0.8); 1.9843 (21.7); 1.9770 (4.1); 1.9691 (77.8); 1.9651 (148.7); 1.9610 (213.2); 1.9570 (150.8); 1.9531 (78.5); 1.9209 (0.5); 1.9067 (0.3); 1.8541 (0.6); 1.8500 (1.0); 1.8459 (1.4); 1.8419 (1.0); 1.8385 (0.6); 1.8128 (15.8); 1.8013 (16.0); 1.7522 (6.5); 1.7408 (6.4); 1.5118 (0.5); 1.5002 (0.5); 1.2613 (0.6); 1.2178 (5.4); 1.2059 (10.5); 1.1940 (5.2); 1.0838 (0.8); 1.0734 (1.1); 1.0627 (0.9); 0.5503 (1.7); 0.5403 |
| | | (2.2); 0.5300 (1.9); 0.5178 (1.2); 0.5082 (1.1); 0.4937 (1.6); 0.4856 (1.9); |
| | | 0.4794 (1.6); 0.4716 (1.4); 0.4647 (1.0); 0.3512 (0.8); 0.3431 (1.1); 0.3359 |
| | | (1.4); 0.3013 (1.3); 0.2872 (3.1); 0.2794 (3.5); 0.2723 (3.0); 0.2653 (2.1); |
| | | 0.2569 (1.3); 0.2490 (1.3); 0.2409 (1.9); 0.2339 (2.2); 0.2271 (2.5); 0.2195 |
| | | (1.9); 0.2043 (0.6); 0.0971 (0.4); −0.0001 (69.2); −0.1000 (0.4); −0.1964 |
| | | (0.8); −0.2046 (1.9); −0.2128 (2.7); −0.2205 (2.9); −0.2282 (2.2); −0.2362 |
| | | (0.9); −0.3706 (0.9); −0.3786 (2.2); −0.3865 (2.9); −0.3943 (2.7); −0.4023 |
| | | (1.9); −0.4107 (0.8) |
| I-63 | 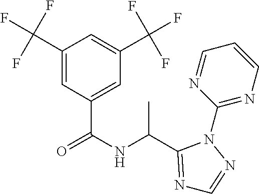 [SMILES: CC(NC(=O)c1cc(C(F)(F)F)cc(C(F)(F)F)c1)c1ncnn1-c1ncccn1] | I-63: ¹H-NMR(400.2 MHz, d₆-DMSO): δ = 9.5745 (3.3); 9.5567 (3.3); 8.9986 (11.1); 8.9864 (11.3); 8.5268 (2.4); 8.4680 (0.5); 8.4078 (12.9); 8.3088 (5.7); 8.1825 (14.3); 7.8816 (0.5); 7.6405 (3.8); 7.6284 (7.2); 7.6162 (3.6); 6.0697 (0.6); 6.0525 (2.6); 6.0350 (4.1); 6.0174 (2.6); 6.0001 (0.6); 3.3581 (4.6); 2.6786 (0.5); 2.6741 (0.7); 2.6696 (0.5); 2.5275 (2.1); 2.5226 (3.4); 2.5141 (42.6); 2.5097 (85.2); 2.5051 (111.3); 2.5006 (80.7); 2.4962 (39.1); 2.3364 (0.5); 2.3319 (0.7); 2.3275 (0.5); 2.0775 (10.3); 1.6751 (16.0); 1.6577 (15.9); 0.1460 (0.4); 0.0079 (3.7); −0.0002 (101.8); −0.0085 (3.8); −0.1495 (0.4) |
| I-66 | 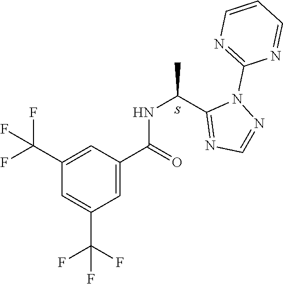 | I-66: ¹H-NMR(400.2 MHz, d₆-DMSO): δ = 9.5676 (2.8); 9.5500 (2.8); 8.9945 (15.7); 8.9823 (16.0); 8.4038 (10.8); 8.3155 (2.3); 8.3069 (4.7); 8.1780 (12.5); 7.6366 (4.3); 7.6244 (8.3); 7.6123 (4.1); 7.0561 (0.4); 6.0664 (0.5); 6.0485 (2.2); 6.0309 (3.5); 6.0133 (2.2); 5.9959 (0.6); 3.3216 (463.3); 3.2817 (0.3); 2.6752 (3.3); 2.6707 (4.7); 2.6661 (3.4); 2.6618 (1.7); 2.5241 (13.0); 2.5193 (19.6); 2.5107 (257.4); 2.5063 (522.8); 2.5017 (694.7); 2.4972 (507.7); 2.4927 (248.4); 2.3373 (1.4); 2.3331 (3.1); 2.3285 (4.4); 2.3240 (3.2); 2.3199 (1.5); 2.0741 (2.6); 1.6718 (13.6); 1.6544 (13.6); 0.1459 (2.0); 0.0236 (0.5); 0.0080 (14.7); −0.0002 (454.2); −0.0084 (16.3); −0.0230 (0.6); −0.0303 (0.4); −0.1496 (2.0) |
| I-76 | 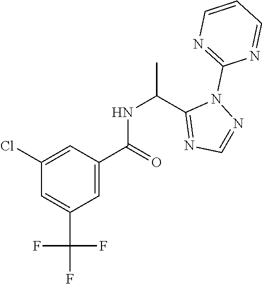 [SMILES: CC(NC(=O)c1cc(Cl)cc(C(F)(F)F)c1)c1ncnn1-c1ncccn1] | I-76: ¹H-NMR(400.2 MHz, CD3CN): δ = 8.8897 (10.9); 8.8775 (11.0); 7.9859 (14.2); 7.9363 (5.2); 7.8645 (4.8); 7.7734 (1.2); 7.7590 (1.1); 7.4816 (3.2); 7.4695 (6.2); 7.4573 (3.1); 6.1510 (0.6); 6.1334 (2.2); 6.1156 (3.3); 6.0979 (2.2); 6.0804 (0.6); 5.4471 (3.0); 2.8888 (0.7); 2.7713 (0.6); 2.1371 (31.4); 2.1137 (0.4); 2.1071 (0.5); 2.1011 (0.4); 2.0863 (1.9); 1.9641 (0.9); 1.9523 (25.9); 1.9462 (50.5); 1.9400 (72.3); 1.9338 (50.4); 1.9277 (25.9); 1.7686 (0.4); 1.6785 (16.0); 1.6611 (15.9); 1.4366 (0.4); 1.2697 (0.5); 0.0802 (0.4); 0.0079 (0.7); −0.0002 (20.3) |
| I-77 | 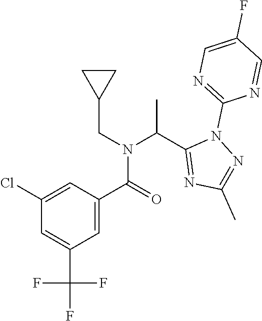 [SMILES: Cc1nc(C(C)N(CC2CC2)C(=O)c2cc(Cl)cc(C(F)(F)F)c2)n(-c2ncc(F)cn2)n1] | I-77: ¹H-NMR(400.6 MHz, CD3CN 260 K): δ = 8.7367 (10.7); 8.4770 (2.8); 7.7740 (2.6); 7.6544 (1.0); 7.4137 (3.4); 7.3536 (1.0); 7.3155 (2.8); 6.2853 (0.5); 6.2679 (1.6); 6.2505 (1.7); 6.2334 (0.5); 5.8879 (0.5); 5.8709 (0.5); 5.4400 (1.2); 3.5842 (0.5); 3.5679 (0.5); 3.5304 (0.5); 3.5137 (0.5); 2.8819 (1.9); 2.8710 (2.2); 2.8656 (2.4); 2.8570 (2.1); 2.5077 (1.1); 2.3785 (16.0); 2.3607 (0.6); 2.3504 (0.4); 2.3436 (0.6); 2.3241 (4.6); 2.3196 (2.0); 2.3154 (1.0); 2.3115 (0.9); 2.3099 (0.8); 2.3068 (1.4); 2.3043 (1.3); 2.3026 (1.7); 2.2937 (321.6); 2.2786 (1.3); 2.2754 (0.9); 2.2738 (1.0); 2.2707 (0.8); 2.2691 (0.7); 2.2660 (1.1); 2.2635 (0.5); 2.2618 (0.6); 2.2586 (0.6); 1.9469 (0.4); 1.9413 (14.4); 1.9351 (28.6); 1.9289 (42.9); 1.9228 (29.0); 1.9166 (14.6); 1.9100 (0.6); 1.7337 (6.6); 1.7163 (6.9); 1.7032 (2.5); 1.6858 (2.0); 1.4860 (0.3); 1.0189 (0.3); 0.5288 (0.6); 0.5143 (0.8); 0.4983 (0.7); 0.4804 (0.4); 0.4541 (0.7); 0.4356 (0.7); 0.2765 (0.6); 0.2627 (0.5); 0.2536 (0.9); 0.2423 (1.3); 0.2315 (1.3); 0.2224 (1.0); 0.2194 (1.0); 0.2130 (1.0); 0.2098 (1.0); 0.2033 (0.9); 0.1903 (0.9); 0.1808 (0.9); 0.1698 (0.7); 0.1605 (0.4) |
| I-78 | 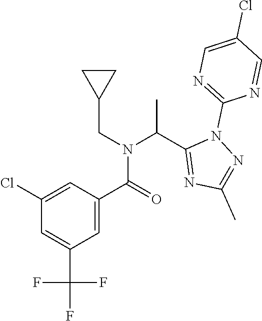 [SMILES: Cc1nc(C(C)N(CC2CC2)C(=O)c2cc(Cl)cc(C(F)(F)F)c2)n(-c2ncc(Cl)cn2)n1] | I-78: ¹H-NMR(400.6 MHz, CD3CN lowT): δ = 9.0753 (1.0); 9.0690 (1.1); 8.8051 (11.2); 8.7044 (0.8); 8.6981 (0.8); 8.5327 (3.3); 7.7753 (2.8); 7.6382 (1.1); 7.4307 (1.2); 7.4057 (3.1); 7.3522 (1.2); 7.3305 (3.1); 6.3139 (0.5); 6.2966 (1.7); 6.2793 (1.7); 6.2619 (0.6); 5.9370 (0.6); 5.9201 (0.6); 3.6056 (0.6); 3.5894 (0.6); 3.5566 (0.6); 3.5400 (0.6); 2.9190 (0.4); 2.9021 (0.4); 2.8797 (1.9); 2.8636 (3.5); 2.8501 (2.0); 2.8252 (0.4); 2.5092 (6.1); 2.3827 (16.0); 2.3452 (0.8); 2.3288 (5.6); 2.3234 (2.8); 2.3193 (1.3); 2.3124 (1.0); 2.2949 (307.0); 2.2691 (0.8); 2.2646 (0.8); 1.9472 (0.7); 1.9417 (14.8); 1.9355 (30.1); 1.9293 (43.9); 1.9232 (30.1); 1.9170 (15.0); 1.9104 (0.7); 1.9061 (0.3); 1.9039 (0.4); 1.7580 (0.4); 1.7517 (0.4); 1.7332 (6.8); 1.7157 (7.5); 1.7065 (3.4); 1.6885 (2.4); 1.2263 (0.4); 1.0512 (0.4); 1.0370 (0.4); 0.5271 (0.7); 0.5127 (0.9); 0.4969 (0.8); 0.4776 (0.7); 0.4608 (0.9); 0.4422 (0.8); 0.2918 (0.6); 0.2730 (0.5); 0.2590 (0.9); 0.2501 (1.3); 0.2388 (1.4); 0.2280 (1.2); 0.2187 (0.9); 0.2057 (1.1); 0.1938 (0.8); 0.1829 (0.9); 0.1734 (1.0); 0.1623 (0.8); −0.1992 (0.4) |
| I-79 | 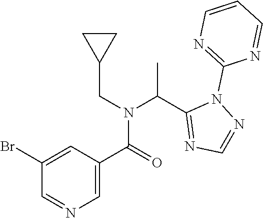 [SMILES: CC(c1ncnn1-c1ncccn1)N(CC1CC1)C(=O)c1cncc(Br)c1] | I-79: ¹H-NMR(600.1 MHz, CD3CN, 260 K): δ = 9.0809 (1.8); 9.0780 (1.8); 8.8794 (9.8); 8.8760 (2.5); 8.8713 (14.5); 8.8697 (11.2); 8.8615 (10.2); 8.7012 (4.8); 8.6976 (4.8); 8.6247 (3.3); 8.6166 (3.3); 8.5897 (1.8); 8.5868 (1.8); 8.4621 (1.3); 8.4587 (1.8); 8.4553 (1.3); 8.3659 (2.0); 8.2299 (5.2); 8.2273 (5.1); 8.0895 (8.9); 8.0411 (9.4); 7.7201 (2.0); 7.6928 (3.5); 7.6896 (5.3); 7.6864 (3.1); 7.5123 (5.1); 7.5042 (10.0); 7.4962 (5.1); 7.4398 (1.0); 7.4317 (1.7); 7.4237 (0.9); 6.5695 (0.8); 6.5585 (2.6); 6.5475 (2.6); 6.5364 (0.8); 6.4156 (0.9); 6.4041 (3.0); 6.3924 (3.0); 6.3808 (0.9); 6.1291 (0.4); 6.1176 (1.1); 6.1061 (1.1); 6.0949 (0.4); 4.0684 (2.1); 4.0565 (6.4); 4.0446 (6.5); 4.0327 (2.1); 3.6248 (0.6); 3.6142 (0.6); 3.6012 (0.9); 3.5907 (0.9); 3.5180 (0.9); 3.5063 (0.9); 3.4943 (0.6); 3.4826 (0.6); 2.9512 (1.4); 2.9396 (1.4); 2.9249 (2.7); 2.9134 (2.7); 2.8948 (2.2); 2.8751 (2.6); 2.8655 (2.6); 2.8488 (1.3); 2.8393 (1.3); 2.7765 (1.7); 2.7757 (1.7); 2.3013 (4.6); 2.0805 (0.5); 2.0764 (0.8); 2.0722 (1.2); 2.0681 (0.8); 2.0640 (0.5); 2.0407 (0.4); 2.0049 (0.3); 2.0004 (0.4); 1.9843 (30.6); 1.9775 |
| | | (3.0); 1.9730 (4.9); 1.9696 (67.3); 1.9655 (130.1); 1.9614 (188.7); 1.9572 |
| | | (128.7); 1.9531 (64.0); 1.9485 (0.9); 1.9344 (32.6); 1.8545 (0.4); 1.8504 |
| | | (0.7); 1.8463 (1.1); 1.8422 (0.7); 1.8381 (0.4); 1.8006 (12.5); 1.7890 (12.6); |
| | | 1.7725 (4.6); 1.7610 (4.3); 1.6791 (13.3); 1.6681 (13.2); 1.2827 (0.4); 1.2178 |
| | | (8.0); 1.2059 (16.0); 1.1940 (7.8); 0.9901 (0.5); 0.9791 (0.6); 0.9690 (0.5); |
| | | 0.5711 (0.5); 0.5668 (0.5); 0.5584 (1.2); 0.5488 (1.4); 0.5376 (1.1); 0.5292 |
| | | (0.5); 0.5249 (0.5); 0.4627 (0.5); 0.4546 (0.7); 0.4483 (0.8); 0.4405 (0.9); |
| | | 0.4339 (0.9); 0.4263 (0.8); 0.4195 (0.7); 0.4120 (0.6); 0.3194 (0.6); 0.3118 |
| | | (0.8); 0.3034 (0.9); 0.2996 (1.0); 0.2903 (1.0); 0.2845 (1.4); 0.2769 (1.8); |
| | | 0.2696 (1.4); 0.2634 (1.1); 0.2542 (0.8); 0.2382 (0.8); 0.2294 (1.2); 0.2220 |
| | | (1.3); 0.2158 (1.7); 0.2083 (1.2); 0.2021 (0.7); 0.1930 (0.8); 0.1859 (0.7); |
| | | 0.1797 (0.8); 0.1715 (0.7); 0.1639 (0.5); 0.0968 (0.8); 0.0204 (0.3); 0.0179 |
| | | (0.4); 0.0104 (0.8); 0.0054 (7.0); −0.0001 (210.5); −0.0057 (5.4); −0.1002 |
| | | (0.8); −0.1841 (0.6); −0.1923 (1.3); −0.2003 (1.9); −0.2084 (1.9); −0.2162 |
| | | (1.4); −0.2246 (0.6); −0.3926 (0.7); −0.4008 (1.5); −0.4086 (2.0); −0.4167 |
| | | (1.8); −0.4247 (1.2); −0.4332 (0.5) |
| I-80 | 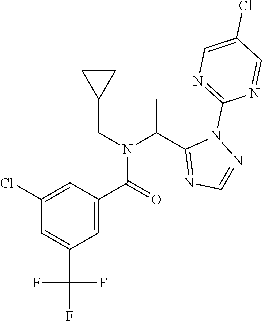 [SMILES: CC(c1ncnn1-c1ncc(Cl)cn1)N(CC1CC1)C(=O)c1cc(Cl)cc(C(F)(F)F)c1] | I-80: ¹H-NMR(600.1 MHz, CD3CN, 260 K): δ = 8.8810 (16.0); 8.6009 (4.5); 8.1005 (7.6); 8.0473 (2.2); 7.8532 (0.8); 7.8093 (4.5); 7.6800 (1.6); 7.6625 (0.9); 7.6181 (0.9); 7.4625 (1.6); 7.4356 (4.7); 7.3848 (1.6); 7.3579 (4.8); 6.3603 (0.8); 6.3488 (2.6); 6.3372 (2.7); 6.3257 (0.8); 6.0059 (0.9); 5.9945 (0.9); 5.4722 (0.8); 4.3256 (0.6); 4.3140 (0.6); 3.6907 (0.5); 3.6814 (6.9); 3.6671 (0.8); 3.6586 (2.2); 3.6033 (0.7); 3.5774 (0.7); 3.5658 (0.7); 3.5538 (0.5); 3.5422 (0.5); 3.2267 (0.4); 3.2166 (0.4); 3.2016 (0.6); 3.1914 (0.6); 3.0085 (0.5); 2.9965 (0.5); 2.9834 (0.4); 2.9713 (0.4); 2.9496 (1.1); 2.9381 (1.1); 2.9233 (2.4); 2.9119 (2.5); 2.8843 (2.4); 2.8748 (2.4); 2.8580 (1.1); 2.8486 (1.1); 2.2918 (87.5); 2.0762 (0.5); 2.0721 (0.7); 2.0680 (0.5); 1.9854 (0.9); 1.9773 (1.4); 1.9694 (44.3); 1.9653 (86.5); 1.9612 (127.2); 1.9571 (87.8); 1.9530 (44.7); 1.9442 (0.8); 1.9392 (0.4); 1.8502 (0.6); 1.8461 (0.8); 1.8420 (0.6); 1.7978 (10.6); 1.7862 (10.8); 1.7576 (3.6); 1.7462 (3.4); 1.5590 (3.2); 1.5474 (3.2); 1.4016 (0.7); 1.3898 (0.7); 1.2587 (0.7); 1.0596 (0.6); 0.5522 (1.1); 0.5418 (1.4); 0.5314 (1.2); 0.5229 (0.7); 0.5180 (0.7); 0.5088 (0.7); 0.5020 (0.9); 0.4952 (1.3); 0.4887 (1.3); 0.4818 (1.3); 0.4755 (1.2); 0.4675 (0.9); 0.4615 (0.9); 0.4540 (0.6); 0.4476 (0.4); 0.3505 (0.4); 0.3425 (0.6); 0.3352 (0.7); 0.3287 (0.6); 0.2916 (0.5); 0.2819 (1.0); 0.2761 (1.7); 0.2685 (2.3); 0.2609 (1.9); 0.2554 (1.6); 0.2464 (1.0); 0.2286 (0.8); 0.2198 (1.2); 0.2128 (1.3); 0.2062 (1.6); 0.1986 |
| | | (1.2); 0.1928 (0.7); 0.1834 (0.4); 0.0968 (0.7); 0.0891 (0.4); 0.0834 (0.3); |
| | | 0.0806 (0.3); 0.0762 (0.4); 0.0687 (0.4); 0.0623 (0.3); 0.0054 (3.1); −0.0001 |
| | | (105.4); −0.0057 (3.6); −0.0147 (0.4); −0.1002 (0.5); −0.1926 (0.5); −0.2009 |
| | | (1.2); −0.2089 (1.7); −0.2169 (1.9); −0.2247 (1.4); −0.2329 (0.6); −0.3995 |
| | | (0.6); −0.4078 (1.4); −0.4156 (1.8); −0.4236 (1.8); −0.4317 (1.2); −0.4400 (0.5) |
| I-81 | 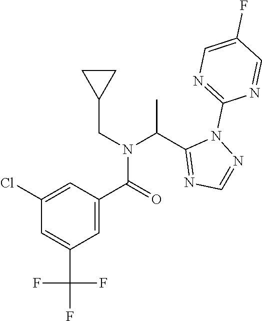 [SMILES: CC(c1ncnn1-c1ncc(F)cn1)N(CC1CC1)C(=O)c1cc(Cl)cc(C(F)(F)F)c1] | I-81: ¹H-NMR(600.1 MHz, CD3CN, 260 K): δ = 8.8099 (16.0); 8.5429 (4.0); 8.5259 (0.6); 8.0859 (7.6); 8.0341 (1.9); 7.8084 (4.3); 7.6967 (1.4); 7.4476 (4.7); 7.3870 (1.4); 7.3462 (4.7); 6.3291 (0.8); 6.3175 (2.6); 6.3059 (2.6); 6.2943 (0.8); 5.9553 (0.8); 5.9440 (0.8); 5.4721 (7.5); 3.6714 (0.4); 3.6606 (0.5); 3.6477 (0.6); 3.6371 (0.6); 3.5472 (0.6); 3.5356 (0.6); 3.5235 (0.5); 3.5121 (0.4); 2.9508 (1.0); 2.9394 (1.1); 2.9245 (2.5); 2.9131 (2.6); 2.9073 (0.6); 2.8926 (2.4); 2.8831 (2.5); 2.8664 (1.0); 2.8568 (1.0); 2.2914 (87.1); 2.0761 (0.5); 2.0719 (0.8); 2.0678 (0.5); 2.0310 (0.4); 1.9853 (0.9); 1.9772 (1.7); 1.9728 (2.8); 1.9693 (48.5); 1.9652 (94.4); 1.9611 (138.6); 1.9570 (95.0); 1.9528 (48.0); 1.9441 (0.6); 1.8501 (0.6); 1.8460 (0.8); 1.8419 (0.6); 1.7988 (10.6); 1.7872 (10.8); 1.7546 (3.2); 1.7432 (3.0); 1.2610 (0.5); 1.0464 (0.4); 1.0375 (0.5); 1.0280 (0.4); 0.5552 (1.0); 0.5453 (1.3); 0.5350 (1.1); 0.5266 (0.5); 0.5224 (0.5); 0.4957 (0.5); 0.4879 (0.6); 0.4817 (0.7); 0.4751 (0.8); 0.4684 (0.8); 0.4617 (0.7); 0.4559 (0.6); 0.4474 (0.5); 0.3419 (0.4); 0.3339 (0.6); 0.3262 (0.7); 0.3198 (0.6); 0.2963 (0.5); 0.2871 (0.8); 0.2810 (1.2); 0.2733 (1.6); 0.2654 (1.4); 0.2586 (1.3); 0.2509 (1.2); 0.2377 (1.2); 0.2293 (1.4); 0.2218 (1.4); 0.2152 (1.6); 0.2076 (1.2); 0.2015 (0.7); 0.1924 (0.4); 0.0967 (0.6); 0.0054 (4.1); −0.0001 (131.7); −0.0057 (4.0); −0.1001 (0.6); −0.1925 (0.6); −0.2009 (1.2); −0.2088 (1.7); −0.2169 (1.8); −0.2246 (1.4); −0.2329 (0.6); −0.3862 (0.6); −0.3945 (1.4); −0.4023 (1.8); −0.4104 (1.7); −0.4184 (1.2); −0.4267 (0.5) |
| I-82 | 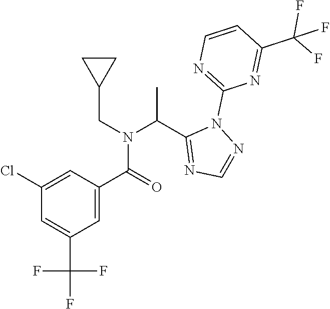 [SMILES: CC(c1ncnn1-c1nccc(C(F)(F)F)n1)N(CC1CC1)C(=O)c1cc(Cl)cc(C(F)(F)F)c1] | I-82: ¹H-NMR(600.1 MHz, CD3CN, 260 K): δ = 9.1150 (0.6); 9.1068 (0.6); 8.8568 (0.2); 8.8488 (0.2); 8.1549 (1.2); 8.1037 (0.4); 7.8876 (0.7); 7.8794 (0.7); 7.8086 (0.7); 7.7748 (0.2); 7.7667 (0.2); 7.5775 (0.3); 7.4742 (0.8); 7.3987 (0.8); 7.3504 (0.4); 7.1642 (0.0); 6.4614 (0.1); 6.4499 (0.4); 6.4383 (0.4); 6.4268 (0.1); 6.0386 (0.0); 6.0275 (0.2); 6.0159 (0.2); 6.0047 (0.0); 5.4721 (2.6); 3.8568 (0.1); 3.8466 (0.1); 3.8330 (0.1); 3.8228 (0.1); 3.6814 (0.0); 3.6085 (0.1); 3.5968 (0.1); 3.5849 (0.1); 3.5731 (0.1); 2.9936 (0.2); 2.9823 (0.2); 2.9672 (0.4); 2.9560 (0.4); 2.9044 (0.4); 2.8950 (0.4); 2.8781 (0.2); 2.8687 (0.2); 2.3018 (0.0); 2.2912 (16.0); 2.0976 (0.3); 2.0802 (0.0); 2.0761 (0.1); 2.0720 (0.1); 2.0679 (0.1); 2.0637 (0.0); 1.9853 (0.9); 1.9772 (0.2); 1.9693 (6.8); 1.9652 (13.3); 1.9611 (19.6); 1.9570 (13.5); 1.9529 (6.9); 1.9442 (0.1); 1.9296 (0.0); 1.9199 (0.0); 1.8543 (0.0); 1.8501 (0.1); 1.8460 (0.1); 1.8419 (0.1); 1.8378 (0.0); 1.8117 (1.7); 1.8001 (1.7); 1.7362 (0.6); 1.7248 (0.6); 1.7027 (0.0); 1.5717 (0.0); 1.5594 (0.0); 1.2608 (0.0); 1.1715 (0.1); 1.1624 (0.1); 1.1533 (0.1); 0.6009 (0.0); 0.5787 (0.2); 0.5685 (0.2); 0.5582 (0.2); 0.5412 (0.2); 0.5316 (0.2); 0.5188 (0.2); 0.3967 (0.0); 0.3748 (0.3); 0.3033 (0.1); 0.2941 (0.1); 0.2879 (0.2); 0.2801 (0.3); 0.2724 (0.2); 0.2661 (0.2); 0.2576 (0.1); 0.2320 (0.1); 0.2231 (0.2); 0.2161 (0.2); 0.2095 (0.3); 0.2018 (0.2); 0.1955 (0.1); 0.1865 |
| | | (0.1); 0.0967 (0.1); 0.0106 (0.0); 0.0054 (0.4); −0.0001 (13.6); −0.0056 |
| | | (0.5); −0.1002 (0.1); −0.1803 (0.1); −0.1886 (0.2); −0.1965 (0.3); −0.2045 |
| | | (0.3); −0.2125 (0.2); −0.2207 (0.1); −0.4029 (0.1); −0.4113 (0.2); −0.4192 |
| | | (0.3); −0.4272 (0.3); −0.4353 (0.2); −0.4436 (0.1) |
| I-83 | 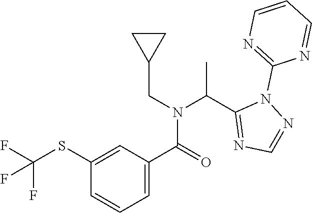 [SMILES: CC(c1ncnn1-c1ncccn1)N(CC1CC1)C(=O)c1cccc(SC(F)(F)F)c1] | I-83: ¹H-NMR(600.1 MHz, CD3CN, 260 K): δ = 8.9240 (0.4); 8.9159 (0.4); 8.8947 (0.5); 8.8865 (0.9); 8.8794 (12.7); 8.8714 (12.9); 8.5563 (3.3); 8.5484 (3.2); 8.3568 (0.7); 8.3492 (0.7); 8.0804 (11.6); 8.0429 (1.8); 8.0335 (3.0); 7.7428 (3.4); 7.7299 (3.8); 7.6968 (0.4); 7.6832 (0.4); 7.6252 (1.2); 7.6124 (1.3); 7.5296 (0.3); 7.5205 (3.5); 7.5124 (6.7); 7.5042 (6.3); 7.4909 (6.0); 7.4779 (3.8); 7.3772 (1.7); 7.3685 (2.3); 7.3654 (2.2); 7.3520 (1.0); 7.2708 (7.6); 7.2523 (4.6); 7.2395 (3.9); 7.1524 (0.4); 7.1388 (0.4); 6.6198 (0.4); 6.4020 (1.2); 6.3904 (3.8); 6.3788 (3.8); 6.3673 (1.2); 6.0542 (0.4); 6.0430 (1.1); 6.0317 (1.1); 6.0204 (0.4); 4.0684 (0.7); 4.0565 (2.0); 4.0446 (2.0); 4.0327 (0.7); 3.6764 (0.7); 3.6664 (0.7); 3.6532 (0.9); 3.6429 (0.9); 3.4774 (0.9); 3.4656 (0.9); 3.4538 (0.8); 3.4421 (0.7); 3.0332 (1.9); 3.0224 (2.9); 3.0117 (1.9); 3.0015 (0.4); 2.9903 (0.6); 2.9791 (0.4); 2.8784 (1.5); 2.8665 (1.5); 2.8523 (3.8); 2.8404 (3.8); 2.8215 (3.6); 2.8120 (3.8); 2.7954 (1.5); 2.7859 (1.4); 2.2972 (41.6); 2.0802 (0.4); |
| | | 2.0762 (0.7); 2.0720 (0.9); 2.0679 (0.7); 2.0638 (0.4); 1.9842 (9.5); 1.9803 |
| | | (1.4); 1.9773 (2.2); 1.9694 (56.2); 1.9653 (107.9); 1.9612 (156.7); 1.9570 |
| | | (108.2); 1.9529 (54.5); 1.9442 (0.7); 1.8543 (0.4); 1.8502 (0.7); 1.8461 (1.0); |
| | | 1.8420 (0.7); 1.8378 (0.4); 1.8178 (15.8); 1.8062 (16.0); 1.7566 (4.4); 1.7452 |
| | | (4.2); 1.6563 (0.5); 1.4478 (0.5); 1.4367 (0.8); 1.4055 (0.4); 1.3941 (0.3); |
| | | 1.3839 (0.5); 1.3750 (0.4); 1.3724 (0.4); 1.3410 (0.4); 1.2827 (0.5); 1.2733 |
| | | (0.4); 1.2607 (0.6); 1.2177 (2.4); 1.2058 (4.8); 1.1939 (2.4); 1.0520 (0.4); |
| | | 1.0282 (0.8); 0.9380 (0.6); 0.9329 (0.5); 0.9301 (0.5); 0.9249 (0.8); 0.9211 |
| | | (0.4); 0.9169 (0.5); 0.9130 (0.5); 0.5551 (0.6); 0.5505 (0.7); 0.5425 (1.6); |
| | | 0.5331 (1.9); 0.5306 (1.9); 0.5212 (1.7); 0.5127 (0.8); 0.5087 (0.8); 0.4992 |
| | | (0.4); 0.4880 (0.5); 0.4806 (0.8); 0.4780 (0.9); 0.4746 (1.0); 0.4672 (1.3); |
| | | 0.4641 (1.7); 0.4568 (3.0); 0.4542 (3.1); 0.4507 (1.7); 0.4472 (1.8); 0.4434 |
| | | (2.8); 0.4409 (2.7); 0.4339 (1.4); 0.3681 (0.3); 0.3602 (0.3); 0.3362 (0.3); |
| | | 0.3288 (0.6); 0.3209 (0.8); 0.3131 (1.0); 0.3067 (0.8); 0.2487 (0.8); 0.2396 |
| | | (1.4); 0.2335 (2.6); 0.2260 (3.4); 0.2190 (3.1); 0.2117 (2.4); 0.2044 (2.6); |
| | | 0.1976 (2.2); 0.1899 (3.0); 0.1829 (5.0); 0.1751 (4.0); 0.1608 (0.6); 0.0053 |
| | | (1.6); −0.0001 (47.3); −0.0057 (1.6); −0.2517 (0.9); −0.2599 (1.9); −0.2679 |
| | | (2.6); −0.2760 (2.7); −0.2832 (2.0); −0.2913 (0.8); −0.4510 (0.9); −0.4590 |
| | | (2.1); −0.4664 (2.7); −0.4744 (2.5); −0.4825 (1.7); −0.4908 (0.7) |
| I-84 | 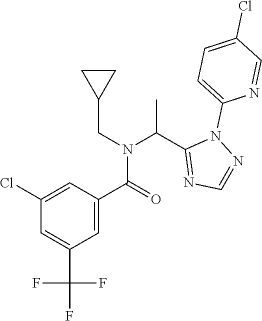 [SMILES: CC(c1ncnn1-c1ccc(Cl)cn1)N(CC1CC1)C(=O)c1cc(Cl)cc(C(F)(F)F)c1] | I-84: ¹H-NMR(600.1 MHz, CD3CN): δ = 8.4419 (0.5); 8.4381 (0.5); 8.0726 (1.2); 8.0627 (0.3); 8.0587 (0.3); 8.0178 (0.5); 7.9666 (0.4); 7.9618 (0.3); 7.9471 (0.2); 7.9433 (0.2); 7.8763 (0.5); 7.8618 (0.5); 7.7895 (0.6); 7.6991 (0.3); 7.6848 (0.3); 7.6138 (0.4); 7.4025 (0.3); 7.2909 (0.3); 7.2543 (0.6); 7.1502 (0.6); 6.3383 (0.1); 6.3268 (0.3); 6.3152 (0.3); 6.3036 (0.1); 6.1010 (0.1); 6.0896 (0.2); 6.0781 (0.2); 6.0666 (0.1); 5.4719 (0.6); 3.7075 (0.1); 3.6970 (0.1); 3.6839 (0.2); 3.6734 (0.2); 3.5949 (0.2); 3.5832 (0.2); 3.5712 (0.1); 3.5596 (0.1); 2.8895 (0.2); 2.8777 (0.2); 2.8633 (0.3); 2.8515 (0.3); 2.8066 (0.3); 2.7971 (0.3); 2.7804 (0.2); 2.7710 (0.2); 2.3107 (0.0); 2.2905 (16.0); 2.2579 (0.0); 2.0801 (0.0); 2.0760 (0.1); 2.0720 (0.2); 2.0678 (0.1); 2.0637 (0.0); 2.0074 (0.0); 2.0035 (0.0); 1.9998 (0.0); 1.9957 (0.0); 1.9852 (0.2); 1.9770 (0.3); 1.9692 (8.3); 1.9651 (16.0); 1.9610 (23.5); 1.9569 (16.2); 1.9528 (8.2); 1.9443 (0.1); 1.8742 (0.0); 1.8541 (0.0); 1.8500 (0.1); 1.8459 (0.1); 1.8418 (0.1); 1.8378 (0.0); 1.8137 (1.3); 1.8021 (1.3); 1.7674 (0.8); 1.7559 (0.8); 1.2608 (0.0); 1.1070 (0.1); 1.1032 (0.1); 1.0963 (0.1); 1.0855 (0.1); 1.0756 (0.0); 0.5378 (0.2); 0.5231 (0.2); 0.5161 (0.2); 0.5083 (0.2); 0.4992 (0.2); 0.4936 (0.2); 0.4847 (0.1); 0.4777 (0.1); 0.4704 (0.1); 0.4636 (0.0); 0.4556 (0.0); 0.3687 (0.0); 0.3607 (0.1); 0.3528 (0.1); 0.3451 (0.2); 0.3387 (0.1); 0.3312 (0.1); 0.3091 (0.1); 0.3013 (0.1); 0.2947 (0.2); 0.2865 (0.2); 0.2790 (0.2); 0.2710 |
| | | (0.2); 0.2638 (0.2); 0.2571 (0.1); 0.2488 (0.1); 0.2434 (0.1); 0.2350 (0.2); |
| | | 0.2279 (0.2); 0.2214 (0.2); 0.2137 (0.1); 0.2074 (0.1); 0.1989 (0.0); 0.0967 |
| | | (0.1); 0.0053 (0.5); −0.0001 (16.0); −0.0056 (0.5); −0.0137 (0.0); −0.1002 |
| | | (0.1); −0.1911 (0.1); −0.1991 (0.2); −0.2072 (0.2); −0.2152 (0.2); −0.2229 |
| | | (0.2); −0.2308 (0.1); −0.3782 (0.1); −0.3863 (0.2); −0.3939 (0.2); −0.4019 |
| | | (0.2); −0.4099 (0.2); −0.4182 (0.1) |
| I-85 | 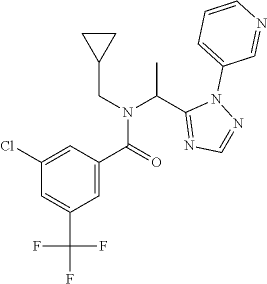 [SMILES: CC(c1ncnn1-c1cccnc1)N(CC1CC1)C(=O)c1cc(Cl)cc(C(F)(F)F)c1] | I-85: ¹H-NMR(600.1 MHz, CD3CN, 260 K): δ = 9.1281 (0.4); 8.8007 (4.9); 8.7966 (5.9); 8.7875 (1.3); 8.7470 (3.1); 8.7452 (3.4); 8.7391 (3.2); 8.7372 (3.3); 8.4859 (1.8); 8.4821 (1.8); 8.0911 (9.9); 8.0547 (3.4); 7.9830 (1.7); 7.9793 (2.2); 7.9768 (1.8); 7.9695 (1.8); 7.9657 (2.4); 7.9632 (1.9); 7.8777 (0.8); 7.7818 (4.9); 7.7654 (2.1); 7.7444 (0.9); 7.6957 (0.9); 7.6823 (1.1); 7.6017 (2.5); 7.5938 (2.5); 7.5883 (2.4); 7.5802 (2.3); 7.5182 (1.0); 7.5102 (1.0); 7.5048 (0.9); 7.4967 (0.8); 7.2427 (0.8); 7.1374 (4.8); 7.0499 (5.1); 6.9794 (0.4); 6.1390 (1.0); 6.1276 (3.2); 6.1162 (3.2); 6.1047 (1.0); 5.4720 (12.2); 5.0109 (0.4); 4.9998 (1.1); 4.9885 (1.1); 4.9773 (0.4); 4.3940 (0.6); 4.3825 (0.6); 3.6812 (0.3); 3.2867 (0.4); 3.2758 (0.5); 3.2724 (0.6); 3.2614 (0.6); 3.2488 (0.9); 3.2379 (0.9); 3.1883 (1.0); 3.1766 (1.0); 3.1647 (0.6); 3.1532 (0.6); 3.1086 (0.6); 3.0963 (0.4); 2.8682 (1.7); 2.8571 (1.7); 2.8419 (2.5); 2.8308 (2.5); 2.7433 (2.4); 2.7330 (2.5); 2.7170 (1.7); 2.7066 (1.6); 2.3803 (0.5); 2.2970 (6.4); 2.0800 (0.5); 2.0759 (0.9); 2.0718 (1.3); 2.0676 (0.9); 2.0635 (0.5); 1.9927 (0.4); 1.9886 (0.4); 1.9850 (1.5); 1.9770 (3.0); 1.9691 (71.8); 1.9650 (139.1); 1.9609 (203.9); 1.9568 (140.3); 1.9527 (73.0); 1.9458 (2.1); 1.8540 (0.4); 1.8499 (0.8); 1.8458 (1.2); 1.8417 (0.8); 1.8376 (0.4); 1.7676 (15.7); 1.7561 (16.0); |
| | | 1.5798 (2.2); 1.5685 (2.2); 1.5140 (0.6); 1.5024 (0.6); 1.1763 (0.5); 1.1642 |
| | | (1.0); 1.1520 (0.5); 0.8166 (0.4); 0.8053 (0.6); 0.7928 (0.4); 0.4816 (0.5); |
| | | 0.4749 (0.6); 0.4667 (0.8); 0.4593 (0.8); 0.4513 (0.7); 0.4439 (0.5); 0.4361 |
| | | (0.3); 0.4007 (0.4); 0.3923 (1.0); 0.3816 (1.5); 0.3709 (1.1); 0.3603 (0.8); |
| | | 0.3502 (0.6); 0.3447 (0.6); 0.3375 (0.7); 0.3304 (0.6); 0.3227 (0.9); 0.3148 |
| | | (1.0); 0.3071 (1.4); 0.2997 (1.7); 0.2912 (1.3); 0.2856 (1.2); 0.2771 (1.2); |
| | | 0.2699 (0.8); 0.2617 (0.8); 0.2538 (0.6); 0.2224 (0.8); 0.2132 (1.2); 0.2057 |
| | | (1.4); 0.1995 (1.7); 0.1920 (1.2); 0.1768 (0.6); 0.0589 (0.3); 0.0508 (0.4); |
| | | 0.0054 (1.5); −0.0001 (51.2); −0.0057 (1.6); −0.2038 (0.6); −0.2120 |
| | | (1.4); −0.2202 (1.9); −0.2282 (2.2); −0.2365 (1.8); −0.2446 (1.0); −0.2557 |
| | | (0.5); −0.4726 (0.6); −0.4808 (1.5); −0.4890 (2.0); −0.4971 (1.9); −0.5052 |
| | | (1.3); −0.5135 (0.5) |
| I-87 | 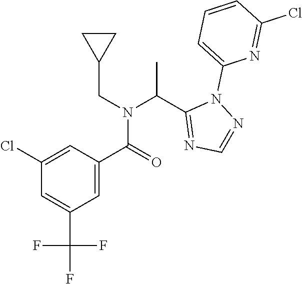 [SMILES: CC(c1ncnn1-c1cccc(Cl)n1)N(CC1CC1)C(=O)c1cc(Cl)cc(C(F)(F)F)c1] | I-87: ¹H-NMR(600.1 MHz, CD3CN, 260 K): δ = 8.0848 (10.8); 8.0554 (3.0); 8.0422 (6.4); 8.0279 (6.6); 7.9473 (1.4); 7.9343 (2.9); 7.9210 (1.6); 7.8538 (6.1); 7.8405 (5.4); 7.7924 (6.8); 7.6972 (2.8); 7.6840 (2.4); 7.5597 (3.5); 7.5261 (5.8); 7.5130 (5.5); 7.3819 (7.1); 7.3649 (2.8); 7.3518 (2.6); 7.2719 (14.2); 7.2592 (2.9); 6.2634 (1.3); 6.2520 (3.9); 6.2405 (3.9); 6.2292 (1.3); 6.0001 (0.6); 5.9890 (1.8); 5.9775 (1.8); 5.9663 (0.6); 5.4720 (11.2); 3.8403 (1.1); 3.8303 (1.2); 3.8166 (1.4); 3.8067 (1.4); 3.6173 (1.4); 3.6053 (1.5); 3.5935 (1.2); 3.5815 (1.2); 2.9421 (2.0); 2.9303 (2.1); 2.9159 (3.3); 2.9041 (3.3); 2.8389 (3.2); 2.8296 (3.2); 2.8128 (2.0); 2.8034 (2.0); 2.2904 (206.0); 2.0801 (0.6); 2.0760 (1.1); 2.0719 (1.6); 2.0678 (1.1); 2.0636 (0.6); 1.9852 (1.9); 1.9771 (3.8); 1.9692 (99.5); 1.9651 (192.9); 1.9610 (282.3); 1.9569 (194.6); 1.9528 (98.8); 1.9320 (0.4); 1.9231 (0.3); 1.8542 (0.7); 1.8500 (1.2); 1.8459 (1.8); 1.8418 (1.4); 1.8376 (1.1); 1.8266 (15.9); 1.8151 (16.0); 1.7402 (7.3); 1.7287 (7.2); 1.2607 (0.5); 1.2039 (0.9); 1.1925 (1.2); 1.1823 (1.0); 0.6035 (1.7); 0.5925 (2.1); 0.5822 (2.0); 0.5689 (1.5); 0.5606 (1.9); 0.5490 (2.4); 0.5366 (1.7); 0.5202 (0.6); 0.4072 (1.1); 0.3990 (2.1); 0.3905 (2.7); 0.3826 (2.0); 0.3186 (0.7); 0.3096 (1.1); 0.3034 (1.9); 0.2954 (2.6); 0.2882 (2.2); 0.2817 (1.7); 0.2733 (1.1); 0.2610 |
| | | (1.2); 0.2525 (1.8); 0.2456 (2.1); 0.2389 (2.5); 0.2314 (1.8); 0.2249 (1.1); |
| | | 0.2163 (0.6); 0.0053 (1.6); −0.0001 (55.4); −0.0057 (1.9); −0.1801 |
| | | (0.8); −0.1884 (1.8); −0.1962 (2.6); −0.2042 (2.8); −0.2119 (2.2); −0.2200 |
| | | (0.9); −0.3447 (0.9); −0.3528 (2.2); −0.3606 (2.8); −0.3685 (2.6); −0.3764 |
| | | (1.8); −0.3847 (0.7) |
| I-88 | 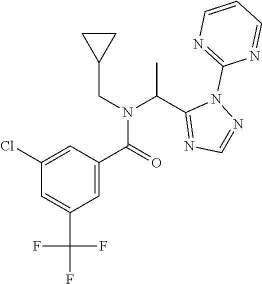 [SMILES: CC(c1ncnn1-c1ncccn1)N(CC1CC1)C(=O)c1cc(Cl)cc(C(F)(F)F)c1] | I-88: ¹H-NMR(600.1 MHz, CD3CN, 260 K): δ = 9.1974 (8.0); 9.0544 (3.6); 8.6639 (6.3); 8.6600 (6.6); 8.5584 (2.8); 8.5548 (2.8); 8.4539 (5.9); 8.1486 (11.2); 8.0969 (4.4); 8.0181 (2.8); 7.7996 (6.3); 7.6174 (3.0); 7.4139 (2.9); 7.3559 (8.9); 7.2951 (7.0); 6.3651 (1.2); 6.3536 (3.9); 6.3420 (3.9); 6.3304 (1.2); 6.0666 (0.6); 6.0553 (1.7); 6.0437 (1.7); 6.0323 (0.6); 5.4721 (0.6); 3.7027 (0.9); 3.6920 (1.0); 3.6792 (1.4); 3.6683 (1.4); 3.5762 (1.4); 3.5646 (1.4); 3.5525 (1.0); 3.5410 (1.0); 2.9257 (1.8); 2.9141 (1.8); 2.8995 (3.4); 2.8878 (3.5); 2.8470 (3.3); 2.8375 (3.4); 2.8207 (1.8); 2.8112 (1.7); 2.2990 (0.8); 2.2915 (138.7); 2.0803 (0.4); 2.0762 (0.7); 2.0721 (1.0); 2.0679 (0.7); 2.0638 (0.4); 1.9853 (1.2); 1.9773 (2.4); 1.9694 (61.2); 1.9653 (118.2); 1.9612 (172.4); 1.9571 (117.8); 1.9529 (59.0); 1.9447 (0.6); 1.8543 (0.4); 1.8502 (0.7); 1.8461 (1.0); 1.8420 (0.7); 1.8379 (0.4); 1.8107 (15.9); 1.7990 (16.0); 1.7599 (6.8); 1.7484 (6.6); 1.5800 (0.3); 1.5686 (0.3); 1.0982 (0.4); 1.0894 (0.7); 1.0789 (1.0); 1.0680 (0.8); 0.5685 (0.6); 0.5558 (1.5); 0.5461 (1.9); 0.5349 (1.6); 0.5256 (0.9); 0.5106 (0.9); 0.5023 (1.1); 0.4960 (1.3); 0.4883 (1.4); 0.4820 (1.5); 0.4745 (1.3); 0.4678 (1.2); 0.4602 (0.9); 0.3593 (0.4); 0.3514 (0.8); 0.3437 (1.1); 0.3359 (1.3); 0.3296 (1.0); 0.3221 (0.5); 0.2968 (0.7); 0.2877 (1.2); 0.2816 (2.3); 0.2740 |
| | | (3.4); 0.2674 (3.0); 0.2600 (2.5); 0.2516 (1.6); 0.2352 (1.1); 0.2266 (1.6); |
| | | 0.2194 (1.8); 0.2129 (2.2); 0.2054 (1.7); 0.1990 (1.0); 0.1902 (0.6); 0.0054 |
| | | (0.8); −0.0001 (25.8); −0.0057 (0.8); −0.1811 (0.8); −0.1895 (1.8); −0.1974 |
| | | (2.5); −0.2055 (2.7); −0.2133 (2.0); −0.2216 (0.8); −0.4061 (0.8); −0.4143 |
| | | (2.0); −0.4222 (2.6); −0.4302 (2.5); −0.4383 (1.7); −0.4466 (0.7) |
| I-89 | 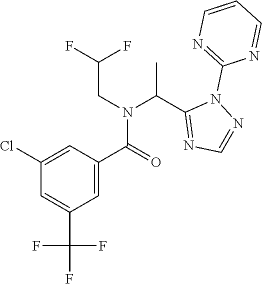 [SMILES: CC(c1ncnn1-c1ncccn1)N(CC(F)F)C(=O)c1cc(Cl)cc(C(F)(F)F)c1] | I-89: ¹H-NMR(600.1 MHz, CD3CN, 260 K): δ = 8.8822 (1.8); 8.8744 (1.8); 8.8652 (0.4); 8.5660 (15.8); 8.5579 (16.0); 8.0977 (1.5); 8.0553 (13.9); 7.8281 (1.2); 7.6512 (7.6); 7.5182 (0.8); 7.5100 (2.1); 7.4439 (8.9); 7.4069 (7.1); 7.3765 (4.4); 7.3685 (8.4); 7.3604 (4.2); 6.4498 (0.6); 6.4384 (0.6); 6.3354 (0.9); 6.3304 (1.0); 6.3260 (1.0); 6.3210 (0.8); 6.2505 (1.5); 6.2390 (6.0); 6.2277 (5.8); 6.2160 (1.5); 6.1464 (0.9); 6.1414 (1.0); 6.1369 (1.0); 6.1318 (0.9); 5.9532 (0.4); 5.4722 (2.3); 4.2714 (0.5); 4.2617 (0.6); 4.2513 (1.3); 4.2468 (1.2); 4.2417 (1.4); 4.2372 (1.3); 4.2268 (2.0); 4.2171 (2.0); 4.2067 (1.0); 4.1970 (0.9); 4.1780 (1.0); 4.1732 (1.1); 4.1648 (1.1); 4.1599 (1.1); 4.1536 (0.7); 4.1486 (0.7); 4.1386 (1.5); 4.1340 (1.5); 4.1250 (1.1); 4.1201 (1.1); 4.1138 (0.8); 4.1089 (0.8); 4.1004 (0.7); 4.0955 (0.6); 3.0210 (1.2); 2.8923 (1.4); 2.2944 (170.1); 2.0801 (0.4); 2.0761 (0.6); 2.0720 (1.0); 2.0679 (0.6); 1.9853 (1.0); 1.9772 (2.3); 1.9693 (61.3); 1.9652 (118.1); 1.9611 (170.7); 1.9570 (117.3); 1.9529 (59.1); 1.9441 (1.1); 1.9386 (0.5); 1.9341 (0.4); 1.8542 (0.4); 1.8501 (0.7); 1.8460 (1.0); 1.8419 (0.7); 1.8378 (0.4); 1.7547 (2.3); 1.7431 (2.4); 1.7107 (15.8); 1.6992 (15.7); 0.0053 (0.6); −0.0001 (17.0); −0.0057 (0.5) |
| I-90 | 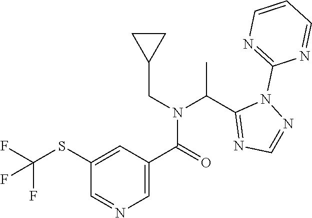 [SMILES: CC(c1ncnn1-c1ncccn1)N(CC1CC1)C(=O)c1cncc(SC(F)(F)F)c1] | I-90: ¹H-NMR(600.1 MHz, CD3CN, 260 K): δ = 8.8792 (0.6); 8.8701 (2.6); 8.8617 (2.5); 8.8568 (1.6); 8.7890 (0.5); 8.5859 (0.6); 8.5781 (0.6); 8.5514 (0.4); 8.4626 (1.5); 8.0961 (2.1); 8.0486 (0.6); 8.0421 (0.5); 7.9705 (0.4); 7.8320 (1.4); 7.5115 (0.7); 7.5035 (1.3); 7.4956 (0.6); 6.4358 (0.8); 6.4242 (0.8); 3.6710 (0.7); 3.6650 (0.8); 3.6603 (1.0); 3.6542 (1.1); 3.6495 (0.8); 3.6434 (0.8); 3.1635 (0.4); 3.1514 (1.2); 3.1450 (1.3); 3.1392 (1.2); 3.1328 (1.2); 3.1206 (0.4); 2.9125 (0.8); 2.9000 (1.2); 2.8878 (0.8); 2.7268 (10.0); 2.3012 (69.7); 2.0794 (0.5); 2.0760 (0.4); 2.0718 (0.4); 2.0677 (0.3); 1.9850 (0.7); 1.9690 (28.0); 1.9649 (53.2); 1.9609 (75.7); 1.9569 (54.4); 1.9528 (28.3); 1.9354 (1.7); 1.8458 (0.4); 1.8126 (3.0); 1.8010 (3.0); 1.7622 (0.8); 1.7510 (0.8); 1.6789 (0.8); 1.6679 (0.8); 1.3185 (2.9); 1.3097 (9.1); 1.3065 (8.9); 1.2999 (16.0); 1.2896 (8.8); 1.2663 (1.6); 1.2554 (1.5); 0.5387 (0.4); 0.5280 (0.4); 0.2536 (0.4); 0.2456 (0.5); 0.2388 (0.4); 0.2321 (0.3); 0.2038 (0.4); 0.1961 (0.4); 0.1901 (0.5); 0.1821 (0.4); |
| | | 0.1756 (0.3); −0.0001 (0.7); −0.2606 (0.4); −0.2687 (0.5); −0.2767 |
| | | (0.5); −0.2842 (0.4); −0.4692 (0.4); −0.4771 (0.5); −0.4851 (0.5); −0.4930 (0.4) |
| I-91 | 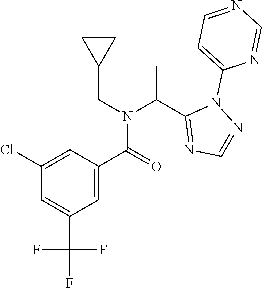 [SMILES: CC(c1ncnn1-c1ccncn1)N(CC1CC1)C(=O)c1cc(Cl)cc(C(F)(F)F)c1] | I-91: ¹H-NMR(600.1 MHz, CD3CN, 260 K): δ = 9.6774 (0.1); 9.5523 (0.1); 9.5226 (5.9); 9.5196 (5.9); 9.4085 (5.2); 9.3991 (5.2); 9.2716 (0.3); 9.2617 (0.5); 9.2549 (0.6); 9.1780 (0.6); 8.3512 (0.1); 8.2359 (0.5); 8.2089 (0.4); 8.1952 (0.6); 8.1799 (11.0); 8.1624 (0.4); 8.1348 (0.8); 8.0561 (0.3); 8.0023 (0.1); 7.9675 (0.5); 7.9411 (0.1); 7.8768 (0.1); 7.8503 (3.8); 7.8459 (3.8); 7.8410 (3.7); 7.8366 (3.4); 7.8014 (6.8); 7.7701 (0.1); 7.7467 (0.8); 7.7143 (0.2); 7.6781 (0.1); 7.6637 (0.2); 7.6542 (0.1); 7.6393 (0.1); 7.6205 (0.2); 7.4912 (0.4); 7.3846 (0.5); 7.3433 (0.1); 7.2338 (0.5); 7.2054 (7.1); 7.1717 (7.3); 6.4480 (0.1); 6.2986 (1.3); 6.2873 (4.0); 6.2760 (4.0); 6.2647 (1.3); 6.1572 (0.1); 5.8738 (0.1); 5.6478 (0.0); 5.6282 (0.1); 5.6226 (0.1); 5.3526 (0.1); 5.1732 (0.4); 5.1625 (0.4); 5.1529 (0.1); 4.4075 (0.1); 4.3957 (0.1); 4.3833 (0.1); 4.2789 (0.1); 4.2672 (0.1); 3.4000 (0.2); 3.3888 (0.2); 3.3761 (0.3); 3.3655 (0.3); 3.3034 (0.3); 3.2930 (0.3); 3.2800 (0.2); 3.2691 (0.2); 3.2151 (0.1); 3.2043 (0.1); 3.1899 (0.1); 3.1798 (0.1); 3.1183 (0.2); 3.1076 (0.2); 3.0323 (0.1); 3.0207 (0.1); 3.0070 (0.1); 2.9955 (0.1); 2.9135 (0.2); 2.8872 (9.8); 2.8767 (10.0); 2.8513 (0.1); 2.7699 (0.1); 2.7584 (0.1); 2.5449 (0.1); 2.5333 (0.1); 2.5137 (0.1); 2.4108 (0.2); 2.2985 (10.5); 2.1218 (0.1); 2.1126 (0.2); 2.1001 (0.3); 2.0871 (0.2); |
| | | 2.0759 (0.6); 2.0719 (0.8); 2.0678 (0.6); 2.0637 (0.4); 2.0459 (0.1); 2.0406 |
| | | (0.1); 2.0360 (0.1); 2.0322 (0.2); 2.0278 (0.2); 2.0200 (0.2); 2.0107 (0.2); |
| | | 1.9852 (1.1); 1.9686 (48.9); 1.9651 (91.5); 1.9611 (130.7); 1.9570 (90.4); |
| | | 1.9529 (45.9); 1.9329 (0.2); 1.9288 (0.2); 1.9171 (0.1); 1.9051 (0.1); 1.8962 |
| | | (0.1); 1.8920 (0.1); 1.8793 (0.2); 1.8749 (0.1); 1.8708 (0.1); 1.8500 (0.6); |
| | | 1.8460 (0.8); 1.8419 (0.6); 1.8378 (0.3); 1.8202 (1.4); 1.8093 (1.5); 1.7747 |
| | | (16.0); 1.7634 (15.8); 1.6651 (0.1); 1.6529 (0.1); 1.5800 (0.2); 1.5688 (0.2); |
| | | 1.5514 (0.4); 1.5398 (0.5); 1.5146 (0.5); 1.5029 (0.5); 1.4855 (0.1); 1.4737 |
| | | (0.1); 1.4049 (0.2); 1.3935 (0.2); 1.3761 (0.1); 1.3411 (0.1); 1.3085 (0.2); |
| | | 1.2607 (1.8); 0.9809 (0.1); 0.9703 (0.1); 0.9580 (0.1); 0.9440 (0.1); 0.9323 |
| | | (0.1); 0.8929 (0.3); 0.8819 (0.6); 0.8699 (0.4); 0.8616 (0.3); 0.5243 (0.1); |
| | | 0.5091 (0.2); 0.4919 (0.2); 0.4745 (0.3); 0.4697 (0.4); 0.4630 (0.4); 0.4556 |
| | | (0.4); 0.3720 (0.3); 0.3648 (0.3); 0.3402 (0.2); 0.3182 (1.4); 0.3086 (2.1); |
| | | 0.2973 (1.8); 0.2871 (1.2); 0.2726 (1.2); 0.2643 (1.5); 0.2569 (2.2); 0.2493 |
| | | (2.5); 0.2418 (1.9); 0.2358 (1.2); 0.2267 (0.8); 0.1813 (1.0); 0.1725 (1.7); |
| | | 0.1651 (1.9); 0.1588 (2.3); 0.1514 (1.7); 0.1452 (1.1); 0.1359 (0.6); 0.1179 |
| | | (0.1); 0.1091 (0.1); 0.1014 (0.1); 0.0949 (0.1); 0.0879 (0.1); 0.0784 (0.1); |
| | | 0.0712 (0.1); 0.0640 (0.1); 0.0578 (0.1); 0.0503 (0.1); 0.0323 (0.1); 0.0249 |
| | | (0.1); 0.0194 (0.1); 0.0000 (1.3); −0.1040 (0.3); −0.1107 (0.3); −0.2384 |
| | | (0.8); −0.2464 (1.8); −0.2545 (2.6); −0.2623 (2.7); −0.2704 (2.0); −0.2786 |
| | | (0.8); −0.5476 (0.8); −0.5559 (2.1); −0.5640 (2.7); −0.5718 (2.6); −0.5800 |
| | | (1.8); −0.5883 (0.7) |
| I-92 | 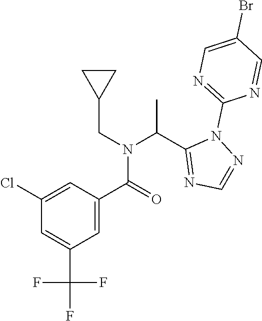 [SMILES: CC(c1ncnn1-c1ncc(Br)cn1)N(CC1CC1)C(=O)c1cc(Cl)cc(C(F)(F)F)c1] | I-92: ¹H-NMR(600.1 MHz, CD3CN, 260 K): δ = 8.9619 (16.0); 8.6793 (5.4); 8.0974 (7.9); 8.0441 (2.7); 7.8072 (5.4); 7.6737 (2.1); 7.4640 (2.1); 7.4152 (5.7); 7.3773 (2.1); 7.3512 (5.9); 6.3544 (1.0); 6.3429 (2.9); 6.3314 (3.0); 6.3200 (1.0); 6.0171 (0.4); 6.0061 (1.1); 5.9949 (1.1); 5.9840 (0.4); 3.6940 (0.6); 3.6838 (0.6); 3.6704 (0.9); 3.6600 (0.9); 3.5835 (0.9); 3.5718 (0.9); 3.5600 (0.6); 3.5483 (0.6); 2.9420 (1.2); 2.9306 (1.3); 2.9157 (2.7); 2.9044 (2.7); 2.8738 (2.7); 2.8644 (2.7); 2.8476 (1.3); 2.8381 (1.2); 2.2901 (113.3); 2.0737 (0.5); 2.0696 (0.7); 2.0656 (0.5); 1.9829 (1.6); 1.9669 (44.5); 1.9628 (84.3); 1.9588 (120.9); 1.9547 (84.9); 1.9507 (43.5); 1.8477 (0.5); 1.8437 (0.7); 1.8397 (0.5); 1.7942 (11.6); 1.7827 (11.9); 1.7537 (4.5); 1.7425 (4.2); 1.0649 (0.8); 0.5459 (1.4); 0.5361 (1.8); 0.5257 (1.5); 0.5141 (0.9); 0.5040 (0.8); 0.4962 (0.9); 0.4901 (1.0); 0.4823 (1.1); 0.4769 (1.1); 0.4688 (1.0); 0.4628 (0.9); 0.3511 (0.6); 0.3433 (0.8); 0.3357 (1.0); 0.2728 (2.4); 0.2653 (2.8); 0.2588 (2.3); 0.2436 (0.9); 0.2256 (0.8); 0.2168 (1.5); 0.2102 (1.7); 0.2035 (2.0); 0.1957 (1.4); 0.1808 (0.5); −0.0025 (1.1); −0.1969 (0.6); −0.2050 (1.5); −0.2130 (2.1); −0.2208 (2.2); −0.2286 (1.6); −0.2367 (0.6); −0.4033 (0.7); −0.4114 (1.7); −0.4192 (2.2); −0.4270 (2.0); −0.4350 (1.4); −0.4431 (0.6) |
| I-93 | 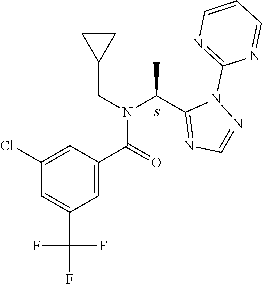 | I-93: ¹H-NMR(400.2 MHz, CD3CN): δ = 8.8330 (1.8); 8.8131 (1.6); 8.7085 (0.7); 8.6981 (0.7); 8.6023 (0.4); 8.0349 (9.9); 7.7136 (1.9); 7.4610 (2.5); 7.3529 (15.6); 7.3005 (2.0); 6.4423 (0.4); 6.3789 (0.8); 6.3269 (0.5); 5.4487 (16.0); 4.6853 (0.3); 3.5638 (0.3); 3.5128 (0.3); 3.5062 (0.3); 2.9477 (0.9); 2.9340 (0.9); 2.8950 (0.9); 2.8754 (0.9); 2.8725 (0.9); 2.8678 (0.9); 2.5095 (0.4); 2.4330 (0.4); 2.1516 (34.4); 2.1091 (0.3); 1.9658 (0.8); 1.9540 (18.2); 1.9479 (34.4); 1.9417 (48.0); 1.9355 (33.0); 1.9294 (16.7); 1.7934 (12.2); 1.7774 (12.4); 1.2693 (0.6); 0.5524 (0.8); 0.5450 (0.8); 0.5052 (0.8); 0.4990 (0.7); 0.3085 (2.3); 0.1644 (0.5); 0.1468 (0.4); −0.0002 (16.9); −0.0083 (0.8); −0.1501 (0.6); −0.1904 (0.8); −0.2027 (0.8); −0.2066 (0.8); −0.3005 (0.5); −0.3045 (0.5); −0.3555 (0.8); −0.3670 (0.8); −0.3775 (0.8) |
| I-94 | 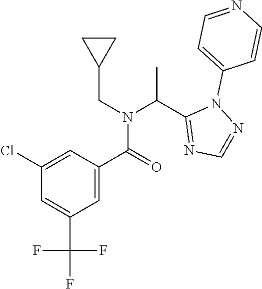 [SMILES: CC(c1ncnn1-c1ccncc1)N(CC1CC1)C(=O)c1cc(Cl)cc(C(F)(F)F)c1] | I-94: ¹H-NMR(600.1 MHz, CD3CN, 260 K): δ = 8.7765 (8.3); 8.7669 (8.5); 8.6499 (1.7); 8.6414 (1.7); 8.1038 (10.3); 8.0566 (1.7); 7.8500 (3.6); 7.8350 (1.4); 7.7796 (6.2); 7.7396 (4.9); 7.7138 (3.9); 7.6806 (1.2); 7.6509 (1.3); 7.6035 (8.8); 7.5938 (8.7); 7.3197 (0.8); 7.2439 (1.8); 7.2357 (1.8); 7.0844 (0.6); 7.0561 (6.2); 7.0071 (6.4); 6.4437 (1.6); 6.2446 (0.6); 6.2328 (1.4); 6.2214 (3.7); 6.2101 (3.7); 6.1988 (1.2); 5.9772 (0.6); 5.8652 (1.6); 5.1571 (0.7); 5.1457 (0.7); 4.4188 (0.6); 4.4072 (1.8); 4.3955 (1.9); 4.3839 (0.6); 4.2076 (0.6); 4.1959 (0.6); 4.0683 (0.8); 4.0563 (2.4); 4.0444 (2.4); 4.0325 (0.8); 3.5836 (0.4); 3.5736 (0.4); 3.5604 (0.4); 3.5503 (0.4); 3.3485 (0.3); 3.3360 (0.6); 3.3247 (0.6); 3.2911 (0.6); 3.2796 (0.6); 3.2677 (0.3); 3.1174 (4.4); 3.1063 (4.4); 2.9473 (0.4); 2.9354 (0.5); 2.9238 (0.4); 2.9123 (0.4); 2.8441 (1.9); 2.8329 (1.9); 2.8178 (3.0); 2.8064 (3.0); 2.7323 (2.8); 2.7224 (2.9); 2.7059 (1.8); 2.6960 (1.8); 2.2927 (284.8); 2.2600 (0.4); 2.0797 (0.7); 2.0757 (1.2); 2.0716 (1.7); 2.0676 (1.2); 2.0636 (0.7); 2.0017 (0.4); 1.9840 (12.1); 1.9765 (5.7); 1.9688 (104.8); 1.9648 (199.4); 1.9608 (287.4); 1.9568 (202.8); 1.9527 (104.6); 1.8538 (0.6); 1.8497 (1.1); 1.8457 (1.6); 1.8416 (1.1); 1.8375 (0.6); 1.7943 (3.0); 1.7780 (16.0); 1.7666 (15.0); 1.5675 (0.4); 1.5553 (0.3); 1.5140 (8.5); 1.5023 (8.4); |
| | | 1.4053 (2.5); 1.3935 (2.5); 1.3408 (1.1); 1.2827 (1.4); 1.2616 (1.0); 1.2176 |
| | | (2.6); 1.2057 (5.1); 1.1938 (2.6); 1.1606 (0.4); 1.1497 (0.4); 0.9524 (0.9); |
| | | 0.9421 (1.2); 0.9314 (0.9); 0.9217 (0.5); 0.9081 (0.4); 0.8363 (0.6); 0.5227 |
| | | (1.2); 0.5095 (1.2); 0.4955 (0.6); 0.4885 (1.0); 0.4814 (1.6); 0.4746 (1.7); |
| | | 0.4647 (2.1); 0.4569 (1.9); 0.4500 (1.7); 0.4434 (1.1); 0.4358 (0.6); 0.4278 |
| | | (0.3); 0.3886 (0.3); 0.3674 (2.2); 0.3577 (2.7); 0.3470 (1.9); 0.3374 (1.0); |
| | | 0.2904 (1.1); 0.2818 (2.0); 0.2750 (2.8); 0.2675 (3.2); 0.2598 (2.4); 0.2449 |
| | | (0.8); 0.1944 (0.9); 0.1853 (1.6); 0.1782 (1.8); 0.1717 (2.2); 0.1640 (1.6); |
| | | 0.1492 (0.6); 0.0846 (0.4); 0.0779 (0.9); 0.0696 (1.1); 0.0616 (1.5); 0.0554 |
| | | (1.4); 0.0313 (1.4); 0.0250 (1.5); 0.0172 (1.1); 0.0089 (0.7); −0.0001 |
| | | (3.0); −0.1117 (0.4); −0.1198 (0.6); −0.1270 (0.5); −0.1347 (0.4); −0.2295 |
| | | (0.7); −0.2377 (1.7); −0.2458 (2.4); −0.2536 (2.5); −0.2619 (1.8); −0.2699 |
| | | (0.7); −0.4909 (0.8); −0.4992 (1.9); −0.5075 (2.5); −0.5152 (2.3); −0.5234 |
| | | (1.7); −0.5317 (0.6) |
| I-95 | 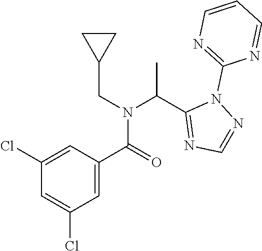 [SMILES: CC(c1ncnn1-c1ncccn1)N(CC1CC1)C(=O)c1cc(Cl)cc(Cl)c1] | I-95: ¹H-NMR(600.1 MHz, CD3CN, 260 K): δ = 8.8758 (10.0); 8.8680 (10.4); 8.6541 (5.3); 8.6465 (5.4); 8.0817 (9.0); 8.0427 (0.6); 8.0298 (4.6); 7.5206 (8.8); 7.5169 (9.6); 7.5077 (3.2); 7.4749 (0.3); 7.4633 (0.4); 7.4371 (1.6); 7.4295 (2.9); 7.4218 (1.6); 7.3325 (3.6); 7.0643 (7.5); 7.0108 (16.0); 6.3622 (1.2); 6.3507 (3.6); 6.3392 (3.7); 6.3278 (1.3); 6.1220 (0.7); 6.1111 (1.9); 6.0996 (2.0); 6.0886 (0.7); 5.4728 (1.7); 3.6748 (1.1); 3.6643 (1.1); 3.6512 (1.6); 3.6409 (1.6); 3.5470 (1.5); 3.5352 (1.6); 3.5234 (1.2); 3.5115 (1.1); 2.9310 (1.9); 2.9195 (1.9); 2.9049 (3.1); 2.8934 (3.1); 2.8252 (3.0); 2.8156 (3.1); 2.7990 (1.9); 2.7896 (1.9); 2.3005 (67.8); 2.0735 (0.4); 1.9847 (1.0); 1.9666 (43.1); 1.9626 (65.8); 1.9603 (62.7); 1.8476 (0.5); 1.7969 (14.6); 1.7854 (14.9); 1.7547 (7.8); 1.7433 (7.5); 1.5843 (0.4); 1.5735 (0.4); 1.3407 (0.4); 1.2820 (0.8); 1.2593 (1.6); 1.2060 (0.4); 1.0541 (1.0); 1.0446 (1.3); 1.0347 (1.0); 0.8812 (0.4); 0.5707 (1.8); 0.5608 (2.3); 0.5506 (1.8); 0.4867 (1.5); 0.4818 (1.6); 0.4738 (1.9); 0.4691 (2.0); 0.4621 (1.6); 0.4553 (1.5); 0.3396 (1.0); 0.3315 (1.4); 0.3241 (1.7); 0.3184 (1.5); 0.3112 (1.3); 0.2954 (2.2); 0.2875 (2.9); 0.2799 (2.9); 0.2729 |
| | | (2.9); 0.2650 (2.7); 0.2561 (2.5); 0.2476 (2.8); 0.2407 (2.6); 0.2344 (2.6); |
| | | 0.2264 (1.9); 0.2116 (0.6); 0.0969 (2.6); 0.0790 (0.3); 0.0524 (0.4); 0.0453 |
| | | (0.4); 0.0360 (0.4); 0.0277 (0.4); −0.0001 (444.1); −0.0247 (0.6); −0.1001 |
| | | (2.5); −0.1543 (0.8); −0.1617 (2.0); −0.1698 (2.7); −0.1774 (2.8); −0.1851 |
| | | (2.1); −0.1929 (0.8); −0.3478 (0.9); −0.3550 (2.1); −0.3628 (2.7); −0.3705 |
| | | (2.6); −0.3785 (1.8); −0.3863 (0.7) |
| I-96 | 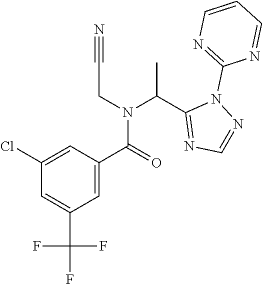 [SMILES: CC(c1ncnn1-c1ncccn1)N(CC#N)C(=O)c1cc(Cl)cc(C(F)(F)F)c1] | I-96: ¹H-NMR(400.6 MHz, CD3CN 260 K): δ = 8.8526 (3.2); 8.8405 (3.3); 8.5537 (15.3); 8.5415 (15.7); 8.1219 (3.0); 8.0956 (12.2); 7.9114 (1.5); 7.7098 (5.1); 7.6722 (1.6); 7.6377 (1.6); 7.5161 (5.4); 7.4944 (6.0); 7.4804 (1.0); 7.3803 (4.2); 7.3682 (8.0); 7.3560 (4.0); 6.4902 (0.9); 6.4727 (0.9); 6.3170 (1.1); 6.2999 (3.8); 6.2827 (3.8); 6.2654 (1.1); 5.4706 (0.9); 4.8970 (5.4); 4.8535 (8.4); 4.7061 (8.1); 4.6626 (5.3); 4.3090 (0.8); 4.2616 (1.8); 4.1998 (1.9); 4.1525 (0.8); 2.3464 (2.0); 2.3400 (0.6); 2.3394 (0.6); 2.3376 (0.7); 2.3371 (0.7); 2.3361 (0.6); 2.3337 (1.0); 2.3330 (1.0); 2.3322 (1.0); 2.3313 (1.1); 2.3290 (1.6); 2.3281 (1.7); 2.3184 (373.2); 2.3065 (1.8); 2.3015 (0.8); 2.3009 (0.8); 2.2984 (0.5); 2.2946 (0.7); 2.2872 (0.7); 2.2833 (0.6); 2.2802 (0.6); 1.9878 (0.3); 1.9816 (0.4); 1.9776 (0.6); 1.9721 (17.3); 1.9659 (35.1); 1.9597 (51.3); 1.9536 (35.1); 1.9474 (17.5); 1.7884 (0.4); 1.7822 (0.4); 1.7632 (15.7); 1.7460 (16.0); 1.7352 (4.3); 1.7175 (3.7) |
| I-97 | 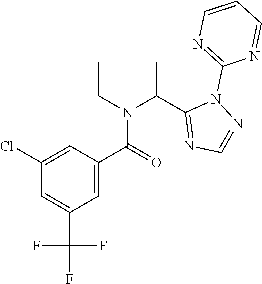 [SMILES: CCN(C(=O)c1cc(Cl)cc(C(F)(F)F)c1)C(C)c1ncnn1-c1ncccn1] | I-97: ¹H-NMR(600.1 MHz, CD3CN, 260 K): δ = 8.8818 (11.6); 8.8738 (11.8); 8.5688 (8.8); 8.5607 (9.0); 8.2371 (0.9); 8.1920 (0.9); 8.0988 (10.4); 8.0563 (7.7); 8.0127 (0.8); 7.8060 (5.3); 7.6260 (4.1); 7.5175 (3.2); 7.5095 (6.2); 7.5014 (3.1); 7.4447 (5.6); 7.4097 (4.0); 7.3838 (2.5); 7.3757 (4.7); 7.3676 (2.4); 7.3492 (7.5); 6.4697 (1.0); 6.4580 (3.4); 6.4464 (3.5); 6.4347 (1.1); 6.1085 (0.8); 6.0971 (2.7); 6.0856 (2.7); 6.0740 (0.8); 5.4733 (3.0); 3.8466 (0.9); 3.8350 (1.5); 3.8236 (2.3); 3.8119 (2.0); 3.7993 (1.0); 3.7866 (2.0); 3.7749 (2.3); 3.7635 (1.5); 3.7519 (0.9); 3.2364 (0.5); 3.2245 (1.6); 3.2124 (1.9); 3.1986 (2.3); 3.1865 (2.0); 3.1748 (0.6); 3.0775 (0.8); 3.0377 (0.9); 3.0335 (0.6); 3.0216 (2.0); 3.0094 (2.2); 2.9957 (1.9); 2.9835 (1.5); 2.9716 (0.6); 2.9559 (0.8); 2.9466 (0.8); 2.3066 (10.0); 2.0984 (28.7); 2.0731 (0.4); 1.9849 (1.7); 1.9783 (1.1); 1.9705 (21.5); 1.9664 (40.8); 1.9623 (59.1); 1.9582 (40.5); 1.9541 (20.4); 1.8472 (0.3); 1.7323 (12.8); 1.7276 (16.0); 1.7208 (13.0); 1.7159 (15.4); 1.2181 (0.4); 1.2062 (0.7); 1.1942 (0.4); 1.1656 (5.8); 1.1539 (11.9); 1.1421 (5.6); 0.6464 (7.3); 0.6345 (15.2); 0.6226 (7.0); −0.0001 (0.4) |
| I-98 | 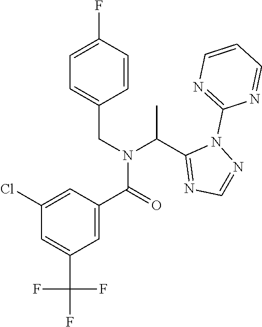 [SMILES: CC(c1ncnn1-c1ncccn1)N(Cc1ccc(F)cc1)C(=O)c1cc(Cl)cc(C(F)(F)F)c1] | I-98: ¹H-NMR(600.1 MHz, CD3CN, 260 K): δ = 8.9237 (1.6); 8.9156 (1.7); 8.9027 (10.8); 8.8947 (10.9); 8.5986 (14.1); 8.5905 (14.2); 8.0726 (1.2); 7.9858 (11.7); 7.9605 (9.6); 7.6858 (5.5); 7.6687 (6.7); 7.5598 (6.0); 7.5326 (8.5); 7.5245 (6.4); 7.5165 (3.0); 7.4081 (5.8); 7.3954 (3.9); 7.3874 (7.4); 7.3793 (3.7); 7.2986 (6.3); 7.2896 (4.2); 7.2798 (5.3); 7.2760 (5.4); 7.2666 (4.3); 7.0370 (5.0); 7.0224 (9.1); 7.0077 (4.4); 6.9065 (2.7); 6.8965 (4.0); 6.8924 (5.0); 6.8833 (4.3); 6.8535 (4.8); 6.8388 (7.4); 6.8242 (2.8); 6.6716 (1.0); 6.6600 (3.2); 6.6484 (3.3); 6.6368 (1.0); 6.2935 (0.5); 6.2822 (0.5); 6.2356 (1.3); 6.2242 (4.2); 6.2127 (4.2); 6.2013 (1.3); 5.4727 (5.8); 5.0672 (1.3); 5.0405 (7.5); 5.0291 (6.5); 5.0024 (1.2); 4.5177 (2.2); 4.4889 (4.9); 4.4437 (4.6); 4.4149 (2.1); 2.3000 (38.1); 2.2022 (0.3); 2.0980 (80.7); 2.0766 (0.5); 2.0725 (0.6); 2.0684 (0.4); 1.9900 (0.5); 1.9845 (1.9); 1.9802 (3.2); 1.9780 (2.0); 1.9698 (41.0); 1.9657 (74.5); 1.9616 (105.3); 1.9575 (71.6); 1.9534 (35.5); 1.9449 (0.4); 1.8507 (0.4); 1.8466 (0.6); 1.8425 (0.4); 1.6711 (12.5); 1.6595 (12.6); 1.6358 (16.0); 1.6244 (15.8); 1.2178 (0.3); 1.2059 (0.6); −0.0001 (0.8) |
| I-99 | 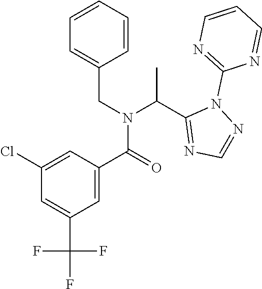 [SMILES: CC(c1ncnn1-c1ncccn1)N(Cc1ccccc1)C(=O)c1cc(Cl)cc(C(F)(F)F)c1] | I-99: ¹H-NMR(600.1 MHz, CD3CN, 260 K): δ = 8.9048 (8.1); 8.8967 (8.1); 8.5988 (9.0); 8.5907 (9.0); 7.9962 (7.7); 7.9547 (7.3); 7.6703 (4.6); 7.6470 (5.0); 7.5322 (6.7); 7.5241 (5.0); 7.5152 (4.6); 7.3995 (5.0); 7.3918 (2.8); 7.3837 (4.8); 7.3756 (2.5); 7.3490 (0.6); 7.3364 (0.9); 7.3133 (5.9); 7.3046 (6.0); 7.2935 (16.0); 7.2808 (2.7); 7.2651 (0.7); 7.2581 (0.6); 7.2383 (1.8); 7.2275 (2.4); 7.2168 (1.0); 7.1347 (0.4); 7.1183 (5.7); 7.1120 (8.7); 7.1094 (8.3); 6.9290 (4.0); 6.9240 (4.3); 6.9171 (3.8); 6.6810 (0.8); 6.6694 (2.6); 6.6578 (2.6); 6.6462 (0.8); 6.2700 (0.9); 6.2586 (2.9); 6.2471 (2.9); 6.2358 (0.9); 5.1325 (1.8); 5.1054 (4.7); 5.0727 (5.2); 5.0457 (2.0); 4.5519 (2.0); 4.5227 (4.4); 4.4780 (4.3); 4.4489 (1.9); 4.3149 (0.8); 4.3047 (0.8); 4.0682 (1.6); 4.0564 (4.8); 4.0445 (4.9); 4.0326 (1.6); 2.2958 (129.4); 2.0757 (0.5); 2.0718 (0.7); 2.0677 (0.5); 1.9841 (21.4); 1.9768 (2.7); 1.9689 (50.1); 1.9649 (92.2); 1.9609 (127.1); 1.9568 (86.9); 1.9528 (43.0); 1.9077 (3.1); 1.8498 (0.6); 1.8458 (0.8); 1.8417 (0.5); 1.6585 (10.0); 1.6468 (10.1); 1.6234 (11.2); 1.6120 (11.0); 1.2176 (5.4); 1.2057 (10.6); 1.1938 (5.2) |
| I-100 | 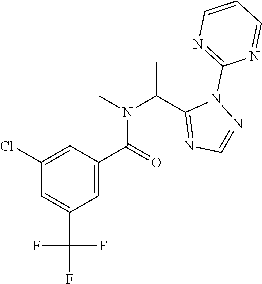 [SMILES: CC(c1ncnn1-c1ncccn1)N(C)C(=O)c1cc(Cl)cc(C(F)(F)F)c1] | I-100: ¹H-NMR(600.1 MHz, CD3CN, 260 K): δ = 8.8590 (5.5); 8.8509 (5.5); 8.5788 (1.7); 8.5707 (1.7); 8.0774 (4.6); 8.0600 (1.4); 7.8088 (2.5); 7.5825 (0.8); 7.4988 (1.5); 7.4907 (2.9); 7.4827 (1.5); 7.4532 (2.6); 7.3763 (2.9); 7.3660 (1.5); 7.3578 (0.5); 7.3166 (0.7); 6.4478 (0.5); 6.4362 (1.6); 6.4245 (1.6); 6.4130 (0.5); 6.1144 (0.5); 6.1030 (0.5); 3.2667 (5.1); 2.7118 (16.0); 2.2931 (94.6); 2.0976 (1.1); 2.0758 (0.5); 2.0717 (0.6); 2.0676 (0.4); 1.9851 (0.7); 1.9769 (1.9); 1.9691 (43.0); 1.9650 (79.1); 1.9609 (107.2); 1.9568 (72.5); 1.9527 (34.9); 1.9440 (0.5); 1.8499 (0.4); 1.8458 (0.6); 1.8417 (0.4); 1.6931 (6.7); 1.6816 (7.8); 1.6715 (2.2) |
| I-101 | 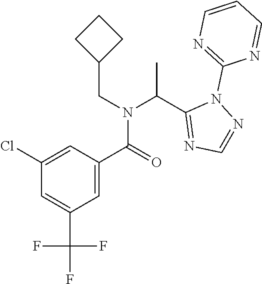 [SMILES: CC(c1ncnn1-c1ncccn1)N(CC1CCC1)C(=O)c1cc(Cl)cc(C(F)(F)F)c1] | I-101: ¹H-NMR(600.1 MHz, CD3CN, 260 K): δ = 8.8825 (9.5); 8.8746 (9.5); 8.5957 (5.2); 8.5878 (5.1); 8.2465 (1.5); 8.2033 (1.5); 8.0970 (8.6); 8.0507 (4.5); 8.0035 (1.3); 7.8187 (6.0); 7.6223 (3.4); 7.5266 (2.7); 7.5186 (5.0); 7.5106 (2.6); 7.4381 (0.4); 7.3902 (10.2); 7.3353 (3.2); 7.3126 (6.5); 6.3331 (1.1); 6.3216 (3.2); 6.3101 (3.2); 6.2985 (1.1); 6.0644 (0.6); 6.0533 (1.8); 6.0422 (1.8); 6.0307 (0.6); 5.4810 (0.6); 3.7936 (0.8); 3.7829 (0.9); 3.7704 (1.7); 3.7596 (1.7); 3.7305 (1.6); 3.7185 (1.7); 3.7074 (0.8); 3.6953 (0.8); 3.2369 (3.2); 3.2276 (2.0); 3.2151 (2.1); 3.2019 (2.4); 3.1895 (2.3); 3.1615 (0.4); 3.1314 (3.1); 2.9926 (0.3); 2.9024 (0.5); 2.8920 (2.3); 2.8817 (2.4); 2.8664 (2.0); 2.8560 (2.0); 2.6197 (0.5); 2.6077 (1.0); 2.5953 (1.3); 2.5833 (1.1); 2.5717 (0.5); 2.3058 (41.8); 2.2681 (3.3); 2.2550 (3.0); 2.2423 (2.2); 2.2293 (1.2); 2.2163 (0.5); 2.1064 (6.5); 2.0846 (1.4); 2.0806 (1.9); 2.0766 (1.5); 2.0725 (1.1); 2.0565 (1.3); 2.0518 (1.4); 2.0436 (1.3); 2.0319 (0.8); 2.0183 (0.6); 1.9939 (2.6); 1.9776 (110.8); 1.9737 (196.5); 1.9697 (256.1); 1.9657 (173.0); 1.9617 (83.2); 1.8628 (1.2); 1.8587 (1.5); 1.8546 (2.1); 1.8506 (2.1); 1.8333 (1.6); 1.8189 (1.5); 1.8056 (1.0); 1.7837 (0.7); 1.7727 (1.0); 1.7608 (2.2); 1.7503 (3.5); 1.7369 (3.3); 1.7235 (15.2); 1.7118 (16.0); 1.7047 (9.9); 1.6928 (8.3); 1.6778 (1.8); 1.6609 |
| | | (1.0); 1.6418 (1.3); 1.6271 (2.0); 1.6111 (2.0); 1.5961 (1.1); 1.4469 (0.7); |
| | | 1.4324 (1.8); 1.4162 (1.7); 1.4002 (0.6); 1.2712 (0.4); 1.2264 (0.8); 1.2110 |
| | | (2.2); 1.2025 (2.6); 1.1958 (3.0); 1.1874 (3.1); 1.1793 (2.1); 1.1722 (1.9); |
| | | 1.1579 (0.5) |
| I-102 | 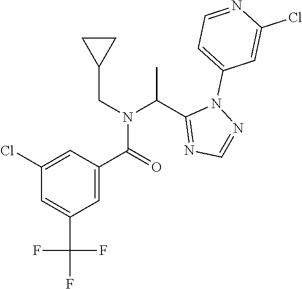 [SMILES: CC(c1ncnn1-c1ccnc(Cl)c1)N(CC1CC1)C(=O)c1cc(Cl)cc(C(F)(F)F)c1] | I-102: ¹H-NMR(600.1 MHz, CD3CN, 260 K): δ = 8.5824 (5.8); 8.5735 (6.0); 8.4478 (0.7); 8.4392 (0.7); 8.1224(11.1); 8.0690 (1.2); 7.8097 (7.0); 7.7715 (1.0); 7.6930 (8.2); 7.6213 (4.4); 7.6125 (4.4); 7.3835 (0.8); 7.3093 (1.1); 7.2469 (0.7); 7.2398 (0.7); 7.1983 (7.9); 7.1639 (7.5); 6.2517 (1.3); 6.2405 (4.0); 6.2292 (4.0); 6.2179 (1.3); 5.2149 (0.5); 5.2039 (0.5); 3.3548 (0.6); 3.3448 (1.0); 3.3354 (0.6); 2.8929 (1.7); 2.8816 (1.7); 2.8664 (3.6); 2.8551 (3.6); 2.8206 (3.4); 2.8107 (3.5); 2.7941 (1.7); 2.7843 (1.7); 2.2920 (134.3); 2.0742 (0.6); 2.0705 (0.8); 2.0665 (0.6); 1.9834 (1.0); 1.9636 (101.3); 1.9620 (98.0); 1.9596 (144.4); 1.9556 (102.4); 1.9516 (53.0); 1.8485 (0.6); 1.8445 (0.9); 1.8405 (0.7); 1.8365 (0.4); 1.8177 (2.0); 1.8065 (2.1); 1.7663 (16.0); 1.7550 (15.9); 1.5783 (0.4); 1.5669 (0.4); 1.4303 (8.3); 1.3394 (0.6); 1.3074 (0.3); 1.2812 (0.5); 1.2719 (0.4); 1.2597 (0.6); 0.8782 (0.4); 0.8670 (0.5); 0.4737 (0.3); 0.4672 (0.4); 0.4604 (0.4); 0.3863 (0.4); 0.3789 (0.4); 0.3720 (0.3); 0.3405 (1.5); 0.3301 (2.1); 0.3195 (1.8); 0.3092 (1.0); 0.2981 (0.6); 0.2806 (1.1); 0.2718 (1.5); 0.2651 (2.0); 0.2576 (2.5); 0.2498 (1.9); 0.2446 (1.3); 0.2350 (0.8); 0.1769 (0.9); 0.1677 (1.7); 0.1606 (1.9); 0.1543 (2.4); 0.1468 (1.7); 0.1315 (0.6); −0.0418 (0.4); −0.0487 (0.4); −0.2397 (0.8); −0.2478 (1.8); −0.2560 (2.6); −0.2638 |
| | | (2.7); −0.2719 (2.0); −0.2802 (0.8); −0.5218 (0.8); −0.5302 (2.1); −0.5383 |
| | | (2.7); −0.5461 (2.6); −0.5543 (1.8); −0.5626 (0.7) |
| I-103 | 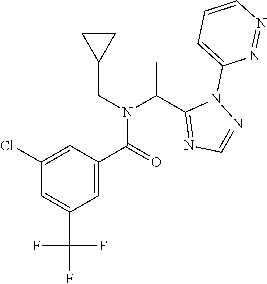 [SMILES: CC(c1ncnn1-c1cccnn1)N(CC1CC1)C(=O)c1cc(Cl)cc(C(F)(F)F)c1] | I-103: ¹H-NMR(600.1 MHz, CD3CN, 260 K): δ = 9.2720 (5.5); 9.2641 (5.6); 9.1835 (4.9); 9.1758 (4.9); 9.1292 (1.2); 8.1661 (10.9); 8.1367 (9.6); 8.1174 (5.2); 8.1027 (5.9); 8.0681 (4.7); 8.0534 (5.2); 7.9227 (0.4); 7.8997 (3.7); 7.8918 (3.8); 7.8850 (3.6); 7.8770 (5.1); 7.8500 (0.7); 7.8323 (3.5); 7.8243 (3.5); 7.8177 (3.1); 7.8096 (2.9); 7.7914 (7.8); 7.7811 (8.3); 7.7639 (8.1); 7.7456 (2.4); 7.7152 (0.7); 7.6882 (7.2); 7.4661 (8.4); 7.3567 (8.9); 6.2874 (1.4); 6.2759 (4.4); 6.2643 (4.5); 6.2528 (1.6); 5.8559 (1.4); 5.8444 (4.0); 5.8330 (4.0); 5.8217 (1.3); 5.3605 (0.6); 5.3525 (1.1); 5.3441 (0.6); 4.4061 (0.5); 4.3943 (1.2); 4.3829 (1.2); 4.3713 (0.4); 3.3639 (0.6); 3.3523 (0.8); 3.3399 (5.3); 3.3324 (6.4); 3.3298 (6.4); 3.3234 (5.4); 3.3124 (1.2); 3.3016 (1.0); 3.2880 (0.9); 3.2780 (0.8); 3.2292 (0.6); 3.1217 (0.9); 3.1090 (1.4); 3.0976 (1.0); 3.0844 (0.7); 3.0720 (0.7); 2.9554 (2.4); 2.9436 (2.5); 2.9291 (3.7); 2.9175 (3.7); 2.8941 (2.5); 2.8308 (3.6); 2.8211 (3.7); 2.8046 (2.5); 2.7949 (2.5); 2.7755 (2.4); 2.4816 (1.3); 2.2985 (26.1); 2.1110 (1.0); 2.0986 (1.7); 2.0860 (1.1); 2.0727 (1.5); 2.0505 (0.3); 2.0318 (0.6); 2.0215 (1.4); 2.0120 (1.4); 2.0004 (0.9); 1.9855 (1.9); 1.9618 (220.4); 1.8908 (0.3); 1.8579 (17.9); 1.8464 (19.1); 1.8112 (0.4); 1.7846 (16.0); 1.7732 (15.8); 1.5812 (4.6); 1.5700 (4.6); 1.5371 (0.3); 1.5150 |
| | | (1.9); 1.5035 (1.8); 1.4798 (0.3); 1.4064 (0.5); 1.3947 (0.5); 1.3406 (0.6); |
| | | 1.2701 (5.8); 1.2624 (6.0); 1.0031 (0.3); 0.9930 (0.5); 0.9909 (0.5); 0.9835 |
| | | (0.7); 0.9715 (0.6); 0.9621 (0.4); 0.9505 (0.3); 0.9438 (0.3); 0.8933 (1.4); |
| | | 0.8826 (2.6); 0.8707 (1.4); 0.8565 (0.4); 0.8346 (1.9); 0.8239 (2.5); 0.8137 |
| | | (2.0); 0.8023 (1.0); 0.7912 (0.4); 0.6874 (0.4); 0.6656 (2.1); 0.6556 (2.7); |
| | | 0.6453 (2.2); 0.6239 (0.4); 0.5545 (0.6); 0.5472 (0.8); 0.5405 (0.8); 0.5255 |
| | | (0.7); 0.5100 (0.4); 0.4994 (0.5); 0.4904 (0.8); 0.4838 (0.9); 0.4769 (1.0); |
| | | 0.4694 (0.9); 0.4543 (0.5); 0.4450 (0.3); 0.3820 (0.9); 0.3669 (2.3); 0.3596 |
| | | (2.9); 0.3524 (2.7); 0.3376 (1.4); 0.3256 (1.0); 0.3016 (5.1); 0.2944 (5.0); |
| | | 0.2681 (3.2); 0.2604 (3.0); 0.2539 (3.2); 0.2458 (2.4); 0.2289 (1.7); 0.2197 |
| | | (2.4); 0.2122 (3.1); 0.2043 (3.5); 0.1970 (2.9); 0.1891 (2.0); 0.1823 (1.4); |
| | | 0.1739 (1.2); 0.1659 (0.9); 0.1519 (0.4); 0.1403 (0.6); 0.1294 (0.8); 0.0976 |
| | | (27.5); 0.0772 (1.7); 0.0573 (2.9); 0.0538 (3.0); 0.0000 (4067.8); −0.0345 |
| | | (3.0); −0.0428 (4.1); −0.0501 (4.6); −0.0601 (4.0); −0.0676 (4.6); −0.0748 |
| | | (2.4); −0.0823 (2.6); −0.0994 (26.5); −0.1516 (2.3); −0.1597 (3.1); −0.1676 |
| | | (3.1); −0.1751 (2.4); −0.1827 (0.8); −0.3206 (1.0); −0.3285 (2.5); −0.3363 |
| | | (3.2); −0.3440 (3.0); −0.3522 (2.0); −0.3604 (0.7) |
| I-104 | 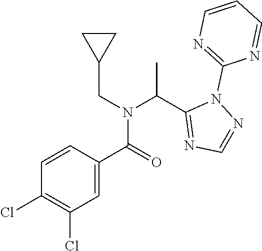 [SMILES: CC(c1ncnn1-c1ncccn1)N(CC1CC1)C(=O)c1ccc(Cl)c(Cl)c1] | I-104: ¹H-NMR(600.1 MHz, CD3CN, 260 K): δ = 8.8943 (0.4); 8.8863 (0.5); 8.8640 (9.7); 8.8562 (11.2); 8.6251 (5.7); 8.6176 (6.4); 8.0772 (9.0); 8.0254 (5.1); 7.9427 (0.7); 7.5198 (4.7); 7.5043 (8.6); 7.4949 (3.9); 7.4329 (1.8); 7.4258 (3.3); 7.4185 (2.0); 7.3716 (2.7); 7.3580 (3.1); 7.2235 (4.4); 7.1893 (8.4); 7.0375 (2.4); 7.0239 (2.5); 6.9812 (4.6); 6.9676 (4.6); 6.3700 (1.1); 6.3585 (3.7); 6.3470 (3.9); 6.3356 (1.5); 6.1196 (0.7); 6.1088 (2.2); 6.0974 (2.3); 6.0864 (1.0); 5.4719 (12.2); 3.6722 (1.2); 3.6620 (1.4); 3.6484 (1.8); 3.6382 (1.8); 3.5262 (1.7); 3.5146 (1.8); 3.5026 (1.4); 3.4910 (1.3); 2.9108 (1.8); 2.8993 (2.0); 2.8848 (3.4); 2.8732 (3.6); 2.8330 (3.4); 2.8236 (3.6); 2.8070 (1.9); 2.7976 (1.8); 2.6955 (0.4); 2.2955 (200.8); 2.2690 (0.7); 2.0971 (0.6); 2.0854 (0.6); 2.0728 (1.4); 2.0040 (0.4); 1.9852 (4.6); 1.9616 (185.2); 1.8462 (1.1); 1.7976 (15.3); 1.7860 (16.0); 1.7646 (9.4); 1.7534 (8.6); 1.3830 (1.3); 1.3717 (1.3); 1.2608 (0.4); 1.0528 (1.7); 0.6228 (0.4); 0.5720 (2.3); 0.5626 (2.8); 0.5530 (2.3); 0.4802 (2.3); 0.4718 (2.6); 0.4668 (2.6); 0.4592 (2.3); 0.4534 (2.1); 0.4127 (0.7); 0.4023 (0.8); 0.3914 (0.8); 0.3795 (0.6); 0.3734 (0.7); 0.3652 (0.8); 0.3583 |
| | | (0.9); 0.3375 (1.8); 0.3296 (2.2); 0.3223 (2.5); 0.2930 (1.5); 0.2700 (5.0); |
| | | 0.2637 (5.0); 0.2491 (3.0); 0.2336 (3.1); 0.2206 (3.6); 0.2124 (2.8); 0.1779 |
| | | (0.8); 0.1571 (0.9); 0.0967 (7.4); 0.0831 (2.3); 0.0673 (2.3); 0.0428 |
| | | (3.5); −0.0001 (1048.9); −0.1002 (4.6); −0.1719 (1.4); −0.1795 (2.1); −0.1874 |
| | | (2.3); −0.1947 (1.6); −0.3713 (2.1); −0.3789 (2.7); −0.3865 (2.4); −0.3942 (1.6) |
| I-105 | 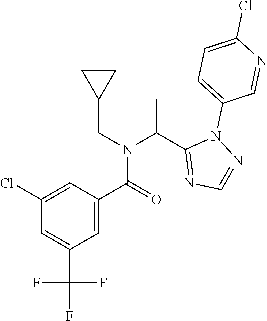 [SMILES: CC(c1ncnn1-c1ccc(Cl)nc1)N(CC1CC1)C(=O)c1cc(Cl)cc(C(F)(F)F)c1] | I-105: ¹H-NMR(600.1 MHz, CD3CN, 260 K): δ = 8.6218 (4.7); 8.6181 (4.8); 8.3093 (1.4); 8.0945 (8.5); 8.0602 (2.2); 8.0015 (2.5); 7.9974 (2.6); 7.9873 (2.7); 7.9832 (2.7); 7.9106 (0.3); 7.8761 (0.4); 7.8049 (5.4); 7.7871 (1.5); 7.7132 (0.7); 7.7101 (0.7); 7.6994 (0.8); 7.6962 (0.8); 7.6581 (4.6); 7.6439 (4.3); 7.5623 (1.3); 7.5482 (1.1); 7.3838 (1.0); 7.1968 (5.5); 7.1593 (5.8); 7.1295 (0.3); 7.0935 (0.6); 6.1579 (1.0); 6.1465 (3.0); 6.1350 (3.0); 6.1236 (1.0); 5.4707 (8.8); 5.0114 (0.8); 5.0004 (0.8); 3.3343 (0.4); 3.3236 (0.4); 3.3107 (0.7); 3.2995 (0.7); 3.2625 (0.7); 3.2512 (0.7); 3.2391 (0.4); 3.2277 (0.4); 2.8896 (1.1); 2.8786 (1.2); 2.8632 (2.8); 2.8521 (2.8); 2.8305 (2.7); 2.8204 (2.8); 2.8041 (1.1); 2.7940 (1.1); 2.2947 (211.1); 2.0745 (0.7); 2.0706 (1.0); 2.0669 (0.7); 1.9830 (2.5); 1.9637 (116.4); 1.9597 (167.3); 1.9560 (123.2); 1.8484 (0.7); 1.8447 (1.0); 1.8409 (0.7); 1.7535 (16.0); 1.7420 (15.7); 1.5782 (0.6); 1.5671 (0.8); 1.4834 (0.5); 1.4716 (0.5); 1.4315 (0.4); 1.3393 (0.6); 1.2812 (0.9); 1.2585 (1.3); 1.2162 (0.4); 1.2044 (0.8); 1.1925 (0.4); 0.8792 (0.4); 0.8678 (0.5); 0.8568 (0.5); 0.8468 (0.6); 0.8406 (0.6); 0.4728 (0.5); 0.4647 (0.6); 0.4582 (0.5); 0.3624 (1.5); 0.3535 (2.1); 0.3437 (1.6); 0.3325 (0.9); 0.3033 (0.7); 0.2944 (1.3); 0.2877 (2.0); 0.2801 (2.4); 0.2725 (2.0); 0.2578 (0.7); 0.2037 (0.8); 0.1947 (1.4); 0.1879 (1.6); 0.1813 (1.9); 0.1734 (1.4); 0.1585 (0.5); −0.1664 (0.4); −0.1734 (0.6); −0.1812 (0.5); −0.1889 (0.4); −0.2174 (0.6); −0.2254 |
| | | (0.6); −0.5139 (1.6); −0.5220 (2.0); −0.5300 (2.0); −0.5380 (1.4); −0.5462 (0.5) |
| I-106 | 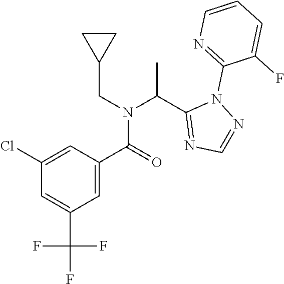 [SMILES: CC(c1ncnn1-c1ncccc1F)N(CC1CC1)C(=O)c1cc(Cl)cc(C(F)(F)F)c1] | I-106: ¹H-NMR(600.1 MHz, CD3CN, 260 K): δ = 8.4112 (3.8); 8.4036 (3.9); 8.1109 (11.3); 8.0770 (3.1); 8.0488 (1.3); 8.0415 (1.4); 7.9273 (1.7); 7.9255 (1.8); 7.9113 (3.6); 7.8970 (2.0); 7.8953 (2.0); 7.8491 (0.6); 7.8340 (1.2); 7.8195 (0.7); 7.7972 (5.5); 7.7428 (1.9); 7.6645 (1.7); 7.6574 (2.6); 7.6505 (3.2); 7.6434 (2.3); 7.6365 (1.5); 7.6014 (0.6); 7.5947 (0.9); 7.5876 (1.0); 7.5806 (0.8); 7.5738 (0.5); 7.3672 (1.6); 7.2978 (5.6); 7.2177 (1.3); 7.1782 (5.9); 5.9662 (1.0); 5.9546 (3.3); 5.9430 (3.4); 5.9315 (1.1); 5.4553 (0.4); 5.4440 (1.1); 5.4325 (1.1); 5.4212 (0.4); 4.0683 (0.7); 4.0564 (2.2); 4.0445 (2.2); 4.0326 (0.7); 3.5105 (0.6); 3.4999 (0.7); 3.4870 (0.8); 3.4764 (0.8); 3.2499 (0.8); 3.2382 (0.8); 3.2264 (0.7); 3.2146 (0.7); 2.8825 (1.6); 2.8714 (1.7); 2.8564 (3.0); 2.8453 (3.0); 2.7978 (3.0); 2.7876 (3.1); 2.7716 (1.7); 2.7614 (1.7); 2.2934 (2.9); 2.0760 (0.6); 2.0719 (0.9); 2.0678 (0.6); 2.0637 (0.3); 1.9842 (9.7); 1.9771 (1.4); 1.9727 (2.4); 1.9693 (58.2); 1.9651 (114.8); 1.9610 (173.3); 1.9569 (118.2); 1.9528 (59.7); 1.9441 (1.1); 1.8542 (0.4); 1.8501 (0.8); 1.8460 (1.0); 1.8418 (0.7); 1.8377 (0.4); 1.8131 (15.6); 1.8014 (16.0); 1.7897 (5.2); 1.7782 (4.7); 1.2604 (0.5); 1.2177 (2.5); 1.2058 (5.1); 1.1939 (2.5); 0.9410 (0.5); 0.9300 (0.6); 0.9193 (0.5); 0.5731 (0.5); 0.5708 (0.5); 0.5620 (1.2); 0.5516 (1.7); 0.5410 |
| | | (1.3); 0.5326 (0.6); 0.5297 (0.6); 0.4699 (0.6); 0.4622 (0.7); 0.4553 (0.7); |
| | | 0.4493 (0.5); 0.4405 (0.3); 0.4263 (0.3); 0.4176 (0.5); 0.4112 (0.6); 0.4043 |
| | | (0.7); 0.3966 (0.6); 0.3456 (0.6); 0.3364 (0.8); 0.3302 (1.6); 0.3228 (2.0); |
| | | 0.3144 (1.8); 0.3075 (1.5); 0.3003 (1.3); 0.2881 (1.7); 0.2803 (1.9); 0.2721 |
| | | (1.8); 0.2656 (2.0); 0.2581 (1.4); 0.2518 (0.8); 0.2429 (0.6); 0.1190 (0.6); |
| | | 0.1116 (0.8); 0.1036 (0.8); 0.0967 (1.2); 0.0092 (0.3); 0.0054 (4.8); −0.0001 |
| | | (169.1); −0.0057 (5.3); −0.1002 (0.8); −0.1827 (0.6); −0.1909 (1.5); −0.1988 |
| | | (2.2); −0.2070 (2.4); −0.2146 (1.9); −0.2230 (0.8); −0.2899 (0.8); −0.2982 |
| | | (1.9); −0.3059 (2.4); −0.3140 (2.1); −0.3220 (1.4); −0.3303 (0.6) |
| I-107 | 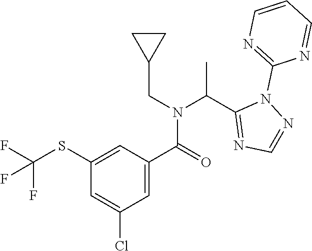 [SMILES: CC(c1ncnn1-c1ncccn1)N(CC1CC1)C(=O)c1cc(Cl)cc(SC(F)(F)F)c1] | I-107: ¹H-NMR(600.1 MHz, CD3CN, 260 K): δ = 8.8760 (13.2); 8.8679 (13.5); 8.8588 (0.5); 8.8523 (0.3); 8.6121 (3.8); 8.6041 (3.9); 8.2071 (0.4); 8.1684 (0.4); 8.0857 (11.9); 8.0349 (3.5); 7.8069 (6.2); 7.6637 (2.3); 7.5237 (3.6); 7.5156 (6.9); 7.5076 (3.5); 7.4317 (2.3); 7.4206 (1.3); 7.4125 (2.1); 7.4045 (1.1); 7.3080 (6.7); 7.2911 (2.2); 7.2517 (6.7); 6.3865 (1.2); 6.3749 (3.8); 6.3633 (3.9); 6.3517 (1.2); 6.0701 (0.4); 6.0587 (1.2); 6.0472 (1.3); 6.0358 (0.4); 4.0684 (0.4); 4.0565 (1.4); 4.0446 (1.4); 4.0327 (0.5); 3.6937 (0.7); 3.6833 (0.8); 3.6700 (1.0); 3.6596 (1.0); 3.5262 (1.0); 3.5143 (1.0); 3.5025 (0.8); 3.4906 (0.8); 2.9077 (1.6); 2.8960 (1.6); 2.8815 (3.5); 2.8698 (3.5); 2.8421 (3.3); 2.8326 (3.4); 2.8159 (1.5); 2.8064 (1.5); 2.2965 (2.0); 2.0927 (0.4); 2.0767 (0.4); 2.0725 (0.6); 2.0684 (0.4); 1.9894 (0.3); 1.9844 (6.5); 1.9777 (1.3); 1.9699 (32.6); 1.9658 (63.4); 1.9617 (92.9); 1.9576 (63.4); 1.9534 (31.8); 1.9493 (0.6); 1.8507 (0.4); 1.8466 (0.6); 1.8425 (0.4); 1.8064 (15.7); 1.7947 (16.0); 1.7825 (0.8); 1.7738 (0.3); 1.7610 (0.4); 1.7431 (5.1); 1.7317 (4.8); 1.2178 (1.6); 1.2059 (3.2); 1.1940 (1.6); 1.0598 (0.6); 1.0491 (0.8); 1.0381 (0.6); 0.5645 (0.6); 0.5603 |
| | | (0.6); 0.5517 (1.4); 0.5423 (1.7); 0.5402 (1.7); 0.5343 (1.2); 0.5306 (1.5); |
| | | 0.5221 (0.7); 0.5178 (0.7); 0.5085 (0.4); 0.5042 (0.4); 0.4976 (0.6); 0.4900 |
| | | (0.9); 0.4837 (1.1); 0.4747 (1.3); 0.4664 (1.1); 0.4598 (0.9); 0.4523 (0.7); |
| | | 0.3484 (0.3); 0.3405 (0.6); 0.3323 (0.8); 0.3246 (1.0); 0.3192 (0.8); 0.2783 |
| | | (1.1); 0.2696 (1.8); 0.2635 (2.7); 0.2558 (3.0); 0.2483 (2.4); 0.2407 (1.7); |
| | | 0.2334 (1.4); 0.2299 (1.4); 0.2215 (1.6); 0.2139 (1.8); 0.2077 (2.0); 0.2001 |
| | | (1.5); 0.1938 (0.8); 0.1849 (0.6); 0.0967 (0.4); 0.0054 (3.2); −0.0001 |
| | | (93.1); −0.0057 (2.4); −0.1002 (0.4); −0.2182 (0.8); −0.2265 (1.7); −0.2345 |
| | | (2.4); −0.2426 (2.5); −0.2500 (1.8); −0.2583 (0.7); −0.4110 (0.8); −0.4192 |
| | | (1.9); −0.4267 (2.5); −0.4348 (2.3); −0.4429 (1.5); −0.4512 (0.6) |
| I-108 | 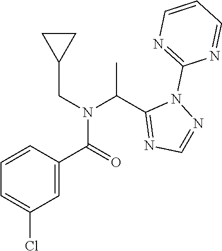 [SMILES: CC(c1ncnn1-c1ncccn1)N(CC1CC1)C(=O)c1cccc(Cl)c1] | I-108: ¹H-NMR(600.1 MHz, CD3CN, 260 K): δ = 8.8775 (6.4); 8.8695 (6.5); 8.5955 (2.6); 8.5876 (2.7); 8.0757 (5.9); 8.0272 (2.3); 7.5191 (1.8); 7.5111 (3.4); 7.5030 (1.8); 7.4242 (1.6); 7.4100 (2.5); 7.3989 (1.5); 7.3909 (0.8); 7.3535 (1.9); 7.3405 (3.1); 7.3273 (1.5); 7.2840 (0.7); 7.2709 (1.2); 7.2465 (0.8); 7.2339 (1.2); 7.2207 (0.5); 7.0719 (1.7); 7.0599 (1.2); 7.0474 (1.0); 7.0222 (3.7); 6.9431 (2.3); 6.9304 (2.2); 6.3810 (0.7); 6.3694 (2.1); 6.3578 (2.1); 6.3463 (0.7); 6.1263 (0.3); 6.1151 (0.9); 6.1036 (0.9); 6.0923 (0.3); 5.4726 (16.0); 3.6456 (0.5); 3.6352 (0.6); 3.6220 (0.7); 3.6117 (0.7); 3.4875 (0.7); 3.4757 (0.7); 3.4639 (0.6); 3.4521 (0.6); 2.8993 (1.0); 2.8874 (1.1); 2.8732 (1.8); 2.8614 (1.8); 2.8084 (1.8); 2.7988 (1.8); 2.7823 (1.0); 2.7728 (1.0); 2.7260 (2.0); 2.2951 (28.5); 2.0723 (0.4); 1.9775 (0.6); 1.9697 (22.6); 1.9655 (44.4); 1.9614 (65.1); 1.9573 (44.7); 1.9532 (22.6); 1.8464 (0.4); 1.8073 (8.7); 1.7957 (8.8); 1.7624 (3.8); 1.7509 (3.6); 1.0246 (0.4); 1.0136 (0.6); 1.0035 (0.4); 0.5601 (0.8); 0.5506 (1.0); 0.5486 (1.0); 0.5389 (0.9); 0.5305 (0.4); 0.4761 (0.5); 0.4680 (0.6); 0.4619 (0.7); 0.4535 (0.8); 0.4473 (0.8); 0.4391 (0.7); 0.4325 (0.7); 0.4250 |
| | | (0.5); 0.3245 (0.5); 0.3170 (0.6); 0.3092 (0.7); 0.3028 (0.6); 0.2804 (0.4); |
| | | 0.2714 (0.6); 0.2653 (1.0); 0.2576 (1.4); 0.2504 (1.2); 0.2438 (0.9); 0.2347 |
| | | (0.9); 0.2317 (1.0); 0.2234 (1.6); 0.2170 (1.8); 0.2096 (1.9); 0.2020 (1.4); |
| | | 0.1869 (0.4); 0.0054 (2.0); −0.0001 (66.9); −0.0057 (2.0); −0.1847 |
| | | (0.4); −0.1929 (1.0); −0.2009 (1.4); −0.2089 (1.5); −0.2164 (1.1); −0.2246 |
| | | (0.5); −0.3825 (0.5); −0.3905 (1.1); −0.3981 (1.5); −0.4061 (1.4); −0.4141 |
| | | (1.0); −0.4224 (0.4) |
| I-109 | 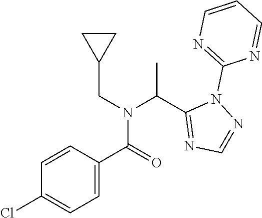 [SMILES: CC(c1ncnn1-c1ncccn1)N(CC1CC1)C(=O)c1ccc(Cl)cc1] | I-109: ¹H-NMR(600.1 MHz, CD3CN, 260 K): δ = 8.8609 (4.8); 8.8529 (4.9); 8.6038 (2.2); 8.5959 (2.2); 8.0721 (4.4); 8.0241 (1.9); 7.5005 (1.5); 7.4924 (2.6); 7.4844 (1.4); 7.4329 (0.7); 7.4251 (1.2); 7.4174 (0.6); 7.3718 (3.8); 7.3581 (4.1); 7.2214 (1.7); 7.2081 (2.0); 7.0759 (1.9); 7.0627 (1.7); 7.0125 (4.2); 6.9988 (3.8); 6.3928 (0.5); 6.3813 (1.6); 6.3698 (1.6); 6.3583 (0.6); 6.0715 (0.8); 6.0601 (0.8); 5.4726 (16.0); 3.6446 (0.4); 3.6343 (0.5); 3.6211 (0.6); 3.6110 (0.6); 3.4733 (0.6); 3.4615 (0.6); 3.4499 (0.5); 3.4378 (0.5); 2.8821 (0.7); 2.8701 (0.7); 2.8561 (1.5); 2.8441 (1.5); 2.8153 (1.5); 2.8059 (1.5); 2.7893 (0.7); 2.7799 (0.7); 2.2949 (9.2); 2.0722 (0.4); 1.9856 (2.3); 1.9774 (0.5); 1.9696 (23.4); 1.9655 (46.2); 1.9614 (68.1); 1.9572 (47.0); 1.9531 (23.9); 1.9444 (0.5); 1.8463 (0.4); 1.8422 (0.3); 1.8010 (6.6); 1.7894 (6.9); 1.7682 (3.4); 1.7568 (3.1); 1.0323 (0.4); 1.0224 (0.5); 1.0131 (0.4); 0.5582 (0.7); 0.5490 (0.9); 0.5467 (0.9); 0.5371 (0.8); 0.4734 (0.4); 0.4654 (0.6); 0.4594 (0.6); 0.4506 (0.7); 0.4445 |
| | | (0.7); 0.4358 (0.6); 0.4294 (0.6); 0.4219 (0.5); 0.3208 (0.4); 0.3132 (0.6); |
| | | 0.3056 (0.7); 0.2995 (0.5); 0.2600 (0.5); 0.2541 (0.8); 0.2462 (1.1); 0.2391 |
| | | (1.0); 0.2319 (1.0); 0.2238 (1.1); 0.2181 (1.2); 0.2097 (1.4); 0.2028 (1.3); |
| | | 0.1973 (1.3); 0.1893 (0.9); 0.0967 (0.3); 0.0054 (2.0); −0.0001 |
| | | (75.7); −0.0057 (2.6); −0.1002 (0.4); −0.1903 (0.4); −0.1984 (0.8); −0.2064 |
| | | (1.2); −0.2144 (1.2); −0.2219 (0.9); −0.2300 (0.4); −0.3992 (0.4); −0.4072 |
| | | (0.9); −0.4148 (1.2); −0.4227 (1.2); −0.4307 (0.8); −0.4388 (0.4) |
| I-110 | 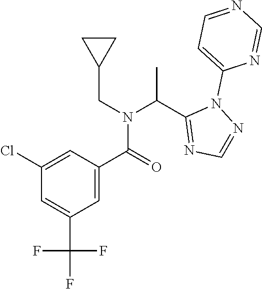 [SMILES: CC(c1ncnn1-c1ccncn1)N(CC1CC1)C(=O)c1cc(Cl)cc(C(F)(F)F)c1] | I-110: ¹H-NMR(600.1 MHz, CD3CN, 260 K): δ = 9.0267 (8.9); 8.9488 (6.1); 8.9395 (6.2); 8.8422 (3.1); 8.8330 (3.1); 8.5971 (4.7); 8.1470 (11.1); 8.0904 (5.4); 7.9765 (5.2); 7.9673 (5.0); 7.8144 (3.2); 7.8053 (9.3); 7.5897 (3.7); 7.4450 (7.1); 7.4095 (3.6); 7.3983 (9.5); 6.5203 (1.3); 6.5087 (4.0); 6.4971 (4.0); 6.4855 (1.3); 6.3007 (0.7); 6.2894 (2.1); 6.2778 (2.1); 6.2665 (0.7); 5.4726 (8.4); 3.7721 (1.2); 3.7615 (1.2); 3.7483 (1.6); 3.7378 (1.6); 3.6076 (1.6); 3.5960 (1.6); 3.5839 (1.3); 3.5722 (1.2); 2.9527 (1.6); 2.9410 (1.7); 2.9264 (3.6); 2.9147 (3.7); 2.8862 (3.6); 2.8770 (3.6); 2.8599 (1.6); 2.8507 (1.6); 2.2942 (70.0); 2.0767 (0.4); 2.0726 (0.6); 2.0685 (0.4); 1.9859 (1.3); 1.9777 (1.4); 1.9700 (37.2); 1.9659 (72.0); 1.9617 (105.1); 1.9576 (72.3); 1.9535 (36.6); 1.9450 (0.5); 1.8508 (0.5); 1.8467 (0.7); 1.8425 (0.5); 1.8384 (0.4); 1.8173 (15.9); 1.8057 (16.0); 1.7536 (8.2); 1.7421 (8.0); 1.2580 (0.6); 1.1323 (0.9); 1.1215 (1.2); 1.1110 (0.9); 0.5895 (1.6); 0.5803 (2.0); 0.5687 (1.7); 0.5563 (0.7); 0.5404 (0.3); 0.5181 (1.4); 0.5120 (1.6); 0.5030 (2.1); 0.4878 (1.5); 0.4741 (0.5); 0.4666 (0.4); 0.3736 (0.4); 0.3659 (0.8); 0.3578 (1.1); 0.3503 (1.7); 0.3449 (1.6); 0.3367 (1.1); 0.3340 (1.1); 0.3263 (1.6); 0.3210 (1.6); 0.3133 (1.1); 0.3056 (0.8); 0.2970 (0.4); 0.2918 (0.8); 0.2827 (1.2); 0.2765 (1.9); 0.2687 (2.5); 0.2612 |
| | | (2.0); 0.2548 (1.6); 0.2461 (1.0); 0.2217 (1.0); 0.2130 (1.7); 0.2059 (2.0); |
| | | 0.1994 (2.4); 0.1918 (1.8); 0.1857 (1.1); 0.1765 (0.6); 0.0053 (1.6); −0.0001 |
| | | (49.3); −0.0057 (1.6); −0.1684 (0.8); −0.1767 (1.9); −0.1847 (2.6); −0.1926 |
| | | (2.8); −0.2006 (2.1); −0.2089 (0.8); −0.4169 (0.9); −0.4252 (2.1); −0.4331 |
| | | (2.7); −0.4411 (2.6); −0.4491 (1.8); −0.4574 (0.7) |
| I-111 | 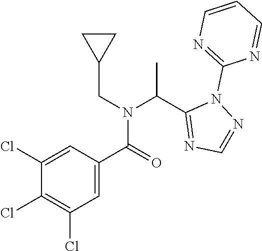 [SMILES: CC(c1ncnn1-c1ncccn1)N(CC1CC1)C(=O)c1cc(Cl)c(Cl)c(Cl)c1] | I-111: ¹H-NMR(600.1 MHz, CD3CN, 260 K): δ = 8.8662 (8.4); 8.8582 (8.5); 8.6547 (4.7); 8.6468 (4.7); 8.1589 (0.4); 8.0835 (7.5); 8.0302 (4.1); 7.5179 (2.4); 7.5099 (4.4); 7.5019 (2.4); 7.4385 (1.4); 7.4305 (2.4); 7.4227 (1.3); 7.2260 (7.7); 7.1902 (16.0); 6.3466 (0.9); 6.3351 (2.8); 6.3235 (2.8); 6.3119 (0.9); 6.1316 (0.6); 6.1202 (1.6); 6.1088 (1.6); 6.0973 (0.6); 3.6960 (0.9); 3.6856 (0.9); 3.6723 (1.3); 3.6619 (1.3); 3.5741 (1.3); 3.5624 (1.3); 3.5505 (0.9); 3.5386 (0.9); 2.9456 (1.4); 2.9339 (1.4); 2.9195 (2.3); 2.9079 (2.3); 2.8481 (2.3); 2.8385 (2.3); 2.8220 (1.4); 2.8124 (1.4); 2.2915 (62.8); 2.0804 (0.4); 2.0762 (0.7); 2.0721 (1.0); 2.0680 (0.7); 2.0639 (0.4); 1.9855 (10.8); 1.9773 (2.6); 1.9695 (61.2); 1.9654 (118.4); 1.9613 (172.0); 1.9571 (118.4); 1.9530 (59.7); 1.8544 (0.4); 1.8503 (0.7); 1.8462 (1.0); 1.8421 (0.7); 1.8380 (0.4); 1.7946 (11.2); 1.7830 (11.5); 1.7637 (6.6); 1.7522 (6.1); 1.0880 (0.7); 1.0775 (1.0); 1.0669 (0.8); 0.6008 (1.2); 0.5904 (1.5); 0.5800 (1.2); 0.5039 (1.1); 0.4981 (1.3); 0.4877 (1.6); 0.4797 (1.3); 0.4726 (1.2); 0.4669 (0.8); 0.4509 (0.3); 0.3596 (0.4); 0.3523 (0.7); 0.3444 (1.0); 0.3369 (1.4); 0.3312 (1.3); 0.3244 (1.2); 0.3088 (2.6); |
| | | 0.3017 (3.0); 0.2944 (2.5); 0.2875 (1.8); 0.2791 (1.1); 0.2706 (0.9); 0.2623 |
| | | (1.4); 0.2551 (1.6); 0.2487 (1.8); 0.2410 (1.3); 0.2259 (0.4); 0.0967 (0.4); |
| | | 0.0053 (2.8); −0.0001 (78.3); −0.0057 (2.5); −0.1002 (0.4); −0.1277 |
| | | (0.6); −0.1360 (1.4); −0.1440 (1.9); −0.1518 (2.0); −0.1596 (1.5); −0.1677 |
| | | (0.6); −0.3154 (0.7); −0.3234 (1.6); −0.3311 (2.0); −0.3391 (1.9); −0.3470 |
| | | (1.3); −0.3552 (0.5) |
| I-112 | 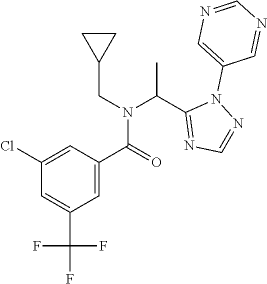 [SMILES: CC(c1ncnn1-c1cncnc1)N(CC1CC1)C(=O)c1cc(Cl)cc(C(F)(F)F)c1] | I-112: ¹H-NMR(600.1 MHz, CD3CN, 260 K): δ = 9.3347 (1.2); 9.3093 (7.1); 9.0198 (16.0); 8.7225 (2.9); 8.1443 (7.0); 8.1146 (1.3); 7.8506 (0.6); 7.8073 (3.7); 7.7949 (0.9); 7.7396 (0.6); 7.7144 (0.7); 7.3163 (0.5); 7.2857 (3.8); 7.2110 (4.0); 6.1852 (0.7); 6.1737 (2.4); 6.1623 (2.4); 6.1508 (0.7); 5.0313 (0.5); 5.0201 (0.5); 4.4067 (0.3); 4.3950 (0.3); 3.2958 (0.4); 3.2851 (0.4); 3.1930 (0.4); 3.1813 (0.4); 3.1177 (0.8); 3.1066 (0.8); 2.9208 (5.5); 2.9102 (5.3); 2.2922 (66.0); 2.0761 (0.4); 2.0720 (0.5); 2.0679 (0.4); 1.9853 (0.4); 1.9772 (1.4); 1.9694 (31.3); 1.9652 (60.5); 1.9611 (87.7); 1.9570 (60.1); 1.9529 (30.1); 1.8502 (0.4); 1.8461 (0.5); 1.8419 (0.3); 1.7901 (2.0); 1.7789 (2.1); 1.7562 (9.7); 1.7447 (9.6); 1.5139 (1.7); 1.5022 (1.6); 1.4053 (0.5); 1.3937 (0.5); 1.3410 (1.9); 1.2828 (2.7); 1.2603 (2.0); 0.8813 (0.4); 0.8302 (0.4); 0.4813 (0.4); 0.4747 (0.4); 0.4660 (0.6); 0.4614 (0.5); 0.4571 (0.5); 0.4505 (0.5); 0.4433 (0.3); 0.3594 (0.6); 0.3513 (1.0); 0.3406 (1.4); 0.3301 (1.0); 0.3219 (0.5); 0.3193 (0.5); 0.3011 (0.5); 0.2916 (0.8); 0.2855 (1.3); 0.2783 (1.6); 0.2709 (1.3); 0.2648 (1.0); 0.2556 (0.7); 0.2118 (0.6); 0.2024 (0.9); 0.1952 (1.0); 0.1891 (1.3); 0.1818 (0.9); 0.1757 (0.6); 0.1663 (0.4); 0.0053 (1.6); −0.0001 (41.6); −0.0057 (1.2); −0.2193 (0.6); −0.2272 (1.2); −0.2354 (1.7); −0.2433 (1.7); −0.2514 |
| | | (1.2); −0.2596 (0.5); −0.5293 (0.5); −0.5374 (1.1); −0.5455 (1.5); −0.5536 |
| | | (1.4); −0.5617 (1.0); −0.5701 (0.4) |
| I-113 | 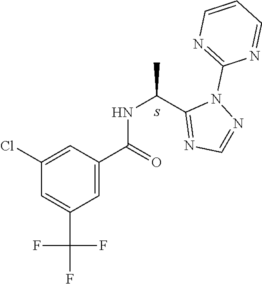 | I-113: ¹H-NMR(600.1 MHz, d₆-DMSO): δ = 8.9901 (0.7); 8.9820 (0.7); 8.1694 (0.6); 8.0558 (0.4); 7.6256 (0.4); 3.3204 (16.0); 2.5074 (5.9); 2.5046 (11.8); 2.5015 (15.8); 2.4985 (11.8); 2.4956 (5.8); 1.6462 (0.6); 1.6346 (0.6); −0.0001 (0.6) |
| I-114 | 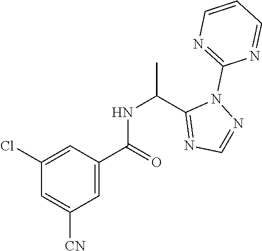 [SMILES: CC(NC(=O)c1cc(Cl)cc(C#N)c1)c1ncnn1-c1ncccn1] | I-114: ¹H-NMR(400.2 MHz, d₆-DMSO): δ = 9.4887 (3.5); 9.4710 (3.6); 8.9997 (15.7); 8.9876 (15.9); 8.5389 (6.7); 8.5065 (7.6); 8.3778 (6.6); 8.1787 (16.0); 7.6435 (4.0); 7.6314 (7.5); 7.6193 (3.8); 6.0595 (0.6); 6.0422 (2.6); 6.0247 (4.0); 6.0072 (2.6); 5.9899 (0.6); 3.3322 (84.2); 2.6784 (0.5); 2.6737 (0.6); 2.6693 (0.4); 2.5136 (42.3); 2.5094 (79.3); 2.5049 (100.6); 2.5004 (73.6); 2.4962 (36.7); 2.3358 (0.4); 2.3317 (0.6); 2.3271 (0.4); 2.0771 (0.6); 1.6635 (15.7); 1.6461 (15.6); 0.0079 (3.4); −0.0002 (67.3); −0.0084 (2.6) |
| I-115 | 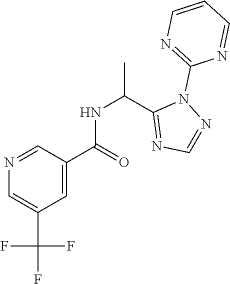 [SMILES: CC(NC(=O)c1cncc(C(F)(F)F)c1)c1ncnn1-c1ncccn1] | I-115: ¹H-NMR(400.2 MHz, d₆-DMSO): δ = 9.4999 (0.7); 9.4818 (0.7); 9.3918 (0.6); 9.3884 (0.6); 9.1645 (1.3); 9.1602 (1.3); 9.1179 (1.2); 9.1153 (1.2); 9.0516 (0.5); 9.0483 (0.5); 9.0019 (3.9); 8.9897 (4.0); 8.5306 (0.5); 8.4953 (1.2); 8.1812 (3.2); 7.6444 (1.0); 7.6322 (2.0); 7.6201 (1.0); 6.0488 (0.6); 6.0313 (0.9); 6.0136 (0.6); 3.3343 (40.8); 2.8921 (16.0); 2.5267 (0.5); 2.5132 (10.8); 2.5090 (21.5); 2.5045 (28.3); 2.5000 (20.7); 2.4956 (10.2); 1.6659 (3.6); 1.6485 (3.6); 0.0079 (0.8); −0.0002 (22.2); −0.0085 (0.8) |
| I-116 | 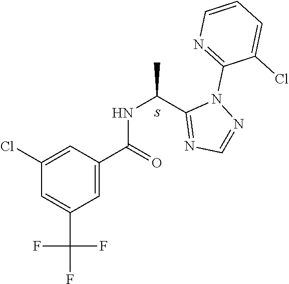 | I-116: ¹H-NMR(400.2 MHz,d₆-DMSO): δ = 11.9588 (0.7); 9.2725 (3.3); 9.2529 (3.4); 8.5019 (4.6); 8.4982 (5.0); 8.4902 (5.0); 8.4864 (5.0); 8.3160 (0.5); 8.2243 (0.3); 8.2068 (15.0); 8.1868 (4.7); 8.1830 (4.8); 8.1665 (5.2); 8.1627 (5.0); 8.0503 (5.8); 7.9659 (6.5); 7.9245 (6.3); 7.6159 (4.9); 7.6041 (4.8); 7.5956 (4.7); 7.5838 (4.6); 5.4075 (0.6); 5.3900 (2.4); 5.3716 (3.5); 5.3532 (2.5); 5.3355 (0.6); 3.3249 (204.8); 2.8094 (0.6); 2.6759 (1.1); 2.6715 (1.6); 2.6669 (1.2); 2.5249 (4.6); 2.5201 (6.9); 2.5113 (94.9); 2.5069 (193.0); 2.5024 (254.4); 2.4979 (184.8); 2.4935 (90.9); 2.3338 (1.2); 2.3293 (1.6); 2.3248 (1.2); 2.3081 (0.4); 2.2115 (0.8); 1.9091 (9.3); 1.6086 (16.0); 1.5910 (15.9); 1.3991 (0.4); 1.3813 (0.4); 1.3514 (2.3); 1.3361 (1.2); 1.2983 (3.8); 1.2588 (5.5); 1.2496 (1.8); 1.2343 (6.2); 0.8678 (0.5); 0.8535 (0.9); 0.8357 (0.5); 0.1459 (0.7); 0.0080 (5.2); −0.0001 (166.0); −0.0083 (6.5); −0.1496 (0.7) |
| I-117 | 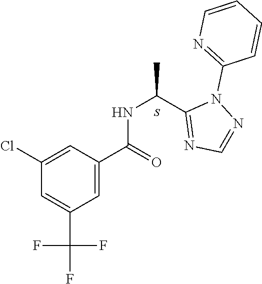 | I-117: ¹H-NMR(400.2 MHz, d₆-DMSO): δ = 9.4022 (3.3); 9.3846 (3.4); 8.5664 (3.3); 8.5637 (3.5); 8.5621 (3.5); 8.5543 (3.6); 8.5516 (3.5); 8.5500 (3.4); 8.3158 (0.5); 8.1472 (14.5); 8.1271 (6.6); 8.1012 (2.0); 8.0966 (2.1); 8.0758 (9.0); 8.0615 (6.5); 8.0572 (8.5); 7.8649 (5.8); 7.8444 (4.9); 7.5020 (3.0); 7.4898 (3.1); 7.4852 (2.9); 7.4834 (3.0); 7.4729 (2.5); 7.4711 (2.7); 6.0709 (0.6); 6.0533 (2.6); 6.0358 (4.1); 6.0183 (2.6); 6.0009 (0.6); 3.3253 (204.4); 2.6760 (1.1); 2.6715 (1.6); 2.6671 (1.2); 2.5246 (6.2); 2.5111 (93.8); 2.5070 (189.0); 2.5025 (251.0); 2.4981 (188.0); 2.3337 (1.1); 2.3294 (1.6); 2.3250 (1.2); 2.0748 (3.4); 1.6453 (16.0); 1.6280 (16.0); 0.1457 (0.6); 0.0078 (4.6); −0.0002 (125.1); −0.0082 (6.7); −0.1497 (0.6) |
| I-118 | 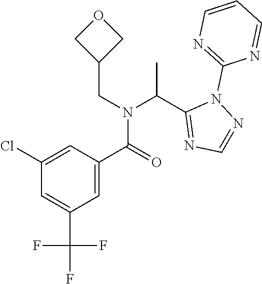 [SMILES: CC(c1ncnn1-c1ncccn1)N(CC1COC1)C(=O)c1cc(Cl)cc(C(F)(F)F)c1] | I-118: ¹H-NMR(400.2 MHz, d₆-DMSO): δ = 8.9805 (0.4); 8.7003 (1.1); 8.3158 (1.0); 8.2498 (16.0); 7.7741 (0.7); 7.6177 (0.4); 7.5592 (0.8); 7.5040 (6.2); 7.4230 (2.1); 5.9223 (0.5); 4.5677 (0.9); 4.5128 (0.9); 4.4972 (0.9); 4.4324 (1.0); 3.9335 (1.0); 3.3234 (348.0); 3.2163 (0.6); 3.1886 (0.6); 2.6753 (2.1); 2.6708 (2.9); 2.6664 (2.1); 2.5243 (7.7); 2.5108 (172.6); 2.5064 (354.9); 2.5019 (470.8); 2.4974 (341.6); 2.4929 (167.1); 2.3332 (2.1); 2.3287 (3.0); 2.3242 (2.2); 2.3034 (0.4); 2.2985 (0.4); 1.6466 (12.4); 1.6294 (12.2); 0.1458 (1.9); 0.0079 (15.0); −0.0002 (439.4); −0.0085 (16.2); −0.1497 (1.9) |
| I-119 | 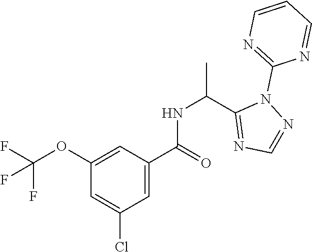 [SMILES: CC(NC(=O)c1cc(Cl)cc(OC(F)(F)F)c1)c1ncnn1-c1ncccn1] | I-119: ¹H-NMR(400.2 MHz, d₆-DMSO): δ = 9.3307 (3.1); 9.3128 (3.1); 8.9914 (15.7); 8.9792 (16.0); 8.1668 (13.2); 7.9055 (4.5); 7.9016 (7.1); 7.8977 (4.9); 7.7662 (4.8); 7.6880 (5.1); 7.6379 (4.3); 7.6258 (8.2); 7.6136 (4.1); 6.0129 (0.5); 5.9956 (2.3); 5.9780 (3.6); 5.9605 (2.3); 5.9431 (0.5); 5.7573 (1.8); 4.0567 (1.0); 4.0389 (3.1); 4.0211 (3.2); 4.0033 (1.1); 3.3277 (87.9); 2.6772 (0.5); 2.6728 (0.6); 2.6685 (0.5); 2.5261 (2.1); 2.5123 (40.2); 2.5083 (79.4); 2.5039 (102.7); 2.4994 (75.4); 2.3351 (0.4); 2.3307 (0.6); 2.3262 (0.4); 1.9899 (13.6); 1.6420 (14.3); 1.6246 (14.1); 1.2592 (0.4); 1.2340 (0.4); 1.1936 (3.6); 1.1758 (7.2); 1.1580 (3.6); 0.0079 (2.0); −0.0002 (58.5); −0.0084 (2.5) |
| I-120 | 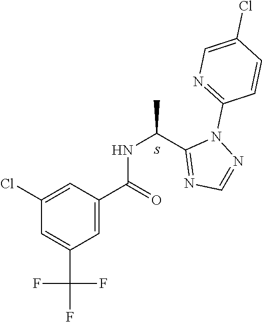 | I-120: ¹H-NMR(400.2 MHz, d₆-DMSO): δ = 9.4062 (3.6); 9.3886 (3.6); 9.3780 (0.6); 8.6314 (7.1); 8.6250 (7.1); 8.3384 (0.3); 8.2119 (4.5); 8.2054 (4.3); 8.1901 (5.2); 8.1835 (6.1); 8.1797 (16.0); 8.1307 (6.8); 8.0735 (7.3); 8.0608 (6.4); 7.9570 (0.4); 7.8910 (7.8); 7.8692 (6.9); 7.8415 (0.4); 7.7559 (0.4); 6.0180 (0.6); 6.0008 (2.6); 5.9834 (4.2); 5.9659 (2.7); 5.9486 (0.6); 5.7592 (1.7); 3.3319 (31.7); 3.0000 (1.1); 2.8915 (1.1); 2.5294 (0.8); 2.5158 (18.2); 2.5117 (37.4); 2.5072 (50.0); 2.5028 (37.4); 2.4987 (19.0); 1.6421 (15.7); 1.6247 (15.6); 1.4333 (0.4); 1.4151 (0.4); 0.0078 (1.9); −0.0002 (48.9); −0.0084 (2.0) |
| I-121 | 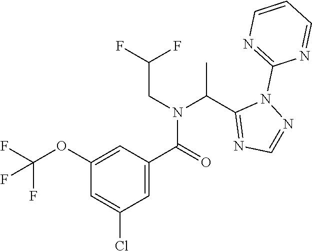 [SMILES: CC(c1ncnn1-c1ncccn1)N(CC(F)F)C(=O)c1cc(Cl)cc(OC(F)(F)F)c1] | I-121: 1H-NMR(400.6 MHz, CD3CN 260 K): δ = 8.8477 (1.3); 8.8357 (1.4); 8.5726 (15.6); 8.5604 (16.0); 8.0631 (1.1); 8.0217 (13.0); 7.4893 (0.4); 7.4772 (0.7); 7.4648 (0.4); 7.4398 (0.8); 7.3737 (4.3); 7.3616 (8.2); 7.3494 (4.1); 7.2756 (5.0); 7.2315 (0.9); 7.1174 (6.7); 7.1137 (4.8); 7.1010 (1.0); 7.0697 (5.2); 6.4086 (0.4); 6.3907 (0.4); 6.3384 (0.8); 6.3304 (0.9); 6.3242 (0.8); 6.3163 (0.7); 6.2197 (1.1); 6.2023 (3.7); 6.1944 (1.8); 6.1855 (4.9); 6.1721 (1.5); 6.0550 (0.8); 6.0472 (1.1); 6.0408 (1.0); 6.0328 (0.8); 5.9108 (0.3); 4.2388 (0.4); 4.2245 (0.4); 4.2086 (1.0); 4.2017 (1.1); 4.1942 (1.1); 4.1875 (1.1); 4.1779 (0.8); 4.1715 (2.0); 4.1636 (0.9); 4.1571 (2.0); 4.1414 (1.5); 4.1360 (1.3); 4.1263 (1.2); 4.1223 (1.2); 4.1140 (1.1); 4.1069 (0.6); 4.0987 (0.6); 4.0859 (1.3); 4.0782 (1.3); 4.0646 (1.0); 4.0567 (1.0); 4.0492 (0.7); 4.0414 (0.6); 4.0274 (0.6); 4.0196 (0.5); 2.3327 (0.4); 2.3248 (0.3); 2.3121 (1.6); 2.3050 (1.1); 2.3000 (0.6); 2.2970 (1.0); 2.2833 (729.2); 2.2656 (2.0); 2.2594 (1.4); 2.2562 (2.0); 2.2490 (1.1); 2.2459 (0.8); 2.2442 (0.3); 2.2327 (0.3); 2.1030 (0.4); 2.0969 (0.6); 2.0907 (0.4); 2.0667 (4.7); 1.9522 (0.5); 1.9477 (1.0); 1.9421 (35.5); 1.9359 (73.2); |
| | | 1.9298 (105.2); 1.9236 (73.1); 1.9174 (36.3); 1.9108 (1.3); 1.9045 (0.6); |
| | | 1.7645 (0.4); 1.7584 (0.6); 1.7522 (0.4); 1.7138 (1.6); 1.6964 (1.8); 1.6696 |
| | | (12.0); 1.6525 (11.8) |
| I-122 | 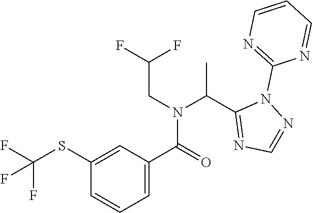 [SMILES: CC(c1ncnn1-c1ncccn1)N(CC(F)F)C(=O)c1cccc(SC(F)(F)F)c1] | I-122: 1H-NMR(400.6 MHz, CD3CN 260 K): δ = 8.8548 (1.2); 8.8431 (1.2); 8.4826 (14.4); 8.4705 (14.9); 8.2595 (0.9); 8.1696 (0.4); 8.1664 (0.6); 8.1626 (0.5); 8.1500 (0.5); 8.1467 (0.6); 8.1431 (0.5); 8.0611 (1.0); 8.0216 (12.3); 7.9359 (0.4); 7.9164 (0.5); 7.7570 (0.5); 7.7377 (0.5); 7.6190 (3.0); 7.6063 (2.2); 7.5998 (3.5); 7.5879 (0.8); 7.5144 (0.6); 7.4934 (0.6); 7.4702 (7.5); 7.3926 (0.6); 7.3727 (0.5); 7.3554 (2.6); 7.3361 (6.0); 7.3193 (5.5); 7.3075 (7.9); 7.2953 (4.1); 7.2816 (4.8); 7.2624 (2.7); 6.4227 (0.4); 6.4051 (0.4); 6.3490 (0.7); 6.3402 (0.9); 6.3355 (0.9); 6.3267 (0.7); 6.2088 (0.8); 6.2048 (1.1); 6.1963 (1.8); 6.1862 (2.0); 6.1685 (3.4); 6.1512 (3.4); 6.1339 (1.1); 6.0649 (0.7); 6.0565 (0.9); 6.0511 (0.9); 6.0426 (0.8); 4.1689 (0.8); 4.1627 (1.1); 4.1550 (0.8); 4.1491 (1.3); 4.1371 (1.7); 4.1318 (2.7); 4.1179 (2.8); 4.1066 (1.4); 4.1005 (1.6); 4.0862 (1.2); 4.0810 (1.3); 4.0727 (1.2); 4.0599 (1.1); 4.0515 (1.1); 4.0442 (0.6); 4.0358 (0.5); 4.0229 (0.4); 4.0145 (0.4); 2.8940 (0.5); 2.5635 (0.9); 2.4080 (0.7); |
| | | 2.2995 (16.0); 2.2241 (1.3); 2.1029 (0.4); 2.0968 (0.6); 2.0907 (0.4); 2.0734 |
| | | (0.4); 2.0718 (0.3); 2.0666 (47.5); 2.0588 (0.8); 1.9526 (0.5); 1.9476 (0.5); |
| | | 1.9420 (20.5); 1.9358 (41.5); 1.9297 (61.8); 1.9235 (42.2); 1.9173 (21.3); |
| | | 1.9108 (1.1); 1.9043 (0.6); 1.8972 (0.3); 1.7583 (0.4); 1.7276 (1.6); 1.7100 |
| | | (1.8); 1.6860 (12.0); 1.6689 (11.9) |
| I-123 | 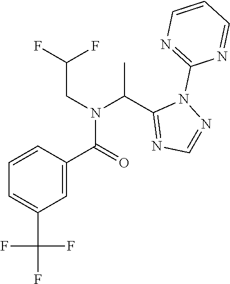 [SMILES: CC(c1ncnn1-c1ncccn1)N(CC(F)F)C(=O)c1cccc(C(F)(F)F)c1] | I-123: 1H-NMR(400.6 MHz, CD3CN 260 K): δ = 8.8563 (1.1); 8.8451 (1.2); 8.8287 (0.4); 8.8261 (0.4); 8.4640 (15.6); 8.4519 (16.0); 8.0619 (1.0); 8.0482 (0.5); 8.0182 (13.3); 7.7415 (0.5); 7.7234 (0.5); 7.5937 (3.4); 7.5748 (4.2); 7.4774 (0.7); 7.4521 (9.2); 7.4329 (2.5); 7.4137 (4.9); 7.3947 (3.7); 7.3772 (5.3); 7.3580 (2.2); 7.2968 (4.3); 7.2847 (8.2); 7.2725 (4.2); 6.4318 (0.4); 6.4151 (0.4); 6.3582 (0.8); 6.3496 (1.0); 6.3446 (1.0); 6.3360 (0.8); 6.2458 (1.2); 6.2285 (3.8); 6.2108 (5.0); 6.1999 (2.0); 6.1944 (2.3); 6.0742 (0.8); 6.0659 (1.0); 6.0603 (1.0); 6.0519 (0.9); 5.4405 (0.4); 4.2179 (0.3); 4.2042 (0.3); 4.1871 (0.9); 4.1810 (1.3); 4.1733 (1.0); 4.1672 (1.4); 4.1506 (3.3); 4.1432 (2.2); 4.1364 (2.8); 4.1304 (1.8); 4.1200 (2.2); 4.1051 (1.5); 4.0952 (1.4); 4.0871 (1.4); 4.0740 (1.3); 4.0658 (1.2); 4.0585 (0.7); 4.0502 (0.6); 4.0371 (0.5); 4.0286 (0.4); 2.3343 (0.6); 2.3103 (2.0); 2.3071 (1.0); 2.3056 (1.2); 2.3049 (1.2); 2.3040 (1.2); 2.3033 (1.2); 2.3024 (1.2); 2.3016 (1.3); 2.2993 (1.9); 2.2985 (1.8); 2.2970 (2.3); 2.2961 (2.4); 2.2944 (3.1); 2.2846 (735.0); 2.2613 (1.8); 2.2563 (3.4); 2.2540 (2.2); 2.2479 (1.9); 2.2393 (0.4); 2.2359 (0.5); 2.1027 (0.4); 2.0965 (0.5); 2.0904 (0.4); 1.9538 (0.3); 1.9474 (1.2); 1.9417 (33.4); 1.9356 (66.5); 1.9294 (99.4); 1.9232 (67.4); 1.9171 (34.5); 1.9012 (0.8); 1.8950 (0.5); 1.8927 (0.5); |
| | | 1.8888 (0.3); 1.8865 (0.3); 1.7642 (0.5); 1.7581 (0.6); 1.7519 (0.5); 1.7456 |
| | | (0.4); 1.7333 (1.5); 1.7153 (2.0); 1.6971 (14.1); 1.6800 (13.7); 1.1976 (0.8); |
| | | 1.1810 (0.8) |
| I-124 | 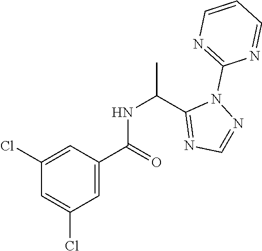 [SMILES: CC(NC(=O)c1cc(Cl)cc(Cl)c1)c1ncnn1-c1ncccn1] | I-124: ¹H-NMR(400.2 MHz, d₆-DMSO): δ = 9.2655 (2.2); 9.2476 (2.3); 8.9953 (12.6); 8.9832 (12.8); 8.1638 (10.8); 7.8036 (2.0); 7.7989 (5.0); 7.7945 (4.4); 7.7797 (16.0); 7.7749 (10.3); 7.6444 (3.4); 7.6323 (6.6); 7.6201 (3.3); 6.0028 (0.4); 5.9854 (1.9); 5.9678 (2.9); 5.9503 (1.9); 5.9327 (0.4); 3.3350 (336.2); 2.6798 (0.6); 2.6752 (0.9); 2.6707 (0.6); 2.5286 (2.4); 2.5238 (3.6); 2.5152 (51.4); 2.5108 (105.2); 2.5062 (138.6); 2.5017 (98.6); 2.4972 (46.5); 2.3376 (0.6); 2.3330 (0.8); 2.3285 (0.6); 1.6316 (11.5); 1.6142 (11.4); 1.0723 (0.4) |
| I-125 | 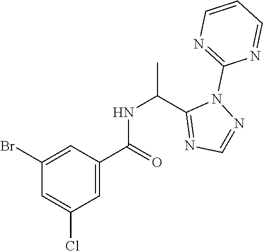 [SMILES: CC(NC(=O)c1cc(Cl)cc(Br)c1)c1ncnn1-c1ncccn1] | I-125: ¹H-NMR(600.4 MHz, d₆-DMSO): δ = 9.2422 (3.0); 9.2302 (3.0); 8.9859 (15.8); 8.9779 (16.0); 8.1558 (12.7); 7.9011 (11.1); 7.8986 (13.0); 7.8010 (4.6); 7.7982 (7.8); 7.7955 (4.4); 7.6333 (3.8); 7.6252 (7.4); 7.6171 (3.7); 5.9827 (0.5); 5.9711 (2.4); 5.9594 (3.8); 5.9477 (2.4); 5.9360 (0.5); 5.7507 (0.4); 3.3235 (199.0); 3.3124 (331.3); 2.6188 (0.5); 2.6158 (1.1); 2.6127 (1.5); 2.6096 (1.1); 2.6066 (0.5); 2.5217 (2.9); 2.5186 (3.5); 2.5155 (3.4); 2.5068 (79.3); 2.5038 (171.0); 2.5007 (237.4); 2.4976 (172.5); 2.4946 (80.6); 2.3907 (0.5); 2.3877 (1.0); 2.3846 (1.5); 2.3816 (1.0); 2.3786 (0.5); 1.6222 (15.0) 1.6106 (15.1); −0.0001 (7.1) |
| I-126 | 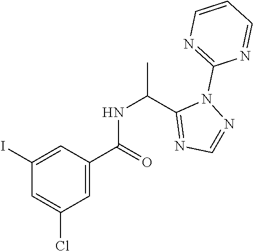 [SMILES: CC(NC(=O)c1cc(Cl)cc(I)c1)c1ncnn1-c1ncccn1] | I-126: ¹H-NMR(400.2 MHz, d₆-DMSO): δ = 9.2347 (3.1); 9.2168 (3.2); 8.9941 (15.8); 8.9819 (16.0); 8.1621 (13.5); 8.0565 (4.4); 8.0531 (8.3); 8.0497 (5.2); 7.9999 (4.4); 7.9956 (6.9); 7.9917 (4.2); 7.7921 (4.7); 7.7879 (7.2); 7.7838 (4.6); 7.6435 (4.3); 7.6314 (8.2); 7.6192 (4.1); 5.9923 (0.5); 5.9751 (2.4); 5.9575 (3.7); 5.9399 (2.4); 5.9225 (0.5); 3.3316 (17.2); 2.5283 (0.6); 2.5148 (14.7); 2.5106 (29.9); 2.5062 (39.4); 2.5017 (28.6); 2.4974 (14.1); 1.6251 (14.4); 1.6077 (14.4); −0.0002 (7.8) |
| I-127 | 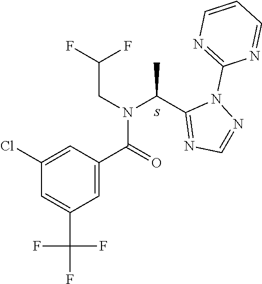 | I-127: ¹H-NMR(400.2 MHz, d₆-DMSO): δ = 8.6894 (1.4); 8.2635 (16.0); 7.8390 (1.0); 7.5780 (7.8); 7.5548 (1.2); 7.5082 (2.5); 6.2637 (0.5); 6.0903 (0.8); 4.1570 (0.7); 3.3277 (29.3); 2.6738 (0.4); 2.5274 (1.0); 2.5226 (1.6); 2.5139 (24.8); 2.5095 (50.9); 2.5049 (66.7); 2.5004 (47.4); 2.4959 (22.7); 2.3317 (0.4); 2.3271 (0.3); 1.6955 (6.4); 1.6792 (6.3); −0.0002 (1.6) |
| I-128 | 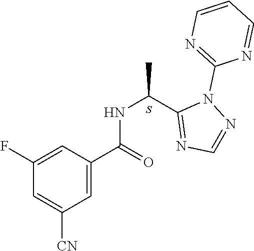 | I-128: ¹H-NMR(400.2 MHz, d₆-DMSO): δ = 9.3145 (2.8); 9.2966 (2.9); 8.9964 (15.7); 8.9842 (16.0); 8.3502 (0.3); 8.1671 (13.4); 8.0991 (4.1); 8.0960 (7.9); 8.0928 (5.0); 8.0662 (2.0); 8.0630 (2.1); 8.0600 (2.4); 8.0453 (2.1); 8.0421 (2.2); 8.0392 (2.2); 7.9282 (2.0); 7.9245 (2.3); 7.9222 (2.3); 7.9185 (1.9); 7.9044 (2.2); 7.9008 (2.4); 7.8985 (2.2); 7.8947 (1.8); 7.6429 (4.3); 7.6307 (8.2); 7.6186 (4.1); 6.0278 (0.5); 6.0105 (2.4); 5.9929 (3.7); 5.9754 (2.4); 5.9579 (0.5); 5.7567 (3.2); 3.3266 (38.5); 2.6771 (0.4); 2.6726 (0.5); 2.6679 (0.4); 2.5259 (1.3); 2.5125 (29.4); 2.5081 (60.5); 2.5037 (80.3); 2.4991 (57.6); 2.4947 (27.6); 2.3347 (0.4); 2.3305 (0.5); 2.3260 (0.4); 1.6449 (14.5); 1.6275 (14.4); 0.0078 (1.6); −0.0002 (45.4); −0.0085 (1.6) |
| I-129 | 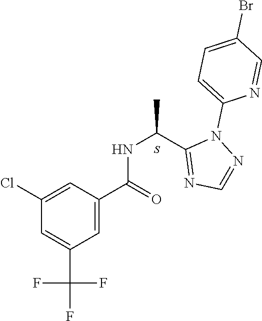 | I-129: ¹H-NMR(400.2 MHz, d₆-DMSO): δ = 9.4022 (3.3); 9.3846 (3.3); 8.7010 (6.1); 8.6998 (6.7); 8.6950 (6.6); 8.6937 (6.6); 8.3227 (5.2); 8.3165 (5.0); 8.3010 (5.6); 8.2948 (5.5); 8.1795 (16.0); 8.1267 (6.2); 8.1232 (4.4); 8.0710 (6.7); 8.0689 (6.2); 8.0665 (6.6); 8.0613 (5.7); 7.8280 (6.8); 7.8268 (7.0); 7.8063 (6.3); 7.8051 (6.6); 6.0179 (0.5); 6.0007 (2.5); 5.9832 (3.9); 5.9657 (2.5); 5.9483 (0.5); 3.3295 (17.4); 2.5290 (0.9); 2.5243 (1.5); 2.5156 (18.3); 2.5111 (37.4); 2.5065 (49.4); 2.5019 (35.5); 2.4974 (16.9); 1.7614 (0.3); 1.6391 (15.1); 1.6217 (15.0); 1.1071 (0.4); −0.0002 (9.1) |
| I-130 | 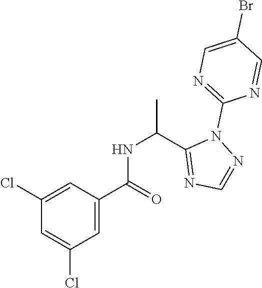 [SMILES: CC(NC(=O)c1cc(Cl)cc(Cl)c1)c1ncnn1-c1ncc(Br)cn1] | I-130: ¹H-NMR(600.4 MHz, DMF): δ = 9.2797 (1.8); 9.2681 (1.8); 9.2235 (15.2); 8.1992 (7.0); 8.0249 (2.4); 7.9000 (9.6); 7.8970 (9.2); 7.7724 (2.8); 7.7694 (4.2); 7.7664 (2.2); 6.1176 (0.5); 6.1060 (1.7); 6.0944 (2.5); 6.0827 (1.6); 6.0711 (0.4); 3.4630 (16.0); 2.9215 (1.7); 2.9186 (2.8); 2.9156 (3.5); 2.9126 (2.5); 2.9097 (1.2); 2.7518 (1.7); 2.7487 (2.8); 2.7456 (3.6); 2.7424 (2.5); 2.7393 (1.3); 1.7211 (10.3); 1.7095 (10.0); −0.0001 (1.3) |
| I-131 | 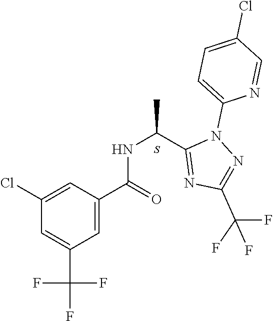 | I-131: ¹H-NMR(600.4 MHz, d₆-DMSO): δ = 9.4261 (3.2); 9.4146 (3.3); 8.6648 (5.6); 8.6641 (5.5); 8.6606 (5.8); 8.2474 (4.1); 8.2431 (4.0); 8.2330 (4.5); 8.2287 (4.4); 8.0808 (5.8); 8.0669 (5.4); 8.0157 (5.8); 7.9261 (6.3); 7.9117 (5.8); 5.9435 (0.5); 5.9319 (2.4); 5.9204 (3.8); 5.9088 (2.5); 5.8972 (0.5); 3.3114 (110.3); 2.6183 (0.4); 2.6153 (0.6); 2.6123 (0.4); 2.5243 (1.4); 2.5212 (1.8); 2.5180 (2.0); 2.5092 (34.4); 2.5063 (70.5); 2.5032 (95.9); 2.5002 (71.2); 2.4973 (34.8); 2.3903 (0.5); 2.3872 (0.6); 2.3842 (0.4); 1.6765 (13.9); 1.6648 (13.9); 1.3981 (16.0); −0.0001 (5.2) |
| I-132 | 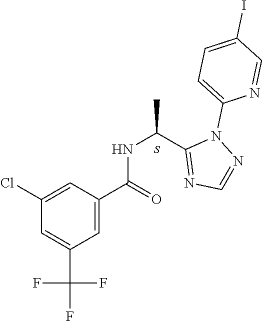 | I-132: ¹H-NMR(400.2 MHz, d₆-DMSO): δ = 9.3868 (3.1); 9.3691 (3.2); 8.7767 (6.0); 8.7752 (6.4); 8.7712 (6.4); 8.7696 (6.2); 8.4258 (5.2); 8.4201 (4.9); 8.4045 (5.4); 8.3988 (5.4); 8.2691 (0.4); 8.2187 (0.4); 8.1679 (16.0); 8.1143 (6.2); 8.1107 (4.4); 8.0631 (12.4); 8.0609 (10.8); 7.6905 (6.5); 7.6890 (6.6); 7.6692 (6.2); 7.6677 (6.3); 6.0098 (0.5); 5.9927 (2.4); 5.9752 (3.8); 5.9578 (2.4); 5.9405 (0.5); 3.6606 (0.6); 3.3293 (70.5); 2.6784 (0.4); 2.6738 (0.6); 2.6692 (0.4); 2.5273 (1.9); 2.5226 (2.9); 2.5140 (35.8); 2.5095 (73.2); 2.5049 (95.4); 2.5002 (66.6); 2.4957 (30.6); 2.3362 (0.4); 2.3316 (0.6); 2.3270 (0.4); 2.0881 (4.8); 1.9081 (0.8); 1.6475 (0.4); 1.6299 (14.9); 1.6125 (14.6); 1.4348 (0.4); 1.4304 (1.1); 1.4164 (0.4); 1.4122 (1.1); 1.0882 (0.8); 1.0385 (0.6); 0.1458 (0.5); 0.0154 (0.4); 0.0080 (4.5); −0.0002 (129.0); −0.0086 (3.6); −0.1497 (0.5) |
| I-133 | 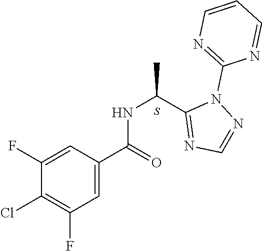 | I-133: ¹H-NMR(400.2 MHz, d₆-DMSO): δ = 9.2582 (2.7); 9.2404 (2.8); 8.9918 (15.6); 8.9797 (16.0); 8.3163 (0.4); 8.1608 (13.5); 7.7262 (1.2); 7.7196 (3.6); 7.7159 (8.8); 7.6961 (8.6); 7.6859 (1.1); 7.6414 (4.2); 7.6293 (8.1); 7.6171 (4.1); 6.0072 (0.5); 5.9897 (2.4); 5.9722 (3.7); 5.9546 (2.4); 5.9375 (0.5); 3.3255 (101.1); 2.6762 (0.6); 2.6717 (0.9); 2.6672 (0.6); 2.5252 (2.1); 2.5203 (3.2); 2.5117 (53.3); 2.5073 (110.9); 2.5028 (147.5); 2.4982 (104.4); 2.4938 (49.1); 2.3341 (0.6); 2.3295 (0.9); 2.3250 (0.6); 1.9893 (0.4); 1.6383 (14.6); 1.6209 (14.5); 1.3976 (10.8); 1.2338 (0.5); 0.1459 (0.4); 0.0079 (2.5); −0.0001 (79.7); −0.0085 (2.5); −0.1495 (0.4) |
| I-134 | 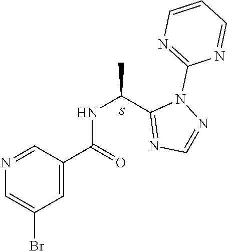 | I-134: ¹H-NMR(400.2 MHz, d₆-DMSO): δ = 9.3395 (2.3); 9.3216 (2.4); 9.0070 (0.6); 8.9985 (15.9); 8.9863 (16.0); 8.9318 (0.3); 8.8648 (0.4); 8.8550 (6.8); 8.8504 (6.8); 8.8412 (6.4); 8.8356 (6.4); 8.6929 (0.6); 8.3624 (0.7); 8.3533 (4.3); 8.3480 (6.9); 8.3430 (4.0); 8.1702 (12.1); 7.9540 (1.0); 7.6444 (4.3); 7.6323 (8.2); 7.6201 (4.1); 6.7554 (0.3); 6.0273 (0.4); 6.0099 (2.1); 5.9923 (3.3); 5.9747 (2.1); 5.9572 (0.4); 5.7574 (2.4); 3.5691 (7.9); 3.3282 (45.8); 2.8920 (8.0); 2.7334 (6.4); 2.7322 (6.6); 2.6774 (0.3); 2.6729 (0.5); 2.6682 (0.3); 2.5264 (1.6); 2.5216 (2.6); 2.5130 (30.4); 2.5085 (61.2); 2.5039 (79.8); 2.4993 (56.1); 2.4948 (26.2); 2.3352 (0.3); 2.3307 (0.5); 2.3262 (0.4); 1.9096 (3.5); 1.6419 (13.1); 1.6245 (12.9); 1.4438 (0.5); 1.4258 (0.5); 0.0079 (2.2); −0.0002 (59.0); −0.0086 (1.8) |
| I-135 | 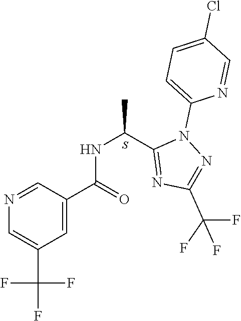 | I-135: ¹H-NMR(400.2 MHz, d₆-DMSO): δ = 9.5327 (1.7); 9.5155 (1.8); 9.1569 (3.1); 9.1523 (3.1); 9.1302 (2.7); 9.1271 (2.7); 8.6824 (3.8); 8.6771 (3.5); 8.6759 (3.7); 8.4600 (2.9); 8.3168 (0.5); 8.2634 (2.7); 8.2570 (2.6); 8.2417 (3.1); 8.2353 (3.0); 7.9452 (4.0); 7.9245 (3.3); 7.9235 (3.6); 5.9747 (1.5); 5.9574 (2.4); 5.9400 (1.5); 3.3254 (50.3); 2.6767 (0.5); 2.6722 (0.6); 2.6675 (0.5); 2.5258 (1.8); 2.5211 (2.8); 2.5123 (39.4); 2.5079 (81.4); 2.5033 (106.8); 2.4987 (74.4); 2.4941 (34.2); 2.3346 (0.5); 2.3301 (0.6); 2.3255 (0.5); 1.6919 (8.3); 1.6745 (8.2); 1.3978 (16.0); 0.0080 (2.1); −0.0002 (65.2); −0.0085 (1.8) |
| I-136 | 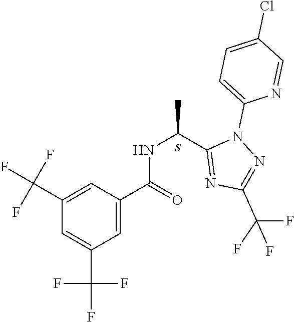 | I-136: ¹H-NMR(400.2 MHz, d₆-DMSO): δ = 9.5917 (3.7); 9.5743 (3.7); 8.6676 (7.1); 8.6663 (7.5); 8.6612 (7.5); 8.6598 (7.2); 8.3717 (13.4); 8.3229 (5.8); 8.2509 (5.6); 8.2444 (5.3); 8.2292 (6.4); 8.2227 (6.2); 7.9376 (8.0); 7.9363 (7.9); 7.9159 (7.1); 7.9146 (6.9); 5.9915 (0.6); 5.9740 (2.9); 5.9566 (4.6); 5.9393 (3.0); 5.9218 (0.6); 3.3244 (56.4); 2.6816 (0.5); 2.6771 (1.1); 2.6725 (1.5); 2.6680 (1.1); 2.6636 (0.5); 2.5261 (4.0); 2.5213 (6.2); 2.5126 (88.8); 2.5081 (182.2); 2.5036 (237.4); 2.4990 (165.4); 2.4944 (75.8); 2.3393 (0.5); 2.3350 (1.0); 2.3304 (1.5); 2.3258 (1.0); 2.3213 (0.5); 1.7004 (16.0); 1.6829 (15.9); 1.3979 (1.3); 0.1460 (0.6); 0.0080 (4.8); −0.0001 (151.1); −0.0085 (4.4); −0.1496 (0.6) |
| I-137 | 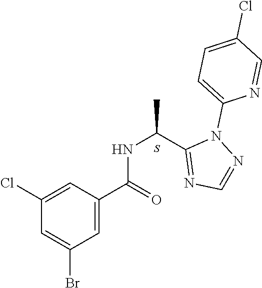 | I-137: ¹H-NMR(400.2 MHz, d₆-DMSO): δ = 9.2553 (3.0); 9.2376 (3.1); 8.6319 (6.5); 8.6265 (6.3); 8.6254 (6.4); 8.3166 (0.5); 8.2159 (4.9); 8.2094 (4.7); 8.1941 (5.5); 8.1876 (5.5); 8.1676 (16.0); 7.9252 (3.0); 7.9210 (9.1); 7.9165 (10.3); 7.9112 (9.2); 7.9067 (3.2); 7.8868 (6.8); 7.8857 (7.3); 7.8650 (6.0); 7.8638 (6.5); 7.8223 (5.6); 7.8180 (7.8); 7.8140 (5.0); 5.9780 (0.5); 5.9608 (2.5); 5.9433 (3.9); 5.9258 (2.5); 5.9085 (0.5); 3.3254 (58.1); 2.6811 (0.3); 2.6765 (0.7); 2.6720 (1.0); 2.6674 (0.7); 2.6627 (0.3); 2.5256 (2.7); 2.5209 (3.9); 2.5121 (54.7); 2.5077 (114.2); 2.5031 (151.1); 2.4985 (106.1); 2.4939 (49.3); 2.3345 (0.6); 2.3299 (0.9); 2.3253 (0.6); 1.9896 (0.6); 1.6142 (15.5); 1.5967 (15.4); 0.1459 (0.3); 0.0080 (2.7); −0.0001 (91.3) −0.0085 (2.6); −0.1496 (0.3) |
| I-138 | 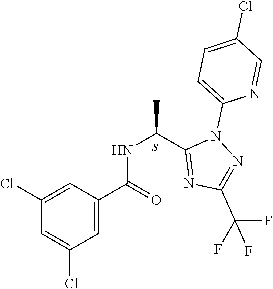 | I-138: ¹H-NMR(400.2 MHz, d₆-DMSO): δ = 9.3026 (2.2); 9.2852 (2.2); 8.6726 (4.5); 8.6675 (4.1); 8.6662 (4.5); 8.3164 (0.5); 8.2624 (3.3); 8.2560 (3.1); 8.2407 (3.7); 8.2343 (3.6); 7.9285 (5.0); 7.9078 (3.9); 7.9067 (4.4); 7.8156 (2.6); 7.8108 (5.5); 7.8061 (3.4); 7.7458 (14.7); 7.7410 (13.0); 5.9237 (0.4); 5.9063 (1.8); 5.8890 (2.8); 5.8716 (1.8); 5.8542 (0.4); 3.3233 (39.6); 2.6762 (0.6); 2.6718 (0.7); 2.6672 (0.5); 2.5253 (2.0); 2.5206 (3.0); 2.5119 (42.1); 2.5074 (87.4); 2.5029 (116.1); 2.4982 (82.4); 2.4937 (38.6); 2.3342 (0.5); 2.3297 (0.7); 2.3250 (0.5); 1.6568 (9.8); 1.6394 (9.8); 1.3977 (16.0); 0.0080 (0.8); −0.0002 (26.6); −0.0086 (0.8) |
| I-139 | 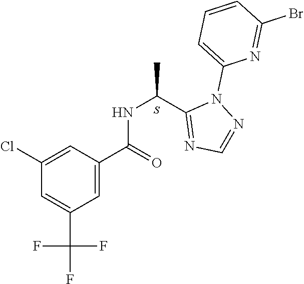 | I-139: ¹H-NMR(400.2 MHz, d₆-DMSO): δ = 9.4491 (3.1); 9.4318 (3.1); 9.0567 (0.3); 8.3169 (0.4); 8.2694 (0.5); 8.2191 (0.6); 8.1886 (16.0); 8.1576 (5.8); 8.1539 (4.0); 8.1098 (6.0); 8.1083 (6.1); 8.0663 (5.2); 8.0451 (4.5); 8.0253 (9.9); 8.0055 (7.1); 7.9144 (7.4); 7.9127 (7.8); 7.8944 (6.0); 7.8927 (5.3); 7.7612 (7.1); 7.7595 (7.0); 7.7417 (6.6); 7.7400 (5.8); 5.9462 (0.5); 5.9290 (2.5); 5.9116 (3.9); 5.8943 (2.5); 5.8771 (0.5); 3.3278 (37.9); 2.6743 (0.4); 2.5278 (1.0); 2.5232 (1.4); 2.5144 (24.6); 2.5099 (51.7); 2.5053 (68.4); 2.5007 (48.1); 2.4961 (22.3); 2.3321 (0.4); 2.0884 (1.4); 1.6634 (15.8); 1.6461 (15.7); 1.4312 (1.5); 1.4130 (1.5); 1.0886 (0.7); 1.0389 (0.5); −0.0002 (9.4) |
| I-140 | 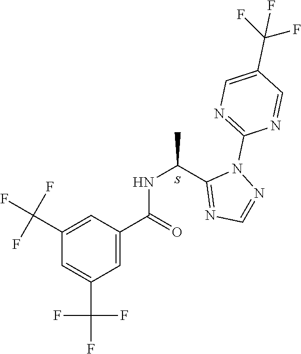 | I-140: ¹H-NMR(400.2 MHz, CD3CN): δ = 9.1997 (12.5); 9.1980 (11.3); 8.6194 (1.0); 8.4145 (1.0); 8.3026 (9.0); 8.1850 (0.4); 8.1493 (3.8); 8.0481 (9.0); 7.9106 (1.2); 7.8949 (1.1); 6.2467 (0.5); 6.2293 (2.1); 6.2115 (3.1); 6.1938 (2.1); 6.1764 (0.5); 4.6790 (0.4); 2.1379 (52.5); 2.1197 (0.4); 2.1134 (0.5); 2.1073 (0.7); 2.1012 (0.4); 1.9642 (1.8); 1.9523 (38.1); 1.9461 (71.8); 1.9400 (99.3); 1.9338 (67.1); 1.9276 (33.6); 1.9146 (0.5); 1.7746 (0.4); 1.7686 (0.6); 1.7623 (0.4); 1.7125 (16.0); 1.6952 (15.9); 1.5330 (1.7); 1.5150 (1.7); 0.1460 (1.3); 0.0203 (0.5); 0.0080 (12.0); −0.0002 (295.4); −0.0086 (9.3); −0.0171 (0.6); −0.0239 (0.4); −0.1495 (1.3) |
| I-141 | 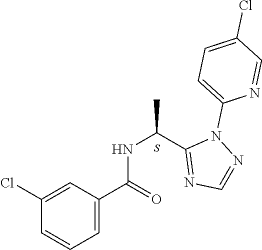 | I-141: ¹H-NMR(400.2 MHz, d₆-DMSO): δ = 9.1444 (2.8); 9.1267 (2.8); 8.6343 (6.5); 8.6279 (6.4); 8.2139 (4.7); 8.2074 (4.5); 8.1921 (5.3); 8.1856 (5.2); 8.1590 (15.3); 7.8894 (7.1); 7.8686 (5.7); 7.8675 (6.3); 7.8254 (3.9); 7.8209 (6.6); 7.8162 (4.2); 7.7447 (2.4); 7.7418 (3.3); 7.7382 (2.4); 7.7253 (2.8); 7.7218 (3.8); 7.7188 (2.7); 7.6030 (2.0); 7.6005 (2.4); 7.5978 (2.2); 7.5952 (2.2); 7.5830 (3.0); 7.5806 (3.1); 7.5778 (3.3); 7.5752 (2.8); 7.4891 (4.7); 7.4695 (7.0); 7.4497 (3.0); 5.9887 (0.5); 5.9712 (2.5); 5.9537 (4.0); 5.9362 (2.5); 5.9189 (0.6); 5.7564 (10.1); 3.8019 (1.5); 3.3293 (62.5); 3.2492 (0.4); 3.2457 (0.5); 3.2428 (0.6); 2.6775 (0.4); 2.6730 (0.5); 2.6685 (0.4); 2.5265 (1.7); 2.5218 (2.4); 2.5131 (32.7); 2.5086 (67.2); 2.5041 (88.1); 2.4994 (61.9); 2.4949 (28.9); 2.3354 (0.4); 2.3308 (0.5); 2.3263 (0.4); 1.6180 (16.0); 1.6006 (15.9); 1.2352 (0.3); 1.0880 (2.7); 1.0384 (1.8); 1.0099 (0.3); 0.8835 (0.3); 0.8653 (0.7); 0.8474 (0.4); 0.8399 (0.9); 0.8226 (0.8); 0.7984 (0.4); 0.0080 (1.2); −0.0002 (41.4); −0.0085 (1.3) |
| I-142 | 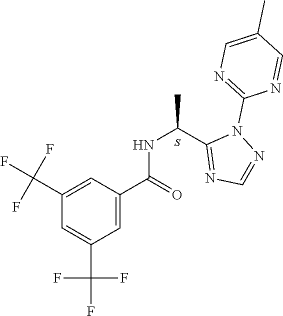 | I-142: ¹H-NMR(400.2 MHz, d₆-DMSO): δ = 9.5447 (1.6); 9.5267 (1.7); 8.8205 (10.0); 8.8189 (10.7); 8.4512 (1.5); 8.3916 (6.2); 8.3085 (2.7); 8.1508 (8.6); 5.9900 (1.3); 5.9725 (2.1); 5.9549 (1.4); 3.3888 (3.6); 2.6768 (0.5); 2.6721 (0.7); 2.6675 (0.5); 2.5257 (2.0); 2.5210 (2.9); 2.5123 (42.1); 2.5078 (87.2); 2.5033 (114.5); 2.4986 (80.2); 2.4940 (37.3); 2.3344 (0.7); 2.3296 (1.2); 2.3205 (16.0); 2.2945 (1.6); 2.0869 (0.5); 1.6593 (8.3); 1.6419 (8.3); 0.0080 (0.9); −0.0002 (34.8); −0.0086 (1.0) |
| I-143 | 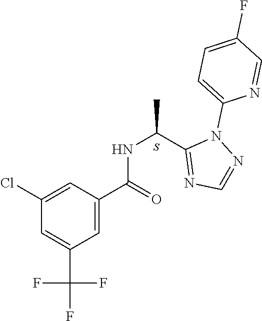 | I-143: ¹H-NMR(400.2 MHz, d₆-DMSO): δ = 9.3922 (2.9); 9.3746 (2.9); 8.5888 (6.4); 8.5813 (6.5); 8.3163 (0.5); 8.1528 (16.0); 8.1242 (5.9); 8.1204 (3.9); 8.0628 (12.2); 8.0605 (10.8); 8.0537 (2.9); 8.0461 (1.9); 8.0331 (2.5); 8.0312 (3.1); 8.0255 (2.3); 8.0237 (3.0); 8.0108 (2.9); 8.0033 (2.6); 7.9176 (3.9); 7.9077 (4.1); 7.8950 (2.8); 7.8851 (2.7); 5.9549 (0.5); 5.9377 (2.4); 5.9202 (3.9); 5.9027 (2.5); 5.8854 (0.5); 5.7564 (2.4); 3.3252 (88.4); 2.6812 (0.4); 2.6766 (0.9); 2.6720 (1.2); 2.6674 (0.9); 2.6629 (0.4); 2.5256 (3.6); 2.5209 (5.2); 2.5122 (71.6); 2.5077 (148.8); 2.5031 (195.2); 2.4984 (136.1); 2.4938 (62.8); 2.3391 (0.4); 2.3345 (0.8); 2.3299 (1.2); 2.3253 (0.8); 2.3208 (0.4); 1.6375 (15.4); 1.6200 (15.3); 0.1460 (0.3); 0.0081 (2.6); −0.0002 (91.1); −0.0085 (2.5); −0.1495 (0.3) |
| I-144 | 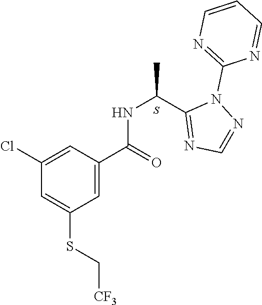 | I-144: ¹H-NMR(400.2 MHz, d₆-DMSO): δ = 9.1997 (1.6); 9.1816 (1.6); 8.9905 (10.8); 8.9783 (11.1); 8.1596 (8.2); 7.7896 (1.9); 7.7852 (4.2); 7.7807 (2.7); 7.7631 (2.8); 7.7593 (4.4); 7.7553 (2.2); 7.6735 (2.8); 7.6692 (3.9); 7.6652 (2.4); 7.6358 (3.0); 7.6236 (5.6); 7.6114 (2.8); 5.9856 (1.2); 5.9680 (2.0); 5.9503 (1.2); 5.7569 (0.9); 4.2048 (1.1); 4.1791 (3.4); 4.1534 (3.6); 4.1276 (1.2); 3.3240 (13.7); 2.6717 (0.4); 2.5254 (1.0); 2.5206 (1.5); 2.5120 (23.4); 2.5074 (48.5); 2.5029 (63.6); 2.4982 (44.4); 2.4936 (20.3); 2.3297 (0.4); 1.6339 (7.8); 1.6165 (7.7); 1.3975 (16.0); −0.0002 (8.5) |
| I-145 | 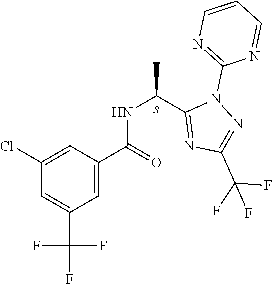 | I-145: ¹H-NMR(400.2 MHz, d₆-DMSO): δ = 9.4900 (2.5); 9.4727 (2.6); 9.0459 (15.6); 9.0337 (16.0); 8.3171 (0.3); 8.2634 (0.5); 8.1480 (0.5); 8.0973 (4.7); 8.0699 (4.5); 8.0372 (4.6); 7.9724 (0.6); 7.8727 (0.3); 7.7374 (4.1); 7.7252 (8.0); 7.7130 (4.1); 6.0558 (0.4); 6.0385 (2.1); 6.0212 (3.3); 6.0038 (2.1); 5.9865 (0.4); 3.3242 (35.5); 3.0657 (0.6); 2.8481 (0.6); 2.6813 (0.4); 2.6767 (0.8); 2.6721 (1.1); 2.6676 (0.8); 2.6629 (0.5); 2.6583 (0.5); 2.5256 (3.5); 2.5209 (5.3); 2.5122 (64.6); 2.5077 (130.7); 2.5031 (172.6); 2.4985 (126.0); 2.4940 (61.5); 2.3389 (0.4); 2.3346 (0.8); 2.3299 (1.1); 2.3254 (0.8); 2.3209 (0.4); 2.0759 (0.4); 1.7000 (11.4); 1.6826 (11.4); 1.6061 (0.4); 1.5884 (0.4); 1.3104 (0.3); 1.2931 (0.4); 1.2408 (2.4); 1.2219 (3.5); 1.2043 (2.5); 1.1835 (0.5); 1.1787 (0.4); −0.0002 (3.4) |
| I-146 | 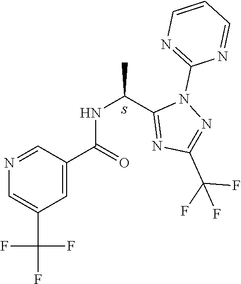 | I-146: ¹H-NMR(400.2 MHz, d₆-DMSO): δ = 9.5716 (2.7); 9.5544 (2.7); 9.1529 (4.9); 9.1484 (5.0); 9.1243 (4.4); 9.1213 (4.3); 9.0703 (0.4); 9.0534 (15.7); 9.0412 (16.0); 8.4768 (4.6); 8.3170 (0.3); 8.3100 (0.5); 8.2978 (0.5); 7.7418 (4.2); 7.7297 (8.1); 7.7175 (4.2); 6.6537 (0.5); 6.0889 (0.5); 6.0717 (2.4); 6.0543 (3.8); 6.0369 (2.4); 6.0196 (0.5); 3.3923 (0.5); 3.3749 (0.5); 3.3248 (36.0); 2.6907 (1.0); 2.6816 (0.4); 2.6771 (0.7); 2.6723 (0.9); 2.6678 (0.7); 2.6634 (0.3); 2.5258 (3.1); 2.5209 (4.9); 2.5124 (55.5); 2.5080 (110.2); 2.5034 (144.2); 2.4988 (104.6); 2.4943 (50.6); 2.3348 (0.6); 2.3302 (0.9); 2.3257 (0.7); 1.7147 (13.1); 1.6973 (13.0); 1.5606 (1.0); 1.5429 (1.0); 1.2477 (0.9); 1.2312 (1.7); 1.2146 (0.9); 1.2057 (0.4); 1.1889 (0.4); 1.1200 (0.3); 1.1093 (0.5); 1.0918 (1.0); 1.0743 (0.5); 0.8548 (0.4); 0.8384 (0.4); −0.0002 (5.1) |
| I-147 | 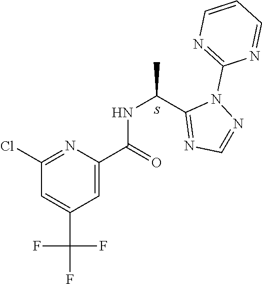 | I-147: ¹H-NMR(400.2 MHz, d₆-DMSO): δ = 9.3328 (3.1); 9.3133 (3.1); 9.0117 (11.2); 8.9995 (11.4); 8.3123 (4.2); 8.2778 (7.0); 8.2762 (7.0); 8.2024 (14.2); 8.1221 (7.2); 8.1201 (6.9); 7.9026 (0.4); 7.6491 (3.9); 7.6370 (7.1); 7.6249 (3.5); 6.0905 (0.6); 6.0732 (2.4); 6.0549 (3.2); 6.0368 (2.4); 6.0197 (0.5); 3.7478 (0.4); 3.3917 (0.4); 3.3828 (0.3); 3.3244 (390.2); 2.6810 (1.2); 2.6765 (2.6); 2.6719 (3.6); 2.6673 (2.6); 2.6628 (1.2); 2.5781 (0.3); 2.5422 (26.2); 2.5254 (11.2); 2.5207 (16.7); 2.5120 (218.3); 2.5075 (442.7); 2.5029 (582.2); 2.4983 (421.7); 2.4938 (203.8); 2.3389 (1.2); 2.3343 (2.6); 2.3297 (3.6); 2.3252 (2.6); 2.3205 (1.2); 2.0735 (14.1); 1.6412 (16.0); 1.6240 (16.0); 0.0081 (0.8); −0.0001 (30.2); −0.0084 (1.0) |
| I-148 | 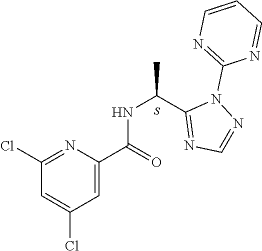 | I-148: ¹H-NMR(400.2 MHz, d₆-DMSO): δ = 9.2019 (2.3); 9.1824 (2.3); 9.0089 (15.7); 8.9968 (16.0); 8.3123 (2.9); 8.1986 (12.4); 8.0432 (7.1); 8.0389 (7.7); 7.9466 (8.8); 7.9423 (8.1); 7.6505 (4.3); 7.6383 (8.1); 7.6262 (4.1); 6.0629 (0.4); 6.0460 (1.8); 6.0279 (2.4); 6.0094 (1.9); 5.9922 (0.4); 3.3244 (437.6); 2.6806 (1.0); 2.6761 (2.3); 2.6716 (3.2); 2.6671 (2.3); 2.6626 (1.0); 2.5420 (7.3); 2.5251 (10.0); 2.5204 (14.9); 2.5117 (190.2); 2.5072 (384.1); 2.5026 (503.7); 2.4980 (363.4); 2.4935 (174.7); 2.4421 (0.4); 2.3386 (1.0); 2.3340 (2.2); 2.3295 (3.1); 2.3249 (2.2); 2.3204 (1.0); 2.0734 (2.2); 1.6217 (12.6); 1.6045 (12.6); 0.0080 (0.8); −0.0002 (26.5); −0.0084 (0.8) |
| I-149 | 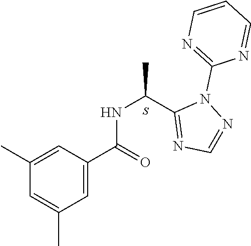 | I-149: ¹H-NMR(400.2 MHz, d₆-DMSO): δ = 8.9887 (1.7); 8.9766 (1.7); 8.8525 (0.8); 8.8342 (0.8); 8.3118 (1.6); 8.1324 (2.6); 7.6344 (0.6); 7.6227 (1.1); 7.6107 (0.5); 7.3246 (3.4); 7.1172 (1.5); 5.9663 (0.7); 5.9487 (1.0); 5.9309 (0.7); 3.3339 (241.2); 2.6806 (0.5); 2.6761 (1.1); 2.6716 (1.6); 2.6670 (1.1); 2.6624 (0.6); 2.5419 (11.2); 2.5251 (4.8); 2.5204 (7.2); 2.5117 (92.2); 2.5072 (186.8); 2.5026 (245.3); 2.4980 (177.0); 2.4934 (85.3); 2.3385 (0.5); 2.3340 (1.1); 2.3294 (1.5); 2.3248 (1.1); 2.3203 (0.5); 2.2727 (16.0); 2.0730 (1.8); 1.6147 (4.4); 1.5973 (4.4); 0.0081 (0.4); −0.0001 (12.8) −0.0084 (0.4) |
| I-150 | 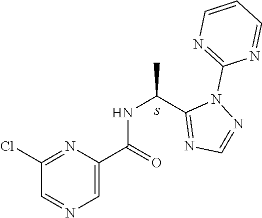 | I-150: ¹H-NMR(400.2 MHz, d₆-DMSO): δ = 9.3345 (2.5); 9.3152 (2.4); 9.2112 (1.4); 9.1906 (0.4); 9.0665 (1.5); 9.0411 (14.2); 9.0275 (0.3); 9.0084 (14.5); 9.0043 (15.3); 8.9990 (2.4); 8.9921 (15.3); 8.9869 (1.9); 8.8264 (1.2); 8.8232 (1.1); 8.8152 (1.2); 8.8121 (1.5); 8.8012 (0.8); 8.7981 (0.8); 8.7836 (2.5); 8.7716 (2.6); 8.7594 (0.8); 8.7560 (0.7); 8.7384 (0.7); 8.7347 (0.6); 8.6973 (0.3); 8.6326 (0.8); 8.6292 (0.8); 8.6112 (0.9); 8.6083 (0.8); 8.3121 (7.5); 8.2372 (0.4); 8.1917 (14.2); 8.0944 (1.3); 7.6731 (0.8); 7.6625 (0.8); 7.6526 (1.1); 7.6439 (4.8); 7.6317 (8.8); 7.6255 (0.6); 7.6196 (4.4); 7.6004 (0.9); 7.5893 (0.9); 7.5793 (0.9); 7.5718 (0.6); 7.5682 (0.9); 7.5598 (1.3); 7.5480 (0.6); 6.0831 (0.7); 6.0651 (2.4); 6.0472 (3.3); 6.0290 (2.4); 6.0114 (0.5); 5.8508 (0.3); 5.8299 (0.3); 4.8539 (1.2); 4.8477 (0.7); 4.8436 (1.2); 4.8392 (0.7); 4.8329 (1.3); 4.5819 (0.4); 4.5728 (0.5); 4.5673 (0.4); 4.5138 (0.5); 4.5000 (0.6); 4.4918 (0.5); 4.4005 (1.4); 4.3944 (0.7); 4.3901 (1.2); 4.3795 (1.3); 4.2357 (0.5); 3.9127 |
| | | (1.2); 3.9027 (1.2); 3.8794 (0.3); 3.8702 (0.5); 3.8619 (0.4); 3.8525 (0.4); |
| | | 3.8336 (0.4); 3.7841 (0.6); 3.7739 (0.9); 3.7612 (0.7); 3.7499 (0.4); 3.7436 |
| | | (0.4); 3.7371 (0.5); 3.7217 (0.7); 3.7174 (0.7); 3.7107 (1.2); 3.6930 (1.3); |
| | | 3.6862 (0.6); 3.6826 (0.8); 3.6747 (0.4); 3.6651 (0.5); 3.6220 (0.6); 3.6119 |
| | | (1.1); 3.6066 (1.1); 3.5987 (1.6); 3.5880 (0.7); 3.5840 (0.9); 3.5792 (1.1); |
| | | 3.5716 (0.8); 3.5577 (0.7); 3.5472 (0.6); 3.5392 (0.5); 3.5278 (0.3); 3.4840 |
| | | (0.5); 3.4769 (0.5); 3.4669 (0.4); 3.4560 (0.6); 3.4354 (0.6); 3.4245 (0.6); |
| | | 3.4037 (1.0); 3.3950 (1.2); 3.3868 (1.0); 3.3658 (1.9); 3.3246 (1141.0); |
| | | 3.2531 (2.2); 3.0256 (2.3); 2.7554 (1.6); 2.7274 (0.4); 2.7126 (0.4); 2.6901 |
| | | (0.5); 2.6803 (3.2); 2.6760 (6.9); 2.6714 (9.8); 2.6668 (7.1); 2.6623 (3.4); |
| | | 2.5849 (2.3); 2.5418 (45.9); 2.5249 (30.2); 2.5202 (42.7); 2.5115 (571.0); |
| | | 2.5070 (1161.3); 2.5024 (1529.0); 2.4978 (1104.2); 2.4933 (532.4); 2.4268 |
| | | (0.5); 2.4195 (0.4); 2.4052 (0.3); 2.3383 (3.0); 2.3338 (6.6); 2.3292 (9.3); |
| | | 2.3246 (6.8); 2.3201 (3.1); 2.0732 (5.3); 1.6366 (15.9); 1.6193 (16.0); 1.4990 |
| | | (0.4); 1.4823 (1.9); 1.4649 (1.6); 0.1459 (0.4); 0.0080 (2.5); −0.0002 |
| | | (90.6); −0.0086 (2.8) |
| I-151 | 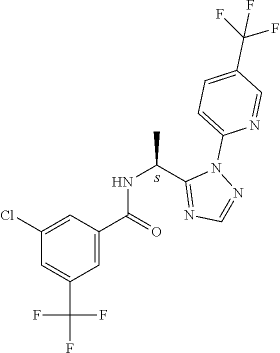 | I-151: ¹H-NMR(400.2 MHz, d₆-DMSO): δ = 9.4178 (0.6); 9.4004 (0.6); 8.9694 (0.9); 8.4923 (0.5); 8.4864 (0.5); 8.4706 (0.5); 8.4649 (0.5); 8.2425 (2.4); 8.1213 (1.1); 8.0895 (0.8); 8.0664 (1.2); 8.0617 (1.2); 8.0555 (1.4); 6.0993 (0.4); 6.0821 (0.7); 6.0647 (0.4); 3.3263 (116.5); 2.6755 (0.5); 2.6711 (0.7); 2.6667 (0.6); 2.5243 (2.2); 2.5065 (87.4); 2.5021 (115.0); 2.4977 (86.4); 2.3333 (0.5); 2.3289 (0.7); 2.3245 (0.5); 1.6623 (2.5); 1.6449 (2.5); 1.3978 (16.0); −0.0002 (0.5) |

The use examples which follow illustrate the invention without limiting it. In these examples, the compounds according to the invention cited relate to the compounds listed in Table 1 with the corresponding reference numerals (No.)

### BIOLOGICAL EXAMPLES

Phaedon cochleariae—Spray Test

| | | |
|---|---|---|
| Solvent: | 78.0 | parts by weight of acetone |
| | 1.5 | parts by weight of dimethylformamide |

| | |
|---|---|
| Emulsifier: | alkylarylpoly glycol ether |

To produce a suitable preparation of active compound, 1 part by weight of active compound is mixed with the stated amount of solvents and is diluted with water, containing an emulsifier concentration of 1000 ppm, to the desired concentration. Further test concentrations are prepared by dilution with emulsifier containing water.

Chinese cabbage (Brassica pekinensis) leaf disks are sprayed with a preparation of the active ingredient of the desired concentration. Once dry, the leaf disks are infested with mustard beetle larvae (Phaedon cochleariae).

After 7 days mortality in % is determined. 100% means all beetle larvae have been killed and 0% means none of the beetle larvae have been killed.

In this test, for example, the following compounds from the preparation examples showed good activity of 100% at an application rate of 500 g/ha: I-06, I-26, I-28, I-37, I-38, I-40, I-41, I-48, I-50, I-52, I-62, I-63, I-66, I-76, I-77, I-78, I-79, I-80, I-81, I-82, I-83, I-84, I-88, I-89, I-90, I-92, I-93, I-95, I-97, I-98, I-99, I-100, I-103, I-104, I-105, I-106, I-107, I-108, I-110, I-113, I-114, I-115, I-116, I-117, I-119, I-120, I-121, I-122.

In this test, for example, the following compounds from the preparation examples showed good activity of 83% at an application rate of 500 g/ha: I-118.

Spodoptera frugiperda—Spray Test

| | | |
|---|---|---|
| Solvent: | 78.0 | parts by weight acetone |
| | 1.5 | parts by weight dimethylformamide |

| | |
|---|---|
| Emulsifier: | alkylarylpolyglycol ether |

To produce a suitable preparation of active compound, 1 part by weight of active compound is mixed with the stated amount of solvents and is diluted with water, containing an emulsifier concentration of 1000 ppm, to the desired concentration. Further test concentrations are prepared by dilution with emulsifier containing water.

Maize (Zea mays) leaf sections are sprayed with a preparation of the active ingredient of the desired concentration. Once dry, the leaf sections are infested with fall armyworm larvae (Spodoptera frugiperda).

After 7 days mortality in % is determined. 100% means all caterpillars have been killed and 0% means none of the caterpillars have been killed.

In this test, for example, the following compounds from the preparation examples showed good activity of 100% at an application rate of 500 g/ha: I-06, I-26, I-37, I-40, I-41, I-48, I-50, I-62, I-63, I-66, I-76, I-77, I-78, I-80, I-81, I-82, I-84, I-88, I-89, I-92, I-93, I-95, I-96, I-97, I-99, I-100, I-101, I-106, I-107, I-110, I-113, I-114, I-116, I-117, I-118, I-119, I-120, I-121, I-123, I-124, I-125, I-126, I-127, I-129, I-130, I-131, I-132, I-135, I-136, I-137.

In this test, for example, the following compounds from the preparation examples showed good activity of 83% at an application rate of 500 g/ha: I-83, I-98, I-115.

Myzus persicae—Spray Test

| | | |
|---|---|---|
| Solvent: | 78.0 | parts by weight acetone |
| | 1.5 | parts by weight dimethylformamide |

| | |
|---|---|
| Emulsifier: | alkylarylpolyglycol ether |

To produce a suitable preparation of active compound, 1 part by weight of active compound is mixed with the stated amount of solvents and is diluted with water, containing an emulsifier concentration of 1000 ppm, to the desired concentration. Further test concentrations are prepared by dilution with emulsifier containing water.

Chinese cabbage (Brassica pekinensis) leaf disks infected with all instars of the green peach aphid (Myzus persicae), are sprayed with a preparation of the active ingredient of the desired concentration.

After 5 days mortality in % is determined. 100% means all aphids have been killed and 0% means none of the aphids have been killed.

In this test, for example, the following compounds from the preparation examples showed good activity of 100% at an application rate of 500 g/ha: I-93, I-127.

In this test, for example, the following compounds from the preparation examples showed good activity of 90% at an application rate of 500 g/ha: I-40, I-96, I-123, I-124, I-125, I-126, I-134.

Myzus persicae—Oral Test

| | | |
|---|---|---|
| Solvent: | 100 | parts by weight acetone |

To produce a suitable preparation of active compound, 1 part by weight of active compound is mixed with the stated amount of solvent, and the concentrate is diluted with water to the desired concentration. 50 μl compound solution is filled in microtiter plates and 150 μl IPL41 insect medium (33%+15% sugar) is added to obtain a total volume of 200 μl per well. Afterwards the plates are sealed with parafilm through which a mixed population of the green peach aphid (Myzus persicae) can suck on the compound preparation.

After 5 days mortality in % is determined. 100% means all aphids have been killed and 0% means none of the aphids have been killed.

In this test, for example, the following compounds from the preparation examples showed good activity of 100% at an application rate of 20 ppm: I-06, I-26, I-28, I-37, I-38, I-40, I-41, I-48, I-50, I-62, I-63, I-66, I-76, I-77, I-78, I-80, I-81, I-82, I-83, I-84, I-85, I-88, I-89, I-90, I-92, I-93, I-94, I-95, I-97, I-98, I-99, I-100, I-101, I-104, I-106, I-107, I-110, I-113, I-114, I-115, I-117, I-118, I-119, I-120, I-121, I-122.

In this test, for example, the following compounds from the preparation examples showed good activity of 90% at an application rate of 20 ppm: I-52, I-103, I-116.

Aphis gossypii—Oral Test

Solvent: 100 parts by weight acetone

To produce a suitable preparation of active compound, 1 part by weight of active compound is mixed with the stated amount of solvent, and the concentrate is diluted with water to the desired concentration.

50 μl compound solution is filled in microtiter plates and 150 μl IPL41 insect medium (33%+15% sugar) is added to obtain a total volume of 200 μl per well. Afterwards the plates are sealed with parafilm through which a mixed population of the cotton aphid (Aphis gossypii) can suck on the compound preparation.

After 5 days mortality in % is determined. 100% means all aphids have been killed and 0% means none of the aphids have been killed.

In this test, for example, the following compounds from the preparation examples showed good activity of 100% at an application rate of 100 ppm: I-06, I-26, I-28, I-37, I-38, I-40, I-41, I-48, I-50, I-52, I-62, I-63, I-66, I-76, I-77, I-78, I-80, I-81, I-82, I-83, I-85, I-88, I-89, I-90, I-92, I-93, I-94, I-95, I-97, I-98, I-99, I-100, I-101, I-103, I-106, I-107, I-110, I-113, I-114, I-115, I-116, I-117, I-119, I-120, I-121, I-122.

In this test, for example, the following compounds from the preparation examples showed good activity of 90% at an application rate of 100 ppm: I-104.

Diabrotica balteata—Spray Test

| | | |
|---|---|---|
| Solvent: | 78.0 | parts by weight of acetone |
| | 1.5 | parts by weight of dimethylformamide |

| | |
|---|---|
| Emulsifier: | alkylarylpolyglycol ether |

To produce a suitable preparation of active compound, 1 part by weight of active compound is mixed with the stated amount of solvent, and the concentrate is diluted with water, containing an emulsifier concentration of 1000 ppm, to the desired concentration. Further test concentrations are prepared by dilution with emulsifier containing water.

Soaked wheat seeds (Triticum aestivum) are placed in a multiple well plate filled with agar and some water and are incubated for 1 day to germinate (5 seeds per well). The germinated wheat seeds are sprayed with a test solution containing the desired concentration of the active ingredient. Afterwards each unit is infected with 10-20 larvae of the banded cucumber beetle (Diabrotica balteata).

After 7 days efficacy in % is determined. 100% means all the seedlings have grown up like in the untreated, uninfected control; 0% means none of the seedlings have grown.

In this test, for example, the following compounds from the preparation examples showed good activity of 100% at an application rate of 160 μg/well: I-06, I-26, I-28, I-37, I-38, I-40, I-41, I-48, I-50, I-62, I-63, I-66, I-76, I-77, I-78, I-79, I-80, I-81, I-82, I-83, I-84, I-85, I-87, I-88, I-89, I-91, I-92, I-93, I-94, I-95, I-97, I-98, I-99, I-100, I-101, I-102, I-103, I-104, I-105, I-106, I-107, I-108, I-109, I-110, I-112, I-113, I-114, I-115, I-116, I-117, I-118, I-119, I-120, I-121, I-122, I-125, I-126, I-127, I-128, I-129, I-130, I-132, I-133, I-134, I-135, I-136, I-137.

In this test, for example, the following compounds from the preparation examples showed good activity of 80% at an application rate of 160 μg/well: I-131.

Meloidogyne incognita—Test

Solvent: 125.0 parts by weight of acetone

To produce a suitable preparation of active compound, 1 part by weight of active compound is mixed with the stated amount of solvent, and the concentrate is diluted with water to the desired concentration.

Vessels are filled with sand, a solution of the active ingredient, a suspension containing eggs and larvae of the southern root-knot nematode (Meloidogyne incognita) and salad seeds. The salad seeds germinate and the seedlings grow. Galls develop in the roots.

After 14 days the nematicidal activity is determined on the basis of the percentage of gall formation. 100% means no galls were found and 0% means the number of galls found on the roots of the treated plants was equal to that in untreated control plants.

In this test, for example, the following compounds from the preparation examples showed good activity of 100% at an application rate of 20 ppm: I-38, I-48, I-79, I-82, I-88, I-89, I-93, I-109.

In this test, for example, the following compounds from the preparation examples showed good activity of 90% at an application rate of 20 ppm: I-80, I-95, I-107, I-108, I-111.

Tetranychus urticae—Spray Test OP-Resistant

| | | |
|---|---|---|
| Solvent: | 78.0 | parts by weight acetone |
| | 1.5 | parts by weight dimethylformamide |

| | |
|---|---|
| Emulsifier: | alkylarylpoly glycol ether |

To produce a suitable preparation of active compound, 1 part by weight of active compound is mixed with the stated amount of solvents and is diluted with water, containing an emulsifier concentration of 1000 ppm, to the desired concentration. Further test concentrations are prepared by dilution with emulsifier containing water.

French bean (Phaseolus vulgaris) leaf disks infected with all instars of the two spotted spidermite (Tetranychus urticae), are sprayed with a preparation of the active ingredient of the desired concentration.

After 6 days mortality in % is determined. 100% means all spider mites have been killed and 0% means none of the spider mites have been killed.

In this test, for example, the following compounds from the preparation examples showed good activity of 100% at an application rate of 500 g/ha: I-83, I-123.

In this test, for example, the following compounds from the preparation examples showed good activity of 95% at an application rate of 500 g/ha: I-110, I-116.

In this test, for example, the following compounds from the preparation examples showed good activity of 90% at an application rate of 500 g/ha: I-37, I-41, I-96, I-112.

In this test, for example, the following compounds from the preparation examples showed good activity of 80% at an application rate of 500 g/ha: I-81, I-82, I-97.

Nezara viridula—Spray Test 1

| | | |
|---|---|---|
| Solvent: | 78.0 | parts by weight of acetone |
| | 1.5 | parts by weight of dimethylformamide |

| | |
|---|---|
| Emulsifier: | alkylarylpolyglycol ether |

To produce a suitable preparation of active compound, 1 part by weight of active compound is mixed with the stated amount of solvent, and the concentrate is diluted with water, containing an emulsifier concentration of 1000 ppm, to the desired concentration. Further test concentrations are prepared by dilution with emulsifier containing water.

Barley plants (Hordeum vulgare) infested with larvae of the southern green stink bug (Nezara viridula) are sprayed with a test solution containing the desired concentration of the active ingredient.

After 4 days mortality in % is determined. 100% means all the stink bugs have been killed; 0% means none of the stink bugs have been killed.

In this test, for example, the following compounds from the preparation examples showed good activity of 100% at an application rate of 500 g/ha: I-06, I-28, I-37, I-38, I-40, I-41, I-48, I-50, I-52, I-63, I-66, I-76, I-77, I-78, I-80, I-81, I-82, I-83, I-84, I-95, I-96, I-97, I-98, I-99, I-100, I-104, I-106, I-107, I-108, I-110, I-113, I-114, I-115, I-116, I-117, I-119, I-120, I-121, I-122, I-123, I-124, I-125, I-126, I-127, I-128, I-129, I-129, I-131, I-132, I-134, I-137.

In this test, for example, the following compounds from the preparation examples showed good activity of 90% at an application rate of 500 g/ha: I-62, I-79.

Nilaparvata lugens—Spray Test 1

| | | |
|---|---|---|
| Solvent: | 78.0 | parts by weight of acetone |
| | 1.5 | parts by weight of dimethylformamide |

| | |
|---|---|
| Emulsifier: | alkylarylpoly glycol ether |

To produce a suitable preparation of active compound, 1 part by weight of active compound is mixed with the stated amount of solvents and is diluted with water, containing an emulsifier concentration of 1000 ppm, to the desired concentration. Further test concentrations are prepared by dilution with emulsifier containing water.

Rice plants (Oryza sativa) are sprayed with a preparation of the active ingredient of the desired concentration and the plants are infested with the brown planthopper (Nilaparvata lugens).

After 4 days mortality in % is determined. 100% means all planthoppers have been killed and 0% means none of the planthoppers have been killed.

In this test, for example, the following compounds from the preparation examples showed good activity of 100% at an application rate of 500 g/ha: I-06, I-28, I-37, I-40, I-41, I-48, I-52, I-63, I-66, I-76, I-77, I-78, I-79, I-81, I-82, I-83, I-93, I-96, I-97, I-98, I-100, I-106, I-107, I-108, I-110, I-113, I-114, I-115, I-116, I-117, I-119, I-121, I-122, I-123, I-131, I-134.

In this test, for example, the following compounds from the preparation examples showed good activity of 90% at an application rate of 500 g/ha: I-26, I-62, I-81, I-95, I-99, I-124.

Nezara viridula—Spray Test 2

| | | |
|---|---|---|
| Solvent: | 52.5 | parts by weight of acetone |
| | 7 | parts by weight of dimethylformamide |

| | |
|---|---|
| Emulsifier: | alkylaryl poly glycolether |

To produce a suitable preparation of active compound, 1 part by weight of active compound is mixed with the stated amount of solvent, and the concentrate is diluted with water, containing an emulsifier concentration of 1000 ppm, to the desired concentration. Ammonium salt and/or penetration enhancer in a dosage of 1000 ppm are added to the desired concentration if necessary.

Barley plants (Hordeum vulgare) infested with larvae of the southern green stink bug (Nezara viridula) are sprayed with a test solution containing the desired concentration of the active ingredient.

After 4 days mortality in % is determined. 100% means all the stink bugs have been killed; 0% means none of the stink bugs have been killed.

In this test, for example, the following compounds from the preparation examples showed good activity of 100% at an application rate of 500 g/ha: I-40, I-76, I-93.

Nilaparvata lugens —Spray Test 2

| | | |
|---|---|---|
| Solvent: | 52.5 | parts by weight of acetone |
| | 7 | parts by weight of dimethylformamide |

| | |
|---|---|
| Emulsifier: | alkylaryl poly glycolether |

To produce a suitable preparation of active compound, 1 part by weight of active compound is mixed with the stated amount of solvents and is diluted with water, containing an emulsifier concentration of 1000 ppm, to the desired concentration. Further test concentrations are prepared by dilution with emulsifier containing water. Ammonium salt and/or penetration enhancer in a dosage of 1000 ppm are added to the desired concentration if necessary.

Rice plants (Oryza sativa) are treated by being sprayed with the desired concentration of the active compound and are infested with larvae of the brown planthopper (Nilaparvata lugens).

After 4 days mortality in % is determined. 100% means all planthoppers have been killed and 0% means none of the planthoppers have been killed.

In this test, for example, the following compounds from the preparation examples showed good activity of 100% at an application rate of 500 g/ha: I-40, I-76, I-93.

### Surface Contact Bioassays (Target Insects: Mosquitoes, Flies, Cockroaches)

### Culex Test (CULXFAS Surface Treatment & Contact Assay)

Solvent: Acetone+2000 ppm rapeseed oil methyl ester (RME)

In order to produce a sufficient, active ingredient containing solution it is necessary to solve the test-compound in an acetone/RME solvent mixture. This solution is pipetted onto a glazed tile and after evaporation of the acetone, adult mosquitoes of the species Culex quinquefasciatus (Brown house mosquito) are placed onto the dried surface. The exposure time is 30 minutes.

Mortality in percent (%) is determined 24 hours after contact to the treated surface. 100% mortality means that all test-insects are dead, whereas 0% means that not a single insect died.

The following compound-example-numbers showed in this test efficacy of 80-100% at a surface concentration of 100 mg/m²: I-93, I-113.

The following compound-example-numbers showed in this test efficacy of 80-100% at a surface concentration of 20 mg/m²: I-37, I-48, I-63, I-77, I-81, I-93, I-113, I-114, I-119, I-120.

The following compound-example-numbers showed in this test efficacy of 80-100% at a surface concentration of 4 mg/m²: I-37, I-48, I-63, I-77, I-81, I-93, I-113, I-114, I-119, I-120.

### Anopheles Test (ANPHFU Surface Treatment & Contact Assay)

Solvent: Acetone+2000 ppm rapeseed oil methyl ester (RME)

In order to produce a sufficient, active ingredient containing solution it is necessary to solve the test-compound in an acetone/RME solvent mixture. This solution is pipetted onto a glazed tile and after evaporation of the acetone, adult mosquitoes of the species Anopheles funestus strain FUMOZ-R (Hunt et al., Med Vet Entomol. 2005 Sep. 19(3):271-5) are placed onto the dried surface. The exposure time is 30 minutes.

Mortality in percent (%) is determined 24 hours after contact to the treated surface. 100% mortality means that all test-insects are dead, whereas 0% means that not a single insect died.

The following compound-example-numbers showed in this test efficacy of 80-100% at a surface concentration of 100 mg/m²: I-93, I-113.

The following compound-example-numbers showed in this test efficacy of 80-100% at a surface concentration of 20 mg/m²: I-93, I-113.

The following compound-example-numbers showed in this test efficacy of 80-100% at a surface concentration of 4 mg/m²: I-93, I-113.

### Aedes Test (AEDSAE Surface Treatment & Contact Assay)

Solvent: Aceton+2000 ppm rapeseed oil methyl ester (RME)

In order to produce a sufficient, active ingredient containing solution it is necessary to solve the test-compound in an acetone/RME solvent mixture. This solution is pipetted onto a glazed tile and after evaporation of the acetone, adult mosquitoes of the species Aedes aegypti strain MONHEIM are placed onto the dried surface. The exposure time is 30 minutes.

Mortality in percent (%) is determined 24 hours after contact to the treated surface. 100% mortality means that all test-insects are dead, whereas 0% means that not a single insect died.

The following compound-example-numbers showed in this test efficacy of 80-100% at a surface concentration of 100 mg/m²: I-93, I-113.

The following compound-example-numbers showed in this test efficacy of 80-100% at a surface concentration of 20 mg/m²: I-37, I-48, I-63, I-77, I-81, I-93, I-113, I-114, I-119, I-120.

The following compound-example-numbers showed in this test efficacy of 80-100% at a surface concentration of 4 mg/m²: I-37, I-48, I-63, I-81, I-93, I-113, I-114, I-119, I-120.

Musca domestica Test (MUSCDO Surface Treatment & Contact Assay)

Solvent: Aceton+2000 ppm Rapeseed oil methyl ester (RME)

In order to produce a sufficient, active ingredient containing solution it is necessary to solve the test-compound in an acetone/RME solvent mixture. This solution is pipetted onto a glazed tile and after evaporation of the acetone, adult flies of the species Musca domestica strain WHO-N are placed onto the dried surface. The exposure time is 30 minutes.

Mortality in percent (%) is determined 24 hours after contact to the treated surface. 100% mortality means that all test-insects are dead, whereas 0% means that not a single insect died.

The following compound-example-numbers showed in this test efficacy of 80-100% at a surface concentration of 20 mg/m²: I-37, I-48, I-63, I-77, I-81, I-113, I-114, I-119, I-120.

The following compound-example-numbers showed in this test efficacy of 80-100% at a surface concentration of 4 mg/m²: I-37, I-48, I-63, I-77, I-81, I-113, I-114, I-119, I-120.

Blattella germanica Test (BLTTGE Surface Treatment & Contact Assay)

Solvent: Aceton+2000 ppm Rapeseed oil methyl ester (RME)

In order to produce a sufficient, active ingredient containing solution it is necessary to solve the test-compound in an acetone/RME solvent mixture. This solution is pipetted onto a glazed tile and after evaporation of the acetone, adult animals of the species Blattella germanica strain PAULINIA are placed onto the dried surface. The exposure time is 30 minutes.

Mortality in percent (%) is determined 24 hours after contact to the treated surface. 100% mortality means that all test-insects are dead, whereas 0% means that not a single insect died.

The following compound-example-numbers showed in this test efficacy of 80-100% at a surface concentration of 20 mg/m²: I-37, I-48, I-63, I-77, I-81, I-114, I-119, I-120.

The following compound-example-numbers showed in this test efficacy of 80-100% at a surface concentration of 4 mg/m²: I-37, I-48, I-63, I-81, I-114, I-119.

1. A pest control product comprising a compound of formula (I) 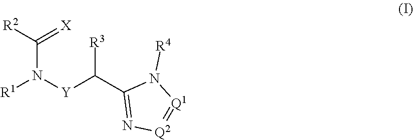
wherein:
X is O or S;
Q¹ and Q² are independently CR⁵ or N, provided at least one of Q¹ and Q² is N;
Y is a direct bond or CH₂;
R¹ is H; C₁-C₆alkyl optionally substituted with one substituent selected from: CN, CONH₂, COOH, NO₂ and —Si(CH₃)₃; C₁-C₆haloalkyl; C₂-C₆alkenyl; C₂-C₆haloalkenyl; C₂-C₆alkynyl; C₂-C₆haloalkynyl; C₃-C₄cycloalkyl-C₁-C₂alkyl- wherein the C₃-C₄cycloalkyl is optionally substituted with 1 or 2 halo atoms; oxetan-3-yl-CH₂—; or benzyl optionally substituted with halo or C₁-C₃haloalkyl;
R² is phenyl, pyridine, pyrimidine, pyrazine or pyridazine, wherein the phenyl, pyridine, pyrimidine, pyrazine or pyridazine is optionally substituted with one to three substituents, provided the substituent(s) are not on either carbon adjacent to the carbon bonded to the 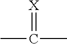
group, each independently selected from: C₁-C₃alkyl, C₁-C₃haloalkyl, C₁-C₃haloalkylsulfanyl, C₁-C₃alkoxy, C₁-C₃haloalkoxy, halo, NO₂, SF₅, CN, CONH₂, COOH and C(S)NH₂;
R³ is C₁-C₃alkyl or C₁-C₃haloalkyl;
R⁴ is pyridine, pyrimidine, pyrazine or pyridazine, wherein the pyridine, pyrimidine, pyrazine or pyridazine is optionally substituted with one substituent selected from: C₁-C₃alkyl, C₁-C₃haloalkyl, C₁-C₃alkoxy, C₃-C₄cycloalkyl, halo or hydroxy;
R⁵ is H, C₁-C₃alkyl, C₁-C₃haloalkyl, C₃-C₄cycloalkyl, C₁-C₃alkoxy, C₁-C₃alkoxyC(O)— or (C₁-C₃alkoxy)₂CH—;
or a salt thereof,
for controlling one or more animal pests, optionally including arthropods and insects, optionally in plant protection.

2. The pest control product comprising the compound or salt according to claim 1, wherein Y is a direct bond.

3. The pest control product comprising the compound or salt according to claim 1, wherein X is O.

4. The pest control product comprising the compound or salt according to claim 1, wherein R³ is methyl.

5. The pest control product comprising the compound or salt according to claim 1, wherein Q¹ is N, Q² is CR and R⁵ is H, methyl, (CH₃CH₂O)₂CH— or CF₃.

6. The pest control product comprising the compound or salt according to claim 1, wherein R⁴ is 2-pyridine, 3-pyridine, 4-pyridine, 2-pyrimidine, 4-pyrimidine, 5-pyrimidine, 2-pyrazine, 3-pyridazine or 4-pyridazine, wherein the 2-pyridine, 3-pyridine, 4-pyridine, 2-pyrimidine, 4-pyrimidine, 5-pyrimidine, 2-pyrazine, 3-pyridazine or 4-pyridazine is optionally substituted with one substituent selected from: C₁-C₃alkoxy, halo, C₁-C₃haloalkyl, or C₁-C₃alkyl.

7. The pest control product comprising the compound or salt according to claim 6, wherein R is 2-pyridine optionally substituted with F, Cl, Br, I, C₁-C₃alkyl or C₁-C₃haloalkyl; or 2-pyrimidine optionally substituted with C₁-C₃alkoxy, F, Cl, Br, I, C₁-C₃alkyl or C₁-C₃haloalkyl.

8. The pest control product comprising the compound or salt according to claim 1, wherein R is H, cyclopropyl-CH₂—, cyclobutyl-CH₂—, CH₃—, CH₃CH₂—, n-propyl, CH≡C—CH₂—, CF₃CH₂CH₂—, FCH₂CH₂—, FCH₂CH₂CH₂—, CHF₂CH₂—, 2,2-difluorocyclopropyl-CH₂—, 2,2-dichlorocyclopropyl-CH₂—, benzyl, 4-fluorobenzyl, 3-oxetanyl, (CH₃)₃SiCH₂— or CN—CH₂—.

9. The pest control product comprising the compound or salt according to claim 1, wherein R² is 3,5-bis(trifluoromethyl)phenyl, 3,5-dichlorophenyl, 3,4,5-trichlorophenyl, 3-chlorophenyl, 4-chlorophenyl, 3,4-dichlorophenyl, 3-trifluoromethoxyphenyl, 3-chloro-5-trifluoromethylphenyl, 3-cyanophenyl, 3-chloro-5-trifluoromethoxyphenyl, 5-trifluoromethylpyridin-3-yl, 5-bromopyridin-3-yl, 5-trifluoromethylsulfanylpyridin-3-yl, 3-bromo-5-trifluoromethylphenyl, 3-cyano-5-trifluoromethyl-phenyl, 3-chloro-5-cyanophenyl, 3-trifluoromethoxy-5-chlorophenyl, 3-trifluoromethylsulfanylphenyl, 3-trifluoromethylsulfanyl-5-chlorophenyl, 2,6-bis(trifluoromethyl)pyridin-4-yl, 3,5-dimethylphenyl, 4-trifluoromethyl-6-chloropyridin-2-yl, 4,6-dichloropyridin-2-yl, 6-chloropyridazin-2-yl, 3-bromo-5-chlorophenyl, 3-iodo-5-chlorophenyl, 4-chloro-3,5-difluorophenyl, 3-fluoro-5-cyanophenyl, or 3-chloro-[(2,2,2-trifluoroethyl)sulfanyl]phenyl.

10. The pest control product comprising the compound or salt according to claim 9, wherein R² is 3,5-bis(trifluoromethyl)phenyl, 3,5-dichlorophenyl, 3-trifluoromethoxyphenyl, 3-chloro-5-trifluoromethylphenyl, 3-cyanophenyl, 3-chloro-5-cyanophenyl, 3-chloro-5-trifluoromethoxyphenyl, 3-chloro-5-trifluoromethylsulfanylphenyl, 5-trifluoromethylpyridin-3-yl, 3-bromo-5-trifluoromethylphenyl, 3-cyano-5-trifluoromethyl-phenyl, 3,5-dimethylphenyl, 4-trifluoromethyl-6-chloropyridin-2-yl, 4,6-dichloropyridin-2-yl, 6-chloropyridazin-2-yl, 3-bromo-5-chlorophenyl, 3-iodo-5-chlorophenyl, 4-chloro-3,5-difluorophenyl, 3-fluoro-5-cyanophenyl, or 3-chloro-[(2,2,2-trifluoroethyl)sulfanyl]phenyl.

11. The pest control product comprising the compound or salt according to claim 1, which is N-(cyclopropylmethyl)-N-[(1S)-1-(2-pyrimidin-2-yl-1,2,4-triazol-3-yl)ethyl]-3,5-bis(trifluoromethyl)benzamide, N-Prop-2-ynyl-N-[(1S)-1-(2-pyrimidin-2-yl-1,2,4-triazol-3-yl)ethyl]-3,5-bis(trifluoromethyl)benzamide, N-methyl-N-[(1S)-1-(2-pyrimidin-2-yl-1,2,4-triazol-3-yl)ethyl]-3,5-bis(trifluoromethyl)benzamide, 3-chloro-N-(cyclopropylmethyl)-N-[1-(2-pyrimidin-2-yl-1,2,4-triazol-3-yl)ethyl]-5-trifluoro-methyl)benzamide, 3-chloro-N-prop-2-ynyl-N-[1-(2-pyrimidin-2-yl-1,2,4-triazol-3-yl)ethyl]-5-(trifluoromethyl)benzamide, 3-chloro-N-(cyclopropylmethyl)-N-[1-(2-pyrimidin-2-yl-1,2,4-triazol-3-yl)ethyl]-5-(trifluoromethyl)benzamide, 3-chloro-N-[1-(2-pyrimidin-2-yl-1,2,4-triazol-3-yl)ethyl]-5-(trifluoromethyl)-N-(3,3,3-trifluoropropyl)benzamide, N-(cyclopropylmethyl)-N-[1-(2-pyrimidin-2-yl-1,2,4-triazol-3-yl)ethyl]-5-(trifluoromethyl)pyridine-3-carboxamide, 3-chloro-N-(cyclopropylmethyl)-N-[1-(2-pyrimidin-2-yl-1,2,4-triazol-3-yl)ethyl]-5-(trifluoromethoxy)benzamide, 3-cyano-N-(cyclopropylmethyl)-N-[1-(2-pyrimidin-2-yl-1,2,4-triazol-3-yl)ethyl]benzamide, 3-chloro-N-(cyclopropylmethyl)-N-[1-(2-pyrimidin-2-yl-1,2,4-triazol-3-yl)ethyl]-5-(trifluoromethyl)benzamide, 3-chloro-N-prop-2-ynyl-N-[1-(2-pyrimidin-2-yl-1,2,4-triazol-3-yl)ethyl]-5-(trifluoromethyl)benzamide, 3-cyano-N-(cyclopropylmethyl)-N-[1-(2-pyrimidin-2-yl-1,2,4-triazol-3-yl)ethyl]-5-(trifluoromethyl)benzamide, 3-bromo-N-(cyclopropylmethyl)-N-[1-(2-pyrimidin-2-yl-1,2,4-triazol-3-yl)ethyl]-5-(trifluoromethyl)benzamide, N-[1-(2-pyrimidin-2-yl-1,2,4-triazol-3-yl)ethyl]-3,5-bis(trifluoromethyl)benzamide, N-[(1S)-1-(2-pyrimidin-2-yl-1,2,4-triazol-3-yl)ethyl]-3,5-bis(trifluoromethyl)benzamide, 3-chloro-N-[1-(2-pyrimidin-2-yl-1,2,4-triazol-3-yl)ethyl]-5-(trifluoromethyl)benzamide, 3-chloro-N-[(1S)-1-(2-pyrimidin-2-yl-1,2,4-triazol-3-yl)ethyl]-5-(trifluoromethyl)benzamide, 3-chloro-N-(cyclopropylmethyl)-N-[1-[2-(5-fluoropyrimidin-2-yl)-5-methyl-1,2,4-triazol-3-yl]ethyl]-5-(trifluoromethyl)benzamide, 3-chloro-N-[1-[2-(5-chloropyrimidin-2-yl)-5-methyl-1,2,4-triazol-3-yl]ethyl]-N-(cyclopropylmethyl)-5-(trifluoromethyl)benzamide, 3-chloro-N-[1-[2-(5-chloropyrimidin-2-yl)-1,2,4-triazol-3-yl]ethyl]-N-(cyclopropylmethyl)-5-(trifluoromethyl)benzamide, 3-chloro-N-(cyclopropylmethyl)-N-[1-[2-(5-fluoropyrimidin-2-yl)-1,2,4-triazol-3-yl]ethyl]-5-(trifluoromethyl)benzamide, 3-chloro-N-[1-[2-(5-chloro-2-pyridyl)-1,2,4-triazol-3-yl]ethyl]-N-(cyclopropylmethyl)-5-(trifluoromethyl)benzamide, 3-chloro-N-(2,2-difluoroethyl)-N-[1-(2-pyrimidin-2-yl-1,2,4-triazol-3-yl)ethyl]-5-(trifluoromethyl)benzamide, N-[1-[2-(5-bromopyrimidin-2-yl)-1,2,4-triazol-3-yl]ethyl]-3-chloro-N-(cyclopropylmethyl)-5-(trifluoromethyl)benzamide, 3-chloro-N-(cyclopropylmethyl)-N-[(1S)-1-(2-pyrimidin-2-yl-1,2,4-triazol-3-yl)ethyl]-5-(trifluoromethyl)benzamide, 3-chloro-N-ethyl-N-[1-(2-pyrimidin-2-yl-1,2,4-triazol-3-yl)ethyl]-5-(trifluoromethyl)benzamide, 3-chloro-N-methyl-N-[1-(2-pyrimidin-2-yl-1,2,4-triazol-3-yl)ethyl]-5-(trifluoromethyl)benzamide, 3-chloro-N-(cyclopropylmethyl)-N-[1-(2-pyrimidin-2-yl-1,2,4-triazol-3-yl)ethyl]-5-(trifluoromethylsulfanyl)benzamide, 3-chloro-5-cyano-N-[1-(2-pyrimidin-2-yl-1,2,4-triazol-3-yl)ethyl]benzamide, 3-chloro-N-[(1S)-1-[2-(2-pyridyl)-1,2,4-triazol-3-yl]ethyl]-5-(trifluoromethyl)benzamide, 3-chloro-N-[1-(2-pyrimidin-2-yl-1,2,4-triazol-3-yl)ethyl]-5-(trifluoromethoxy)benzamide, or 3-chloro-N-[(1S)-1-[2-(5-chloro-2-pyridyl)-1,2,4-triazol-3-yl]ethyl]-5-(trifluoromethyl)benzamide, 3-chloro-N-(2,2-difluoroethyl)-N-[1-(2-pyrimidin-2-yl-1,2,4-triazol-3-yl)ethyl]-5-(trifluoromethoxy)benzamide, 3-bromo-5-chloro-N-[1-(2-pyrimidin-2-yl-1,2,4-triazol-3-yl)ethyl]benzamide, 3-chloro-5-iodo-N-[1-(2-pyrimidin-2-yl-1,2,4-triazol-3-yl)ethyl]benzamide, 3-chloro-N-(2,2-difluoroethyl)-N-[(1S)-1-(2-pyrimidin-2-yl-1,2,4-triazol-3-yl)ethyl]-5-(trifluoromethyl)benzamide, N-[(1S)-1-[2-(5-bromo-2-pyridyl)-1,2,4-triazol-3-yl]ethyl]-3-chloro-5-(trifluoromethyl)benzamide, 3-chloro-N-[(1S)-1-[2-(5-chloro-2-pyridyl)-5-(trifluoromethyl)-1,2,4-triazol-3-yl]ethyl]-5-(trifluoromethyl)benzamide, 3-chloro-N-[(1S)-1-[2-(5-iodo-2-pyridyl)-1,2,4-triazol-3-yl]ethyl]-5-(trifluoromethyl)benzamide, N-[(1S)-1-[2-(5-chloro-2-pyridyl)-5-(trifluoromethyl)-1,2,4-triazol-3-yl]ethyl]-3,5-bis(trifluoromethyl)benzamide, 3-bromo-5-chloro-N-[(1S)-1-[2-(5-chloro-2-pyridyl)-1,2,4-triazol-3-yl]ethyl]benzamide, 3,5-bis(trifluoromethyl)-N-[(1S)-1-[2-[5-(trifluoromethyl)pyrimidin-2-yl]-1,2,4-triazol-3-yl]ethyl]benzamide, 3-chloro-N-[(1S)-1-[2-(5-fluoro-2-pyridyl)-1,2,4-triazol-3-yl]ethyl]-5-(trifluoromethyl)benzamide, 3-chloro-N-[(1S)-1-[2-pyrimidin-2-yl-5-(trifluoromethyl)-1,2,4-triazol-3-yl]ethyl]-5-(trifluoromethyl)benzamide, or 3-chloro-5-(trifluoromethyl)-N-[(1S)-1-[2-[5-(trifluoromethyl)-2-pyridyl]-1,2,4-triazol-3-yl]ethyl]benzamide.

12. A Method of controlling one or more animal pests optionally in plant protection, optionally including arthropods and insects, comprising allowing the pest control product comprising the compound or salt according to claim 1 to act on said animal pests and/or a habitat thereof, wherein said method comprises treatment of a human or animal body, by surgery or therapy and further wherein diagnostic methods practiced on a human or animal body, are excluded.

13. The pest control product comprising the compound or salt according to claim 1 for treatment of seeds.

14. The pest control product comprising the compound or salt according to claim 1 in vector control, wherein a host is a human body.

15. A Method of controlling one or more vectors comprising allowing the pest control product comprising the compound or salt according to claim 1 to act on said one or more vectors and/or a habitat thereof, wherein a host of said vector is the human body and wherein said method comprises surgery or therapy and wherein diagnostic methods practiced on a human body, are excluded.

16. Compound which is selected from the group of the following compounds of formula (I-76) to (I-151): 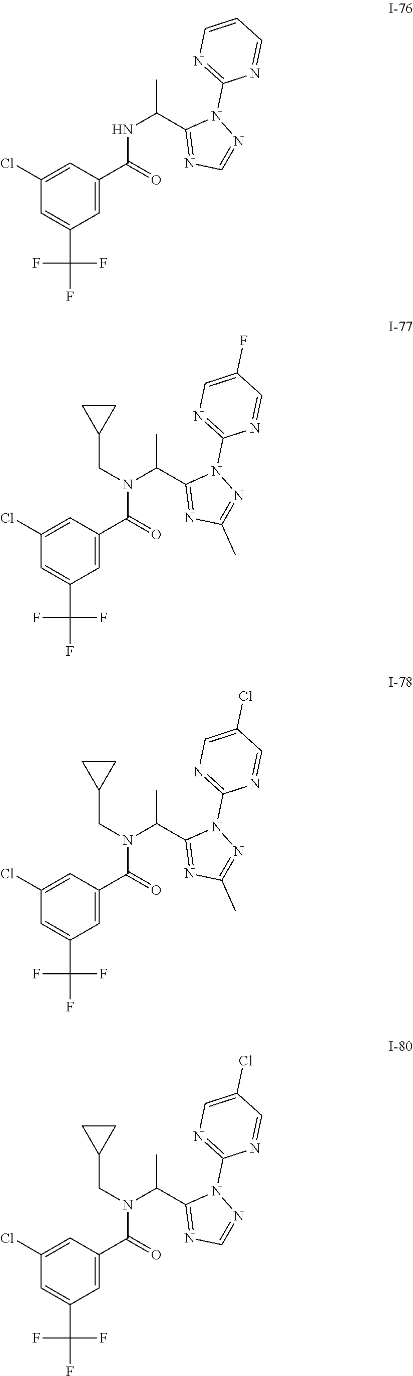 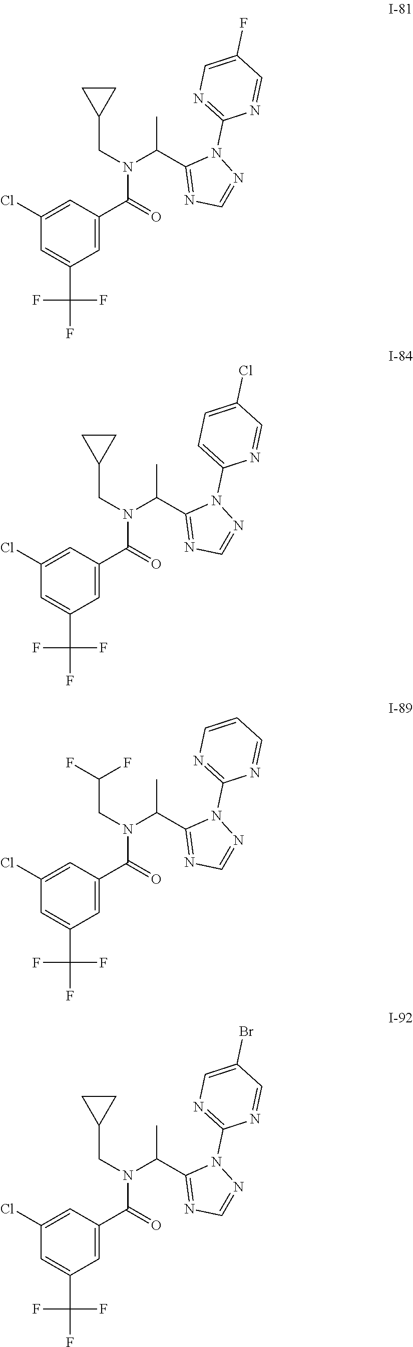 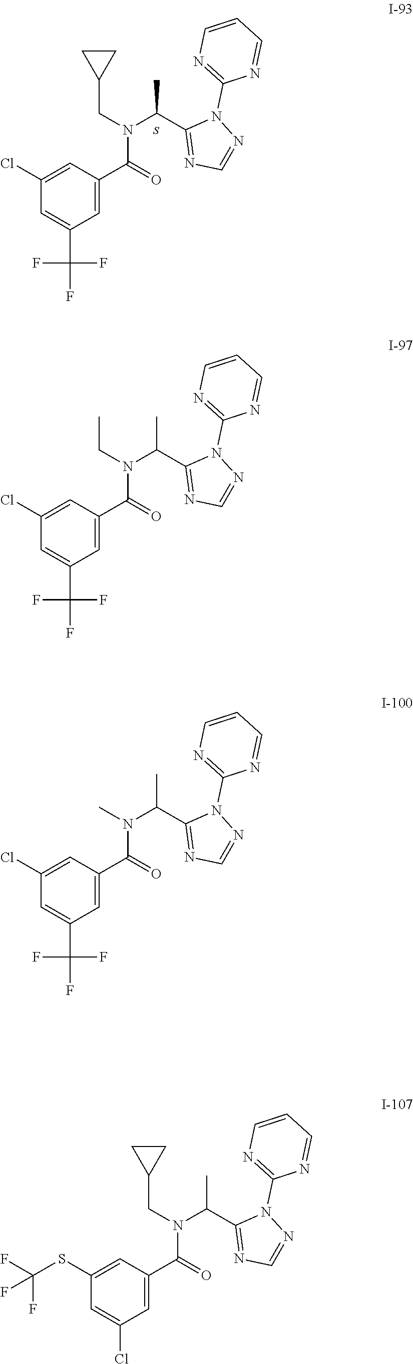 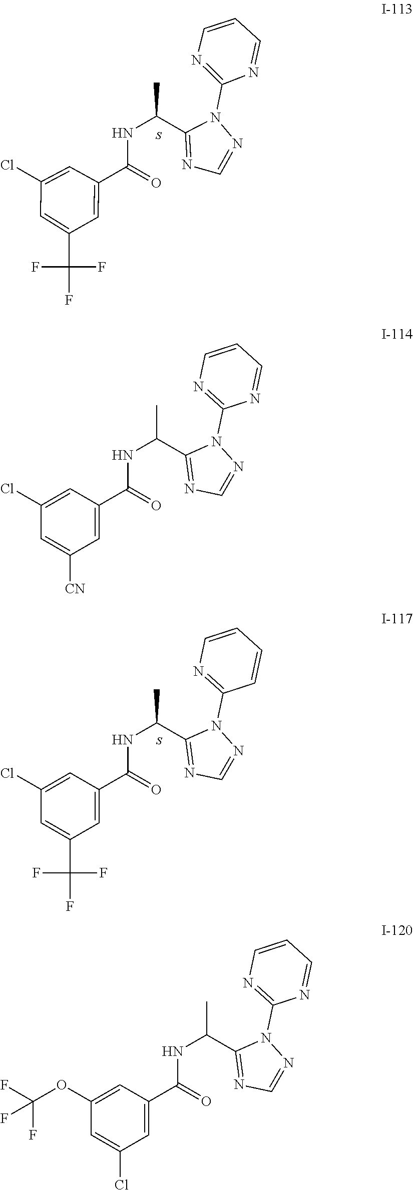 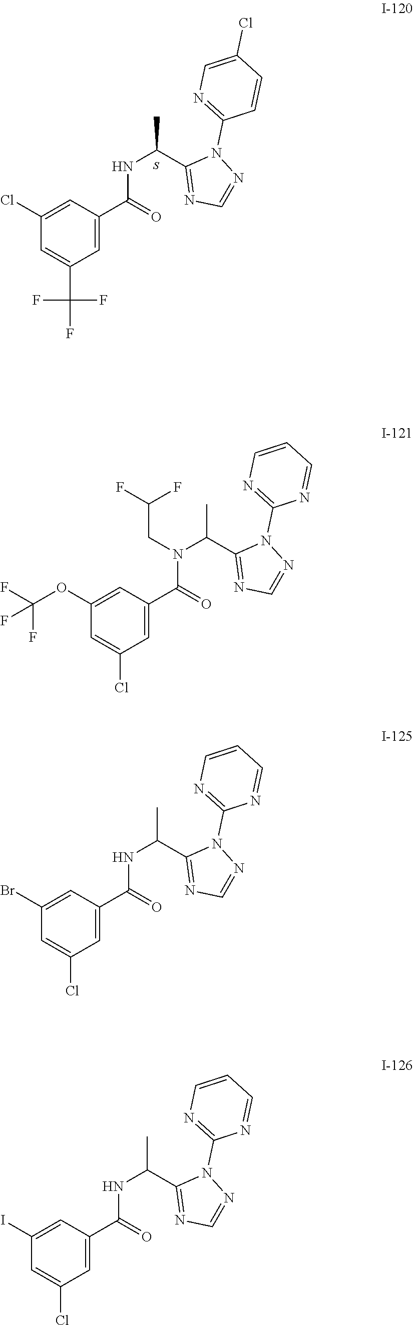 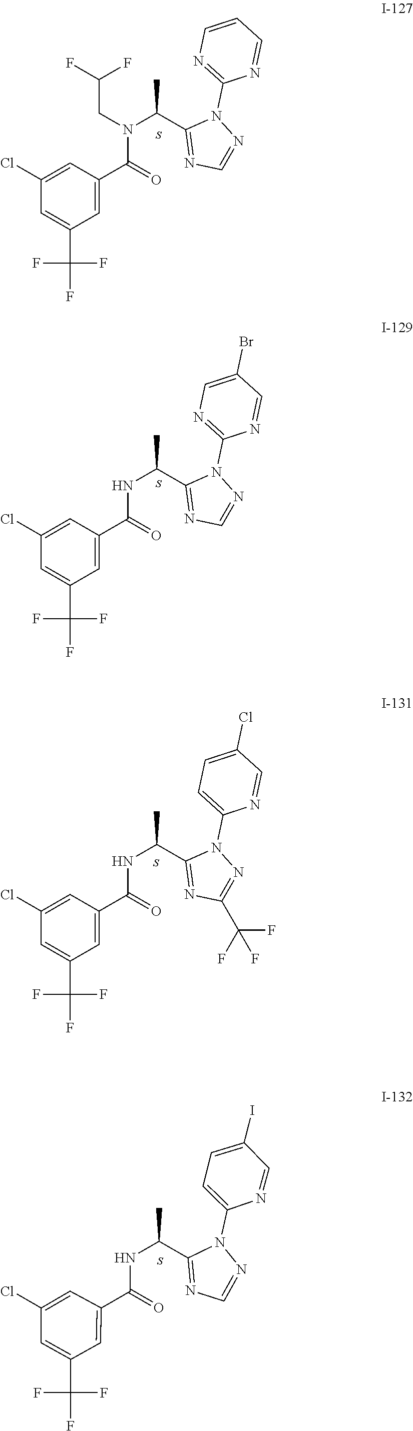 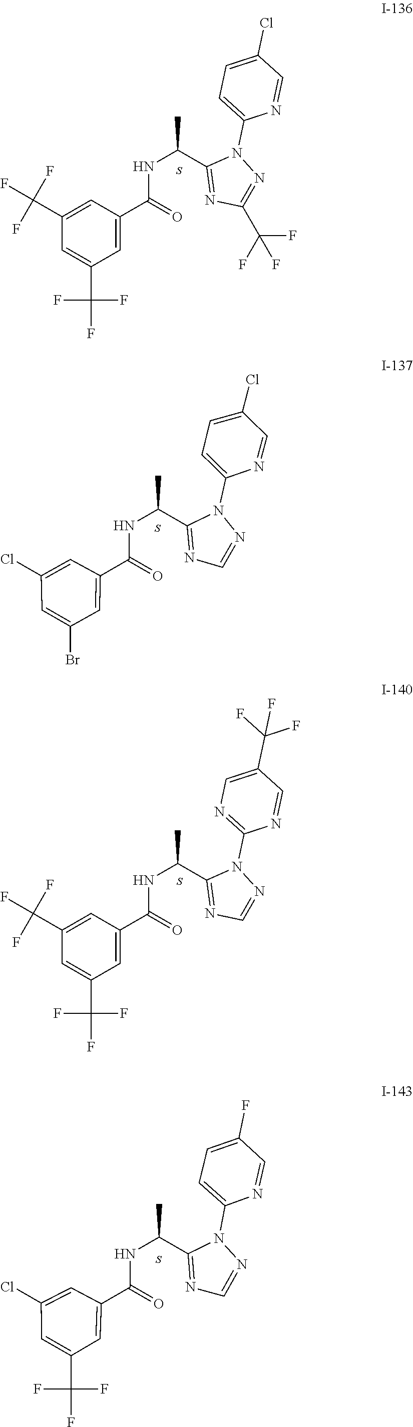 [chemical structure]
